(19) United States
(12) Patent Application Publication
(10) Pub. No.: US 2025/0086738 A1
(43) Pub. Date: Mar. 13, 2025

(54) DATABASES OF AN IMPROVED COMPUTER FOR TECHNOLOGY

(71) Applicant: Markison Patent Portal, Inc., Chicago, IL (US)

(72) Inventor: Timothy W. Markison, Mesa, AZ (US)

(73) Assignee: Markison Patent Portal, Inc., Chicago, IL (US)

(21) Appl. No.: 18/830,993

(22) Filed: Sep. 11, 2024

Related U.S. Application Data
(60) Provisional application No. 63/538,000, filed on Sep. 12, 2023.

(51) Int. Cl. G06Q 50/18; G06F 16/93

(52) U.S. Cl. CPC G06Q 50/184; G06F 16/93; G06F 2216/11

(57) ABSTRACT

A method for generating a docket number includes determining, by a computing entity, whether a specification of an application includes a detailed discussion for a single invention or for a plurality of inventions. When the specification includes the detailed discussion for the plurality of inventions, the method includes generating, by the computing entity, a common specification number. The method further includes generating, by the computing entity, a common specification designator. The method further includes generating, by the computing entity, a plurality of invention numbers. The method further includes generating, by the computing entity, a plurality of protection type designators. For the first invention, the method further includes combining, by the computing entity, the common specification number, the common specification designator, the first invention number, and the first protection type designator to produce a first docket number for the first invention.

### CROSS-REFERENCE TO RELATED APPLICATIONS

The present U.S. Utility patent application claims priority pursuant to 35 U.S.C. § 119 (e) to U.S. Provisional Application No. 63/538,000, entitled “DATABASES OF AN IMPROVED COMPUTER FOR TECHNOLOGY”, filed Sep. 12, 2023, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

The disclosed subject matter relates to a variety of technologies and more particularly to one or more databases of an improved computer for technology.

### Description of Related Art

Technology is defined as the application of scientific knowledge for practical purposes. The scientific knowledge often applied are physical sciences and/or life sciences but may further include social sciences and/or political sciences. Physical sciences involve the study of the physical world and/or the universe. Life sciences involve the study of living things, human and non-human.

The physical sciences are divided and sub-divided into a plurality of physical science fields (e.g., electrical engineering, computer science, data science, physics, etc.). Similarly, the life sciences are divided and sub-divided into a plurality of life science fields (e.g., biology, human anatomy, physiology, botany, etc.). The advancement of most, if not all, of the scientific fields rely on data analytics provided by computers.

Many advancements in the various scientific fields are innovative and warrant protection. There is a variety of protection mechanisms to protect such innovations; which include legal protection, physical protection, and virtual protection. Creating, identifying, managing, tracking, protecting, utilizing, organizing, and/or evolving innovations within a scientific field is often an overwhelming task and, as such, is often not done or is done ineffectively and/or inefficiently. When the task is over multiple scientific fields, it is even more daunting.

### BRIEF DESCRIPTION OF THE SEVERAL VIEWS OF THE DRAWING(S)

FIG. 1 is a schematic block diagram of an embodiment of an improved computer for technology;

FIG. 2 is a schematic block diagram of another embodiment of an improved computer for technology;

FIGS. 3A through 3E are schematic block diagram of embodiments of computing entities that are part of an improved computer for technology;

FIGS. 4A through 4G are schematic block diagram of embodiments of computing devices that form at least a portion of a computing entity;

FIG. 5 is a schematic block diagram of an embodiment of a database;

FIG. 6 is a schematic block diagram of a further embodiment of an improved computer for technology;

FIG. 7 is a schematic block diagram of a further embodiment of an improved computer for technology;

FIG. 8 is a schematic block diagram of a further embodiment of an improved computer for technology;

FIG. 9 is a schematic block diagram of a further embodiment of an improved computer for technology;

FIG. 10 is a schematic block diagram of a further embodiment of an improved computer for technology;

FIG. 10A is a logic diagram of an example of a method for an improved computer for technology to generate a technology report;

FIG. 10B is a logic diagram of an example of a method for an improved computer for technology to generate a technology protection report;

FIG. 10C is a schematic block diagram of an example of a technology report generated by an improved computer for technology;

FIG. 10D is a schematic block diagram of an example of another technology report generated by an improved computer for technology;

FIG. 11 is a schematic block diagram of an embodiment of a private patent tracking database of an improved computer for technology;

FIG. 11A is a schematic block diagram of an example of a product-tech unit (PTU) naming convention for use by one or more databases of an improved computer for technology;

FIG. 11B is a schematic block diagram of an example of applying the PTU naming convention to the tech protection & tech score unit of an improved computer for technology;

FIG. 11C is a schematic block diagram of an example of applying the PTU naming convention to components of the tech protection & tech score unit of an improved computer for technology;

FIG. 11D is a schematic block diagram of a further example of applying the PTU naming convention to components of the tech protection & tech score unit of an improved computer for technology;

FIG. 11E is a schematic block diagram of a further example of applying the PTU naming convention to components of the tech protection & tech score unit of an improved computer for technology;

FIG. 11F is a schematic block diagram of an example of a tech challenge to problem mapping for a component of the tech protection & tech score unit of an improved computer for technology;

FIG. 12 is a schematic block diagram of an embodiment of a data query processing computing entity (of a private patent tracking database of an improved computer for technology);

FIG. 13 is a schematic block diagram of a functional embodiment of a data organizing computing entity (of a private patent tracking database of an improved computer for technology);

FIG. 14 is a schematic block diagram of another functional embodiment of a data organizing computing entity (of a private patent tracking database of an improved computer for technology);

FIG. 15 is a schematic block diagram of another functional embodiment of a data organizing computing entity (of a private patent tracking database of an improved computer for technology);

FIG. 16 is a schematic block diagram of an embodiment of an invention protection database and a client database (of a private patent tracking database of an improved computer for technology);

FIG. 17 is a schematic block diagram of an example of a docketing section of an invention protection database (of a private patent tracking database of an improved computer for technology);

FIG. 17A is a diagram of an example of a list of invention patent protection status options for a record within an invention protection database (of a private patent tracking database of an improved computer for technology);

FIG. 17B is a diagram of an example of a list of invention patent protection type options for a record within an invention protection database (of a private patent tracking database of an improved computer for technology);

FIG. 17C is a diagram of an example of a first pre-filing docket number format for a record within an invention protection database (of a private patent tracking database of an improved computer for technology);

FIG. 17D is a diagram of an example of a second pre-filing docket number format for a record within an invention protection database (of a private patent tracking database of an improved computer for technology);

FIG. 17E is a diagram of an example of a first filing docket number format for a record within an invention protection database (of a private patent tracking database of an improved computer for technology);

FIG. 17F is a diagram of an example of a second filing docket number format for a record within an invention protection database (of a private patent tracking database of an improved computer for technology);

FIG. 18 is a schematic block diagram of an example of a representation section of an invention protection database (of a private patent tracking database of an improved computer for technology);

FIG. 19 is a schematic block diagram of an example of an invention information section of an invention protection database (of a private patent tracking database of an improved computer for technology);

FIG. 20 is a schematic block diagram of an example of an application section of an invention protection database (of a private patent tracking database of an improved computer for technology);

FIG. 21 is a schematic block diagram of an example of a priority & inclusion data section of an invention protection database (of a private patent tracking database of an improved computer for technology);

FIG. 21A is a diagram of an example of a list of priority claim type options for a record within an invention protection database (of a private patent tracking database of an improved computer for technology);

FIG. 21B is a diagram of an example of a list of priority claim suffix options for a filing docket number of a record within an invention protection database (of a private patent tracking database of an improved computer for technology);

FIG. 22 is a schematic block diagram of an example of a prosecution data section of an invention protection database (of a private patent tracking database of an improved computer for technology);

FIG. 23 is a schematic block diagram of an example of a probability data section of an invention protection database (of a private patent tracking database of an improved computer for technology);

FIG. 24 is a schematic block diagram of an example of an invention patent protection data section of a client database (of a private patent tracking database of an improved computer for technology);

FIG. 25 is a schematic block diagram of an example of time periods data section of a client database (of a private patent tracking database of an improved computer for technology);

FIG. 26 is a schematic block diagram of an embodiment of an invention protection database and a patent plan database (of a private patent tracking database of an improved computer for technology);

FIG. 27 is a schematic block diagram of an example of a plurality of patent plans created by a patent plan database (of a private patent tracking database of an improved computer for technology);

FIG. 27A is a schematic block diagram of an embodiment of a factual new invention database and a PTU database of a patent plan database (of a private patent tracking database of an improved computer for technology);

FIG. 28 is a schematic block diagram of an example of a plurality of factual new invention reports created by a factual new invention database of a patent plan database (of a private patent tracking database of an improved computer for technology);

FIG. 29 is a schematic block diagram of an example of a predictive new invention report created by a PTU database of a patent plan database (of a private patent tracking database of an improved computer for technology);

FIG. 29A is a schematic block diagram of an example of a plurality of curves that plot percentage of tech life completed versus percentage of inventing completed for various patent positions, which is an input to a PTU database for generating a predictive new invention report;

FIG. 30 is a schematic block diagram of an example of a factual new invention report created, based on an input from the factual new invention database, by a PTU database of a patent plan database (of a private patent tracking database of an improved computer for technology);

FIG. 31 is a schematic block diagram of an example of a filing report for predictive new inventions created by a PTU database of a patent plan database (of a private patent tracking database of an improved computer for technology);

FIG. 32 is a schematic block diagram of an example of a filing report for factual new inventions created by a PTU database of a patent plan database (of a private patent tracking database of an improved computer for technology);

FIG. 33 is a schematic block diagram of an example of a graph of phases of technology development, product development, and corresponding types of inventions, which is an input to a PTU database for generating a predictive new invention report and/or for generating a factual new invention report;

FIG. 34 is a schematic block diagram of an example of a patent protection planning parameters section and a US patent protection planning parameters of patent plan database (of a private patent tracking database of an improved computer for technology);

FIG. 35 is a schematic block diagram of an example of a PCT patent planning parameters section of patent plan database (of a private patent tracking database of an improved computer for technology);

FIG. 36 is a schematic block diagram of an example of a foreign patent planning parameters section of patent plan database (of a private patent tracking database of an improved computer for technology);

FIG. 37 is a schematic block diagram of an example of a tech development timeline data section of patent plan database (of a private patent tracking database of an improved computer for technology);

FIG. 38 is a schematic block diagram of an example of a tech disruption data section of patent plan database (of a private patent tracking database of an improved computer for technology);

FIG. 39 is a schematic block diagram of an example of an invention type data section of patent plan database (of a private patent tracking database of an improved computer for technology);

FIG. 40 is a schematic block diagram of an example of a patent position data section of patent plan database (of a private patent tracking database of an improved computer for technology);

FIG. 41 is a schematic block diagram of an example of inputs to a PTU database that are used by the PTU database to generate a predictive new invention report;

FIG. 42 is a schematic block diagram of an example of a predictive PTU to invention tree based on inputs of FIG. 41;

FIG. 43 is a schematic block diagram of an example of a predictive tech challenge to invention data section of a PTU database and/or of patent plan database (of a private patent tracking database of an improved computer for technology);

FIG. 44 is a schematic block diagram of an example of a PTU patent plan for predictive new inventions section of a PTU database and/or of patent plan database (of a private patent tracking database of an improved computer for technology);

FIG. 45 is a schematic block diagram of an example of a factual PTU to invention tree that is created by a PTU database and/or by a patent plan database (of a private patent tracking database of an improved computer for technology);

FIG. 46 is a schematic block diagram of an example of a first part of a factual tech challenge to new inventions section of a PTU database and/or of patent plan database (of a private patent tracking database of an improved computer for technology);

FIG. 47 is a schematic block diagram of an example of a second part of a factual tech challenge to new inventions section of a PTU database and/or of patent plan database (of a private patent tracking database of an improved computer for technology);

FIG. 48 is a schematic block diagram of an example of a third part of a factual tech challenge to new inventions section of a PTU database and/or of patent plan database (of a private patent tracking database of an improved computer for technology);

FIG. 49 is a schematic block diagram of an example of a PTU patent plan for factual new inventions section of a PTU database and/or of patent plan database (of a private patent tracking database of an improved computer for technology);

FIG. 50 is a schematic block diagram of an example of a first part of patent plan summary section of patent plan database (of a private patent tracking database of an improved computer for technology);

FIG. 51 is a schematic block diagram of an example of a second part of patent plan summary section of patent plan database (of a private patent tracking database of an improved computer for technology);

FIG. 52 is a schematic block diagram of an example of a plurality of product PTU tech score reports over a plurality of evaluation periods that are generated by a tech score database (of a private patent tracking database of an improved computer for technology);

FIG. 53 is a schematic block diagram of an example of functional interaction of databases (of a private patent tracking database of an improved computer for technology);

FIG. 54 is a schematic block diagram of an example of a patent family tree of patents that protect a single invention and corresponding records of an invention protection database (of a private patent tracking database of an improved computer for technology);

FIG. 55 is a schematic block diagram of an example of a record regarding an invention and patent protection thereof via single invention patent application, where the record is within an invention protection database (of a private patent tracking database of an improved computer for technology);

FIG. 56 is a schematic block diagram of an example of various patent application filing options and corresponding docket numbers regarding a record of an invention within an invention protection database (of a private patent tracking database of an improved computer for technology);

FIG. 57 is a schematic block diagram of an example of first filing a provisional patent application for an invention, updating its record, subsequent patent application filing with first claiming options, and updating their corresponding record within an invention protection database (of a private patent tracking database of an improved computer for technology);

FIG. 58 is a schematic block diagram of an example of first filing a US utility patent application for an invention, updating its record, subsequent patent application filing with first claiming options, and updating their corresponding record within an invention protection database (of a private patent tracking database of an improved computer for technology);

FIG. 59 is a schematic block diagram of an example of first filing a Foreign utility patent application for an invention, updating its record, subsequent patent application filing with first claiming options, and updating their corresponding record within an invention protection database (of a private patent tracking database of an improved computer for technology);

FIG. 60 is a schematic block diagram of an example of first filing a PCT patent application for an invention, updating its record, subsequent patent application filing with first claiming options, and updating their corresponding record within an invention protection database (of a private patent tracking database of an improved computer for technology);

FIG. 61 is a schematic block diagram of another example of first filing a provisional patent application for an invention, updating its record, subsequent patent application filing with first claiming options, and updating their corresponding record within an invention protection database (of a private patent tracking database of an improved computer for technology);

FIG. 62 is a schematic block diagram of another example of first filing a PCT patent application for an invention, updating its record, subsequent patent application filing with first claiming options, and updating their corresponding record within an invention protection database (of a private patent tracking database of an improved computer for technology);

FIG. 63 is a schematic block diagram of another example of first filing a US utility patent application for an invention, updating its record, subsequent patent application filing with first claiming options, and updating their corresponding record within an invention protection database (of a private patent tracking database of an improved computer for technology);

FIG. 64 is a schematic block diagram of another example of first filing a Foreign utility patent application for an invention, updating its record, subsequent patent application filing with first claiming options, and updating their corresponding record within an invention protection database (of a private patent tracking database of an improved computer for technology);

FIG. 65 is a schematic block diagram of another example of first filing a provisional patent application for an invention, subsequent patent application filing with first claiming options, and subsequent patent application filing with subsequent claiming options as recorded within an invention protection database (of a private patent tracking database of an improved computer for technology);

FIG. 66 is a schematic block diagram of an example of first filing a US utility patent application for an invention with first claiming, its prosecution to expiration timeline, and US subsequent patent application filing with subsequent claiming options as recorded within an invention protection database (of a private patent tracking database of an improved computer for technology);

FIG. 67 is a schematic block diagram of an example of first filing a provisional patent application for an invention, filing a US utility application for the invention as a subsequent filing with first claiming, its prosecution to expiration timeline, and a series of US subsequent patent application filings with subsequent claiming as recorded within an invention protection database (of a private patent tracking database of an improved computer for technology);

FIG. 68 is a schematic block diagram of an example of first filing a provisional patent application for an invention, filing a US utility application for the invention as a subsequent filing with first claiming, filing a PCT application for the invention as a subsequent filing with first claiming, filing one or more Foreign utility applications for the invention as a subsequent filing with first claiming, a series of US subsequent patent application filings with subsequent claiming, and corresponding docket numbers as recorded within an invention protection database (of a private patent tracking database of an improved computer for technology);

FIG. 69 is a schematic block diagram of an example of first filing multiple provisional patent applications for different aspects of an invention, filing a US utility application for the invention as a subsequent filing with first claiming and with priority to the multiple provisional applications, and corresponding docket numbers as recorded within an invention protection database (of a private patent tracking database of an improved computer for technology);

FIG. 70 is a schematic block diagram of an example of first filing multiple provisional patent applications for multiple inventions, filing a common spec US utility application for the inventions as a subsequent filing with first claiming of one of the inventions and with priority to the multiple provisional applications, and corresponding docket numbers as recorded within an invention protection database (of a private patent tracking database of an improved computer for technology);

FIG. 71 is a schematic block diagram of an example of first filing multiple provisional patent applications for multiple inventions, filing multiple US utility applications using a common spec for the inventions as a subsequent filing with first claiming of the inventions and with priority to the multiple provisional applications, and corresponding docket numbers as recorded within an invention protection database (of a private patent tracking database of an improved computer for technology);

FIG. 72 is a schematic block diagram of an example of first filing multiple provisional patent applications for multiple inventions, filing multiple US utility applications for the inventions as a subsequent filing with first claiming of the inventions and each with priority to one of the provisional applications, subsequent filing with subsequent claiming via combining the multiple US utility applications, and corresponding docket numbers as recorded within an invention protection database (of a private patent tracking database of an improved computer for technology);

FIG. 73 is a schematic block diagram of an example of first filing a provisional patent application for an invention, filing a US utility application for the invention as a subsequent filing with first claiming of the invention and with priority to the provisional application, subsequent filing with subsequent claiming via combining the US utility application with a new invention, and corresponding docket numbers as recorded within an invention protection database (of a private patent tracking database of an improved computer for technology);

FIG. 74 is a schematic block diagram of an example of four records within an invention protection database (of a private patent tracking database of an improved computer for technology), a first record for first patent protection of an invention via a provisional application, a second record for a subsequent filing with first claiming via a US utility application, a third record for a subsequent filing with subsequent claiming via a US CON application for the invention, and a fourth record for another subsequent filing with subsequent claiming via a US CIP application for the invention;

FIG. 75 is a schematic block diagram of another example of three records within an invention protection database (of a private patent tracking database of an improved computer for technology), a fifth record for a new invention that is combined with a pending application and filed as a second invention via a US CIP with new invention application, a sixth record for the pending patent application that was combined with the new invention, a seventh record for a subsequent filing with subsequent claiming via a US CON application for the new invention of the combined CIP application;

FIG. 76 is a schematic block diagram of an example of multiple record regarding multiple inventions and a common spec patent application thereof as recorded within an invention protection database (of a private patent tracking database of an improved computer for technology);

FIG. 77 is a schematic block diagram of an example of various patent application filing options for multiple inventions of a common spec application as associated with an invention protection database (of a private patent tracking database of an improved computer for technology);

FIG. 78 is a schematic block diagram of an example of first filing a provisional patent application for multiple inventions, updating their records by updating the corresponding docket numbers, invention patent protection type, invention patent protection status, and priority claim type as recorded within an invention protection database (of a private patent tracking database of an improved computer for technology);

FIG. 79 is a schematic block diagram of an example of first filing multiple provisional patent applications for multiple inventions, updating their records by updating the corresponding docket numbers, invention patent protection type, invention patent protection status, and priority claim type as recorded within an invention protection database (of a private patent tracking database of an improved computer for technology);

FIG. 80 is a schematic block diagram of an example of first filing multiple provisional patent applications for multiple inventions, the first provisional application includes one new invention and embellishes on two inventions of the first provisional application, the third provisional application includes one new invention and further embellishes on three inventions of the first two provisional applications as recorded within an invention protection database (of a private patent tracking database of an improved computer for technology);

FIG. 81 is a schematic block diagram of updating records of the provisional applications and inventions thereof of FIG. 80 by updating the corresponding docket numbers, invention patent protection type, invention patent protection status, and priority claim type as recorded within an invention protection database (of a private patent tracking database of an improved computer for technology);

FIG. 82 is a schematic block diagram of an example of first filing a provisional patent application for multiple inventions, converting the provisional application into a US utility patent application with claims for invention number 2, updating their records by updating the corresponding docket numbers, invention patent protection type, invention patent protection status, and priority claim type as recorded within an invention protection database (of a private patent tracking database of an improved computer for technology);

FIG. 83 is a schematic block diagram of an example of first filing multiple provisional patent applications for multiple inventions, converting the multiple provisional applications into a US utility patent application with claims for invention number 2, updating their records by updating the corresponding docket numbers, invention patent protection type, invention patent protection status, and priority claim type as recorded within an invention protection database (of a private patent tracking database of an improved computer for technology);

FIG. 84 is a schematic block diagram of an example of first filing three provisional patent applications for multiple inventions, converting the three multiple provisional applications into a US utility patent application with claims for invention number 3, updating their records by updating the corresponding docket numbers, invention patent protection type, invention patent protection status, and priority claim type as recorded within an invention protection database (of a private patent tracking database of an improved computer for technology);

FIG. 85 is a schematic block diagram of an example of first filing a common spec US utility patent application for multiple inventions with claims for invention number 2, updating their records by updating the corresponding docket numbers, invention patent protection type, invention patent protection status, and priority claim type as recorded within an invention protection database (of a private patent tracking database of an improved computer for technology);

FIG. 86 is a schematic block diagram of an example of first filing two US utility patent applications for multiple inventions and sharing a common spec, the first patent application includes claims for invention number 2, the second patent application includes claims for invention number 4, updating their records by updating the corresponding docket numbers, invention patent protection type, invention patent protection status, and priority claim type as recorded within an invention protection database (of a private patent tracking database of an improved computer for technology);

FIG. 87 is a schematic block diagram of an example of first filing a common spec PCT patent application for multiple inventions with claims for invention number 2, updating their records by updating the corresponding docket numbers, invention patent protection type, invention patent protection status, and priority claim type as recorded within an invention protection database (of a private patent tracking database of an improved computer for technology);

FIG. 88 is a schematic block diagram of an example of first filing a common spec Foreign utility patent application for multiple inventions with claims for invention number 2, updating their records by updating the corresponding docket numbers, invention patent protection type, invention patent protection status, and priority claim type as recorded within an invention protection database (of a private patent tracking database of an improved computer for technology);

FIG. 89 is a schematic block diagram of an example of first filing a provisional patent application for five inventions, converting the provisional patent application into a US utility patent application having a common spec for the five inventions and having claims for invention number 2, the US utility application's prosecution to expiration timeline, subsequent filing with first claiming filing options prior to time t4, subsequent patent application filing with first claiming options for one of the other inventions before t6, and subsequent patent application filing with subsequent claiming options for invention number 2 before t6 as recorded within an invention protection database (of a private patent tracking database of an improved computer for technology);

FIG. 90 is a schematic block diagram of an example of first filing a US utility patent application having a common spec for five inventions and having claims for invention number 2, the US utility application's prosecution to expiration timeline, subsequent filing with first claiming filing options within one year of time t4 for invention number 2, subsequent patent application filing with first claiming options for one of the other inventions before t6, and subsequent patent application filing with subsequent claiming options for invention number 2 before t6 as recorded within an invention protection database (of a private patent tracking database of an improved computer for technology);

FIG. 91 is a schematic block diagram of an example of first filing a provisional patent application for five inventions, converting the provisional patent application into a US utility patent application having a common spec for the five inventions and having claims for invention number 2, and updates to their corresponding records as recorded within an invention protection database (of a private patent tracking database of an improved computer for technology);

FIG. 92 is a schematic block diagram of an example of a record within an invention protection database (of a private patent tracking database of an improved computer for technology) first filing of a provisional patent application that includes a common spec for five inventions;

FIG. 93 is a schematic block diagram of an example of a record within an invention protection database (of a private patent tracking database of an improved computer for technology) for a first invention of first filing of a provisional patent application that includes a common spec for five inventions;

FIG. 94 is a schematic block diagram of an example of a record within an invention protection database (of a private patent tracking database of an improved computer for technology) for a second invention of first filing of a provisional patent application that includes a common spec for five inventions;

FIG. 95 is a schematic block diagram of an example of a record within an invention protection database (of a private patent tracking database of an improved computer for technology) for a third invention of first filing of a provisional patent application that includes a common spec for five inventions;

FIG. 96 is a schematic block diagram of an example of a record within an invention protection database (of a private patent tracking database of an improved computer for technology) for a fourth invention of first filing of a provisional patent application that includes a common spec for five inventions;

FIG. 97 is a schematic block diagram of an example of a record within an invention protection database (of a private patent tracking database of an improved computer for technology) for a fifth invention of first filing of a provisional patent application that includes a common spec for five inventions;

FIG. 98 is a schematic block diagram of an example of editing a record within an invention protection database (of a private patent tracking database of an improved computer for technology) for a first invention of provisional conversion US utility patent application that claims priority to a provisional patent application, that includes a common spec for five inventions, and that includes claims for invention number 2;

FIG. 99 is a schematic block diagram of an example of editing a record within an invention protection database (of a private patent tracking database of an improved computer for technology) for a second invention of provisional conversion US utility patent application that claims priority to a provisional patent application, that includes a common spec for five inventions, and that includes claims for invention number 2;

FIG. 100 is a schematic block diagram of an example of editing a record within an invention protection database (of a private patent tracking database of an improved computer for technology) for a third invention of provisional conversion US utility patent application that claims priority to a provisional patent application, that includes a common spec for five inventions, and that includes claims for invention number 2;

FIG. 101 is a schematic block diagram of an example of editing a record within an invention protection database (of a private patent tracking database of an improved computer for technology) for a fourth invention of provisional conversion US utility patent application that claims priority to a provisional patent application, that includes a common spec for five inventions, and that includes claims for invention number 2;

FIG. 102 is a schematic block diagram of an example of editing a record within an invention protection database (of a private patent tracking database of an improved computer for technology) for a fifth invention of provisional conversion US utility patent application that claims priority to a provisional patent application, that includes a common spec for five inventions, and that includes claims for invention number 2;

FIG. 103 is a schematic block diagram of an example of allowance of US utility patent application that includes a common spec for five inventions and includes claims for invention number 2, subsequent filing with first claiming options of the other inventions, and subsequent filing with subsequent claiming options for invention number 2 as recorded within an invention protection database (of a private patent tracking database of an improved computer for technology);

FIG. 104 is a schematic block diagram of an example of a single branch common spec application tree of a provisional patent application that includes a common spec for five inventions, subsequent filing with first claiming options of the other inventions, and subsequent filing with subsequent claiming options for inventions 1 and 2 as recorded within an invention protection database (of a private patent tracking database of an improved computer for technology);

FIG. 105 is a schematic block diagram of an example of two docket number approaches and the corresponding suffixes for the common spec application tree of FIG. 104 as recorded within an invention protection database (of a private patent tracking database of an improved computer for technology);

FIG. 106 is a schematic block diagram of another example of a single branch common spec application tree of a US utility patent application that includes a common spec for five inventions and claims for invention 2, subsequent filing with first claiming options of the other inventions, and subsequent filing with subsequent claiming options for inventions 1 and 2 as recorded within an invention protection database (of a private patent tracking database of an improved computer for technology);

FIG. 107 is a schematic block diagram of an example of a multiple branch common spec application tree of a provisional patent application that includes a common spec for five inventions, subsequent filing with first claiming options of the other inventions, and subsequent filing with subsequent claiming options for inventions 1 and 2 as recorded within an invention protection database (of a private patent tracking database of an improved computer for technology);

FIG. 108 is a schematic block diagram of another example of a multiple branch common spec application tree of a provisional patent application that includes a common spec for five inventions, subsequent filing with first claiming options of the other inventions, and subsequent filing with subsequent claiming options for inventions 1 and 2 as recorded within an invention protection database (of a private patent tracking database of an improved computer for technology);

FIG. 109 is a schematic block diagram of another example of a multiple branch common spec application tree of a provisional patent application that includes a common spec for five inventions, subsequent filing with first claiming options of the other inventions, and subsequent filing with subsequent claiming options for inventions 1, 2, 4, and 5 as recorded within an invention protection database (of a private patent tracking database of an improved computer for technology);

FIG. 110 is a schematic block diagram of another example of a single branch common spec application tree of a provisional patent application that includes a common spec for five inventions, subsequent filing with first claiming options of the other inventions, subsequent filing with subsequent claiming options for inventions 1 and 2, and inclusion of another invention as part of an LPC CIP with invention 3 as recorded within an invention protection database (of a private patent tracking database of an improved computer for technology);

FIG. 111 is a schematic block diagram of another example of a single branch common spec application tree of a provisional patent application that includes a common spec for five inventions, subsequent filing with first claiming options of the other inventions, subsequent filing with subsequent claiming options for inventions 1 and 2, and inclusion of another legal placeholder invention as part of an LPC CIP with invention 3 as recorded within an invention protection database (of a private patent tracking database of an improved computer for technology);

FIG. 112 is a schematic block diagram of another example of a single branch common spec application tree of a provisional patent application that includes a common spec for five inventions, subsequent filing with first claiming options of the other inventions, subsequent filing with subsequent claiming options for inventions 1 and 2, and inclusion of another pending single invention patent application as part of an LPC CIP with invention 3 as recorded within an invention protection database (of a private patent tracking database of an improved computer for technology);

FIG. 113 is a schematic block diagram of another example of two docket number approaches and the corresponding suffixes for records as recorded within an invention protection database (of a private patent tracking database of an improved computer for technology);

FIG. 114 is a schematic block diagram of another example of a single branch common spec application tree of a provisional patent application that includes a common spec for five inventions, subsequent filing with first claiming options of the other inventions, subsequent filing with subsequent claiming options for invention 2, and corresponding direct priority claiming as recorded within an invention protection database (of a private patent tracking database of an improved computer for technology);

FIG. 115 is a schematic block diagram of another example of a multiple branch common spec application tree of a provisional patent application that includes a common spec for five inventions, subsequent filing with first claiming options for the inventions, subsequent filing with subsequent claiming options for the inventions, and corresponding direct priority claiming as recorded within an invention protection database (of a private patent tracking database of an improved computer for technology);

FIG. 116 is a schematic block diagram of another example of a multiple branch common spec application tree of a provisional patent application that includes a common spec for five inventions, subsequent filing with first claiming options for the inventions, and subsequent filing with subsequent claiming options for the inventions as recorded within an invention protection database (of a private patent tracking database of an improved computer for technology);

FIG. 117 is a schematic block diagram of an example of editing a record within an invention protection database (of a private patent tracking database of an improved computer for technology) for a fourth invention of a provisional application of FIG. 116 that is being converted into a US utility patent application that claims priority to the provisional patent application, that includes a common spec for five inventions, and that includes claims for invention number 4;

FIG. 118 is a schematic block diagram of an example of editing a record within an invention protection database (of a private patent tracking database of an improved computer for technology) for a fifth invention of a provisional application of FIG. 116 that is being converted as a legal placeholder conversion into a US utility patent application that claims priority to the US utility patent application for invention 4, that includes a common spec for five inventions, and that includes claims for invention number 5;

FIG. 119 is a schematic block diagram of an example of creating a record within an invention protection database (of a private patent tracking database of an improved computer for technology) for a fifth invention of a provisional application of FIG. 116 that is being filed as a continuation in part application that claims priority to the legal placeholder conversion patent application for invention 5, that includes a common spec for five inventions, and that includes claims for invention number 5;

FIG. 120 is a schematic block diagram of an example of creating a record within an invention protection database (of a private patent tracking database of an improved computer for technology) for a fourth invention of a provisional application of FIG. 116 that is being filed as a continuation application that claims priority to the provisional conversion patent application for invention 4, that includes a common spec for five inventions, and that includes claims for invention number 4;

FIG. 121 is a schematic block diagram of an example of creating a record within an invention protection database (of a private patent tracking database of an improved computer for technology) for a fourth invention of a provisional application of FIG. 116 that is being filed as a second continuation application that claims priority to the continuation patent application for invention 4, that includes a common spec for five inventions, and that includes claims for invention number 4;

FIG. 122 is a schematic block diagram of an example of editing a record within an invention protection database (of a private patent tracking database of an improved computer for technology) for a second invention of a provisional application of FIG. 116 that is being converted into a US utility patent application that claims priority to the provisional patent application, that includes a common spec for five inventions, and that includes claims for invention number 2;

FIG. 123 is a schematic block diagram of an example of creating a record within an invention protection database (of a private patent tracking database of an improved computer for technology) for a second invention of a provisional application of FIG. 116 that is being filed as a PCT patent application that claims priority to the US utility patent application for invention 2, that includes a common spec for five inventions, and that includes claims for invention number 2;

FIG. 124 is a schematic block diagram of an example of creating a record within an invention protection database (of a private patent tracking database of an improved computer for technology) for a second invention of a provisional application of FIG. 116 that is being filed as Foreign utility patent application that claims priority to a PCT patent application for invention 2, that includes a common spec for five inventions, and that includes claims for invention number 2;

FIG. 125 is a schematic block diagram of an example of creating a record within an invention protection database (of a private patent tracking database of an improved computer for technology) for a second invention of a provisional application of FIG. 116 that is being filed as a continuation patent application that claims priority to the US utility patent application for invention 2, that includes a common spec for five inventions, and that includes claims for invention number 2;

FIG. 126 is a schematic block diagram of an example of editing a record within an invention protection database (of a private patent tracking database of an improved computer for technology) for a third invention of a provisional application of FIG. 116 that is being converted as a legal placeholder conversion into a US utility patent application that claims priority to the US utility patent application for invention 2, that includes a common spec for five inventions, and that includes claims for invention number 3;

FIG. 127 is a schematic block diagram of an example of creating a record within an invention protection database (of a private patent tracking database of an improved computer for technology) for a third invention of a provisional application of FIG. 116 that is being patent protected as a continuation patent application that claims priority to a pending LPC US utility patent application for invention 3, that includes a common spec for five inventions, and that includes new claims for invention number 3;

FIG. 128 is a schematic block diagram of an example of creating a record within an invention protection database (of a private patent tracking database of an improved computer for technology) for a second invention of a provisional application of FIG. 116 that is being patent protected as a continuation patent application that claims priority to a pending CON patent application for invention 2, that includes a common spec for five inventions, and that includes new claims for invention number 2;

FIG. 129 is a schematic block diagram of an example of creating a record within an invention protection database (of a private patent tracking database of an improved computer for technology) for a second invention of a provisional application of FIG. 116 that is being patent protected as another continuation patent application that claims priority to a pending second CON patent application for invention 2, that includes a common spec for five inventions, and that includes new claims for invention number 2;

FIG. 130 is a schematic block diagram of an example of editing a record within an invention protection database (of a private patent tracking database of an improved computer for technology) for a first invention of a provisional application of FIG. 116 that is being converted as a legal placeholder conversion into a US utility patent application that claims priority to the US utility patent application for invention 2, that includes a common spec for five inventions, and that includes claims for invention number 1;

FIG. 131 is a schematic block diagram of an example of creating a record within an invention protection database (of a private patent tracking database of an improved computer for technology) for a first invention of a provisional application of FIG. 116 that is being patent protected as a continuation patent application that claims priority to a pending CON patent application for invention 1, that includes a common spec for five inventions, and that includes new claims for invention number 1;

FIG. 132 is a schematic block diagram of an example of creating a record within an invention protection database (of a private patent tracking database of an improved computer for technology) for a first invention of a provisional application of FIG. 116 that is being patent protected as another continuation patent application that claims priority to a pending second CON patent application for invention 1, that includes a common spec for five inventions, and that includes new claims for invention number 1;

FIG. 133 is a schematic block diagram of another example of a multiple branch common spec application tree of two US utility patent applications that each include a common spec for five inventions, subsequent filing with first claiming options for the inventions, and subsequent filing with subsequent claiming options for the inventions as recorded within an invention protection database (of a private patent tracking database of an improved computer for technology);

FIG. 134 is a schematic block diagram of another example of a multiple branch common spec application tree of a US utility patent application that includes a common spec for five inventions, subsequent filing with first claiming options for the inventions, and subsequent filing with subsequent claiming options for the inventions as recorded within an invention protection database (of a private patent tracking database of an improved computer for technology);

FIG. 135 is a schematic block diagram of another example of a multiple branch common spec application tree of multiple provisional patent applications converted into a US utility application that includes a common spec for five inventions, subsequent filing with first claiming options for the inventions, and subsequent filing with subsequent claiming options for the inventions as recorded within an invention protection database (of a private patent tracking database of an improved computer for technology);

FIG. 136 is a logic diagram of an example of a method for generating a docket number and/or a record within an invention protection database (of a private patent tracking database of an improved computer for technology);

FIG. 137 is a logic diagram of another example of a method for generating a docket number and/or a record within an invention protection database (of a private patent tracking database of an improved computer for technology);

FIG. 138 is a logic diagram of another example of a method for generating a docket number and/or a record within an invention protection database (of a private patent tracking database of an improved computer for technology);

FIG. 139 is a logic diagram of another example of a method for generating a docket number and/or a record within an invention protection database (of a private patent tracking database of an improved computer for technology);

FIG. 140 is a logic diagram of another example of a method for generating a docket number and/or a record within an invention protection database (of a private patent tracking database of an improved computer for technology);

FIG. 141 is a logic diagram of another example of a method for generating a docket number and/or a record within an invention protection database (of a private patent tracking database of an improved computer for technology);

FIG. 142 is a logic diagram of another example of a method for generating a docket number and/or a record within an invention protection database (of a private patent tracking database of an improved computer for technology);

FIG. 143 is a logic diagram of another example of a method for generating a client designator for a docket number of a record within an invention protection database (of a private patent tracking database of an improved computer for technology);

FIG. 144 is a diagram of an example of a PTU to inventive embodiment hierarchy of a PTU database and/or of an invention protection database (of a private patent tracking database of an improved computer for technology);

FIG. 145 is a diagram of an example of a graphical representation of tech score for a PTU product based on data of a tech score database, where the graphical representation is created and/or displayed by a data query processing computing entity and/or by a data storage computing entity (of a private patent tracking database of an improved computer for technology);

FIG. 146 is a diagram of another example of a graphical representation of tech score for a PTU product based on value and cost data of a tech score database, where the graphical representation is created and/or displayed by a data query processing computing entity and/or by a data storage computing entity (of a private patent tracking database of an improved computer for technology);

FIG. 147 is a diagram of an example of a graphical representation of tech score for a PTU product based on data of a tech score database, where the graphical representation is created, processed, and/or displayed by a data query processing computing entity and/or by a data storage computing entity (of a private patent tracking database of an improved computer for technology);

FIG. 148 is a diagram of an example of a graphical representation of tech score for a PTU product based on data of a tech score database, where the graphical representation is created, processed, and/or displayed by a data query processing computing entity and/or by a data storage computing entity (of a private patent tracking database of an improved computer for technology);

FIG. 149 is a diagram of an example of a graphical representation of a selectable level of disruption input for a tech score for a PTU product, where the graphical representation is created, processed, and/or displayed by a data query processing computing entity and/or by a data storage computing entity (of a private patent tracking database of an improved computer for technology);

FIG. 150 is a diagram of an example of a graphical representation of a selectable level of market differentiation based on technology input for a tech score for a PTU product, where the graphical representation is created, processed, and/or displayed by a data query processing computing entity and/or by a data storage computing entity (of a private patent tracking database of an improved computer for technology);

FIG. 151 is a diagram of an example of a graphical representation of a product and/or tech development level or remaining tech life input for a tech score for a PTU product, where the graphical representation is created, processed, and/or displayed by a data query processing computing entity and/or by a data storage computing entity (of a private patent tracking database of an improved computer for technology);

FIG. 152 is a diagram of an example of a graphical representation of a product-tech-patent “k” factor input for a tech score for a PTU product, where the graphical representation is created, processed, and/or displayed by a data query processing computing entity and/or by a data storage computing entity (of a private patent tracking database of an improved computer for technology);

FIG. 153 is a diagram of an example of inputs for generating a tech score for a PTU product by a data query processing computing entity and/or by a data storage computing entity (of a private patent tracking database of an improved computer for technology);

FIG. 154 is a diagram of an example of a graphical representation of a tech life score and its factors that are inputs for a tech score for a PTU product, where the graphical representation is created, processed, and/or displayed by a data query processing computing entity and/or by a data storage computing entity (of a private patent tracking database of an improved computer for technology);

FIG. 155 is a diagram of an example of a graphical representation of an effected market score and its factors that are inputs for a tech score for a PTU product, where the graphical representation is created, processed, and/or displayed by a data query processing computing entity and/or by a data storage computing entity (of a private patent tracking database of an improved computer for technology);

FIG. 156 is a logic diagram of an example of a method for generating a tech ownership availability score by a data query processing computing entity and/or by a data storage computing entity (of a private patent tracking database of an improved computer for technology);

FIG. 157 is a diagram of an example of a graphical representation of a tech ownership availability score and its factors that are inputs for a tech score for a PTU product, where the graphical representation is created, processed, and/or displayed by a data query processing computing entity and/or by a data storage computing entity (of a private patent tracking database of an improved computer for technology);

FIG. 158 is a diagram of an example of a graphical representation of a tech ROI score and its factors that are inputs for a tech score for a PTU product, where the graphical representation is created, processed, and/or displayed by a data query processing computing entity and/or by a data storage computing entity (of a private patent tracking database of an improved computer for technology);

FIG. 159 is a diagram of an example of a graph that plots patenting focus versus tech market value, which are inputs for a tech score for a PTU product as created, processed, and/or displayed by a data query processing computing entity and/or by a data storage computing entity (of a private patent tracking database of an improved computer for technology);

FIG. 160 is a diagram of an example of a graph that plots patenting position versus tech value, which are inputs for a tech score for a PTU product as created, processed, and/or displayed by a data query processing computing entity and/or by a data storage computing entity (of a private patent tracking database of an improved computer for technology);

FIG. 161 is a schematic block diagram of an example of tech challenge to inventive embodiment patent fence, which are inputs for a tech score for, and/or a patent plan of, a PTU product as created, processed, and/or displayed by a data query processing computing entity and/or by a data storage computing entity (of a private patent tracking database of an improved computer for technology);

FIG. 162 is a schematic block diagram of an example of physical sciences to tech area mapping, which are inputs for a tech score for, a patent plan of, and/or defining a PTU product as created, processed, and/or displayed by a data query processing computing entity and/or by a data storage computing entity of an improved computer for technology;

FIG. 163 is a schematic block diagram of an example of a physical science product and its generic high-level components, which are inputs for a tech score for, a patent plan of, and/or defining a PTU product as created, processed, and/or displayed by a data query processing computing entity and/or by a data storage computing entity of an improved computer for technology;

FIG. 164 is a schematic block diagram of an example of a computing device and its generic high-level components, which are inputs for a tech score for, a patent plan of, and/or defining a PTU product as created, processed, and/or displayed by a data query processing computing entity and/or by a data storage computing entity of an improved computer for technology;

FIG. 165 is a schematic block diagram of an example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology;

FIG. 166 is a schematic block diagram of another example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology;

FIG. 167 is a schematic block diagram of another example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology;

FIG. 168 is a schematic block diagram of another example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology;

FIG. 169 is a schematic block diagram of an example of a graphical representation of data processing unit and its generic high-level components, which are inputs for a tech score for, a patent plan of, and/or defining a PTU product as created, processed, and/or displayed by a data query processing computing entity and/or by a data storage computing entity of an improved computer for technology;

FIG. 170 is a schematic block diagram of another example of PTU naming and/or PTU hierarchy of a data processing unit and its generic high-level components, which are inputs for a tech score for, a patent plan of, and/or defining a PTU product as created, processed, and/or displayed by a data query processing computing entity and/or by a data storage computing entity of an improved computer for technology;

FIG. 171 is a schematic block diagram of an example of PTU naming and/or PTU hierarchy of a data processing unit, a specific PTU product type/sub-type, and its generic high-level components, which are inputs for a tech score for, a patent plan of, and/or defining a PTU product as created, processed, and/or displayed by a data query processing computing entity and/or by a data storage computing entity of an improved computer for technology;

FIG. 172 is a schematic block diagram of another example of PTU naming and/or PTU hierarchy of a data processing unit, a specific PTU product type/sub-type, and its generic high-level components, which are inputs for a tech score for, a patent plan of, and/or defining a PTU product as created, processed, and/or displayed by a data query processing computing entity and/or by a data storage computing entity of an improved computer for technology;

FIG. 173 is a schematic block diagram of an example of a graphical representation of microprocessor and its generic high-level components, which are inputs for a tech score for, a patent plan of, and/or defining a PTU product as created, processed, and/or displayed by a data query processing computing entity and/or by a data storage computing entity of an improved computer for technology;

FIG. 174 is a schematic block diagram of an example of PTU naming and/or PTU hierarchy of a data processing unit, a specific PTU product type/sub-type, and its generic high-level components, which are inputs for a tech score for, a patent plan of, and/or defining a PTU product as created, processed, and/or displayed by a data query processing computing entity and/or by a data storage computing entity of an improved computer for technology;

FIG. 175 is a schematic block diagram of an example of a graphical representation of cell phone and its generic high-level components, which are inputs for a tech score for, a patent plan of, and/or defining a PTU product as created, processed, and/or displayed by a data query processing computing entity and/or by a data storage computing entity of an improved computer for technology;

FIG. 176 is a schematic block diagram of an example of PTU naming and/or PTU hierarchy of a cell phone, specific PTU product type/sub-types, and its generic high-level components, which are inputs for a tech score for, a patent plan of, and/or defining a PTU product as created, processed, and/or displayed by a data query processing computing entity and/or by a data storage computing entity of an improved computer for technology;

FIG. 177 is a schematic block diagram of an example of PTU naming and/or PTU hierarchy of a cell phone, specific PTU product type/sub-types, specific PTU products, and its high-level components, which are inputs for a tech score for, a patent plan of, and/or defining a PTU product as created, processed, and/or displayed by a data query processing computing entity and/or by a data storage computing entity of an improved computer for technology;

FIG. 178 is a schematic block diagram of an example of PTU naming and/or PTU hierarchy of a sensor circuit and its generic high-level components, which are inputs for a tech score for, a patent plan of, and/or defining a PTU product as created, processed, and/or displayed by a data query processing computing entity and/or by a data storage computing entity of an improved computer for technology;

FIG. 179 is a schematic block diagram of an example of PTU naming and/or PTU hierarchy of a sensor circuit, specific PTU product type/sub-types, and its generic high-level components, which are inputs for a tech score for, a patent plan of, and/or defining a PTU product as created, processed, and/or displayed by a data query processing computing entity and/or by a data storage computing entity of an improved computer for technology;

FIG. 180 is a schematic block diagram of an example of PTU naming and/or PTU hierarchy of a touch sensor circuit, a specific PTU product type/sub-type, a specific PTU product, and its high-level components, which are inputs for a tech score for, a patent plan of, and/or defining a PTU product as created, processed, and/or displayed by a data query processing computing entity and/or by a data storage computing entity of an improved computer for technology;

FIG. 181 is a schematic block diagram of another example of PTU naming and/or PTU hierarchy of a touch sensor circuit, a specific PTU product type/sub-type, a specific PTU product, and its high-level components, which are inputs for a tech score for, a patent plan of, and/or defining a PTU product as created, processed, and/or displayed by a data query processing computing entity and/or by a data storage computing entity of an improved computer for technology;

FIG. 182 is a schematic block diagram of another example of PTU naming and/or PTU hierarchy of a touch sensor circuit, a specific PTU product type/sub-type, a specific PTU product, and its high-level components, which are inputs for a tech score for, a patent plan of, and/or defining a PTU product as created, processed, and/or displayed by a data query processing computing entity and/or by a data storage computing entity of an improved computer for technology;

FIG. 183 is a diagram of an example of data processing stages, which are inputs for a tech score for, a patent plan of, and/or defining a PTU product as created, processed, and/or displayed by a data query processing computing entity and/or by a data storage computing entity of an improved computer for technology;

FIG. 184 is a schematic block diagram of an example of PTU naming and/or PTU hierarchy of a data processing unit, specific PTU product type/sub-types, specific PTU products, and their high-level components, which are inputs for a tech score for, a patent plan of, and/or defining a PTU product as created, processed, and/or displayed by a data query processing computing entity and/or by a data storage computing entity of an improved computer for technology;

FIG. 185 is a schematic block diagram of an example of priority claim language that is auto-generated by an invention protection database (of a private patent tracking database of an improved computer for technology) in accordance with priority data of one or more records within the invention protection database;

FIG. 186 is a schematic block diagram of an example of programming language that of an invention protection database (of a private patent tracking database of an improved computer for technology) to generate a new record and/or a new docket number of a single invention patent protection;

FIG. 187 is a schematic block diagram of an example of a data input layout of an invention protection database (of a private patent tracking database of an improved computer for technology) regarding the generation of a new record and/or of a new docket number for a single invention patent protection;

FIG. 188 is a schematic block diagram of an example of programming language of an invention protection database (of a private patent tracking database of an improved computer for technology) to generate a new record and/or a new docket number for an invention of a common spec;

FIG. 189 is a schematic block diagram of a further example of programming language of an invention protection database (of a private patent tracking database of an improved computer for technology) to generate a new record and/or a new docket number for an invention of a common spec;

FIG. 190 is a schematic block diagram of a further example of programming language of an invention protection database (of a private patent tracking database of an improved computer for technology) to generate a new record and/or a new docket number for an invention of a common spec;

FIG. 191 is a schematic block diagram of an example of a data input layout of an invention protection database (of a private patent tracking database of an improved computer for technology) regarding the generation of a new record and/or of a new docket number for patent protection of an invention;

FIG. 192 is a schematic block diagram of a further example of a data input layout of an invention protection database (of a private patent tracking database of an improved computer for technology) regarding the generation of a new record and/or of a new docket number for patent protection of an invention;

FIG. 193 is a schematic block diagram of a further example of a data input layout of an invention protection database (of a private patent tracking database of an improved computer for technology) regarding the generation of a new record and/or of a new docket number for patent protection of an invention;

FIG. 194 is a schematic block diagram of a further example of a data input layout of an invention protection database (of a private patent tracking database of an improved computer for technology) regarding the generation of a new record and/or of a new docket number for patent protection of an invention;

FIG. 195 is a schematic block diagram of a further example of a data input layout of an invention protection database (of a private patent tracking database of an improved computer for technology) regarding the generation of a new record and/or of a new docket number for patent protection of an invention;

FIG. 196 is a schematic block diagram of a further example of a data input layout of an invention protection database (of a private patent tracking database of an improved computer for technology) regarding the generation of a new record and/or of a new docket number for patent protection of an invention;

FIG. 197 is a schematic block diagram of a further example of a data input layout of an invention protection database (of a private patent tracking database of an improved computer for technology) regarding the generation of a new record and/or of a new docket number for patent protection of an invention;

FIG. 198 is a schematic block diagram of a further example of a data input layout of an invention protection database (of a private patent tracking database of an improved computer for technology) regarding the generation of a new record and/or of a new docket number for patent protection of an invention; and

FIG. 199 is a schematic block diagram of a further example of a data input layout of an invention protection database (of a private patent tracking database of an improved computer for technology) regarding the generation of a new record and/or of a new docket number for patent protection of an invention.

### DETAILED DESCRIPTION OF THE INVENTION

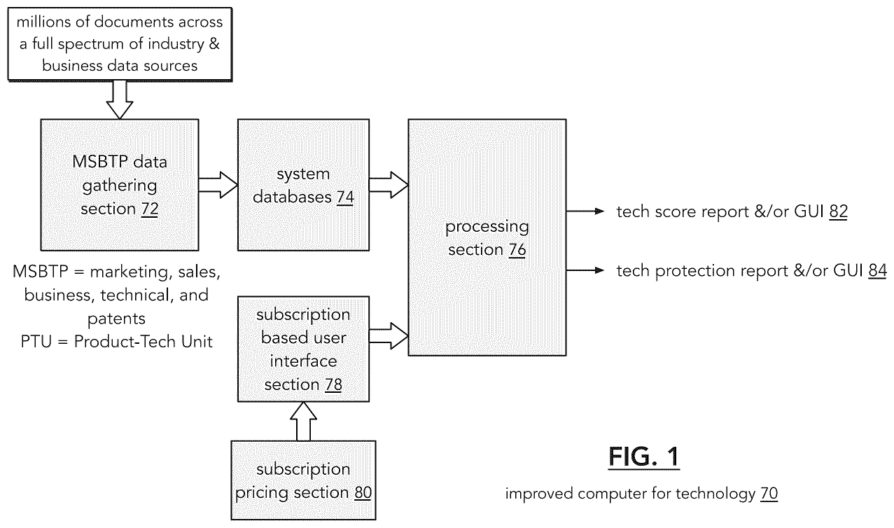

FIG. 1 is a schematic block diagram of an embodiment of an improved computer 70 for technology that includes an MSBTP (marketing, sales, business, technical, and patent) data gathering section 72, system databases 74, a processing section 76, a subscription based user interface section 78, and a subscription pricing section 80, which are supported by one or more computing entities. In general, the MSBTP data gathering section 72 executes machine learning and/or artificial intelligence programs to routinely (e.g., periodically, pseudo randomly, upon request, etc.) ingest a large number of documents and dissect each document for relevant information regarding existing product-tech units (PTUs) and potentially new PTUs, where a PTU is a piece of quantified technology.

Relevant documents come in a variety of forms, are of a variety of types, and contain information regarding a variety of technology related topics. The form of a document is either a digital form or a physical form (e.g., printed on a piece of paper, in a printed newspaper, in a printed magazine, etc.). For documents in physical form to be ingested by the MSBTP data gathering section, the document is scanned to produce a digital version of it.

A digital form document, it is formatted in accordance with one or more document formats. For example, a document is a PDF (portable document format) document, another document is an HTML (hypertext markup language) document, another document is a word processing document, another document is a spreadsheet, another document is an image of one or more image formats (JPEG, PNG, GIF, SVG, MP4, etc.), and/or any other manner of digitizing information.

The document type is one or more of, but not limited to, a scholarly paper, an article, an essay, a study, a report (market, financial, business, technical, etc. that is regarding the past, present, and/or future), a manuscript, a deed, a certificate, a file, an experiment, a summary, a compilation, a data sheet, marketing material, sales material, an annual report, a patent, a patent application, a business plan, and a record.

The relevant content of document is information regarding a PTU's technical boundaries, its PTU inclusion hierarchy, its PTU composition hierarchy, functionality, its market impact, science categories, its inventions and patent protection thereof, and/or manufacturing. Each of these content categories will be discussed in greater detail with reference to subsequent figures. As a non-exhaustive list of examples, the document content includes information regarding technology, businesses that leverage (use, buy, sell, trade, lease, etc.) technology, financial data regarding technology, past and current market data regarding technology, transactions (buy, sell, license, litigate, etc.) regarding technology, development of new technology, requirements of a technology, standardizations of a technology, legal regulations of a technology, revenue forecasts regarding products/services embodying technology, and forecasts of future technology.

For documents ingested by the MSBTP data gathering section 72, it generates data for a MSBT (marketing, sales, business, technology) record to be created in an MSBT database; it generates data for an annotated patent record to be created in an annotated patent database; and it generates data for a patent term record to be crated in a patent term database if the ingested patent contains a new patent term (i.e., not already in the patent term database).

As documents are ingested, the MSBTP data gathering section 72 tags them with a PTU classification, which includes the classification of the PTU(s) name if the document is clearly associated with the PTU(s), the classification of “undecided, potential new PTU” if the document is not clearly associated with an existing PTU but is likely associated with a potentially new PTU, or a classification of “undecided” if the document is not clearly associated with an existing PTU or a potentially new PTU.

For a document that is tagged with a PTU name, relevant information regarding the document is added to the PTU record regarding the PTU in a PTU database. The MSBTP data gathering section 72 routinely (e.g., periodically (minutes, hours, days), pseudo-randomly, upon command) reviews the documents that have been classified “undecided, potential new PTU” to determine if there is sufficient data to establish a new PTU, to establish that there is not a new PTU, and/or to reclassify a document. The MSBTP data gathering section 72 also routinely reviews documents with the classification of “undecided” to determine if they should be reclassified or ultimately deleted.

When there is sufficient data to establish a new PTU, MSBTP data gathering section 72 generates data to create a new PTU record in the PTU database. The data includes the documents used to establish the existence of a new PTU.

From the records in the MSBT database, the annotated patent database, and/or the patent term database, the MSBTP data gathering section 72 generates market impact data for a PTU. The market impact data includes existing market impact data and future forecasted market impact data.

The processing section 76, as will be discussed in greater detail with reference to subsequent Figures, includes machine learning and/or artificial intelligence programs that function based on a PTU operating system and in accordance with a re-engineered patent process. The processing section 76 produces a plurality of digital reports regarding one or more PTUs, which include, for example, a tech score report and/or a graphical representation thereof 82 and tech protection report and/or graphical representation thereof 84.

Per the re-engineered patent process, an architectural patent protection plan is created by the processing section 76 for a PTU as early in the development of the PTU as practically possible. Using machine learning and/or artificial intelligence programs, which will be described in detail with subsequent figures, the processing section 76 calculates the total number of inventions that are likely to be invented over the life of the PTU based on, at least in part, technical challenges of the PTU; calculates invention types breakdown of the total number of inventions; calculates how many of the total number of inventions should be patent protected based on a desired patent position balanced with a desired patent spend and desired patent ROI (return on investment); and determines, when, where, and how to patent protect selected inventions.

In this manner, a patent portfolio for a PTU is built in accordance with a detailed architectural plan, which can be adjusted as the technology and/or market of the PTU evolve. As such, every invention that is patent protected is done so with a purpose in accordance with the plan, there is virtually no waste due to unnecessary patents, the resulting patent portfolio is balanced, of the desired scope and breadth to maximize the value of the PTU. When the patent application drafting and prosecution tools of the improved computer are used, waste due to filing patent applications that will not issue or issue with fatal flaws is eliminated.

As an analogy, the architectural plan to patent protect a PTU (product-tech unit, which is a quantifiable piece of technology) is similar to the architectural plan for a building. The architectural plan for a building defines the size of the building, the shape of the building, the types of rooms in the building and quantity for each, the plumbing, the electrical, the HVAC, and so on. Every detail of the building is mapped out before building materials are purchased and construction commences.

The architectural plan to patent protect a PTU defines the size of the patent protection (number of inventions to protect), the type of inventions to protect and when & how to protect them, the technology challenges to be addressed, which leads to problems to be solved, inventive concepts for solving the problems, and particular solutions. In essence, every detail for building a patent portfolio to protect a PTU is mapped out as early in the development of the PTU as possible. This ensures, like a building, that only necessary building materials are being acquired so that waste is minimized, and the desired structure is created (building or patent portfolio).

In contrast, the conventional patent process, which does not determine the number of inventions to patent protect for a technology over its life and does not quantify a technology in definitive terms that clearly defines technical boundaries, is like collecting building materials over several years for a variety of suppliers of which, some regularly provide certain building materials and others rarely provide other types of building materials. Then, years later collecting an imbalance of building materials, determining what can be built from the collected building materials.

If such an approach were taken with constructing a building, a contractor would collect too many building materials from some sources (e.g., plumbing supplies, roofing materials, paint, floor covering) and receiving too few building materials from other sources (e.g., framing material, electrical, drywall) over a multi-year period. After years of gathering various building materials in this manner, the contractor now decides what can be built with the collected building materials. Clearly, what can be built would have some functioning building elements but would not resemble the building that was constructed from a detailed architectural plan.

The improved computer 70 includes a new computer architecture that uses a new PTU operating system and system level machine learning and/or artificial intelligence programs to balance data analytics performed by user machine learning and/or artificial intelligence programs on the improved computer. The balancing of data analytics is to keep reports, summaries, and/or plans at the digestible pieces of meaningful information level and avoid swinging too far into the details or swinging too far into the general. With too far into the detail, the important take-aways of the data analysis are lost in the detail. With too far into the general, any important take-aways are lost in generality.

Within the improved computer 70, the user machine learning and/or artificial intelligence programs are software tools with the same purpose as any tool. In general, a tool (physical and/or virtual) provides a useful function for its user by improving something, making something more efficient, making something more reliable, making something faster, etc., where the something is an aspect of the user's life (e.g., making a business more financially sound, providing better production (output &/or efficiency), providing more efficient business functions, making a higher quality product, and so on). From a business standpoint, any tool that aids in increasing the value of the company is a valuable tool, regardless of its particular function.

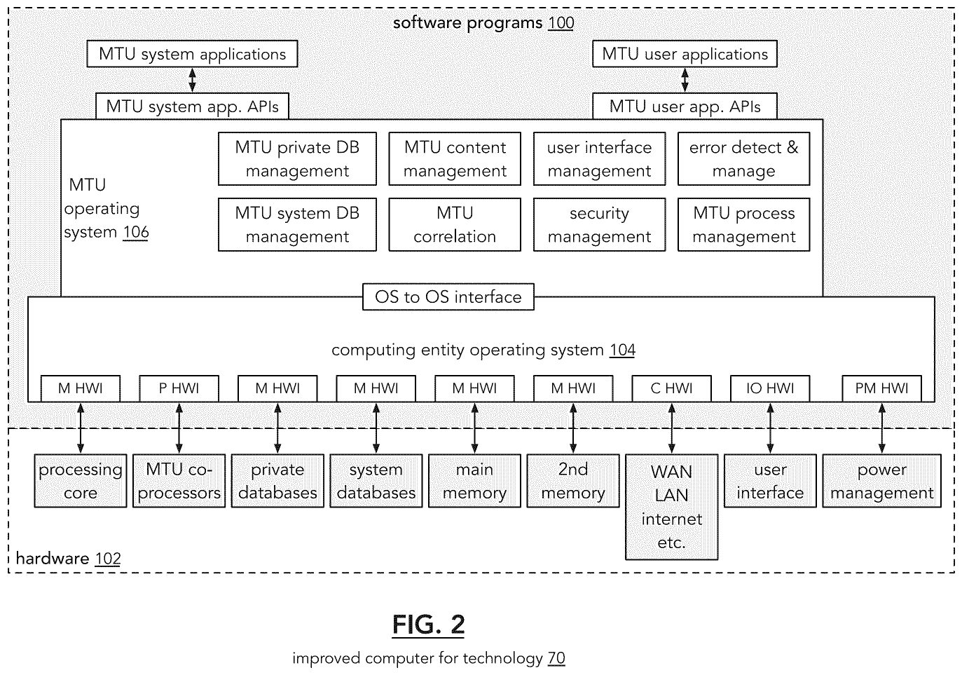

FIG. 2 is a schematic block diagram of another embodiment of an improved computer 70 for technology. The improved computer 70, which is implemented using one or more computing entities, includes a hardware section 102 and a software programs 100. The hardware section 102 includes a processing core, a plurality of co-processors (e.g., a co-processor is a processing core of a computing entity, is a stand-alone processing unit, and/or is a section of a processing unit), private databases, system databases, main memory, secondary memory, network communication access devices (e.g., WAN (wide area network), LAN (local area network, wired and/or wireless), the Internet, etc.), user interfaces, and power management.

The software programs 100 include a computing entity operating system 104, a PTU operating system 106, PTU machine learning and/or artificial intelligence system applications, PTU machine learning and/or artificial intelligence user applications, PTU system application programming interfaces (APIs), and PTU user application APIs. The computing entity operating system 104 includes hardware interfaces (HWI) for the various hardware components of the hardware section 102. The PTU operating system (OS) 106 includes OS programs regarding PTU private database (DB) management, PTU system DB management, PTU content management, PTU correlation, user interface management, security management, error detection and correction management, and PTU process management.

The PTU operating system 106 interacts with the computing entity operating system 104 via an operating system (OS) to operating system (OS) interface. The OS to OS interface primarily functions as a translator between the OS programs of the PTU operating system and the OS programs of the computing entity operating system 104, which include process management, command interpreter system, input/output device management, main memory management, file management, second storage management, error detection and management, and security management.

The PTU operating system 106 controls the operation of the PTU system applications. The PTU system applications include machine learning and/or artificial intelligence programs for identifying data, gathering data, extracting relevant information from the data, PTU (product-tech unit) classifying the data, creating PTUs, creating and updating PTU records, creating and updating MSBT (marketing, sales, business, technology) records, creating and updating patent data records, creating and updating market impact records, storing PTU records, storing MSBT records, storing patent data records, and storing market impact records).

The PTU operating system 106 also controls the operation of the PTU user applications. The PTU user applications include machine learning and/or artificial intelligence programs regarding PTU generation and phase calculations and/or report generation, PTU existing patent data calculations and/or report generation, PTU existing marketing impact calculations and/or report generation, PTU existing patent protection calculations and/or report generation, PTU previous & current valuation calculations and/or report generation, PTU future forecasted patent data calculations and/or report generation, PTU future forecasted marketing impact calculations and/or report generation, PTU future forecasted patent protection calculations and/or report generation, PTU future forecasted valuation calculations and/or report generation, PTU technology expansion calculations and/or report generation, PTU market opportunity calculations and/or report generation, PTU market expansion calculations and/or report generation, PTU patent portfolio growth & expense calculations and/or report generation, PTU patent protection plan calculations and/or report generation, PTU future value calculations and/or report generation, PTU invention identification and claim drafting calculations and/or report generation, PTU patent application drafting calculations and/or report generation, PTU patent prosecution response calculations and/or report generation, PTU patent quality calculations and/or report generation, PTU patent plan execution & tracking calculations and/or report generation, PTU constructive notice calculations and/or report generation, PTU patent sale opportunity calculations and/or report generation, PTU patent purchase opportunity calculations and/or report generation, PTU patent licensing opportunity calculations and/or report generation, MUT patent standards opportunity calculations and/or report generation, and PTU patent based spin-off or joint venture (JV) opportunity calculations and/or report generation.

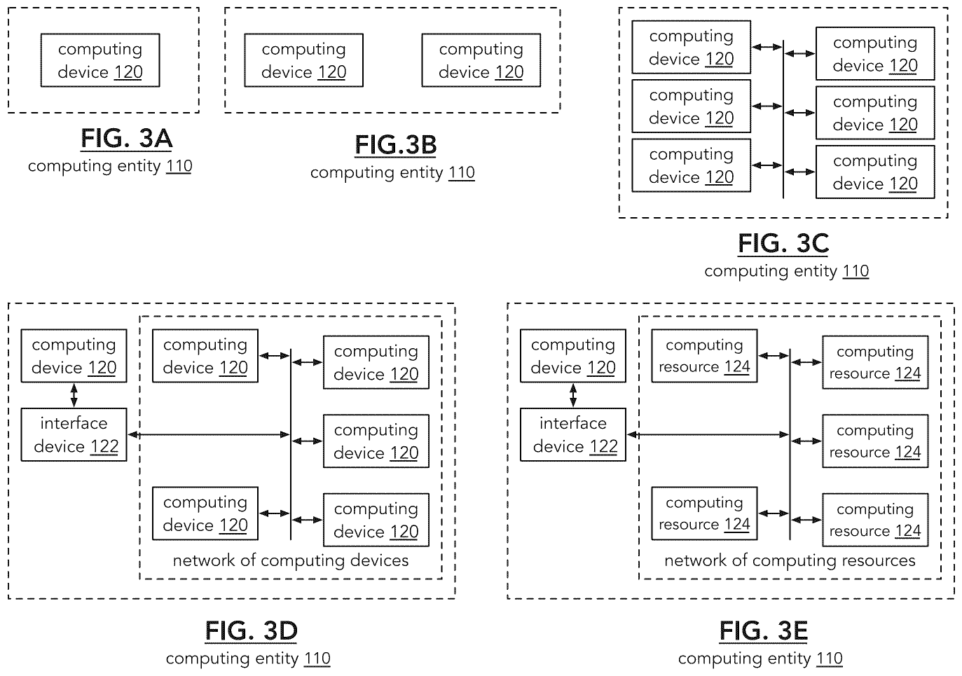

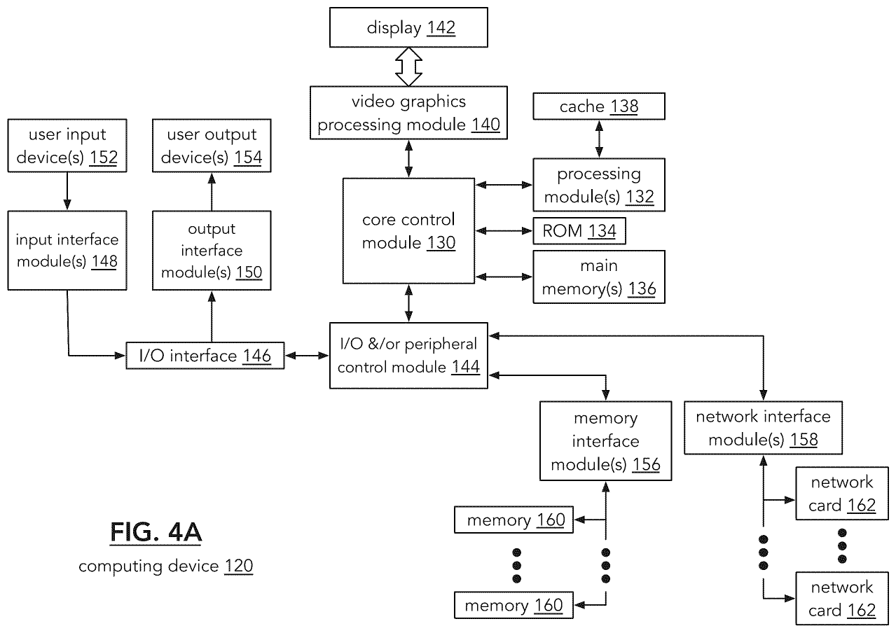

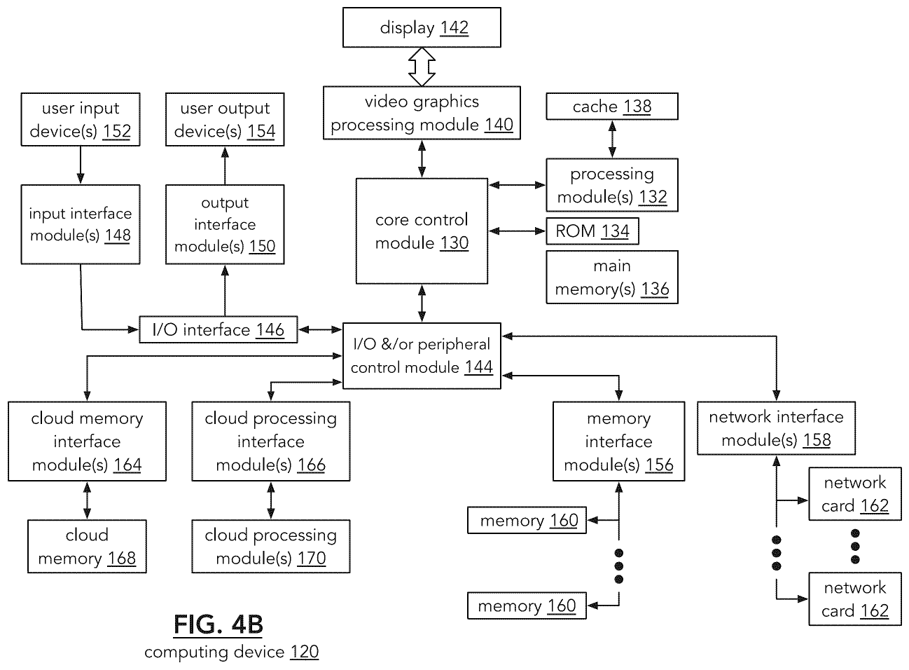

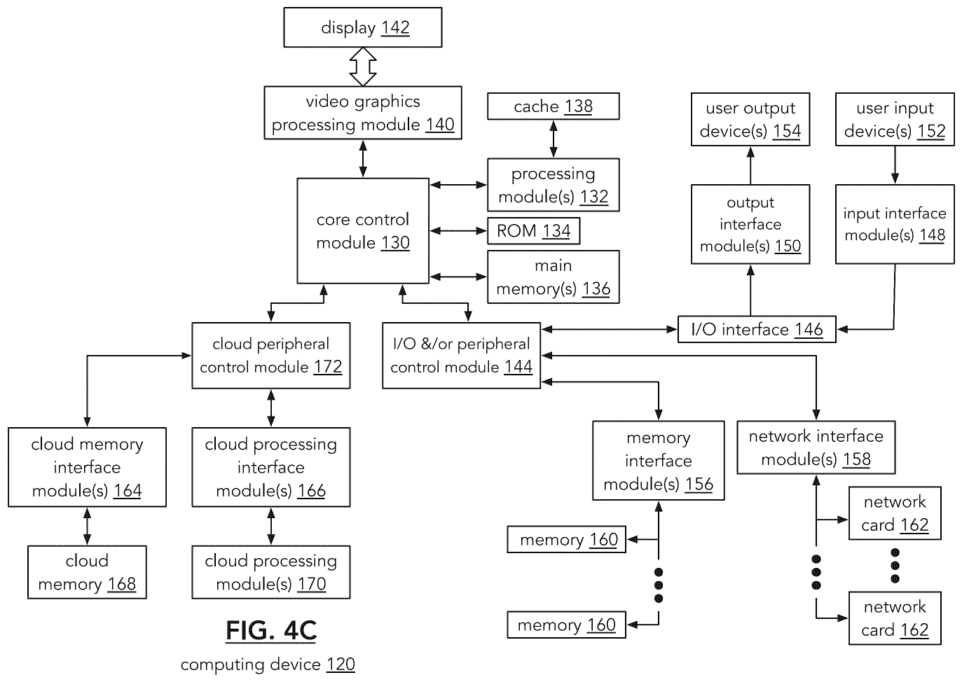

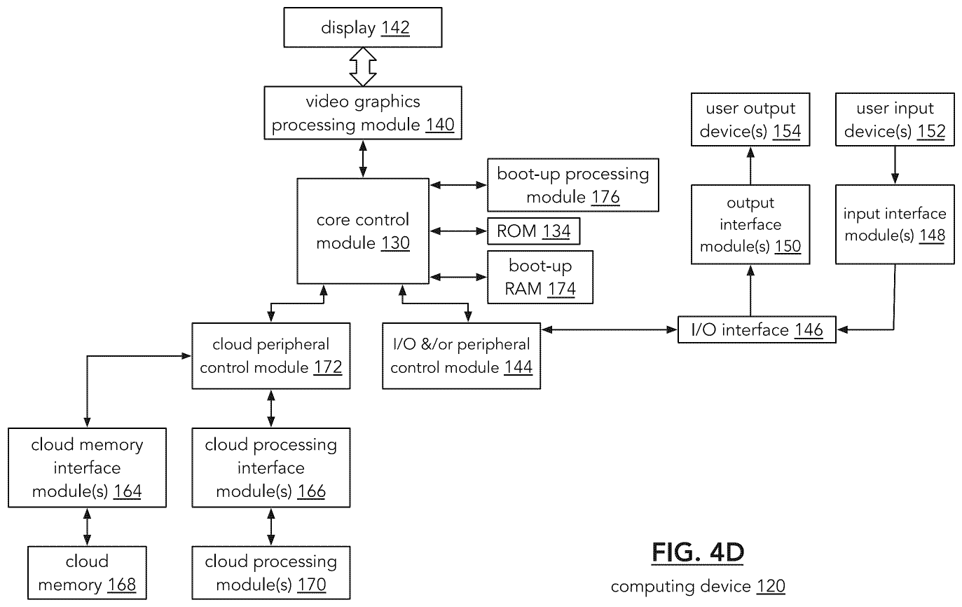

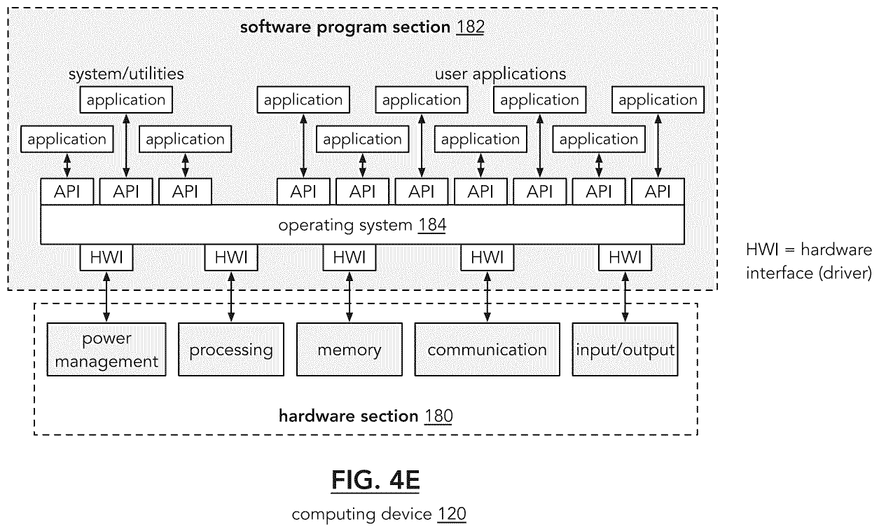

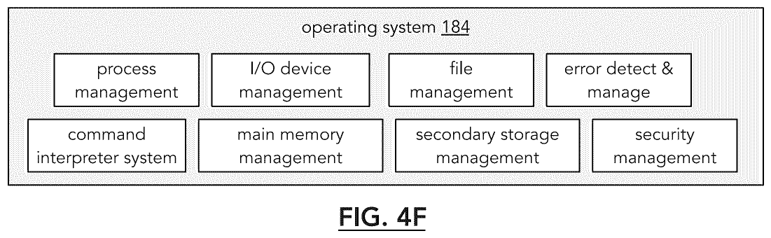

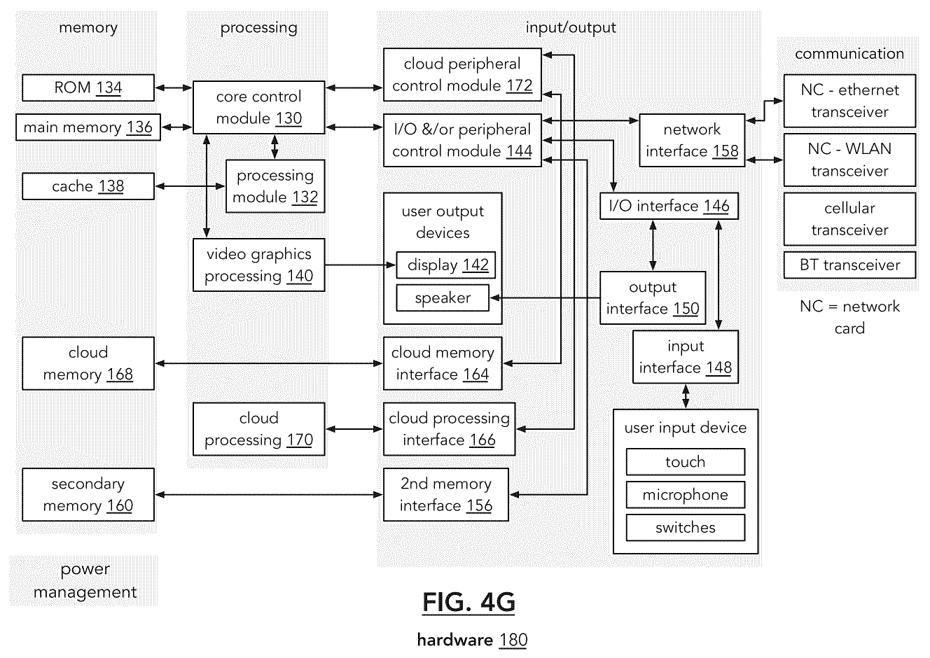

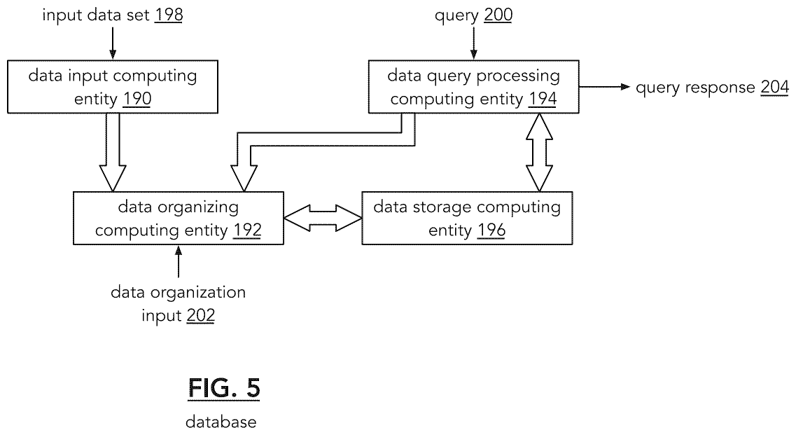

FIGS. 3A through 3E are schematic block diagram of embodiments of computing entities that form at least part of an improved computer for technology. FIG. 5A is schematic block diagram of an embodiment of a computing entity 110 that includes a computing device 120 (e.g., one or more of the embodiments of FIGS. 4A-4G). A computing device may function as a user computing device, a server, a system computing device, a data storage device, a data security device, a networking device, a user access device, a cell phone, a tablet, a laptop, a printer, a game console, a satellite control box, a cable box, etc.

FIG. 3B is schematic block diagram of an embodiment of a computing entity 110 that includes two or more computing devices 120 (e.g., two or more from any combination of the embodiments of FIGS. 4A-4G). The computing devices 120 perform the functions of a computing entity in a peer processing manner (e.g., coordinate together to perform the functions), in a master-slave manner (e.g., one computing device coordinates and the other support it), and/or in another manner.

FIG. 3C is schematic block diagram of an embodiment of a computing entity 110 that includes a network of computing devices 120 (e.g., two or more from any combination of the embodiments of FIGS. 4A-4G). The computing devices are coupled together via one or more network connections (e.g., WAN, LAN, cellular data, WLAN, etc.) and perform the functions of the computing entity.

FIG. 3D is schematic block diagram of an embodiment of a computing entity 110 that includes a primary computing device (e.g., any one of the computing devices of FIGS. 4A-4G), an interface device (e.g., a network connection), and a network of computing devices 120 (e.g., one or more from any combination of the embodiments of FIGS. 4A-4G). The primary computing device utilizes the other computing devices as co-processors to execute one or more of the functions of the computing entity, as storage for data, for other data processing functions, and/or storage purposes.

FIG. 3E is schematic block diagram of an embodiment of a computing entity 110 that includes a primary computing device (e.g., any one of the computing devices of FIGS. 4A-4G), an interface device (e.g., a network connection) 122, and a network of computing resources 124 (e.g., two or more resources from any combination of the embodiments of FIGS. 4A-4G). The primary computing device utilizes the computing resources as co-processors to execute one or more of the functions of the computing entity, as storage for data, for other data processing functions, and/or storage purposes.

FIGS. 4A through 4G are schematic block diagram of embodiments of computing devices that form at least a portion of a computing entity. FIG. 4A is a schematic block diagram of an embodiment of a computing device 120 that includes a plurality of computing resources. The computing resources, which form a computing core, include one or more core control modules 130, one or more processing modules 132, one or more main memories 136, a read only memory (ROM) 134 for a boot up sequence, cache memory 138, one or more video graphics processing modules 140, one or more displays 142 (optional), an Input-Output (I/O) peripheral control module 144, an I/O interface module 146 (which could be omitted if direct connect IO is implemented), one or more input interface modules 148, one or more output interface modules 150, one or more network interface modules 158, and one or more memory interface modules 156.

A processing module 132 is described in greater detail at the end of the detailed description section and, in an alternative embodiment, has a direction connection to the main memory 136. In an alternate embodiment, the core control module 130 and the I/O and/or peripheral control module 144 are one module, such as a chipset, a quick path interconnect (QPI), and/or an ultra-path interconnect (UPI).

The processing module 132, the core module 130, and/or the video graphics processing module 140 form a processing core for the improved computer. Additional combinations of processing modules 132, core modules 130, and/or video graphics processing modules 140 form co-processors for the improved computer for technology. Computing resources 124 of FIG. 3E include one more of the components shown in this Figure and/or in or more of FIGS. 4B through 4G.

Each of the main memories 136 includes one or more Random Access Memory (RAM) integrated circuits, or chips. In general, the main memory 136 stores data and operational instructions most relevant for the processing module 132. For example, the core control module 130 coordinates the transfer of data and/or operational instructions between the main memory 136 and the secondary memory device(s) 160. The data and/or operational instructions retrieved from secondary memory 160 are the data and/or operational instructions requested by the processing module or will most likely be needed by the processing module. When the processing module is done with the data and/or operational instructions in main memory, the core control module 130 coordinates sending updated data to the secondary memory 160 for storage.

The secondary memory 160 includes one or more hard drives, one or more solid state memory chips, and/or one or more other large capacity storage devices that, in comparison to cache memory and main memory devices, is/are relatively inexpensive with respect to cost per amount of data stored. The secondary memory 160 is coupled to the core control module 130 via the I/O and/or peripheral control module 144 and via one or more memory interface modules 156. In an embodiment, the I/O and/or peripheral control module 144 includes one or more Peripheral Component Interface (PCI) buses to which peripheral components connect to the core control module 130. A memory interface module 156 includes a software driver and a hardware connector for coupling a memory device to the I/O and/or peripheral control module 144. For example, a memory interface 156 is in accordance with a Serial Advanced Technology Attachment (SATA) port.

The core control module 130 coordinates data communications between the processing module(s) 132 and network(s) via the I/O and/or peripheral control module 144, the network interface module(s) 158, and one or more network cards 162. A network card 160 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 158 includes a software driver and a hardware connector for coupling the network card to the I/O and/or peripheral control module 144. For example, the network interface module 158 is in accordance with one or more versions of IEEE 802.11, cellular telephone protocols, 10/100/1000 Gigabit LAN protocols, etc.

The core control module 130 coordinates data communications between the processing module(s) 132 and input device(s) 152 via the input interface module(s) 148, the I/O interface 146, and the I/O and/or peripheral control module 144. An input device 152 includes a keypad, a keyboard, control switches, a touchpad, a microphone, a camera, etc. An input interface module 148 includes a software driver and a hardware connector for coupling an input device to the I/O and/or peripheral control module 144. In an embodiment, an input interface module 148 is in accordance with one or more Universal Serial Bus (USB) protocols.

The core control module 130 coordinates data communications between the processing module(s) 132 and output device(s) 154 via the output interface module(s) 150 and the I/O and/or peripheral control module 144. An output device 154 includes a speaker, auxiliary memory, headphones, etc. An output interface module 150 includes a software driver and a hardware connector for coupling an output device to the I/O and/or peripheral control module 144. In an embodiment, an output interface module 150 is in accordance with one or more audio codec protocols.

The processing module 132 communicates directly with a video graphics processing module 140 to display data on the display 142. The display 142 includes an LED (light emitting diode) display, an LCD (liquid crystal display), and/or other type of display technology. The display has a resolution, an aspect ratio, and other features that affect the quality of the display. The video graphics processing module 140 receives data from the processing module 132, processes the data to produce rendered data in accordance with the characteristics of the display, and provides the rendered data to the display 142.

FIG. 4B is a schematic block diagram of an embodiment of a computing device 120 that includes a plurality of computing resources similar to the computing resources of FIG. 4A with the addition of one or more cloud memory interface modules 164, one or more cloud processing interface modules 166, cloud memory 168, and one or more cloud processing modules 170. The cloud memory 168 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 170 is similar to processing module 132 but is remoted from the core control module and is accessed via a network.

FIG. 4C is a schematic block diagram of an embodiment of a computing device 120 that includes a plurality of computing resources similar to the computing resources of FIG. 4B with a change in how the cloud memory interface module(s) 164 and the cloud processing interface module(s) 166 are coupled to the core control module 130. In this embodiment, the interface modules 164 and 166 are coupled to a cloud peripheral control module 172 that directly couples to the core control module 130.

FIG. 4D is a schematic block diagram of an embodiment of a computing device 120 that includes a plurality of computing resources, which includes include a core control module 130, a boot up processing module 176, boot up RAM 174, a read only memory (ROM) 134, a one or more video graphics processing modules 140, one or more displays 48 (optional), an Input-Output (I/O) peripheral control module 144, one or more input interface modules 148, one or more output interface modules 150, one or more cloud memory interface modules 164, one or more cloud processing interface modules 166, cloud memory 168, and cloud processing module(s) 170.

In this embodiment, the computing device 120 includes enough processing resources (e.g., module 176, ROM 134, and RAM 174) to boot up. Once booted up, the cloud memory 168 and the cloud processing module(s) 170 function as the computing device's memory (e.g., main and hard drive) and processing module.

FIG. 4E is a schematic block diagram of another embodiment of a computing device 120 that includes a hardware section 180 and a software program section 182. The hardware section 180 includes the hardware functions of power management, processing, memory, communications, and input/output. FIG. 4G illustrates the hardware section 180 in greater detail.

The software program section 182 includes an operating system 184, system and/or utilities applications, and user applications. The software program section further includes APIs and HWIs. APIs (application programming interface) are the interfaces between the system and/or utilities applications and the operating system and the interfaces between the user applications and the operating system 184. HWIs (hardware interface) are the interfaces between the hardware components and the operating system. For some hardware components, the HWI is a software driver. The functions of the operating system 184 are discussed in greater detail with reference to FIG. 4F.

FIG. 4F is a diagram of an example of the functions of the operating system of a computing device 120. In general, the operating system function is to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 184 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes:
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other, ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 4G is a schematic block diagram of the hardware components of the hardware section 180 of a computing device. The memory portion of the hardware section includes the ROM 134, the main memory 136, the cache memory 138, the cloud memory 168, and the secondary memory 160. The processing portion of the hardware section includes the core control module 130, the processing module 132, the video graphics processing module 140, and the cloud processing module 170.

The input/output portion of the hardware section includes the cloud peripheral control module 172, the I/O and/or peripheral control module 144, the network interface module 158, the I/O interface module 146, the output device interface 150, the input device interface 148, the cloud memory interface module 164, the cloud processing interface module 166, and the secondary memory interface module 156. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

FIG. 5 is a schematic block diagram of an embodiment of a database that includes a data input computing entity 190, a data organizing computing entity 192, a data query processing computing entity 194, and a data storage computing entity 196. Each of the computing entities is implemented in accordance with one or more of the embodiments of FIGS. 3A through 3E.

The data input computing entity 190 is operable to receive an input data set 198. The input data set 198 is a collection of related data that can be represented in a tabular form of columns and rows, and/or other tabular structure. In an example, the columns represent different data elements of data for a particular source and the rows corresponds to the different sources (e.g., employees, licenses, email communications, etc.).

If the data set 198 is in a desired tabular format, the data input computing entity 190 provides the data set to the data organizing computing entity 192. If not, the data input computing entity 190 reformats the data set to put it into the desired tabular format.

The data organizing computing entity 192 organizes the data set 198 in accordance with a data organizing input 202. In an example, the input 202 is regarding a particular query and requests that the data be organized for efficient analysis of the data for the query. In another example, the input 202 instructions the data organizing computing entity 192 to organize the data in a time-based manner. The organized data is provided to the data storage computing entity for storage.

When the data query processing computing entity 194 receives a query 200, it accesses the data storage computing entity 196 regarding a data set for the query. If the data set is stored in a desired format for the query, the data query processing computing entity 194 retrieves the data set and executes the query to produce a query response 204. If the data set is not stored in the desired format, the data query processing computing entity 194 communicates with the data organizing computing entity 192, which re-organizes the data set into the desired format.

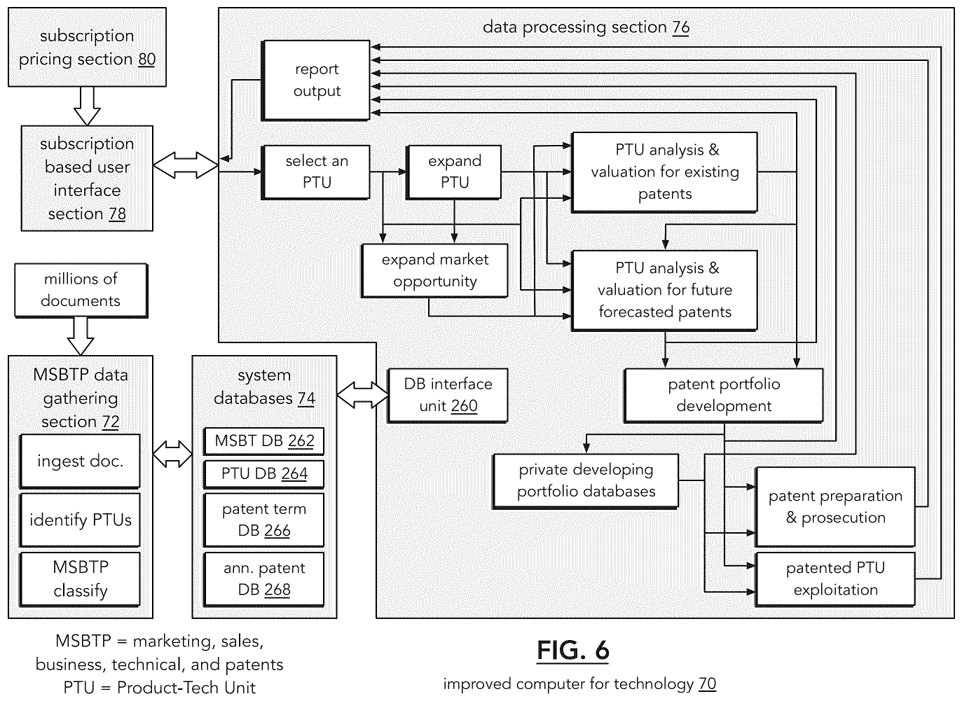

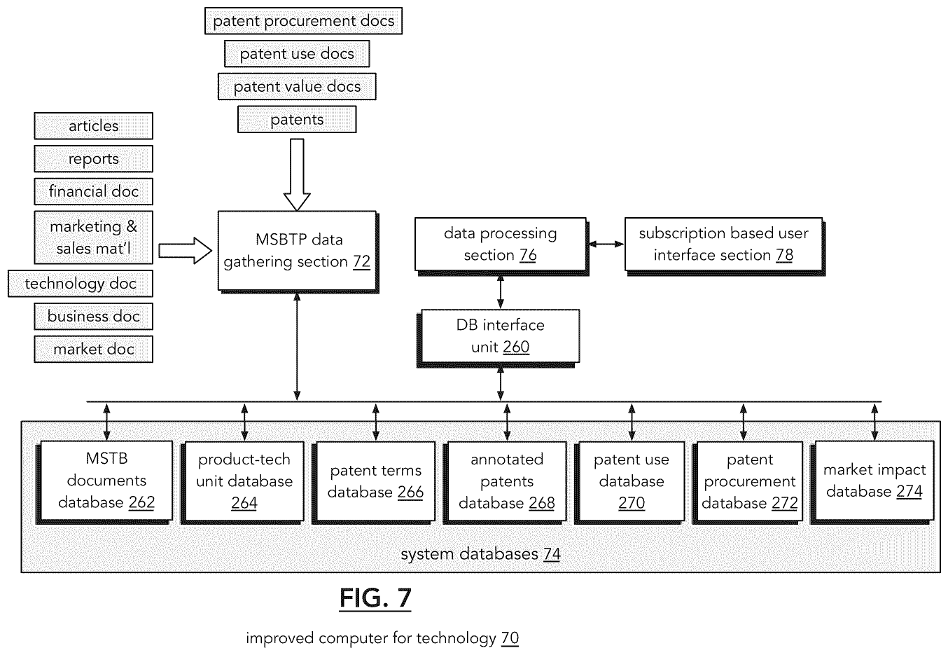

FIG. 6 is a schematic block diagram of a further embodiment of an improved computer for technology 70. The improved computer 70 includes the MSBTP (marketing, sales, business, technology, patents) data gathering section 72, which, in an embodiment, is implemented via one or more computing entities; system databases 74, each of which, in an embodiment, is implemented as per FIG. 7; a data processing section 76, which, in an embodiment, is implemented via one or more computing entities; a subscription based user interface section 78, which, in an embodiment, is implemented via one or more computing entities; and a subscription pricing section 80, which, in an embodiment, is implemented via one or more computing entities.

As will be discussed in greater detail with reference to subsequent figures, the MSBTP data gathering section 72 includes one or more co-processors for ingest documents, for classifying the documents with a PTU classification, and for identifying new PTUs from the documents. Relevant documents are stored in a system databases 74, which includes an MSBTP database (DB) 262, a PTU database 264, a patent term database 266, and an annotated (ann.) patent database 268.

The data processing section 76 includes one or more co-processors for an report output function; for a select a PTU function; for an expand a PTU function; for an expand market opportunities function; for analysis and valuation of a PTU with respect to existing patents; for analysis and valuation of a PTU with respect to future forecasted patents; for patent portfolio development based on PTUs; for patent application preparation and prosecution; and for patented PTU exploitation (e.g., patent uses and/or constructive notice). The data processing section 76 also includes private developing portfolio databases and a database interface unit 260 (which provides the data processing section access to the system databases).

In operation, the MSBTP data gathering section 72 routinely ingests documents (millions over time) and processing them to extract PTU information. The PTU information corresponds to data regarding an existing PTU and/or to data to identify a new PTU. For each ingested document to be saved (e.g., the document has at least one piece of information (regardless of how small) pertaining to an existing PTU or a potential new PTU, the MSBTP data gathering section 72 creates a database entry request.

For example, when the document is an issued patent or a pending patent application, the MSBTP data gathering section 72 generates an annotated patent database entry request for the patent or application that has been annotated with respect to PTU information. The request is sent to the annotated patent database 268 for a record to be created for the annotated patent or application. The MSBTP data gathering section 72 may further generate a patent term database entry request for a new patent term found in the patent or application. This request is sent to the patent term database 266 for a record to be created for the new patent term.

As another example, when the document is related to marketing, sales, business (financial, market, economy, etc.), and/or technology, the MSBTP data gathering section 72 generates an MSBT database entry request for the document. The request is sent to the MSBT database 262 for a record to be created for the MSBT document.

From the ingested documents, the MSBTP data gathering section 72 classifies the documents with a PTU classification, which include a PTU name, undecided, and undecided/potential new PTU. The MSBTP data gathering section 72 adds the PTU classification to the database record for the document. The MSBTP data gathering section 72 routinely reviews the PTU classification of stored documents to determine if a PTU classification update is needed. If so, the MSBTP data gathering section 72 updates a document's PTU classification.

The MSBTP data gathering section 72 also processes stored documents with the PTU classification of undecided/potential new PTU to determine whether a new PTU should be created. If so, the MSBTP data gathering section 72 generates a PTU database entry request for the new PTU and sends it to the PTU database 264.

The data processing section 76 receives a selection of a PTU from the subscription based user interface section 78 and a selection of a report, or reports, to be generated. The reports of the data processing section 76 are per selected PTU(s) and include an existing patent landscape report, a competitor existing patent analysis report, a “how well the PTU is patent protected with existing patents” report, a market impact of the PTU in light of existing patents report, a value of a PTU in light of existing patents report, a forecasted future patent landscape report, a competitor forecasted future patent analysis report, a “how well the PTU is patent protected with forecasted future patents” report, a market impact of the PTU in light of forecasted future patents report, a value of a PTU in light of forecasted future patents report, an architectural plan for developing a patent portfolio for a PTU report, an expense & growth report for a PTU being developed per the architectural plan, a patent protection tracking report, a patent use report, and a constructive notice report.

For a selected PTU, the data processing section 76, if not already done, expands the innovation of the PTU and expands the market opportunity for the PTU and the expansion of the PTU. Expanding innovation of the PTU includes identifying new unique values propositions for the PTU, identifying new features for the PTU, identifying new technical challenges for the PTU, identifying new uses for the PTU, and so on. Expanding the market opportunities includes identifying new market opportunities for the expanded PTU and further includes identifying other PTUs that have similar unique value propositions, similar features, and/or similar technical challenges and determining the PTU applicability in markets of the other PTUs.

From the selected PTU, the expansion of the PTU, and the expansion of the market opportunities, the data processing section 76 analyzes the PTU from an existing patent standpoint to produce one or more of the above mentioned existing patent reports and/or analyzes the PTU from a forecasted future patent standpoint to produce one or more of the above mentioned forecasted future patent reports.

From the existing patent analysis, forecasted future patent analysis, and inputted data regarding patent position and/or patent spend, the data processing section 76 generates an architectural plan for patent protecting the PTU. The data processing section tracks execution of the architectural plan via a private database (one for each authorized user). To ensure quality of executing the architectural plan, the data processing section includes an ML and/or AI patent application preparation program and an ML and/or AI patent application prosecution program.

From the stored data and the various other analysis performed by, and/or reports generated by, the data processing section, it generates one or more reports regarding market exploitation of the patent protected PTU. For example, the data processing section 76 generates a report on uses of the patents of the PTU. As another example, the data processing section generates a constructive notice report.

The co-processors of the improved computer 70 may be implemented in a variety of ways. For example, a co-processor is one or more computing entities and/or one or more computing devices. As another example, a co-processor is a dedicated processing module of a computing entity and/or of a computing device. As yet another example, a co-processor is a computing core of a computing device. As a further example, a co-processor is an allocation portion of processing resources of a computing entity and/or of a computing device. As yet a further example, a co-processor is a temporary allocation of processing resources of a user computing device.

The various programs, including ML and/or AI programs, of the improved computer for technology may be allocated to co-processors in a variety of ways. For example, a co-processor is allocated multiple programs for execution. As another example, a co-processor is dedicated to a specific program, or programs. As yet another example, co-processors are allocated programs on an as-needed basis. As a further example, each program, or set of programs, is allocated to a dedicated set of co-processors to increase parallel operations of the improved computer, the number of co-processors in a dedicated set can vary to accommodate scaling of parallel operations.

FIG. 7 is a schematic block diagram of a further embodiment of an improved computer for technology 70, which includes the MSBTP data gathering section 72, the data processing section 76, the subscription based user interface section 78, the database interface unit 260, and the system databases 74. The system databases 74 include the MSBT (marketing, sales, business, technology) database 262, the product-tech unit (PTU) database 264, the patent terms database 266, the annotated patent database 268, a patent use database 270, a patent procurement databased 272, and a market impact database 278.

The MSBTP data gathering section 72 ingests a variety of documents. As an example of documents, which far from an exhaustive list, the documents include articles from various publications, reports, financial documents, marketing material, sales material, technology documents, business documents, market documents, patent procurement documents, patent use documents, patent value documents, and patents. In general, the MSBTP data gathering section 72 seeks to ingest and process any document that pertains to a technology category, business regarding a technology, financial reports and/or analysis of a technology and/or business regarding technology, market reports and/or analysis of a technology and/or business regarding technology, technical description of a technology, and/or existing and/or projected use of a technology.

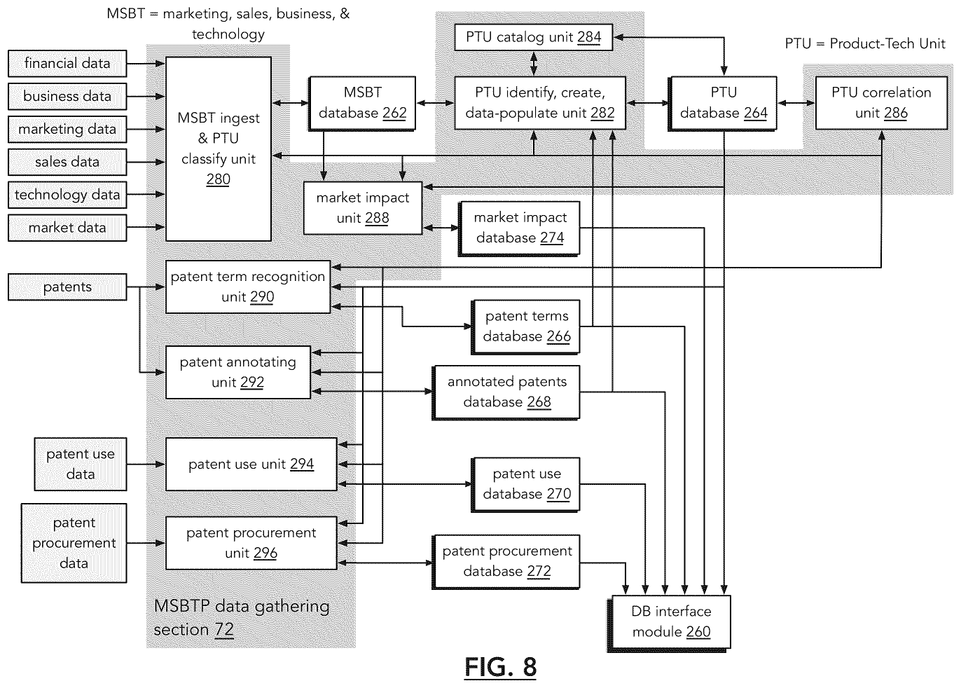

FIG. 8 is a schematic block diagram of a further embodiment of an improved computer for technology 70 that includes, in part, the MSBTP data gathering section 72 and the system databases. The MSBTP data gathering section 72 includes an MSBT ingest and PTU classify unit 280, a PTU identify, create, and data populate unit 282, a PTU catalog unit 284, a PTU correlation unit 286, a market impact unit 288, a patent term recognition unit 290, a patent annotating unit 292, a patent use unit 294, and a patent procurement unit 296. As used herein, a unit is implemented via one or more co-processors and/or one more processing modules.

The MSBT ingest and PTU classify unit 280 ingests MSBT (marketing, sales, business, and technology) documents that include, but is not limited to, financial data, business data, marketing data, sales data, technology data, and market data. The unit 280 processes each document with respect to PTU information (e.g., information relevant to a PTU record) and classifies documents with a PTU classification in conjunction with the PTU correlation unit 286. The unit 280 also creates MSBT database entry requests for documents to be saved as MSBT records in the MSBT database 262.

The PTU identify, create, and data populate unit 282 retrieves MSBT records from the MSBT database 262, annotated patent records from the annotated patent database 268, and/or patent term records from the patent term database 266, and PTU records from the PTU database 264. The unit 282 processes the MSBT records, the annotated patent records, and/or the patent term records to identify new data to add to an existing PTU record and/or to identify edits to be made to existing PTU records. For new data to add to an existing PTU record, the unit 282 generates a data populate request for the existing PTU record regarding the new data and sends it to the PTU database 264. For data edits, the unit 282 generates a data populate request for the existing PTU record regarding the data edits and sends it to the PTU database 264.

The PTU identify, create, and data populate unit 282 retrieves MSBT records, annotated patent records, and/or patent term records from the respective databases that have a PTU classification of undecided/potential new PTU. The unit 282 processes the records to determine if there is sufficient data to support the existence of a new PTU. If yes, the unit 282 generates a new PTU record request for the new PTU and sends it to the PTU database 264. The unit 282 also updates the PTU classification of the records from undecided/potential new PTU to the name of the new PTU.

If there is not sufficient data to support the determination of a new PTU, the unit 282 determines whether the accumulated data is indicating an increase or decrease in the likelihood of it representing a new PTU. When the data indicates a decrease in the likelihood of new PTU, the unit 282 determines whether the likelihood of a new PTU has dropped below a lower limit threshold (e.g., less than a 1% to 5% chance a new PTU is emerging). If yes, the unit 282 changes the PTU classification of the retrieved records from undecided/potential new PTU to undecided.

The PTU identify, create, and data populate unit 282 also retrieves MSBT records, annotated patent records, and/or patent term records from the respective databases that have a PTU classification of undecided. The unit 282 processes the records to determine if there is sufficient data to support the existence of a potential new PTU. If yes, the unit 282 updates the PTU classification of the records from undecided to undecided/potential new PTU.

The PTU catalog unit 284 retrieves PTU records from the PTU database to catalog the records. In this context, cataloging means creating and/or updating technology maps of PTUs by linking PTUs together in a functional and/or hierarchical manner. A technology map is for a particular technology category (e.g., communications technology, information technology, electrical technology, medical technology, etc.) or a combination of technologies (e.g., communications technology, information technology, and electrical technology) from a high-level down to a microscopic technical detail (e.g., fundamental components, circuits, and/or elements). PTU inclusion diagrams and PTU composition diagrams are derived from the technology maps.

The PTU correlation unit 286 is operable to ensure that MSBT records, annotated patent records, and/or patent term records are correlated with the appropriate PTUs. In particular, the PTU correlation unit 286 ensures that PTU classification of records is accurate and is drawn from value PTU records.

The market impact unit 288 retrieves MSBT records and PTU records from respective databases to determine existing market impact of a PTU and to determine a forecasted future market impact of the PTU. For a PTU, the unit 288 generates a market impact record regarding the existing market impact of the PTU and/or the forecasted future market impact of the PTU.

The patent term recognition unit 290 ingests new patents (issued and pending), retrieves annotated patent records, and retrieves patent term records to identify new patent terms and/or to update existing patent terms in light of PTU classifications based on the ingested new patents. As used herein, a patent term is a claim term or a technical term. A claim term includes one or more words regarding a claim noun (e.g., an element, a step, an input, output, and/or some quantifiable thing), a claim descriptor (e.g., a feature, a function, a description, an interaction, an operational limitation of a claim noun and/or the like), and/or a claim relator (relationship of two or more claim nouns). A technical term includes one or more words that is regarding a technical aspect of a PTU.

The patent term recognition unit 290 identifies new patent terms in the ingested patents based on the retrieved patent term records and/or the retrieved annotated patent records. The unit 290 determines which records to retrieve based on one or more of a multitude of factors, which includes assignee name, inventor name, patent title, patent classification, and/or similar patent terms. For a new patent term, the unit 290 generates a new patent term record request and sends it to the patent term database 266. For updating an existing patent term, the unit 290 generates an update patent term record request and sends it to the patent term database 266.

The patent annotating unit 292 ingests new patents (issued and pending), retrieves annotated patent records, and retrieves patent term records to annotate the ingested patents in light of PTU data. As used herein, annotate means highlighting patent terms within a patent, identifying general patent information, identifying foreign counterparts, extracting technology boundary data that pertain to technical boundaries of an existing PTU and/or a potential new PTU, generating a PTU orientated general description of the patent, identifying a science category, identifying product and/or service data, identifying manufacturing data, and/or identifying market impact data.

For a new annotated patent, the patent annotating unit 292 generates a new annotated patent record request and sends it to the annotated patent database 268. The unit 292 also routinely reviews existing annotated patent records to determine, based on more recent ingested data, whether an existing annotated patent record should be updated. If so, unit 292 generates an update an existing annotated patent record request and sends it to the annotated patent database 268.

The patent use unit 294 ingests documents regarding patent use (e.g., patent sales, patent litigation, patent licensing, product/service information, technology investments, assignment records, etc.) and retrieves existing patent use documents from the patent use database 270. For new documents, unit 294 generates a new patent use record request and sends it to the patent use database 270. The unit 294 also routinely reviews existing patent use records to determine, based on more recent ingested data, whether an existing patent use record should be updated. If so, unit 294 generates an update to an existing patent use record request and sends it to the patent use database 270.

The patent procurement unit 296 ingests and processes documents regarding pricing of various patent services and/or patent filing statistics, patent prosecution statistics, patent issuance statistics, and patent abandonment statistics. For new documents, unit 296 generates a new patent procurement record request and sends it to the patent procurement database 272. The unit 296 also routinely reviews existing patent procurement records to determine, based on more recent ingested data, whether an existing patent procurement record should be updated. If so, unit 296 generates an update an existing patent procurement record request and sends it to the patent procurement database 272.

By quantifying technology with product-tech units, which have definable technical boundaries, the improved computer has significantly greater data consistency with respect to most, if not all, of the functions it offers in comparison to services that support the conventional patent process. The greater data consistency of PTUs enables more efficient and effective prior art searching, better architectural planning of patent protecting a technology, clear definitions for technology, better valuation of technology, and/or any other benefits of better data consistency.

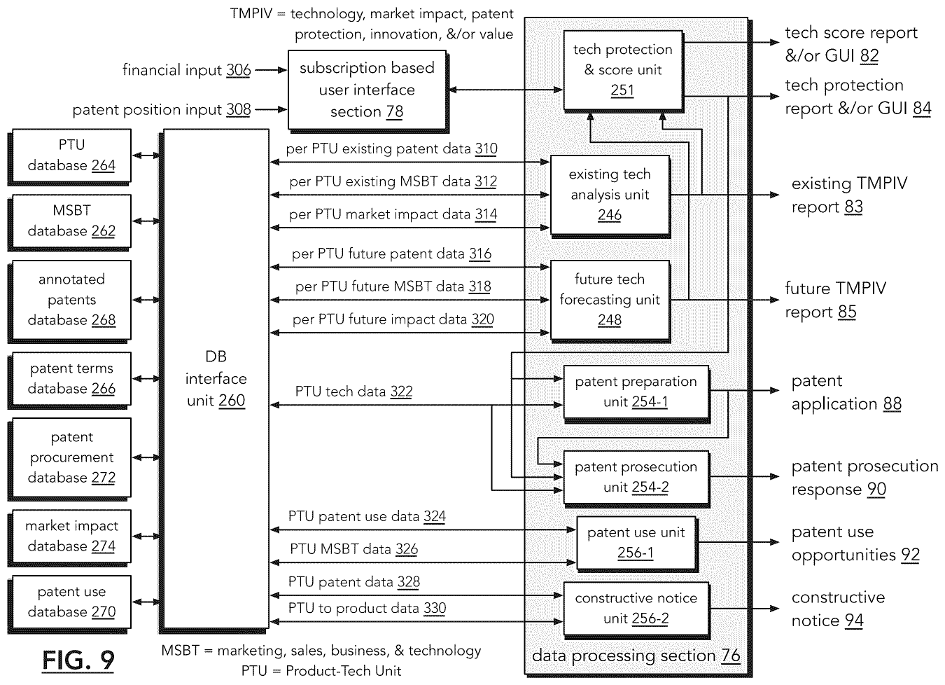

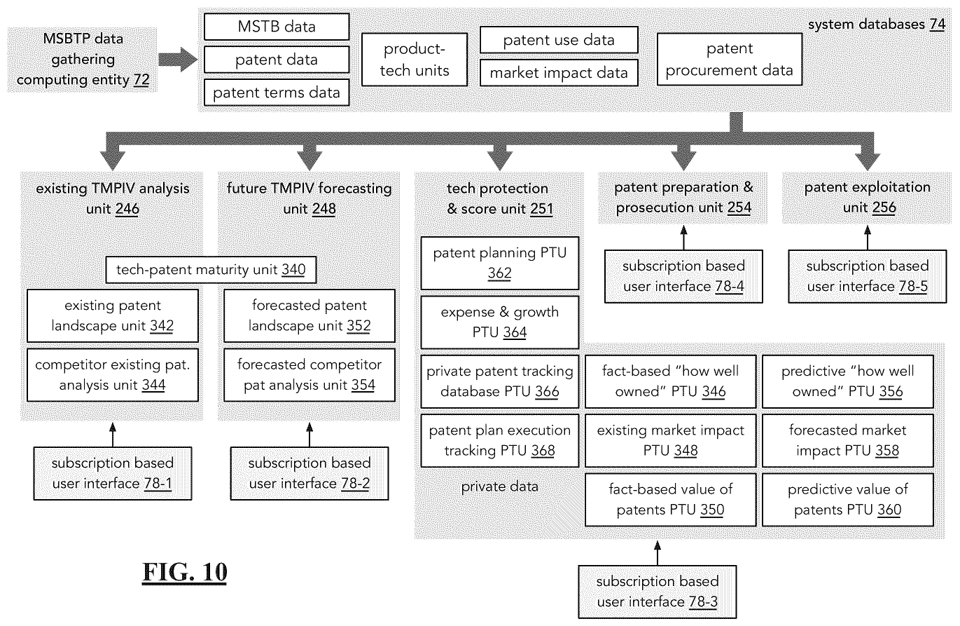

FIG. 9 is a schematic block diagram of a further embodiment of an improved computer for technology 70 that includes the system databases 262-274, the database interface unit 260, the subscription based user interface section 78, and the data processing section 76. The data processing section 76 includes a tech protection & score unit 251, an existing TMPIV analysis unit 246, a future TMPIV forecasting unit 248, a patent preparation unit 254-1, a patent prosecution unit 254-2, a patent use unit 256-1, and constructive notice unit 256-2; where TMPIV is an abbreviation for Technology, Market impact, Patent protection, Innovation, and Value of technology.

The existing TMPIV (tech) analysis unit 246 generates one or more reports 82 based on data retrieved from the PTU database 264, from the MSBT database 262, from the annotated patent database 268, the from the patent term database 266, and/or from the market impact databased 274. For example, the unit 246 generates an existing patent landscape report for a PTU based on per PTU existing patent data 310 (annotated patents and/or patent terms), per PTU existing MSBT data 312, and per PTU market impact data 314 for the selected PTU.

The unit 246 generates an existing patent landscape report for a selected PTU to include a list of inventions that have some form of patent protection, a list of assignees of existing patents (issued and pending), a breakdown of existing patents per assignee, a number of total inventions that should exist to date for the technology, an ideal number of inventions that should have been patent protected to date, a general description of the PTU, general descriptions of the existing patents, a comparison of existing patents to the total number of inventions to date, and/or a comparison of existing patents to an ideal number of inventions that have been patent protected to date.

The unit 246 generates a competitor existing patent analysis report regarding a PTU based on the existing patent landscape report tailored for a particular assignee. The report further compares the particular assignee's patenting of the PTU to date with the patenting to date of the PTU by other assignees.

The unit 246 generates a “how well the PTU is patent protected with existing patents” report based on the existing patent landscape report and the retrieved data. The report includes the list of inventions that have some form of patent protection, the number of total inventions that should exist to date for the technology, the ideal number of inventions that should have been patent protected to date, a quality analysis of the existing patent protection, and a calculation of the level of patent protection based on a ratio of the actual number of inventions protection with respect to the ideal number of inventions and the quality of the existing patent protection. The quality includes a cumulative score of per patent application preparation and prosecution quality score and a patent portfolio sufficiency score (e.g., balance, breadth, scope, etc.).

The unit 246 generates a market impact of the PTU in light of existing patents report based on the existing patent landscape report and the retrieved data. The report includes existing total available market (TAM) data, a compound annual growth rate (CAGR) for the TAM, service obtainable market (SOM) data, a CAGR for the SOM, influence of the marketable features of the PTU on the TAM and/or the SOM, influence of the unique value propositions (UVPs) of the PTU on the TAM and/or the SOM, influence of the technical challenges of the PTU on the TAM and/or the SOM, and a market impact calculation on the TAM and/or on the SOM.

The unit 246 generates a value of a PTU in light of existing patents report based on the how well patented report, the market impact report, and a market-patent “k” factor. The report includes the relevant data points of the other reports and a calculation of the value of the PTU at present. The calculation could further include past values of the PTU.

The future TMPIV (tech) forecasting unit 248 generates one or more reports 84 based on data retrieved from the PTU database 264, from the MSBT database 262, from the annotated patent database 268, from the patent term database 266, and/or from the market impact databased 274. For example, the unit 248 generates a forecasted future patent landscape report for a PTU based on per PTU future patent data 316, per PTU future MSBT data 318, and per PTU future market impact data 320 for the selected PTU.

The unit 248 generates a forecasted future patent landscape report for a selected PTU to a number of total inventions that should be created from present day to end of life of the PTU, an ideal number of inventions to be patent protected from present day to end of life of the PTU, a general description of the PTU, a forecast of assignees of future patents, and/or a list of technical challenges, unique value propositions, and/or marketable features for future inventions.

The unit 248 generates a competitor forecasted future patent analysis report based on the future patent landscape report tailored for a particular assignee. The report further compares the particular assignee's forecasted future patenting of the PTU with the forecasted future patenting of the PTU by other assignees.

The unit 248 generates a “how well the PTU is patent protected with forecasted future patents” report based on the future patent landscape report and the retrieved future forecasting data. The report includes the number of total inventions that should be created from present day to end of life of the PTU, the ideal number of inventions that should be patent protected from present day to end of file, a quality projection of the future patent protection, and a calculation of the level of patent protection based on desired patent position, a ratio of the number of inventions that will likely be patent protected based on desired patent position with respect to the ideal number of inventions and the quality of the future patent protection. The quality includes a cumulative score of per patent application preparation and prosecution quality forecasted score and a patent portfolio sufficiency forecasted score (e.g., balance, breadth, scope, etc.).

The unit 248 generates a market impact of the PTU in light of forecasted future patents report based on the future patent landscape report and the retrieved future forecasting data. The report includes, on a year-by-year basis, forecasted total available (or addressable) market (TAM) data, a forecasted compound annual growth rate (CAGR) for the TAM, forecasted service obtainable market (SOM) data, a forecasted CAGR for the SOM, forecasted influence of the marketable features of the PTU on the TAM and/or the SOM, forecasted influence of the unique value propositions (UVPs) of the PTU on the TAM and/or the SOM, forecasted influence of the technical challenges of the PTU on the TAM and/or the SOM, and a forecasted market impact calculation on the TAM and/or on the SOM.

The unit 248 generates a value of a PTU in light of forecasted future patents report based on the forecasted how well patented report, the forecasted market impact report, and the market-patent “k” factor. The report includes, on a year-by-year basis, the relevant data points of the other reports and a calculation of the future value of the PTU.

The tech protection and score unit 251 generates a tech score report and/or a graphical representation thereof 82. It also generates a tech protection report and/or a graphical representation thereof 82. Both reports are based on an architectural plan for developing a patent portfolio for a PTU product, an expense & growth report for the PTU product based on the architectural plan, and a patent protection tracking analysis. The unit 251 further generates its reports based on the financial input 306, the patent position input 308, and/or the reports produced by the existing TMPIV analysis unit 246 and/or the future TMPIV analysis unit 248.

The patent preparation unit 254-1 generates a patent application, or at least a claim set, for an invention of a PTU in accordance with architectural plan and PTU technical data 322. The PTU technical data 322 includes data regarding the PTU from the PTU database 264, business and technical information regarding the PTU from the MSBT database 262, market impact data from the market impact database 274, annotated patents from the annotated patent database 268, and/or patent terms from the patent terms database 266.

The patent prosecution unit 254-2 generates a prosecution response (e.g., an office action response) for a pending patent application regarding an invention of a PTU in accordance with architectural plan and PTU technical data 322. The PTU technical data 322 includes data regarding the PTU from the PTU database 264, business and technical information regarding the PTU from the MSBT database 262, market impact data from the market impact database 274, annotated patents from the annotated patent database 268, and/or patent terms from the patent terms database 266.

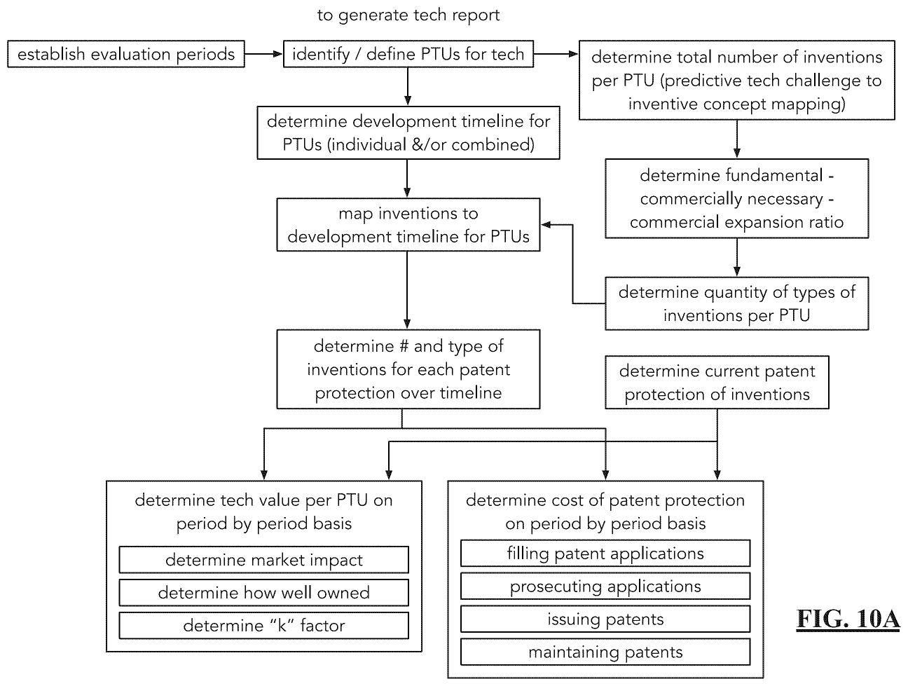

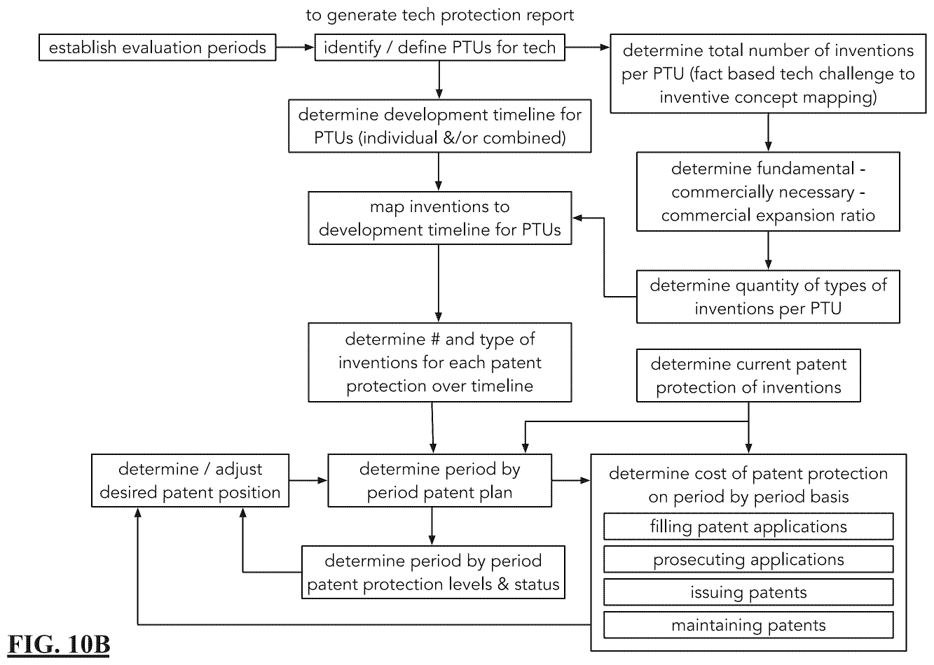

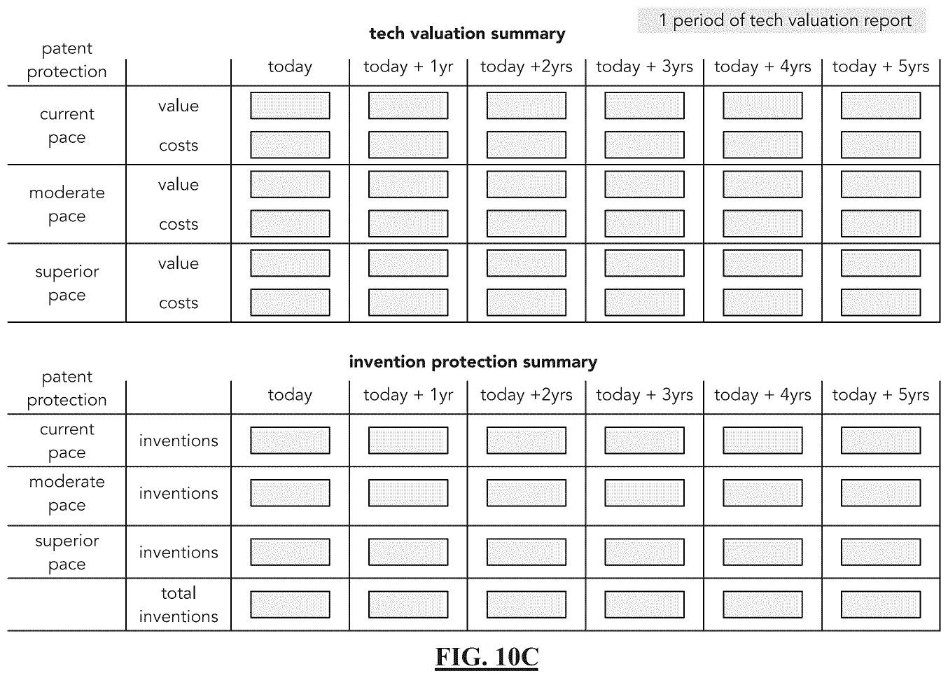

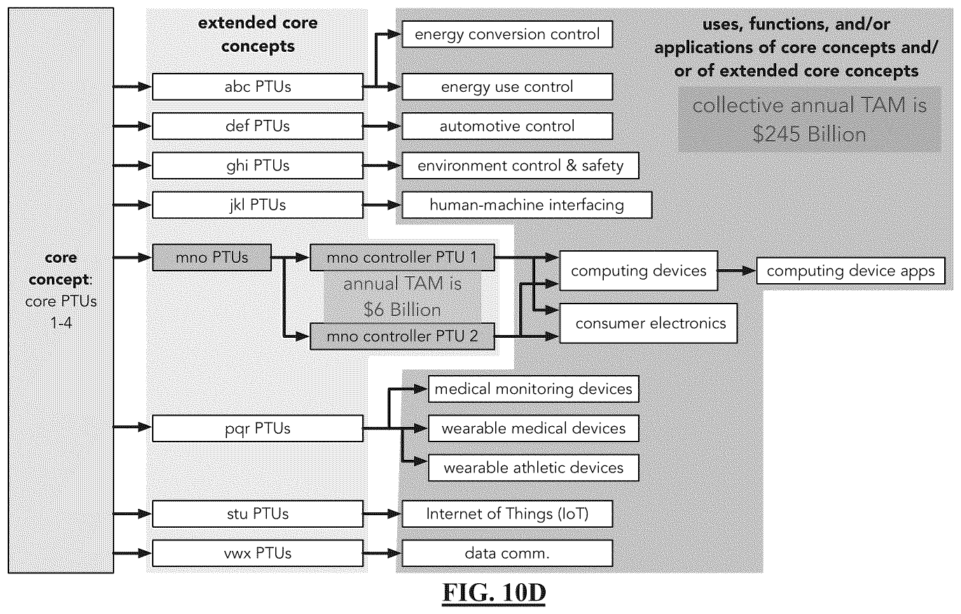

FIG. 10 is a schematic block diagram of a further embodiment of an improved computer for technology 70. In this embodiment, the improved computer includes the MSBTP (marketing, sales, business, technology, patents) data gathering section 72, the system databases 74, the subscription based user interface 78, the existing TMPIV (Technology, Market impact, Patent protection, Innovation, and Valuation) analysis unit 246, the future TMPIV analysis unit 248, the tech protection and score unit 251. The patent application preparation and prosecution unit 254, and the patent exploitation unit 256. Units 246-256 are part of the data processing section 76.

The system databases 74 stores MSBT data, patent data, patent terms, product-tech units (PTU) data, patent use data, market impact data, and patent procurement data. In an embodiment, the data of the system databases 74 is not directly accessible to authorized and authenticated user devices. Such user devices have read access only to the data of the system databases 74 indirectly via the data processing section 76.

The units of the data processing section 76 have read access to the data of the system databases 74, but do not have write access. The reports generated by the various units are stored by the respective units. The respective units may further store the data used to generate the reports. Authorized and authenticated user devices have read access only the reports and do not have read or write access to the data used to generate the reports, if stored by a respective unit.

The existing TMPIV analysis unit 246 includes a technology-patent maturity unit 340, an existing patent landscape unit 342, and a competitor existing patent analysis unit 344. The technology-patent maturity unit 340 determines the generation of a PTU and the phase of the current generation. The unit 340 also calculates the total number of inventions that are likely to be created over the life of the PTU, the percentage of the total number of inventions that should have been invented to date (e.g., existing inventions) and the remaining number of inventions to be invented (e.g., forecasted future inventions).

The existing patent landscape unit 342 generates an existing patent landscape report as generally discussed with reference to FIG. 9 and as described in greater detail with reference to subsequent figures. The competitor existing patent analysis unit 344 generates a competitor existing patent report as generally discussed with reference to FIG. 9 and as described in greater detail with reference to subsequent figures.

The future TMPIV analysis unit 248 includes the technology-patent maturity unit 340, a forecasted future patent landscape unit 352, and a competitor forecasted future patent analysis unit 354. The forecasted future patent landscape unit 352 generates a forecasted future patent landscape report as generally discussed with reference to FIG. 9 and as described in greater detail with reference to subsequent figures. The competitor forecasted future patent analysis unit 354 generates a competitor forecasted future patent report as generally discussed with reference to FIG. 9 and as described in greater detail with reference to subsequent figures.

The tech protection and score unit 251 includes a patent planning unit 362, an expense and growth unit 364, a private patent tracking database 366, a patent plan execution tracking unit 368, an existing “how well protected” unit 346, an existing market impact unit 348, and a PTU valuation in light of existing patents unit 350, a forecasted future “how well protected” unit 356, a forecasted future market impact unit 358, and a PTU valuation in light of forecasted future patents unit 360.

The patent planning unit 362 generates the architectural plan for patent protection of a PTU as generally discussed with reference to FIG. 9 and as described in greater detail with reference to subsequent figures. The expense and growth unit 364 calculates the expense of patenting inventions per the architectural plan, calculates prosecution timing and expense of pending patent applications, calculates timing and expense of issuing patent applications, and calculates timing and expense of subsequent filings.

The existing “how well protected” unit 346 generates an existing “how well protected” report as generally discussed with reference to FIG. 9 and as described in greater detail with reference to subsequent figures. The existing market impact unit 348 generates an existing market impact report as generally discussed with reference to FIG. 9 and as described in greater detail with reference to subsequent figures. The PTU valuation in light of existing patents unit 350 generates an existing PTU valuation report as generally discussed with reference to FIG. 9 and as described in greater detail with reference to subsequent figures.

The forecasted future “how well protected” unit 356 generates a forecasted future “how well protected” report as generally discussed with reference to FIG. 9 and as described in greater detail with reference to subsequent figures. The forecasted future market impact unit 358 generates a forecasted future market impact report as generally discussed with reference to FIG. 9 and as described in greater detail with reference to subsequent figures. The PTU valuation in light of forecasted future patents unit 360 generates a forecasted future PTU valuation report as generally discussed with reference to FIG. 9 and as described in greater detail with reference to subsequent figures.

A private patent tracking database 366 is an individual database for authorized and authenticated user devices that are affiliated with executing an architectural plan for a PTU. Note that a private database 366 tracks one or more PTU architectural plans of a user (via its device). The patent plan execution unit 368 coordinates data entry in the private databases 366 and generates periodic (and/or on-demand) reports regarding the execution of the architectural plan.

The patent preparation and prosecution unit 254 includes a PTU technology for lawyers unit 370, an invention identification (ID) and claim drafting unit 372, a patent application drafting unit 374, a patent prosecution unit 376, and a patent quality analysis unit 378. The PTU technology for lawyers unit 370 provides general descriptions of relevant PTUs that are associated with a PTU of which an invention is being patented. For example, if the invention is regarding a touch screen controller, the PTU technology for lawyers unit 370 retrieves general descriptions of touch screen controllers, touch screens, and the devices using touch screens (inclusion PTUs-higher tier PTUs). The PTU technology for lawyers unit 370 may further retrieve general descriptions of touch screen controller composition PTUs (lower tier PTUs).

The invention identification (ID) and claim drafting unit 372 generates a report that identifies novel aspects of an invention of a PTU based on the technical boundaries of the PTU and a particular problem the invention is addressing. In an embodiment, the unit 372 uses an interactive ML and/or AI program to generate an initial report regarding novel aspect and a series of questions to tune the novel aspects and outline independent claims.

The patent quality analysis unit 378 generates a report regarding patent quality by reviewing and analyzing the claims, support of the claims, clarity of the invention being patented, clarity of problem being solved, clarity of benefit of invention, and/or relative scope of claim coverage. The determination of patent quality will be discussed in greater detail with reference to subsequent figures.

The improved computer disclosed herein provides an improved computer architecture, provides many new technologies, and provides many significant technical improvements and/or technical advantages over existing computers and computer programs that support the conventional patent process. These include, but are not limited to, one or more of:
increased data consistency regarding data identification, data retrieval, data analysis, and/or data results through the use of one or more new computer co-processing units and/or functions that quantify technology in terms of product-tech units (PTUs);
one or more new computer co-processing units and/or functions to identify new PTUs and create database records for new PTUs, one or more new computer co-processing units and/or functions to identify documents relevant to new and/or existing PTUs, to retrieve such documents, dissecting such documents to extract relevant PTU data, create database records for storing such documents, and/or to update existing PTU records with further PTU data, which further improves data consistency;
one or more new computer co-processing units and/or functions to generate an architectural plan to patent protect a PTU over the life of the PTU, only patents that service a purpose per the plan are pursued, which eliminates waste and increases effectiveness;
   to answer the question of “how many patents are needed to appropriately protect a technology?”
   to calculate, for the quantified technology as represented by a PTU, a total number of inventions likely to be invented over the life of the quantified technology;
   to calculate the life of a quantified technology (PTU);
   to generate a report regarding invention types for the PTU and to calculate quantities for each invention type;
one or more new computer co-processing units and/or functions to calculate, on a year-by-year basis (or other frequency) expense and growth of patent protection of a PTU from its infancy to its end of life;
one or more new computer co-processing units and/or functions to calculate a year-by-year (or other frequency) value of a PTU from its infancy to its end of life;
one or more new computer co-processing units and/or functions to generate an existing patent landscape report (and/or prior art search report) for a PTU (and/or PTUs);
one or more new computer co-processing units and/or functions to track and record execution of an architectural plan for patent protecting a PTU; and/or
one or more new computer co-processing units and/or functions to generate an improved and streamlined architectural plan to patent protect a PTU over the life of the PTU, which;
   answers the question of “how many patents are needed to appropriately protect a technology?”
   calculates, for the quantified technology as represented by a PTU, a total number of inventions likely to be invented over the life of the quantified technology;
   calculates the life of a quantified technology (PTU); and/or
   generates a report regarding invention types for the PTU and to calculate quantities for each invention type.

Like other computers, the improved computer operates at the machine level where data is represented as unique sequences of 1's and 0's. For the improved computer data is one of data operands, operational instructions, or resulting data, where a set of operational instructions (or operational codes, or op codes) is performed on one or more data operands to produce resulting data. Within the improved computer it is common for the resulting data of a previously executed set of operational instructions to be a data operand(s) [intermediate operand] for a subsequently executed set of operational instructions, where a set includes one or more operational instructions.

Operational instructions are programming language specific and provide the instructions for the computer to read data operands, write data operands, write data results, and/or perform a function on a data operand(s). Examples of functions includes, but are not limited to, add, subtract, shift left, shift right, multiply, divide, a logic AND, a logic OR, a logic XOR, etc. A generic format for an operational instruction is [function; address for operand; (additional address for additional operands if functions involve two or more operands); address of where to write the data result].

The data operands, operational instructions, and data results are stored within the improved computer's memory as unique sequences of 1's and 0's. How the 1's and 0's are stored, retrieved, and processed within the computer dictate whether they are related to a data operand, an operational instruction, or a data result. All of the unique sequences of 1's and 0's regarding a program need to be properly associated with data operands, operational instructions, and data result; and need to be retrieved, processed, and/or stored in a precise manner for the program to operating correctly (e.g., produce the desired data result(s) from one or more initial data operands and/or one or more intermediate data operands).

A new combination and/or ordering of operational instructions that is executed by the improved computer on data operands (new, known, initial, and/or intermediate) to produce a new data result is novel. The creation, storage, and/or execution of operational instructions by an improved computer on data operands to produce a new data result are, in it of themselves, technical challenges.

Creating a new tool via the novel programming of a computer provides the benefits of any physical tool, which include, but are not limited to, improving performance, efficiency, accurately, reliability, safety, resolution, etc. of an existing task, providing new solutions to an existing task, and providing solutions to new tasks.

The human meaning of the 1's and 0's of the data operands, the operational instructions, and/or the data results does not change the technical challenges of programming a computer to produce an output, or outputs, through one or more sets of operational instructions operating on initial data operands and/or intermediate operands.

FIG. 10A is a logic diagram of an example of a method for an improved computer for technology to generate a technology report. The report is on a period by period basis (e.g., yearly) and includes a value analysis and cost analysis. The value analysis is based on a market impact of the technology (in terms of one or more PTUs), how well the technology is owned through patents, and market-tech-patent “k” factor.

FIG. 10B is a logic diagram of an example of a method for an improved computer for technology to generate a technology protection report.

FIG. 10C is a schematic block diagram of an example of a technology report generated by an improved computer for technology.

FIG. 10D is a schematic block diagram of an example of another technology report generated by an improved computer for technology.

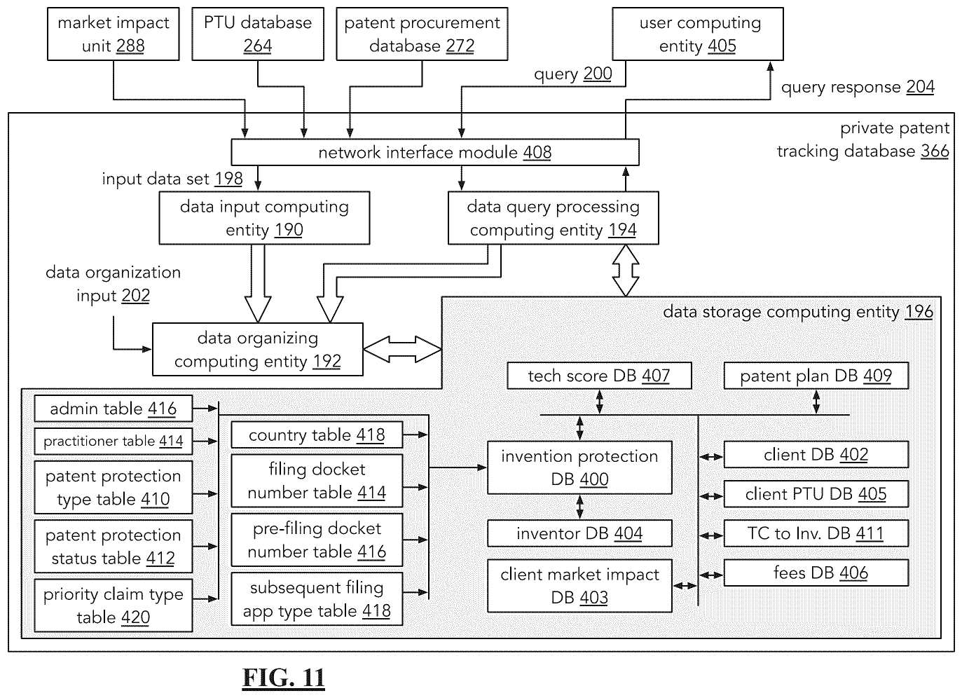

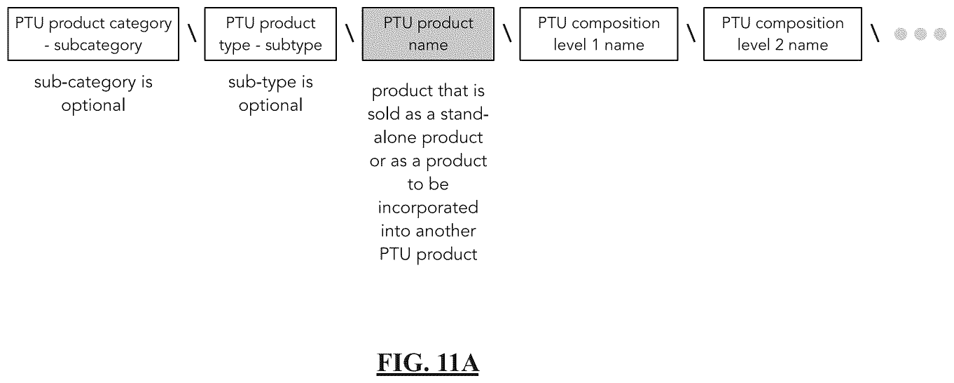

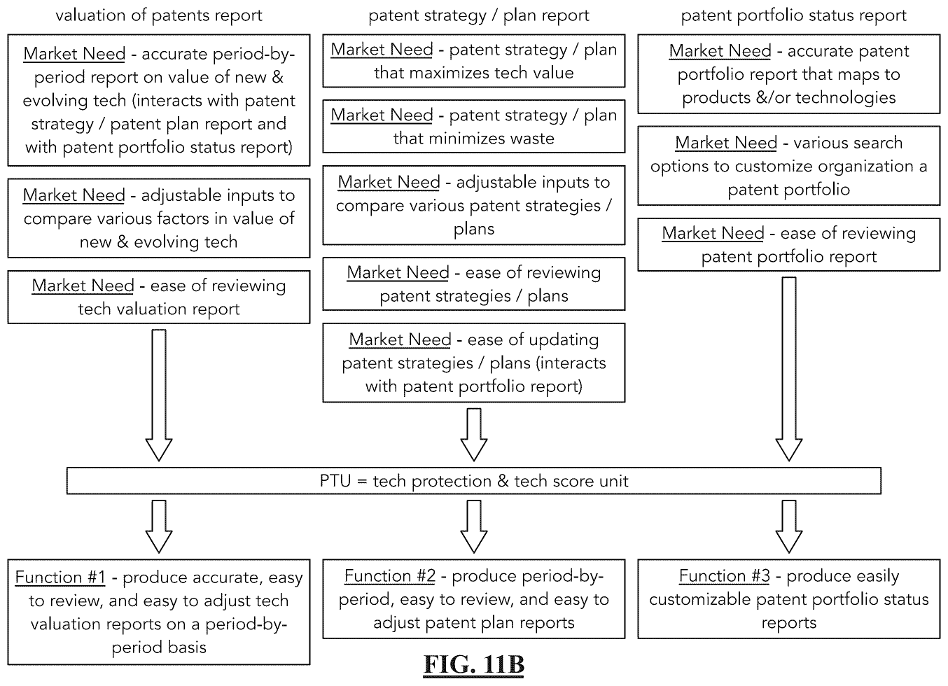

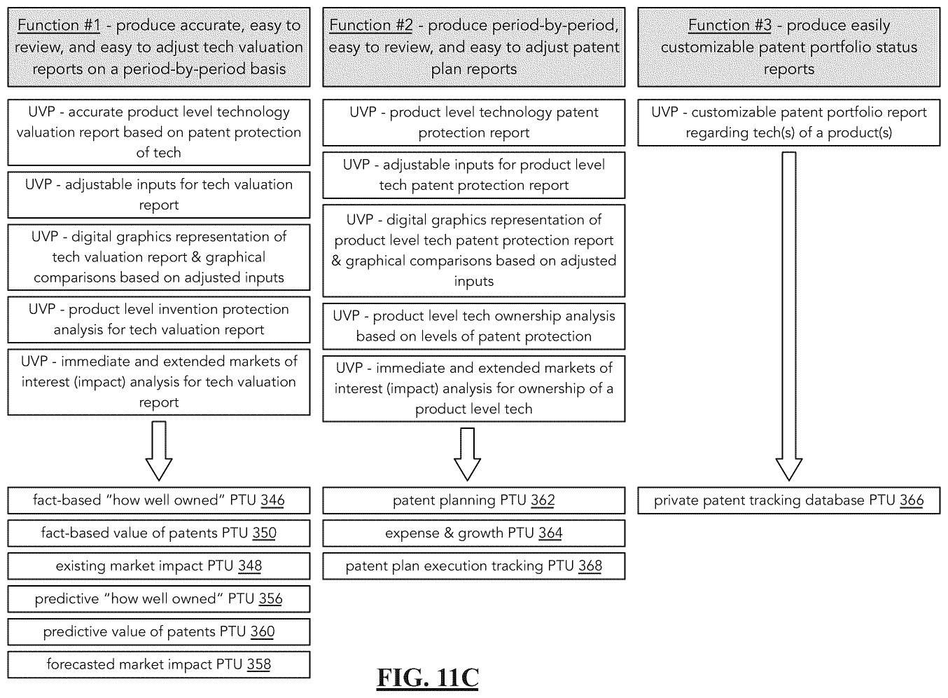

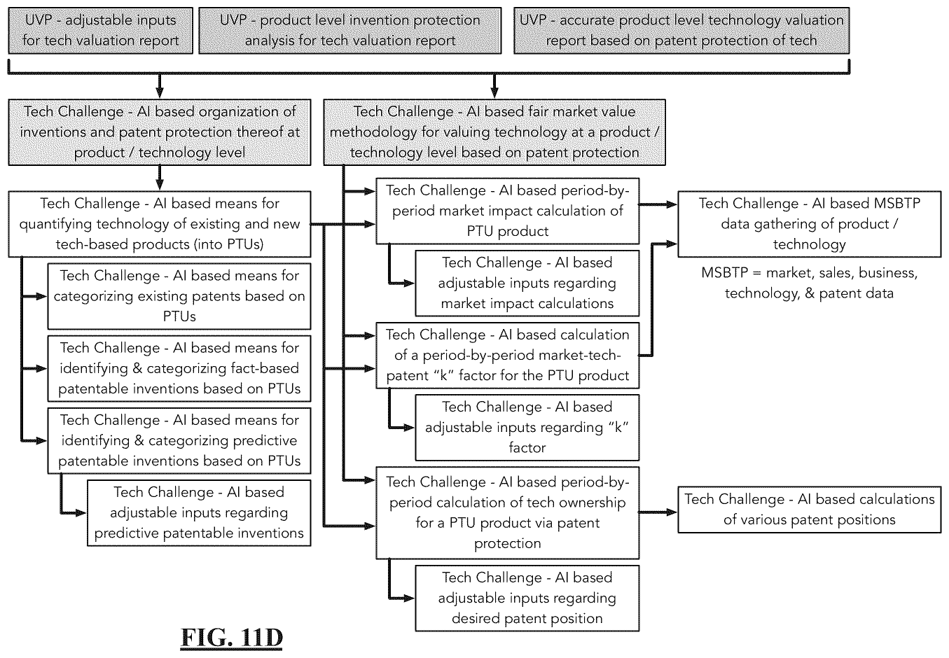

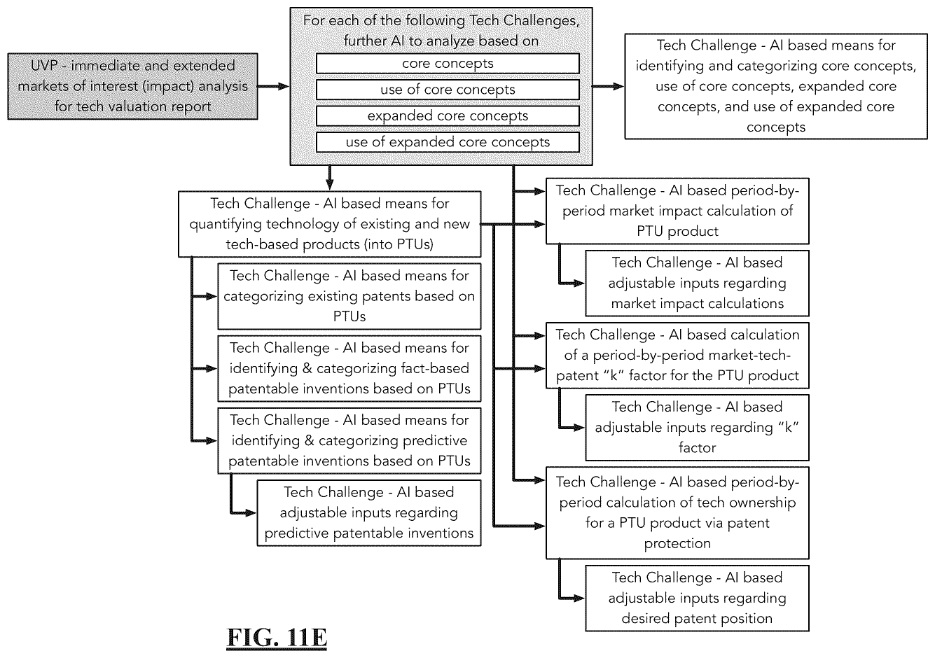

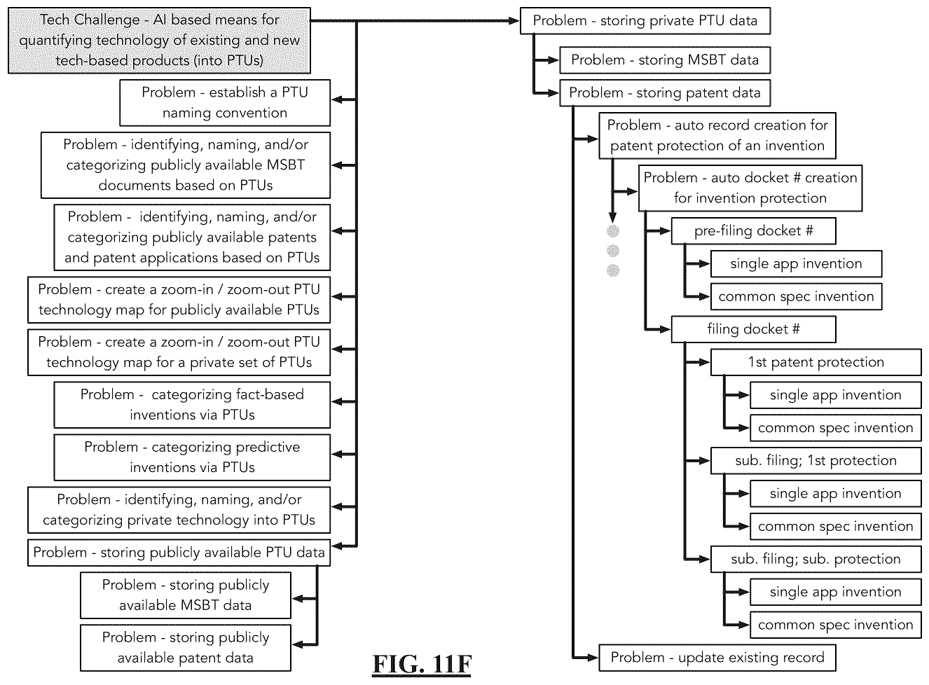

FIG. 11 is a schematic block diagram of an embodiment of a private patent tracking database of an improved computer for technology. The private patent tracking database 366 includes a network interface 408, a data input computing entity 190, a data organizing computing entity 192, a data query processing computing entity 194, and a data storage computing entity 196. The data storage computing entity 196 includes a tech score database 407, a patent plan database 409, an invention protection database 400, a client database 402, a client market impact database 403, an inventor database 404, a client PTU database 405, a factual tech challenge to invention database 411, and a fees database 406. Note that a database 400-411 may be a table of another database. For example, the inventor database (DB) 404 is a table of the client DB 402.

FIG. 11A is a schematic block diagram of an example of a product-tech unit (PTU) naming convention for use by one or more databases of an improved computer for technology. The PTU naming convention includes a PTU product category-subcategory field, a PTU product type-subtype field, a PTU product name field, a PTU composition level 1 field, a PTU composition level 2 field, and so on. The PTU product name field is for a technology based product that is sold, licensed, consumed, or otherwise transferred from one party to another.

The PTU composition level fields are the quantified technologies that comprise the PTU product and are not generally sold, licensed, consumed, or otherwise transferred from one party to another. As an example and as will be further illustrated below, a data processing core is a Product Category; discrete components is a subcategory of the Product Category; processing module is a Product Type; microprocessor is a subcategory of the Product Type; AAA microprocessor is a Product Name; and arithmetic logic unit is a level 1 composition of the AAA microprocessor.

FIG. 11B is a schematic block diagram of an example of applying the PTU naming convention to the tech protection & tech score unit of an improved computer for technology.

FIG. 11C is a schematic block diagram of an example of applying the PTU naming convention to components of the tech protection & tech score unit of an improved computer for technology.

FIG. 11D is a schematic block diagram of a further example of applying the PTU naming convention to components of the tech protection & tech score unit of an improved computer for technology.

FIG. 11E is a schematic block diagram of a further example of applying the PTU naming convention to components of the tech protection & tech score unit of an improved computer for technology.

FIG. 11F is a schematic block diagram of an example of a tech challenge to problem mapping for a component of the tech protection & tech score unit of an improved computer for technology.

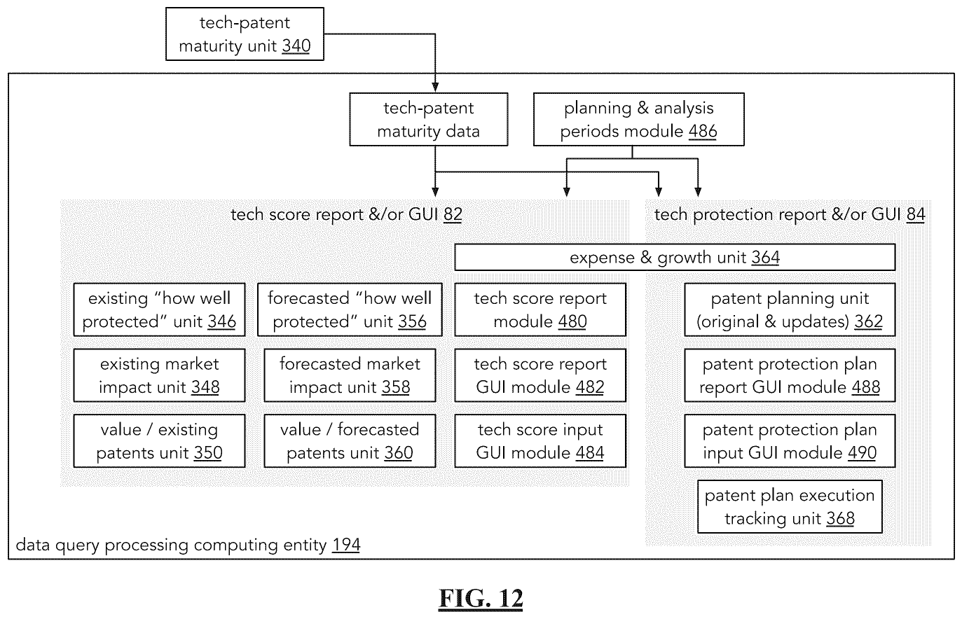

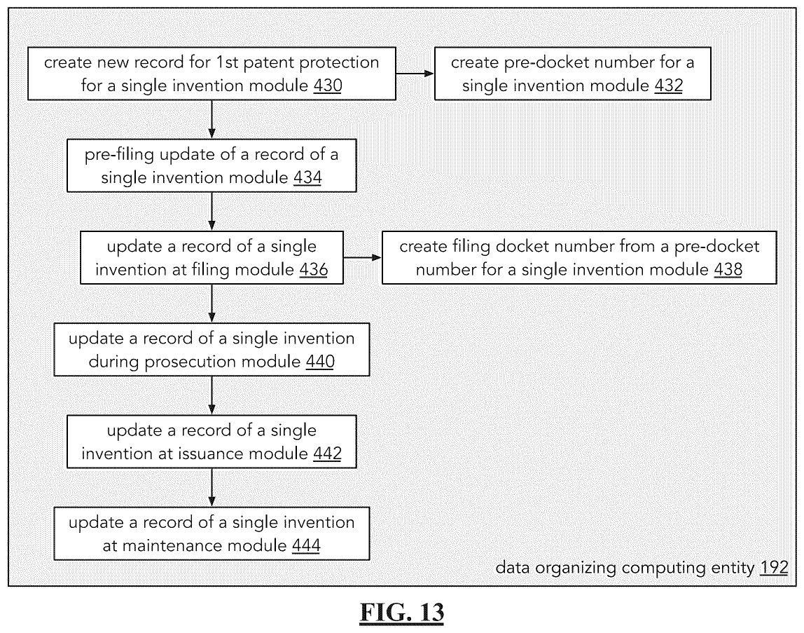

FIG. 12 is a schematic block diagram of an embodiment of a data query processing computing entity of a private patent tracking database of an improved computer for technology.

FIG. 13 is a schematic block diagram of a functional embodiment of a data organizing computing entity of a private patent tracking database of an improved computer for technology. As used herein:

A common spec refers to the detailed discussion section of a patent application and the detailed discussion section includes a discussion of two or more inventions.

A common spec patent application refers to a patent application that has a common spec and claims for one of the two or more inventions.

First patent protection without claiming refers to the filing of a patent application that includes a common spec detailed section or a single invention detailed discussion and does not include claims for an invention (e.g., a provisional patent application).

First patent protection with claiming refers to the filing of a patent application that includes a common spec detailed section or a single invention detailed discussion and includes a first set of claims for an invention (e.g., a US utility patent application, a PCT patent application, a Foreign National utility patent application, each without a priority patent application claim).

Subsequent patent protection with first claiming refers to the filing of a patent application that includes a common spec detailed section or a single invention detailed discussion, includes a first set of claims for an invention, and includes a priority claim to another patent application.
a) A US utility patent application that claims priority to a provisional patent application;
b) A US utility patent application that claims priority to a PCT patent application;
c) A US utility patent application that claims priority to a Foreign National patent application;
d) A PCT patent application that claims priority to a provisional patent application;
e) A PCT patent application that claims priority to a US utility patent application;
f) A PCT patent application that claims priority to a Foreign National patent application;
g) A Foreign National utility patent application that claims priority to a provisional patent application;
h) A Foreign National utility patent application that claims priority to a US utility patent application;
i) A Foreign National utility patent application that claims priority to a PCT patent application; and/or
j) A legal placeholder conversion for an unclaimed invention of a common spec that claims priority to a US utility patent application.

Subsequent patent protection with subsequent claiming refers to the filing of a patent application that includes a common spec detailed section or a single invention detailed discussion, includes a second (or greater) set of claims for an invention, and includes a priority claim to another patent application as a continuation application, a continuation-in-part application, and/or a divisional application.

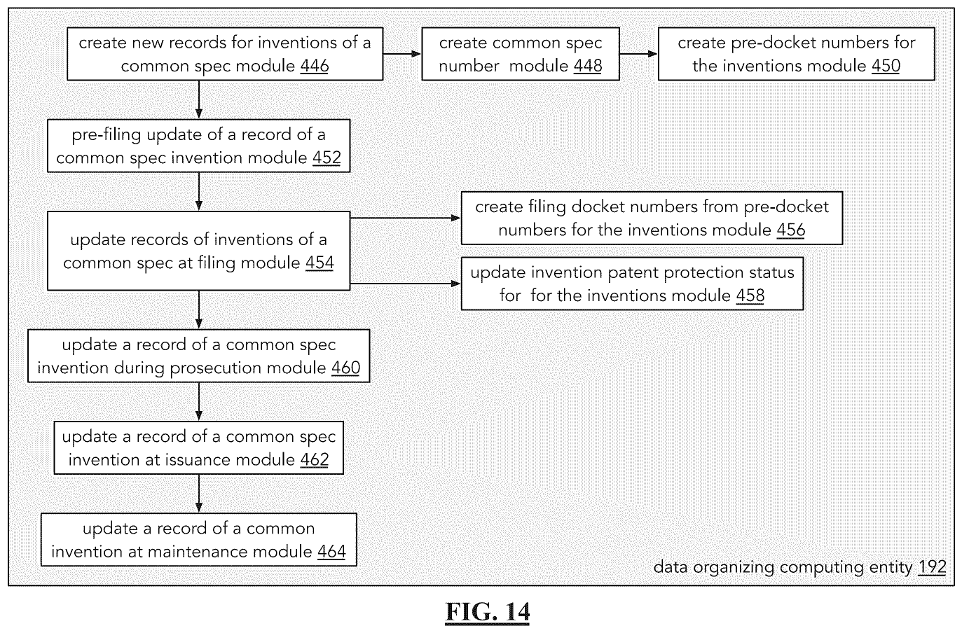

FIG. 14 is a schematic block diagram of another functional embodiment of a data organizing computing entity of a private patent tracking database of an improved computer for technology.

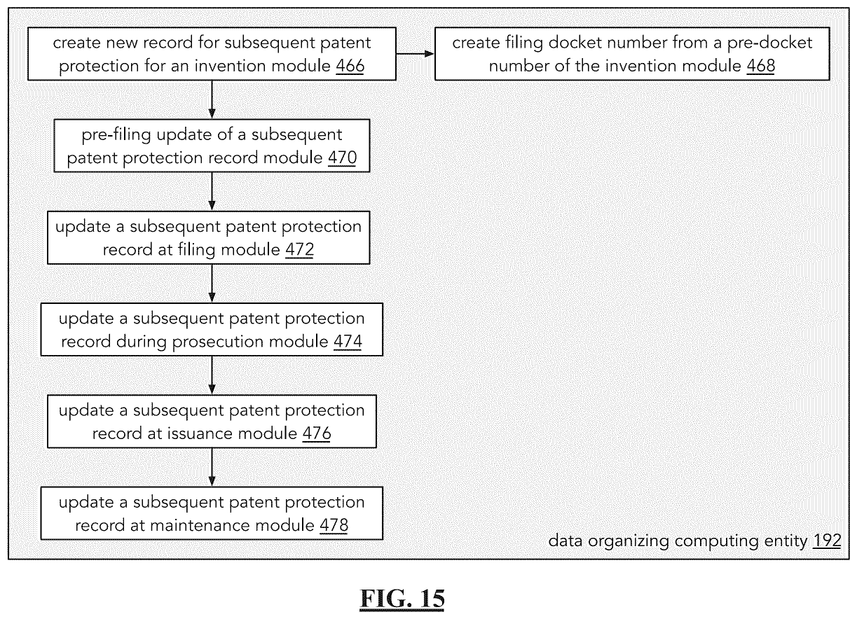

FIG. 15 is a schematic block diagram of another functional embodiment of a data organizing computing entity of a private patent tracking database of an improved computer for technology.

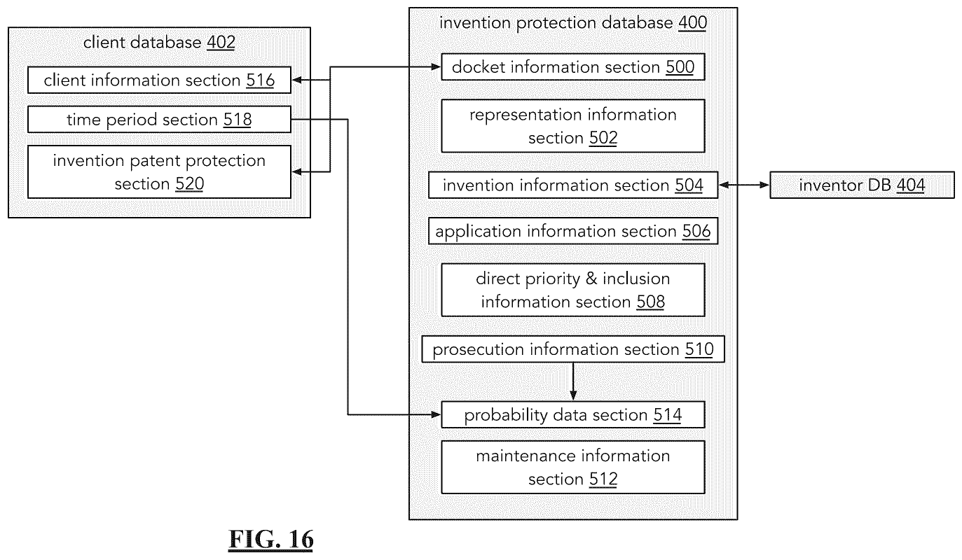

FIG. 16 is a schematic block diagram of an embodiment of an invention protection database and a client database of a private patent tracking database of an improved computer for technology.

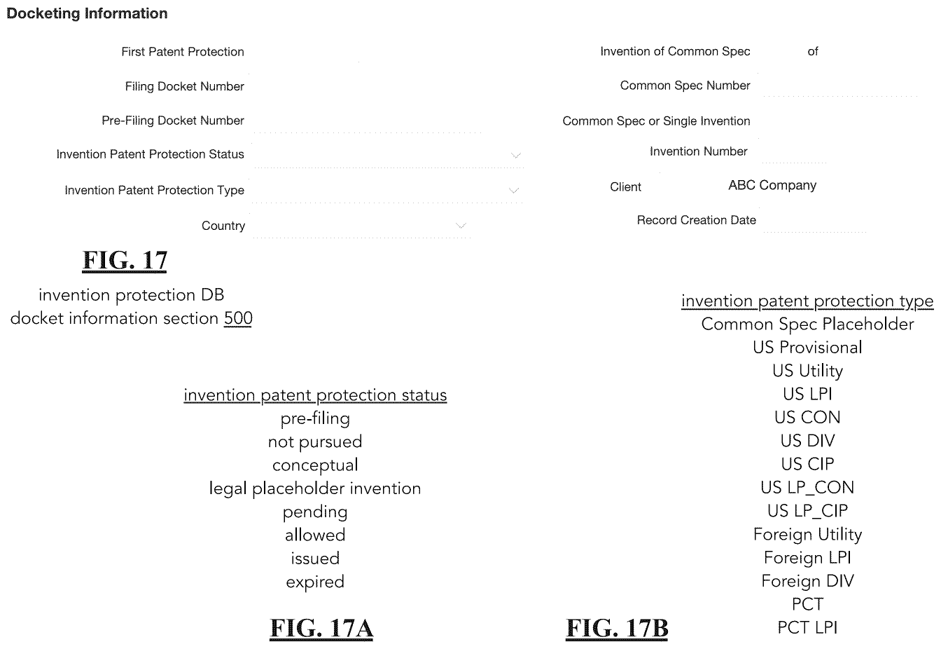

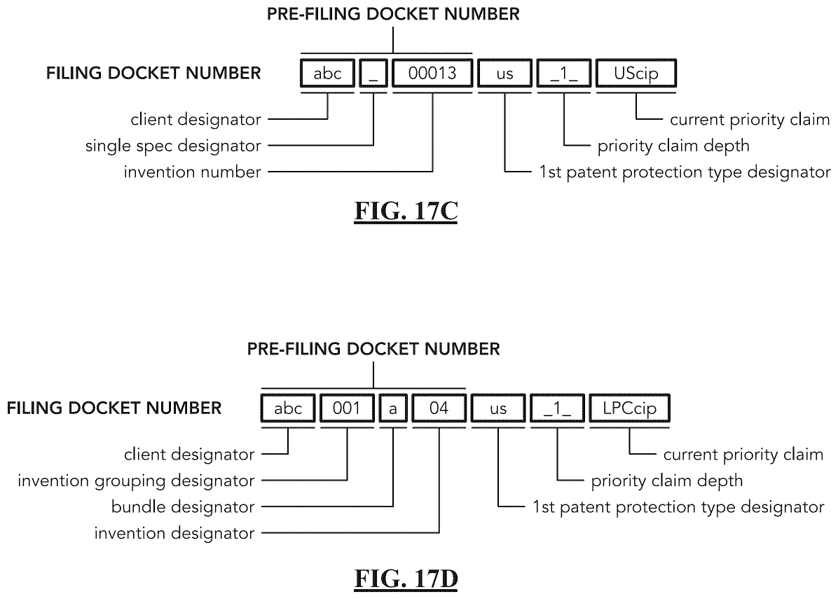

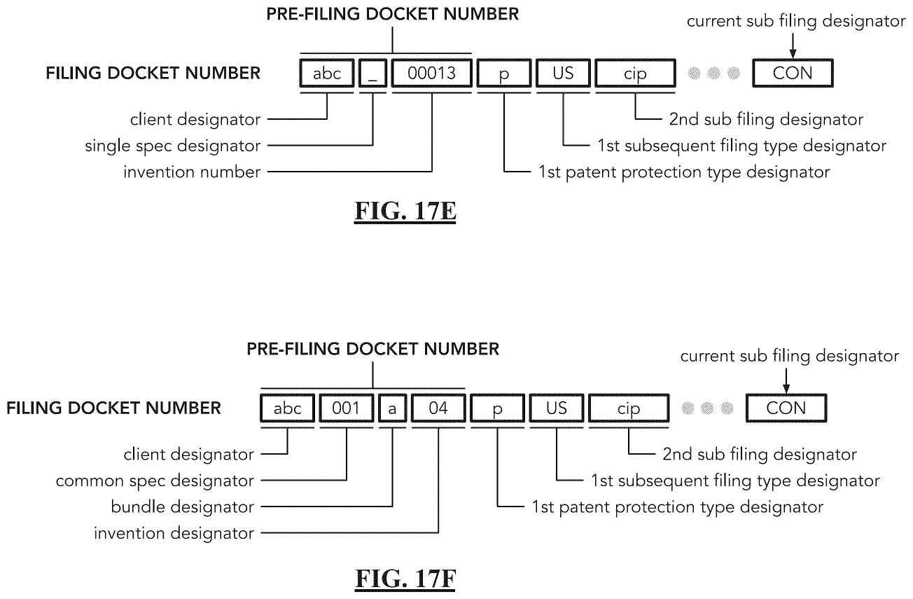

FIG. 17 is a schematic block diagram of an example of a docketing section of an invention protection database of a private patent tracking database of an improved computer for technology.

FIG. 17A is a diagram of an example of a list of invention patent protection status options for a record within an invention protection database of a private patent tracking database of an improved computer for technology.

FIG. 17B is a diagram of an example of a list of invention patent protection type options for a record within an invention protection database of a private patent tracking database of an improved computer for technology.

FIG. 17C is a diagram of an example of a first pre-filing docket number format for a record within an invention protection database of a private patent tracking database of an improved computer for technology. For example, the filing docket number includes a pre-filing docket number and one or more suffixes for a patent application that includes a detailed discussion section for one invention.

FIG. 17D is a diagram of an example of a second pre-filing docket number format for a record within an invention protection database of a private patent tracking database of an improved computer for technology. For example, the filing docket number includes a pre-filing docket number and one or more suffixes for a patent application that includes a common spec (i.e., a detailed discussion section for two or more inventions).

FIG. 17E is a diagram of an example of a first filing docket number format for a record within an invention protection database of a private patent tracking database of an improved computer for technology. For example, the filing docket number includes a pre-filing docket number and one or more different suffixes (with respect to FIG. 17C) for a patent application that includes a detailed discussion section for one invention.

FIG. 17F is a diagram of an example of a second filing docket number format for a record within an invention protection database (of a private patent tracking database of an improved computer for technology). For example, the filing docket number includes a pre-filing docket number and one or more different suffixes (with respect to FIG. 17D) for a patent application that includes a common spec (i.e., a detailed discussion section for two or more inventions).

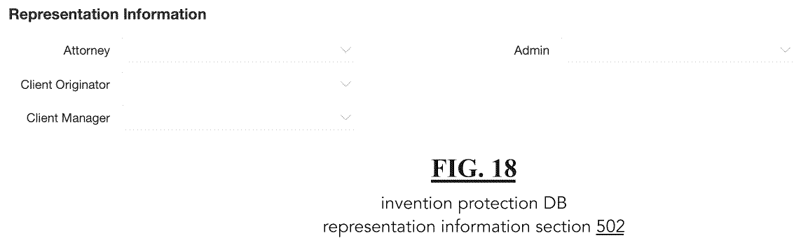

FIG. 18 is a schematic block diagram of an example of a representation section of an invention protection database of a private patent tracking database of an improved computer for technology.

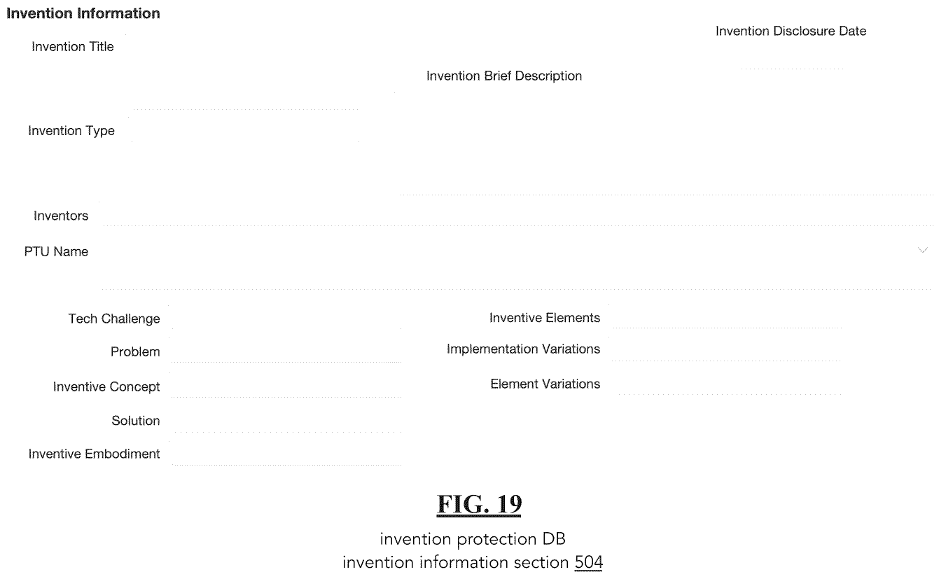

FIG. 19 is a schematic block diagram of an example of an invention information section of an invention protection database of a private patent tracking database of an improved computer for technology.

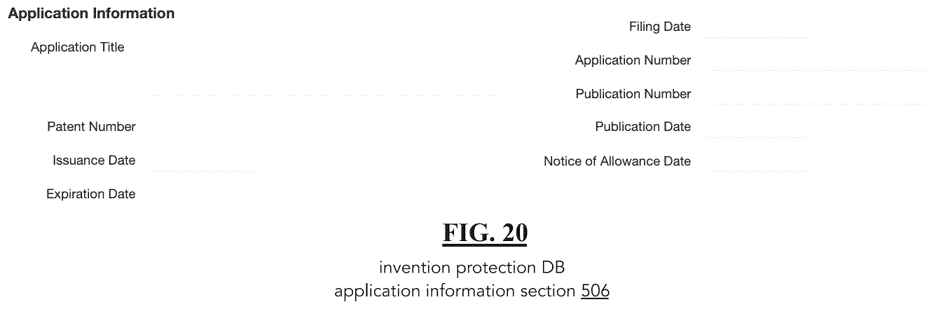

FIG. 20 is a schematic block diagram of an example of an application section of an invention protection database of a private patent tracking database of an improved computer for technology.

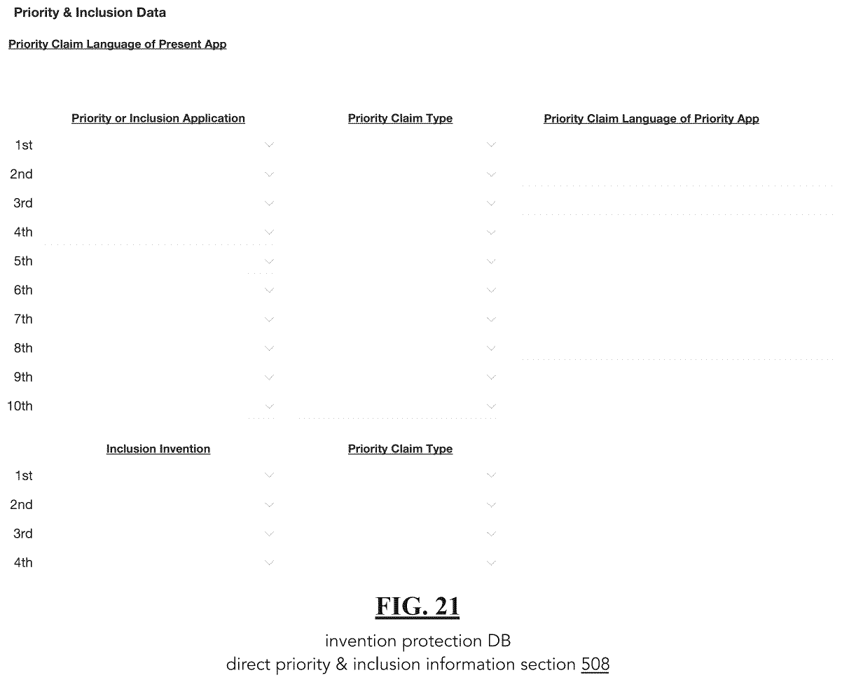

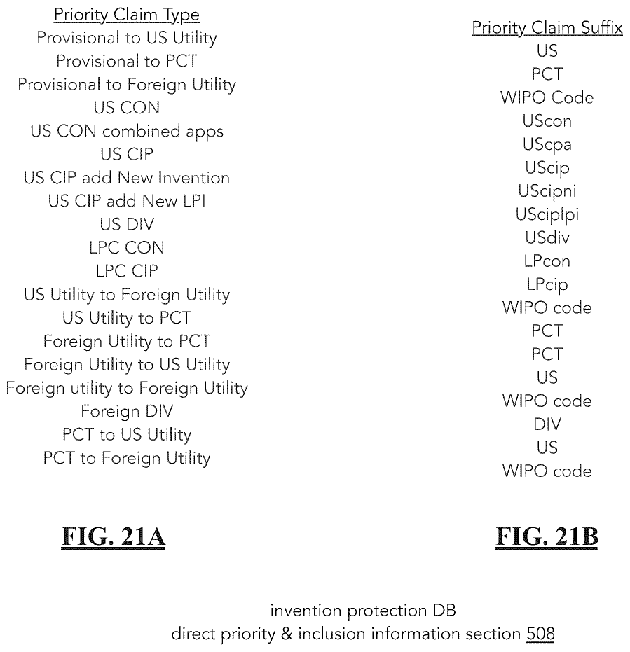

FIG. 21 is a schematic block diagram of an example of a priority & inclusion data section of an invention protection database of a private patent tracking database of an improved computer for technology.

FIG. 21A is a diagram of an example of a list of priority claim type options for a record within an invention protection database of a private patent tracking database of an improved computer for technology.

FIG. 21B is a diagram of an example of a list of priority claim suffix options of a first docket number approach for a filing docket number of a record within an invention protection database of a private patent tracking database of an improved computer for technology.

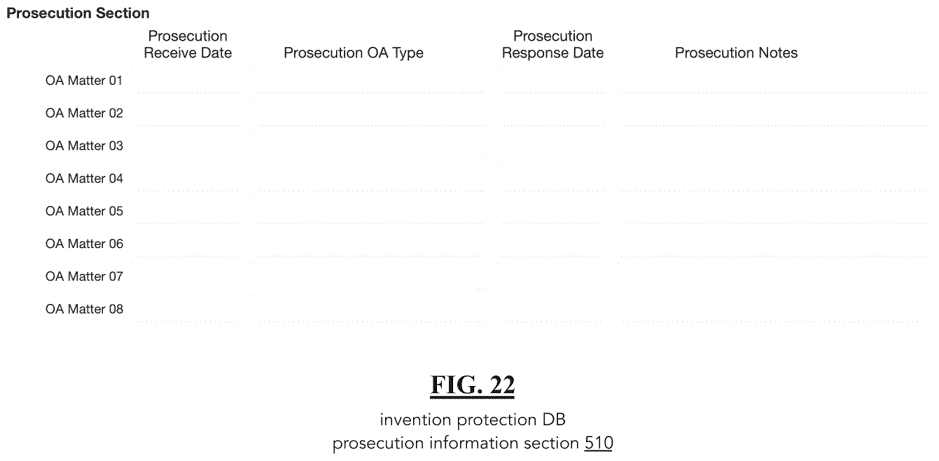

FIG. 22 is a schematic block diagram of an example of a prosecution data section of an invention protection database of a private patent tracking database of an improved computer for technology.

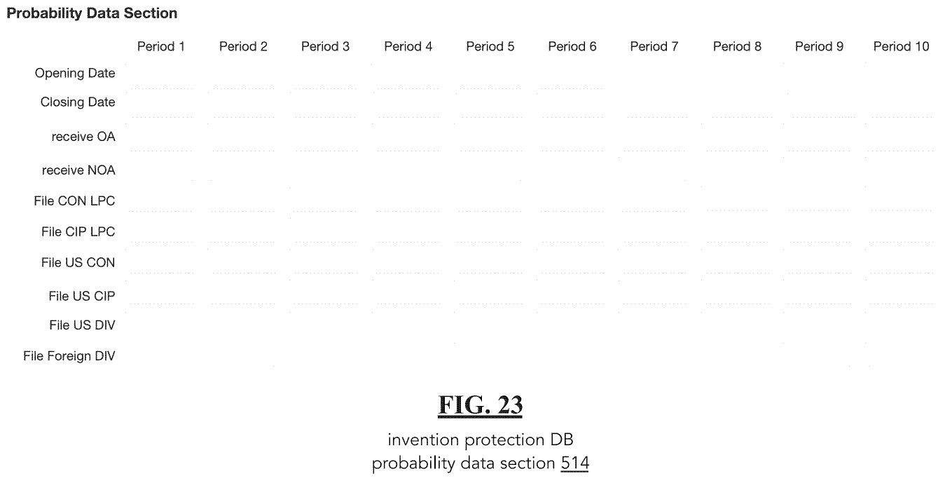

FIG. 23 is a schematic block diagram of an example of a probability data section of an invention protection database of a private patent tracking database of an improved computer for technology.

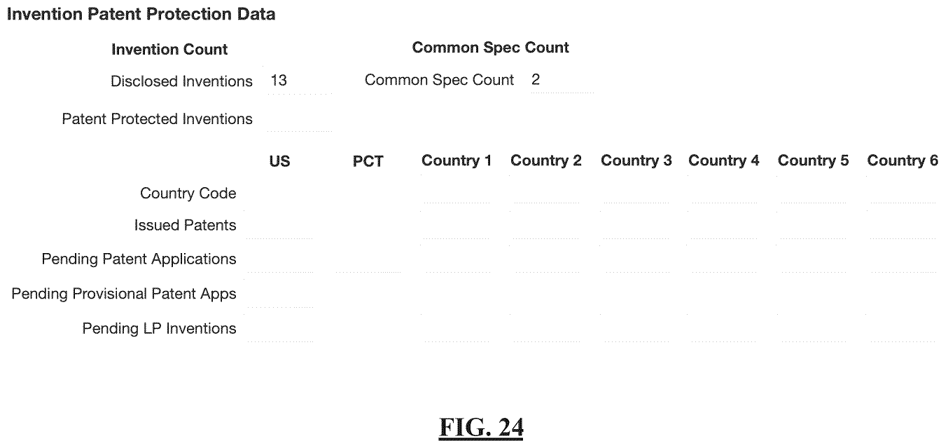

FIG. 24 is a schematic block diagram of an example of an invention patent protection data section of a client database of a private patent tracking database of an improved computer for technology.

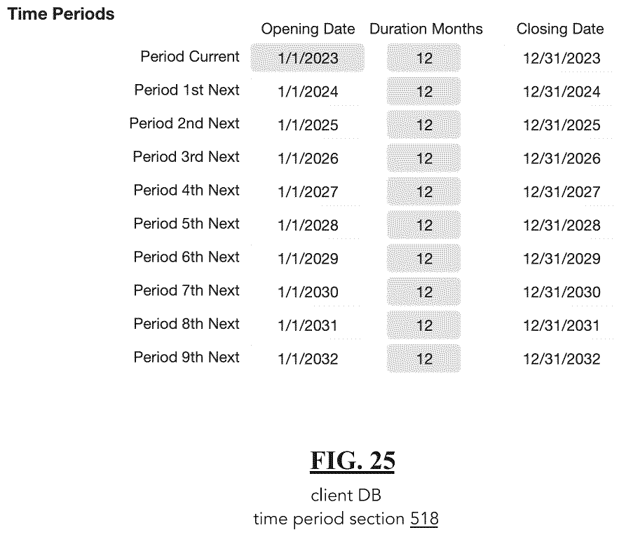

FIG. 25 is a schematic block diagram of an example of time periods data section of a client database of a private patent tracking database of an improved computer for technology.

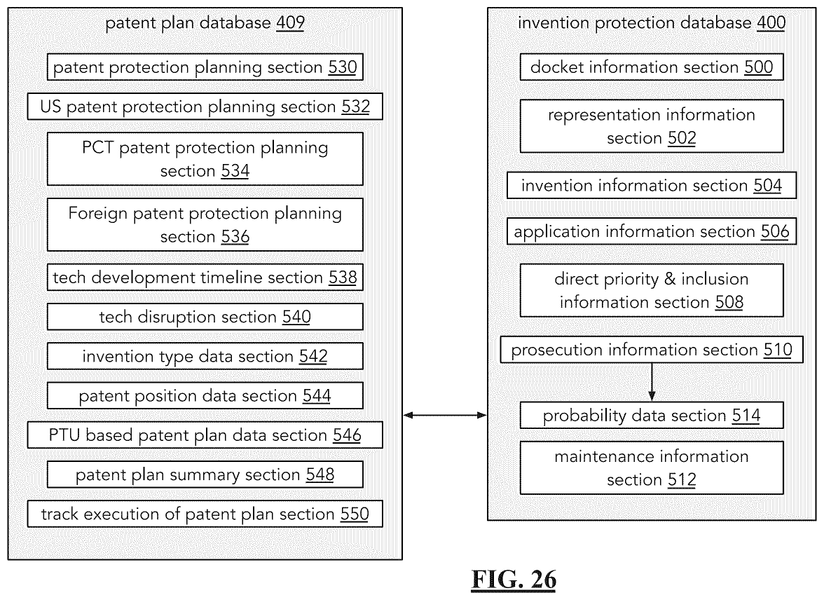

FIG. 26 is a schematic block diagram of an embodiment of an invention protection database and a patent plan database of a private patent tracking database of an improved computer for technology.

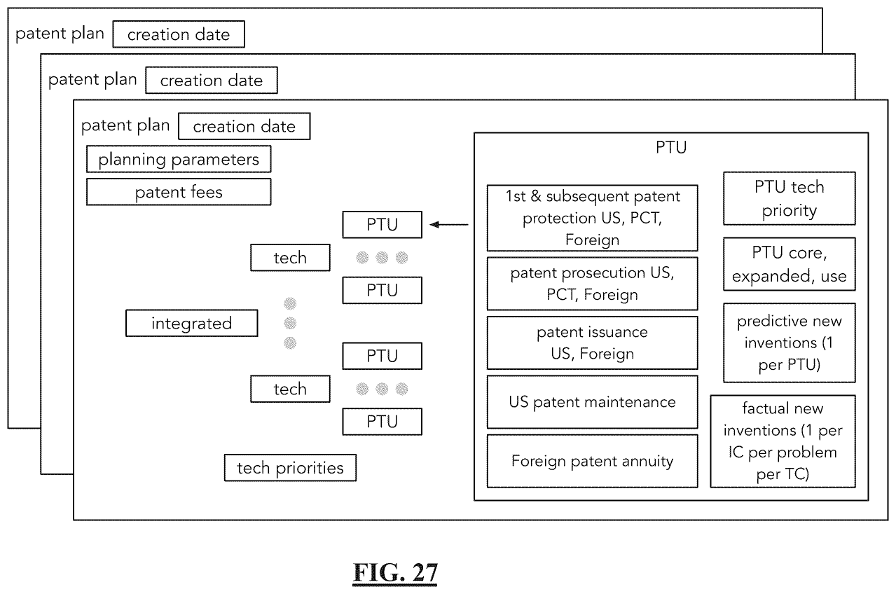

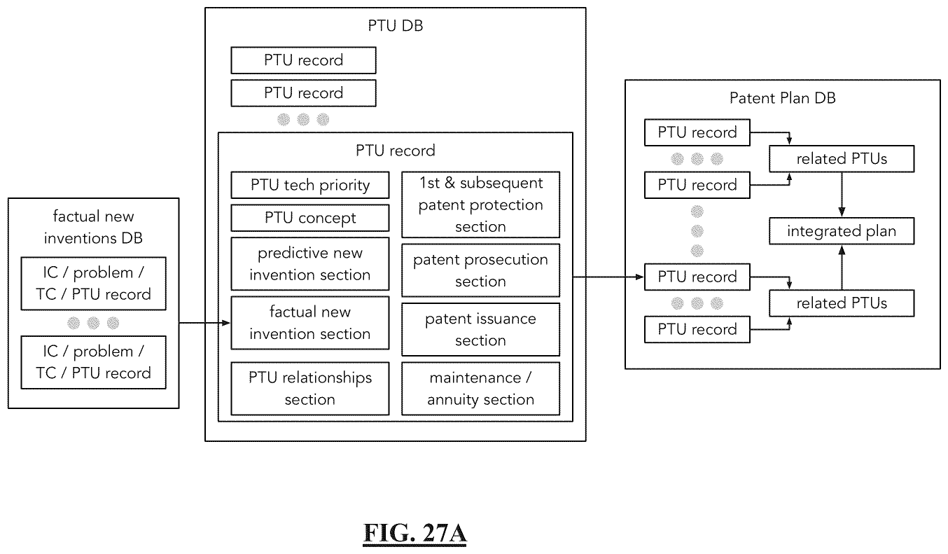

FIG. 27 is a schematic block diagram of an example of a plurality of patent plans created by a patent plan database of a private patent tracking database of an improved computer for technology. A new or updated patent plan is created as often as desired based on market variables, technology variable, and/or product variables. At a minimum, a new or updated patent plan would be created once every period.

As an example, a patent plan is a compilation of patent plans for each PTU product, which is a complication of composition PTUs. At the PTU level, the database(s) generate data regarding factual new inventions, predictive new inventions, PTU core concepts, PTU expanded core concepts, PTU uses of core concepts, PTU uses of extended core concepts, 1st and subsequent invention patent protection forecasting, patent prosecution forecasting, patent issuance forecasting, US maintenance forecasting, and/or foreign annuity forecasting. As inputs, the database(s) use planning parameters (US and/or foreign) and corresponding patent fees.

FIG. 27A is a schematic block diagram of an embodiment of a factual new invention database and a PTU database of a patent plan database of a private patent tracking database of an improved computer for technology.

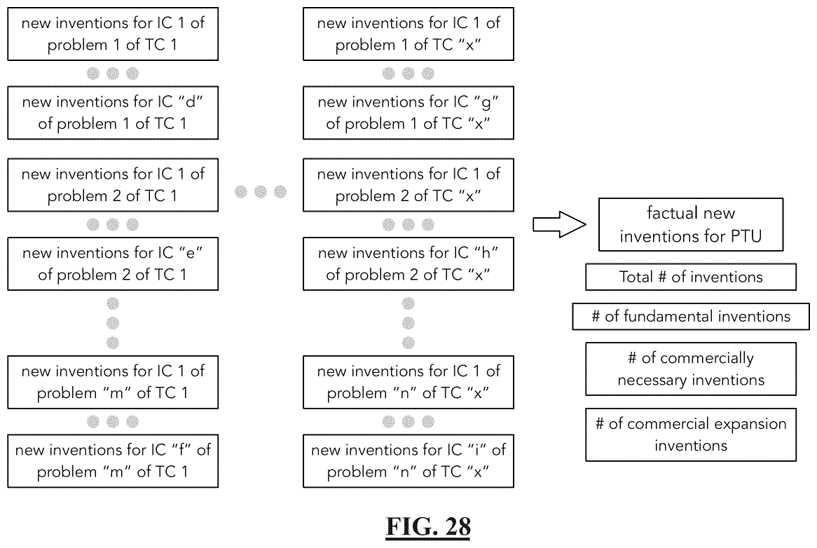

FIG. 28 is a schematic block diagram of an example of a plurality of factual new invention reports created by a factual new invention database of a patent plan database of a private patent tracking database of an improved computer for technology. In this diagram, IC means inventive concept, and TC means technical challenge.

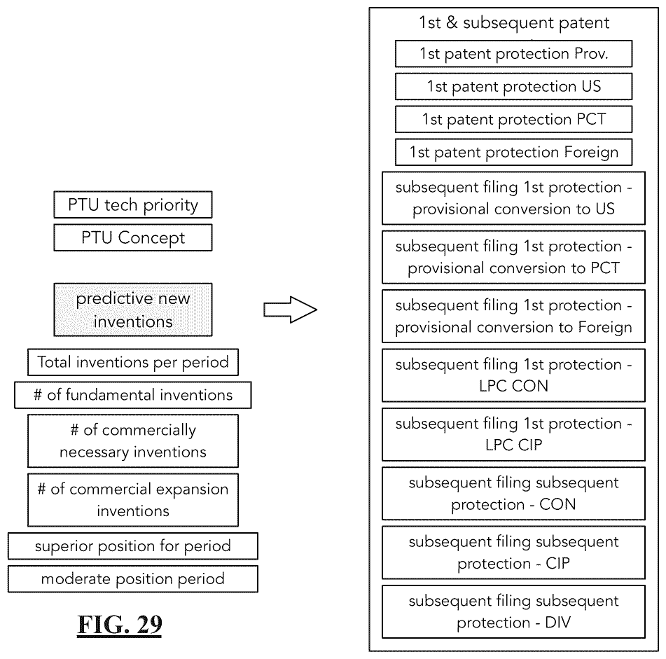

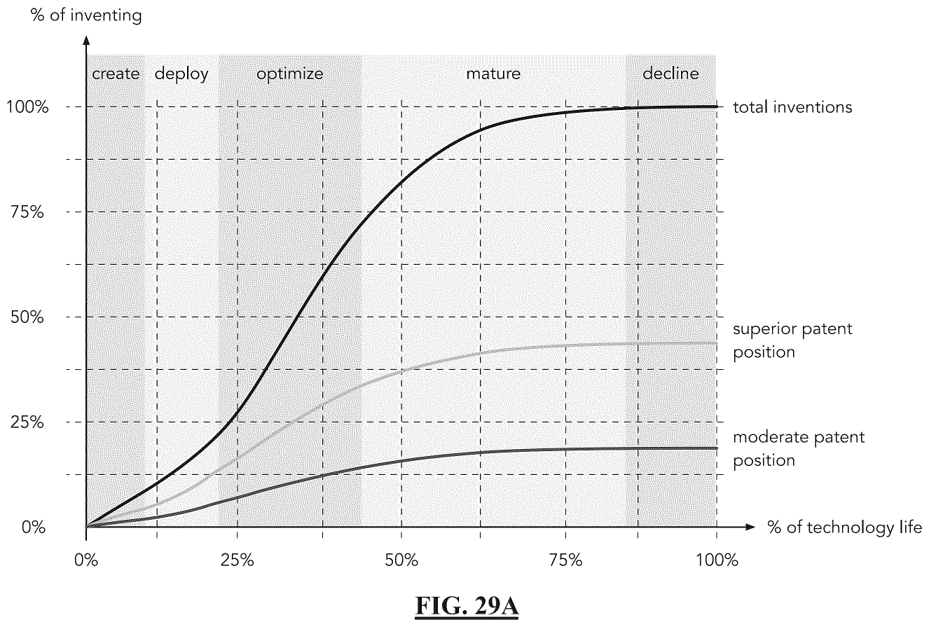

FIG. 29 is a schematic block diagram of an example of a predictive new invention report created by a PTU database of a patent plan database of a private patent tracking database of an improved computer for technology.

FIG. 29A is a schematic block diagram of an example of a plurality of curves that plot percentage of tech life completed versus percentage of inventing completed for various patent positions, which is an input to a PTU database for generating a predictive new invention report.

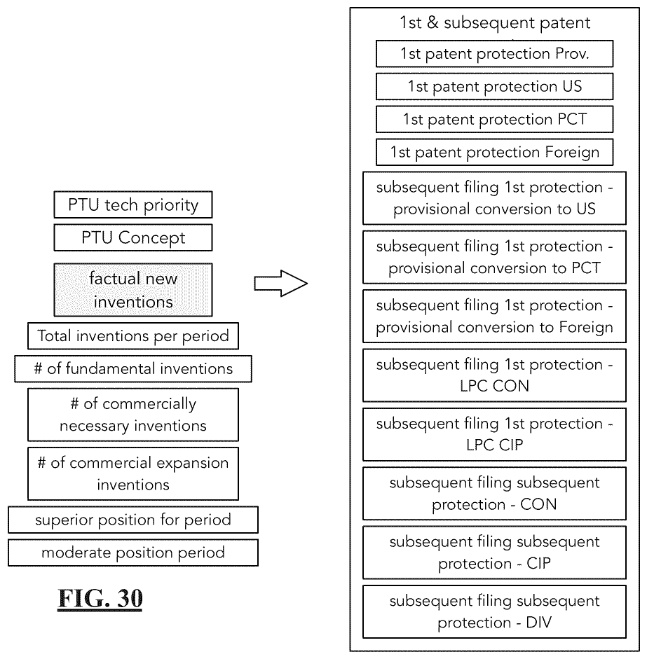

FIG. 30 is a schematic block diagram of an example of a factual new invention report created, based on an input from the factual new invention database, by a PTU database of a patent plan database of a private patent tracking database of an improved computer for technology.

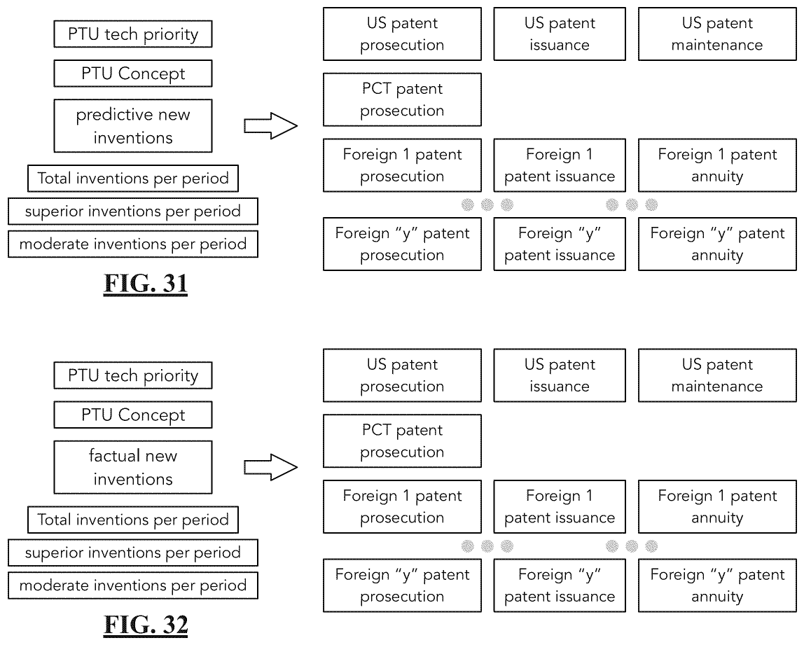

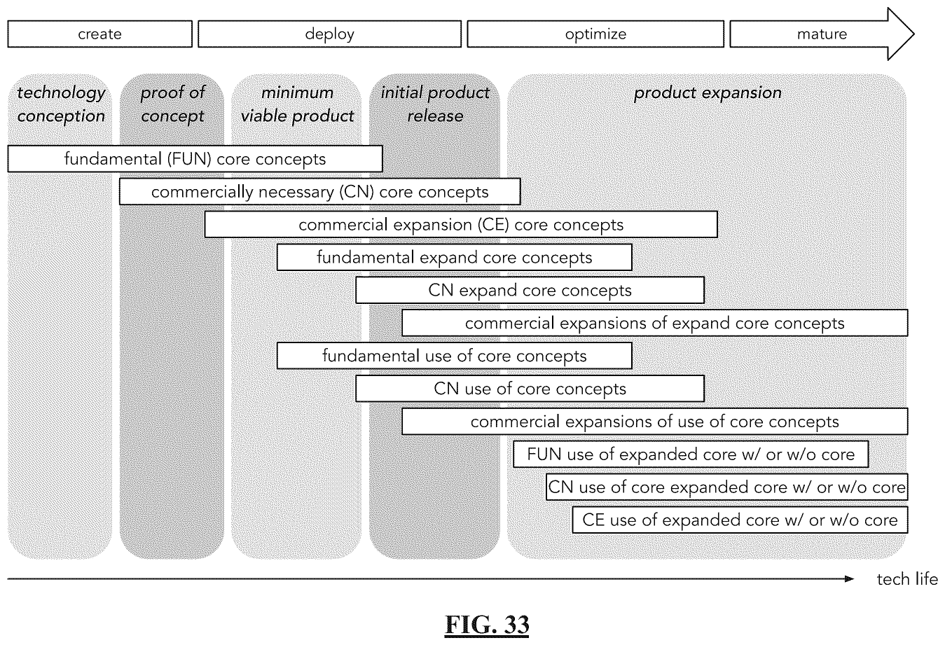

FIG. 31 is a schematic block diagram of an example of a filing report for predictive new inventions created by a PTU database of a patent plan database of a private patent tracking database of an improved computer for technology.

FIG. 32 is a schematic block diagram of an example of a filing report for factual new inventions created by a PTU database of a patent plan database of a private patent tracking database of an improved computer for technology.

FIG. 33 is a schematic block diagram of an example of a graph of phases of technology development, product development, and corresponding types of inventions, which is an input to a PTU database for generating a predictive new invention report and/or for generating a factual new invention report.

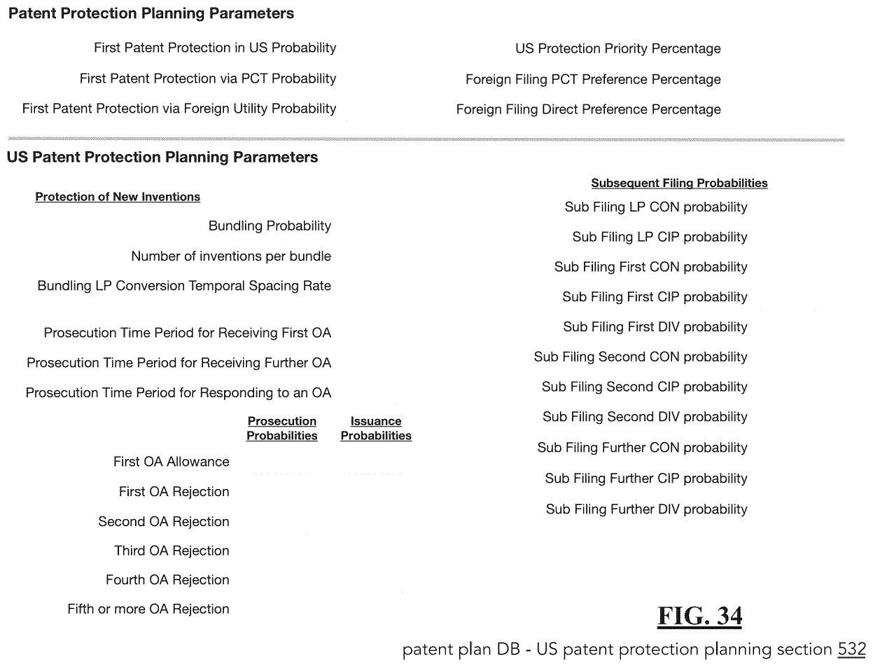

FIG. 34 is a schematic block diagram of an example of a patent protection planning parameters section and a US patent protection planning parameters of patent plan database of a private patent tracking database of an improved computer for technology.

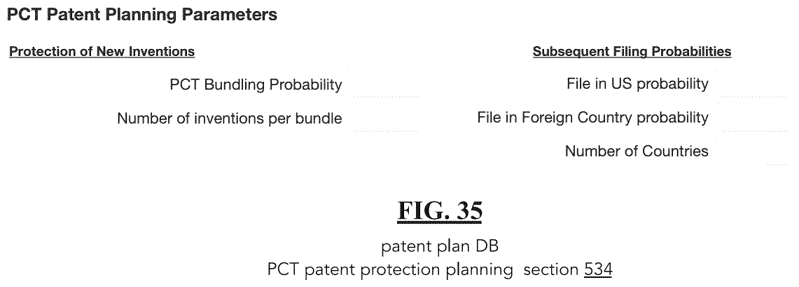

FIG. 35 is a schematic block diagram of an example of a PCT patent planning parameters section of patent plan database of a private patent tracking database of an improved computer for technology.

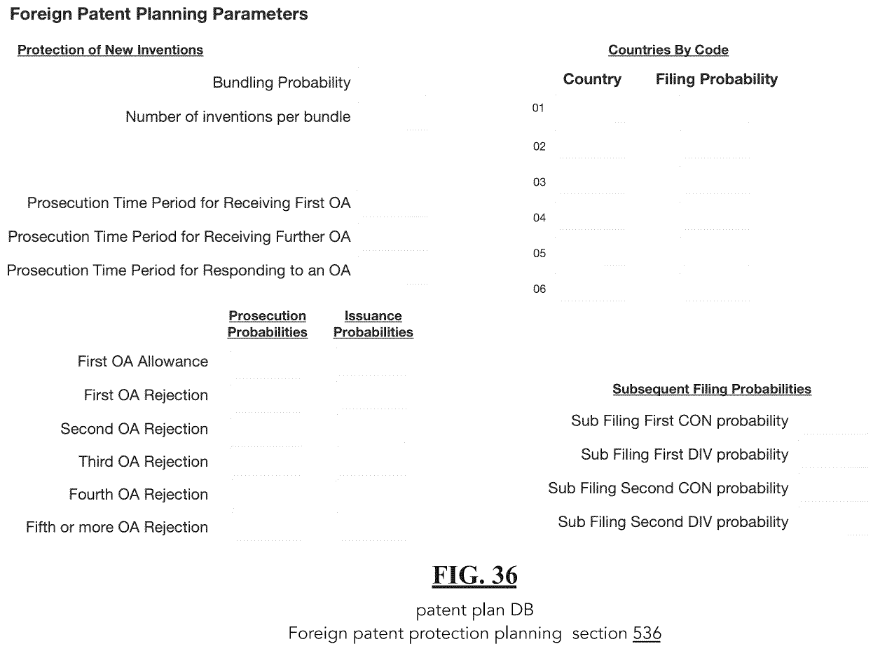

FIG. 36 is a schematic block diagram of an example of a foreign patent planning parameters section of patent plan database of a private patent tracking database of an improved computer for technology.

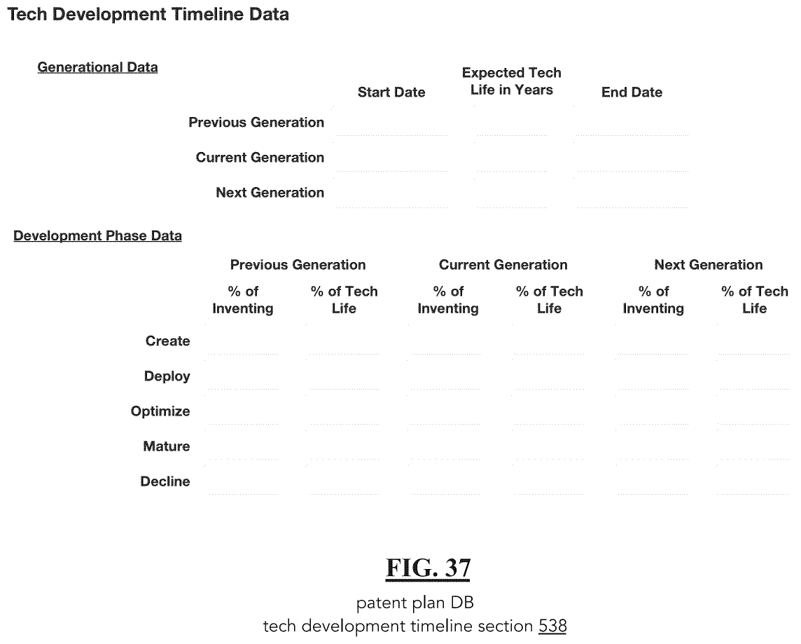

FIG. 37 is a schematic block diagram of an example of a tech development timeline data section of patent plan database of a private patent tracking database of an improved computer for technology.

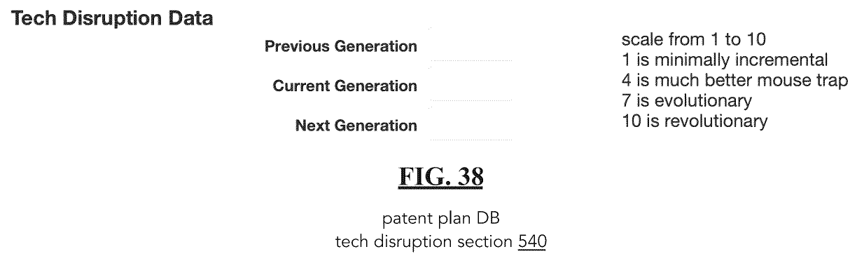

FIG. 38 is a schematic block diagram of an example of a tech disruption data section of patent plan database of a private patent tracking database of an improved computer for technology.

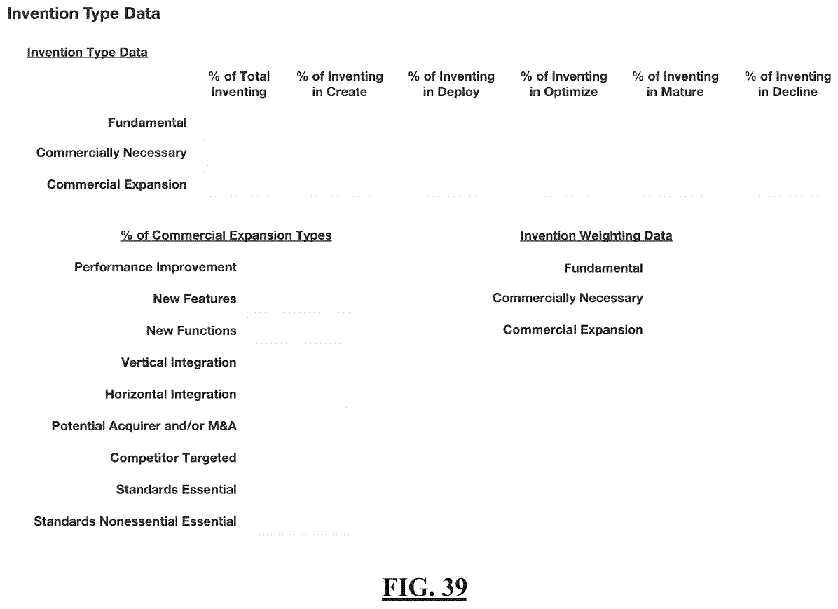

FIG. 39 is a schematic block diagram of an example of an invention type data section of patent plan database of a private patent tracking database of an improved computer for technology.

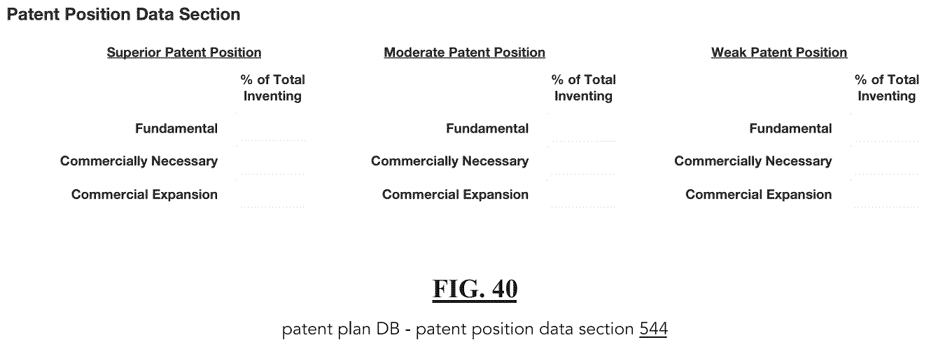

FIG. 40 is a schematic block diagram of an example of a patent position data section of patent plan database of a private patent tracking database of an improved computer for technology.

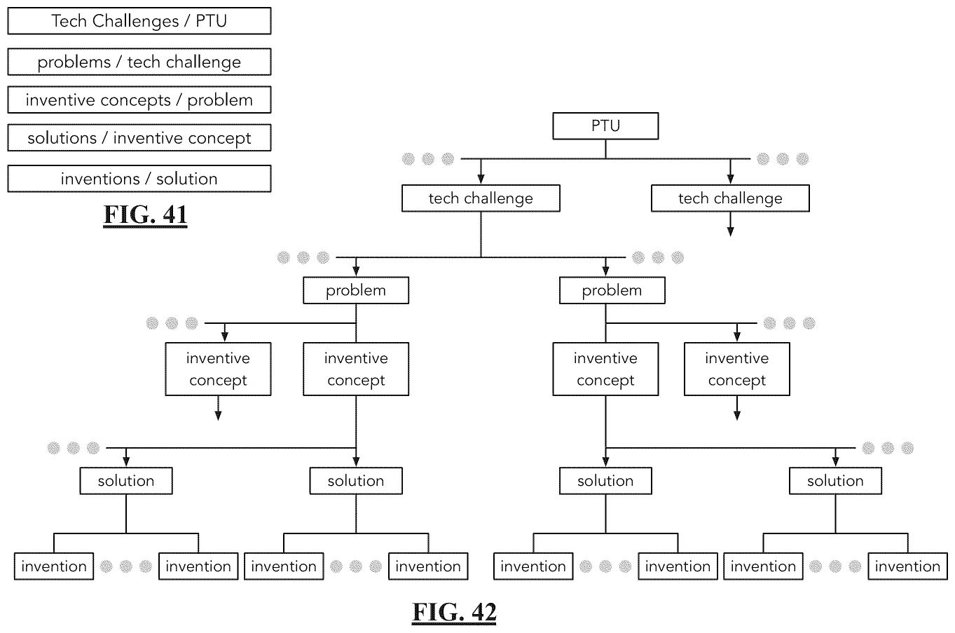

FIG. 41 is a schematic block diagram of an example of inputs to a PTU database that are used by the PTU database to generate a predictive new invention report.

FIG. 42 is a schematic block diagram of an example of a predictive PTU to invention tree based on inputs of FIG. 41.

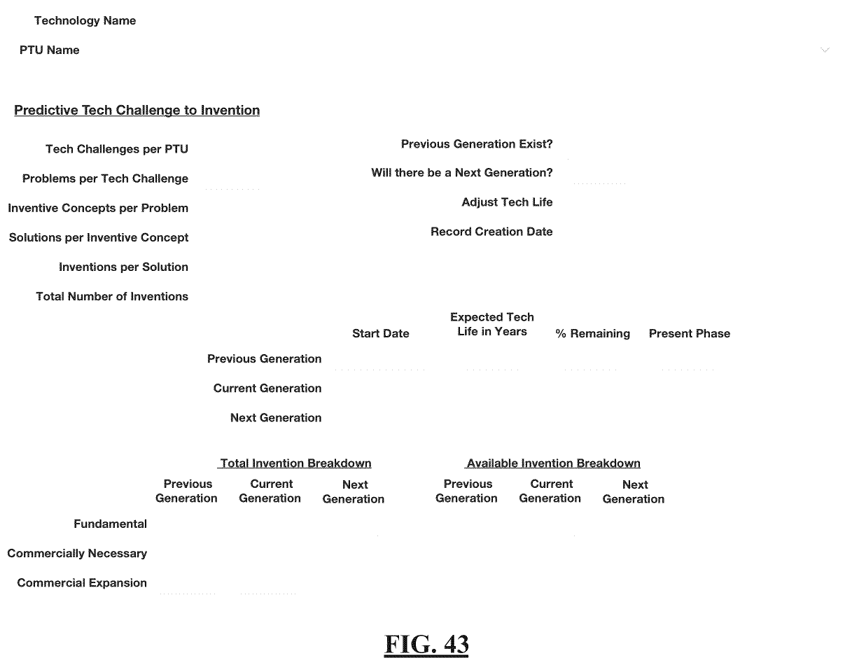

FIG. 43 is a schematic block diagram of an example of a predictive tech challenge to invention data section of a PTU database and/or of patent plan database of a private patent tracking database of an improved computer for technology.

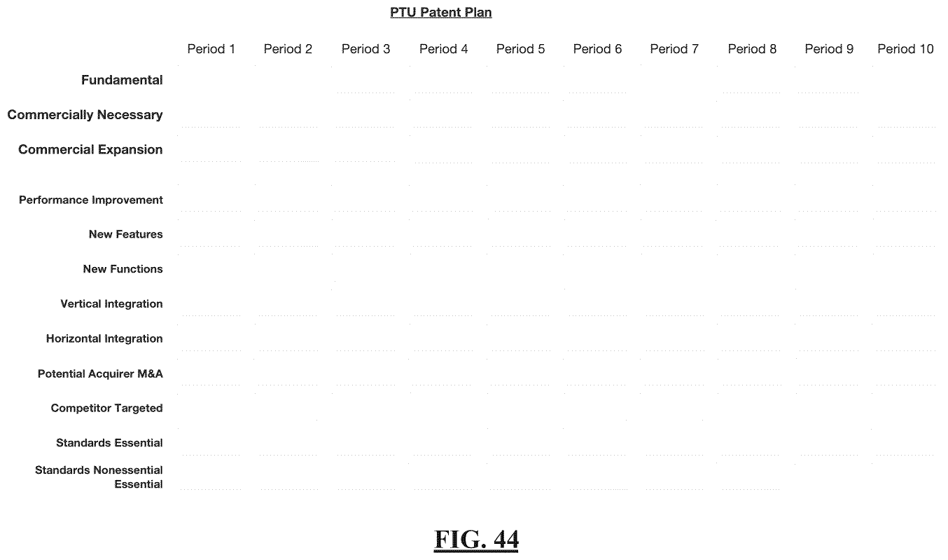

FIG. 44 is a schematic block diagram of an example of a PTU patent plan for predictive new inventions section of a PTU database and/or of patent plan database of a private patent tracking database of an improved computer for technology.

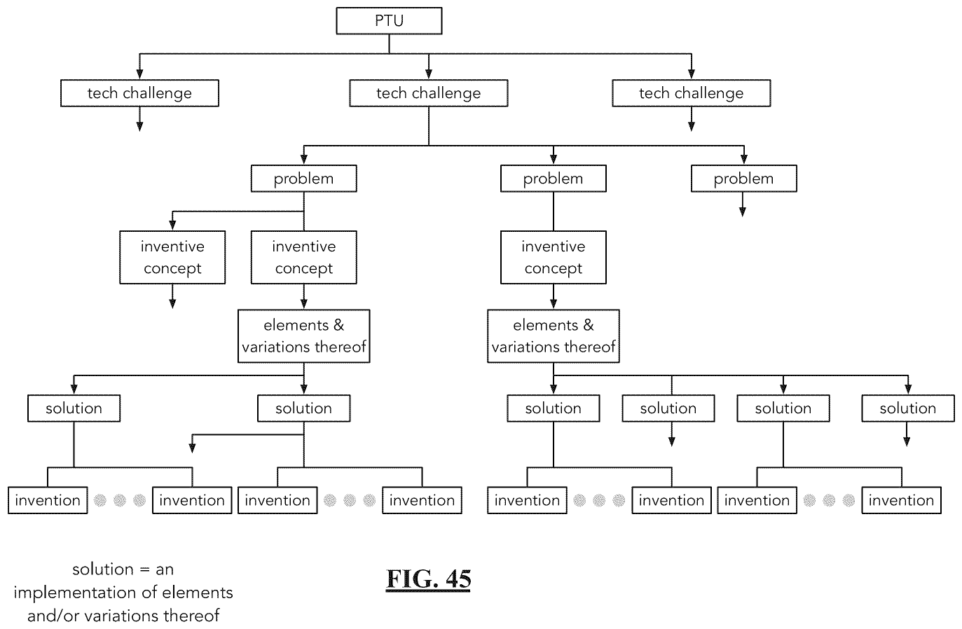

FIG. 45 is a schematic block diagram of an example of a factual PTU to invention tree that is created by a PTU database and/or by a patent plan database of a private patent tracking database of an improved computer for technology.

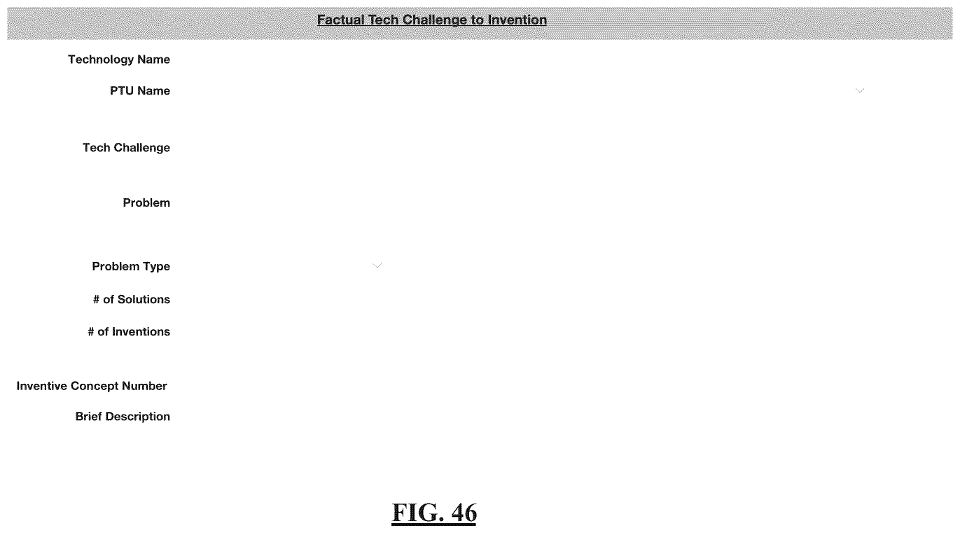

FIG. 46 is a schematic block diagram of an example of a first part of a factual tech challenge to new inventions section of a PTU database and/or of patent plan database of a private patent tracking database of an improved computer for technology.

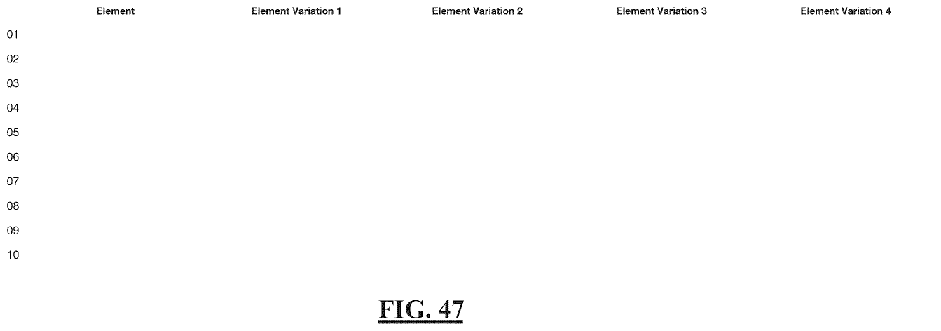

FIG. 47 is a schematic block diagram of an example of a second part of a factual tech challenge to new inventions section of a PTU database and/or of patent plan database of a private patent tracking database of an improved computer for technology.

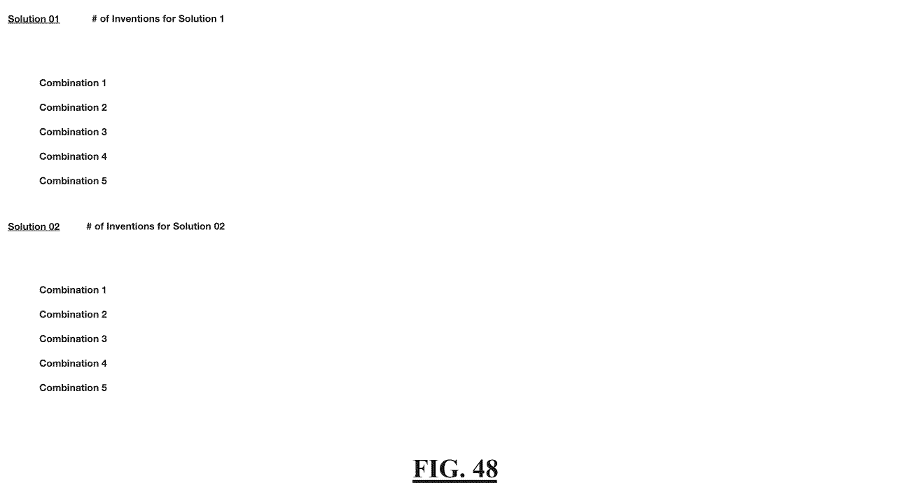

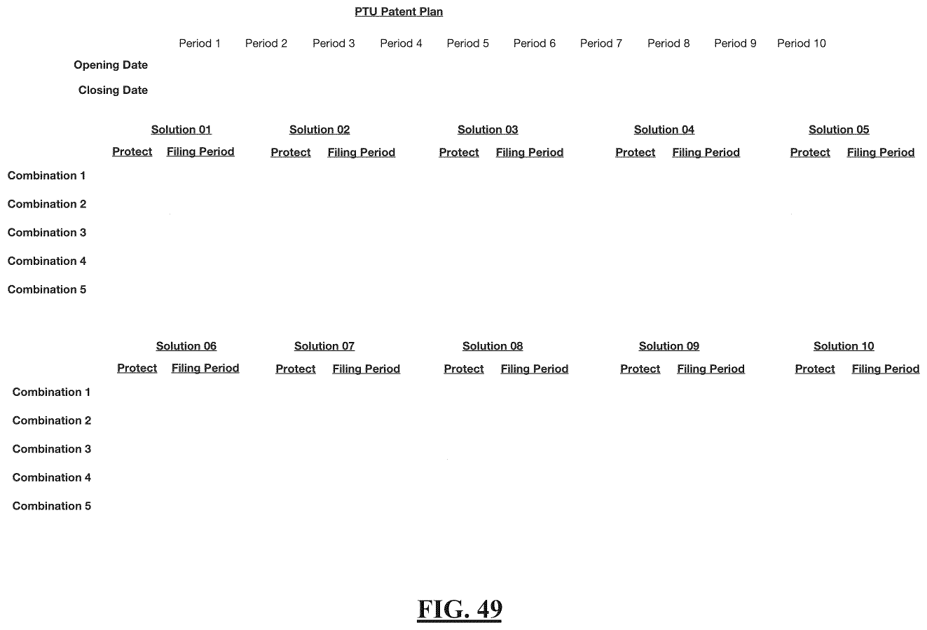

FIG. 48 is a schematic block diagram of an example of a third part of a factual tech challenge to new inventions section of a PTU database and/or of patent plan database of a private patent tracking database of an improved computer for technology.

FIG. 49 is a schematic block diagram of an example of a PTU patent plan for factual new inventions section of a PTU database and/or of patent plan database of a private patent tracking database of an improved computer for technology.

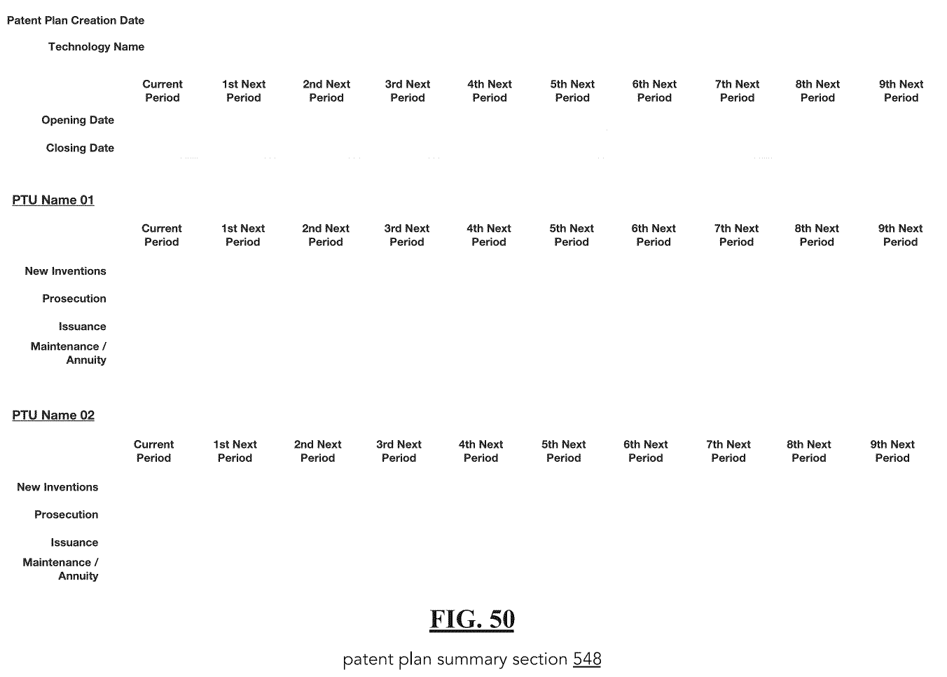

FIG. 50 is a schematic block diagram of an example of a first part of patent plan summary section of patent plan database of a private patent tracking database of an improved computer for technology.

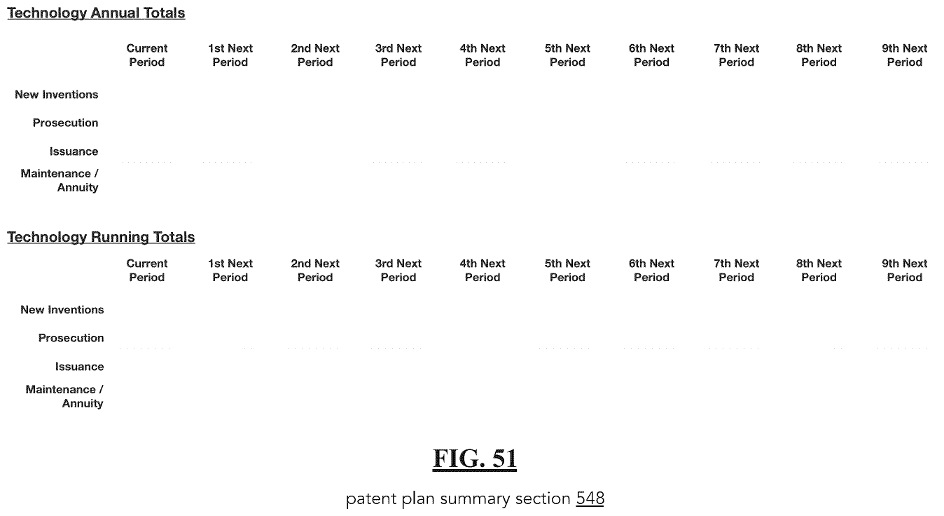

FIG. 51 is a schematic block diagram of an example of a second part of patent plan summary section of patent plan database of a private patent tracking database of an improved computer for technology.

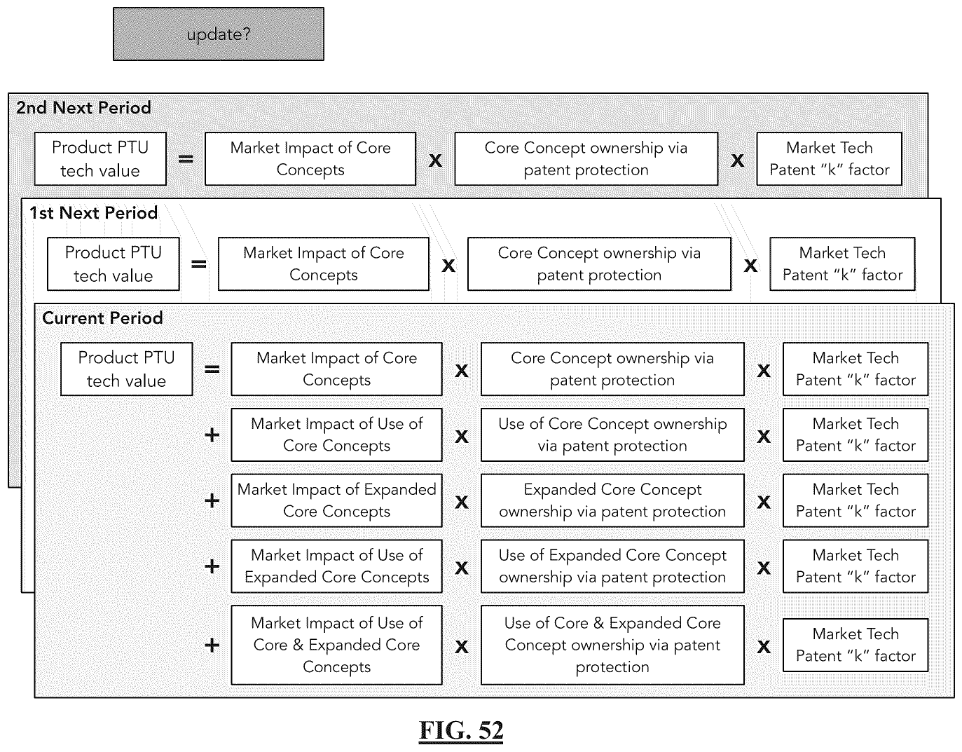

FIG. 52 is a schematic block diagram of an example of a plurality of product PTU tech score reports over a plurality of evaluation periods that are generated by a tech score database of a private patent tracking database of an improved computer for technology.

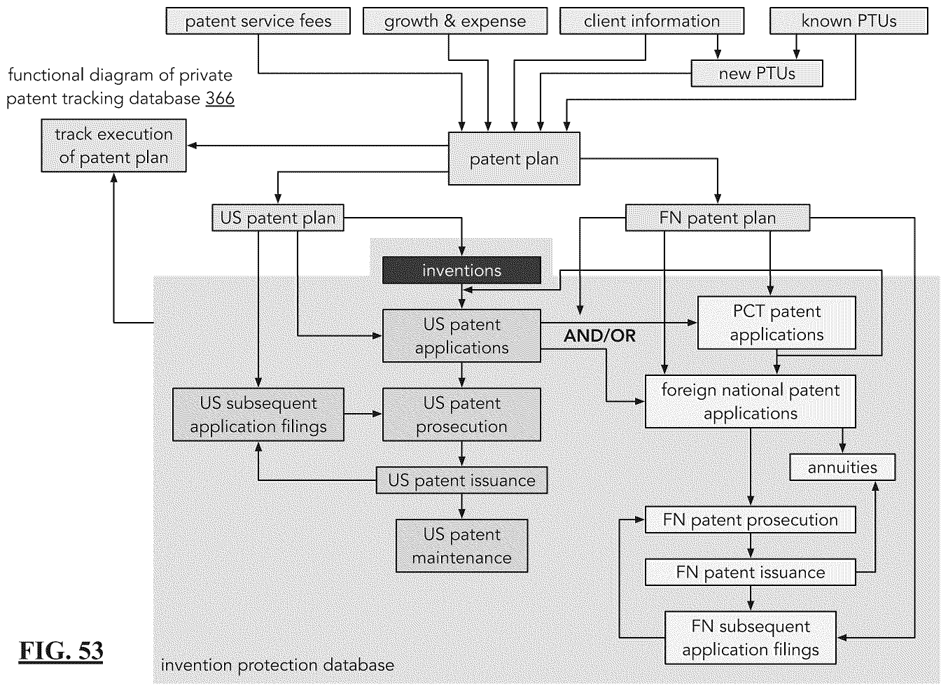

FIG. 53 is a schematic block diagram of an example of functional interaction of databases of a private patent tracking database of an improved computer for technology.

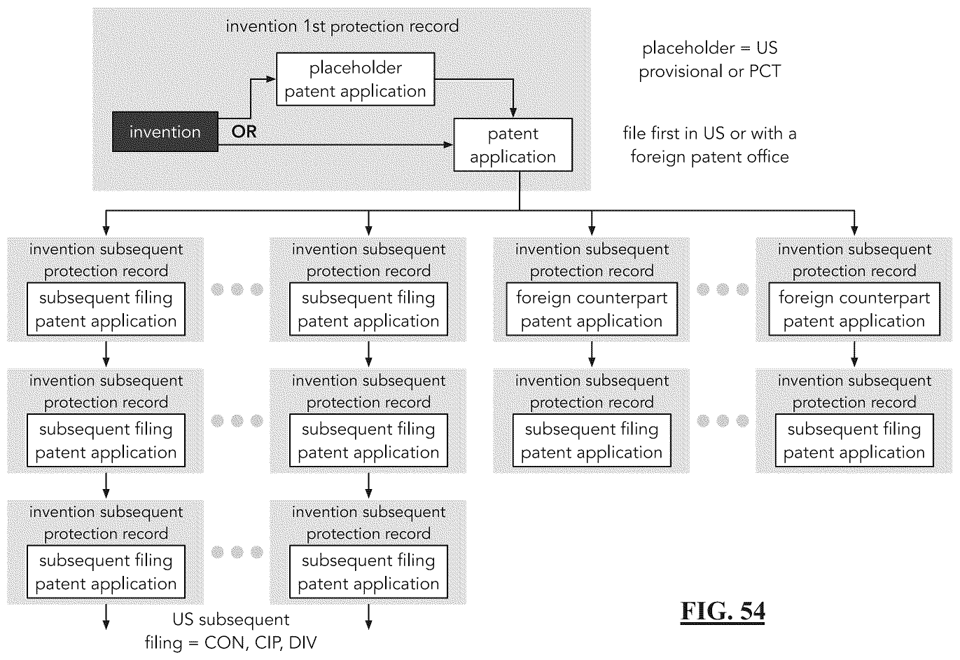

FIG. 54 is a schematic block diagram of an example of a patent family tree of patents that protect a single invention and corresponding records of an invention protection database of a private patent tracking database of an improved computer for technology.

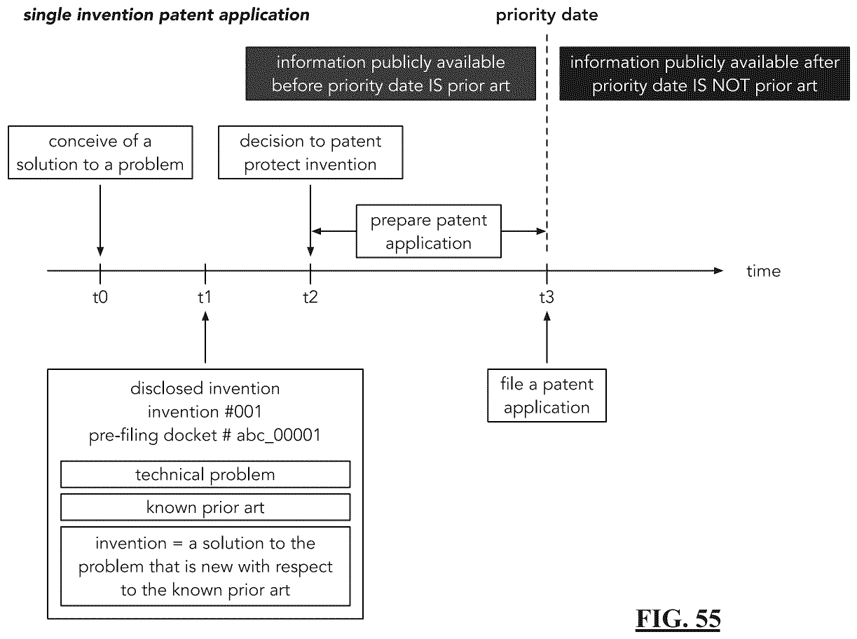

FIG. 55 is a schematic block diagram of an example of a record regarding an invention and patent protection thereof via single invention patent application, where the record is within an invention protection database of a private patent tracking database of an improved computer for technology.

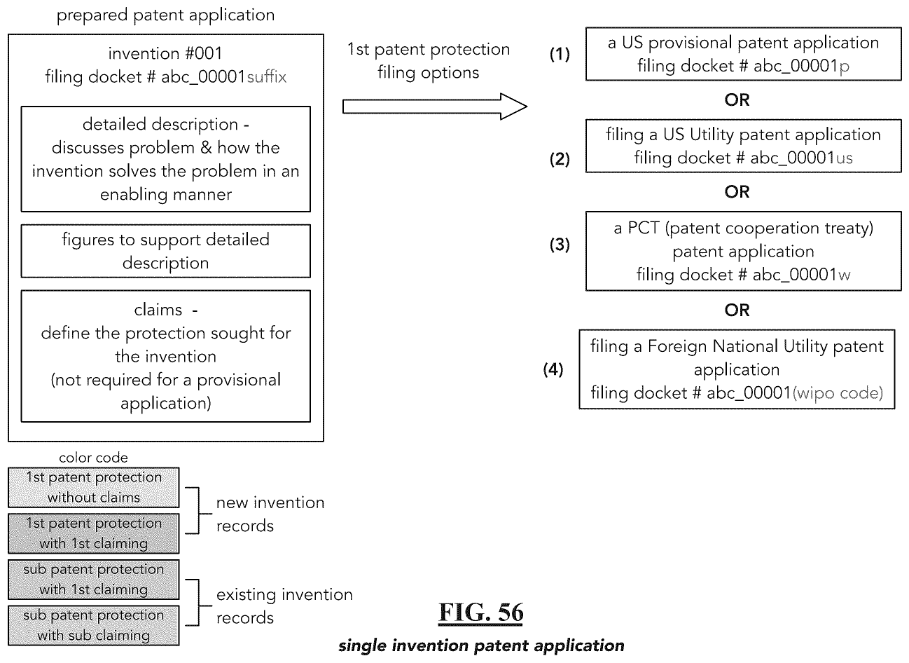

FIG. 56 is a schematic block diagram of an example of various patent application filing options and corresponding docket numbers regarding a record of an invention within an invention protection database of a private patent tracking database of an improved computer for technology.

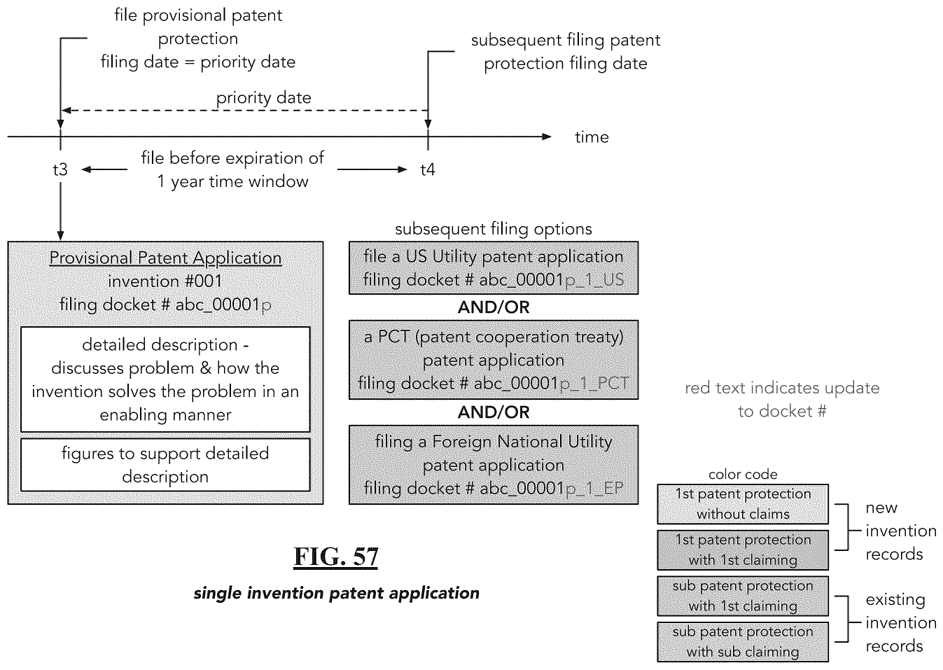

FIG. 57 is a schematic block diagram of an example of first filing a provisional patent application for an invention, updating its record, subsequent patent application filing with first claiming options, and updating their corresponding record within an invention protection database of a private patent tracking database of an improved computer for technology.

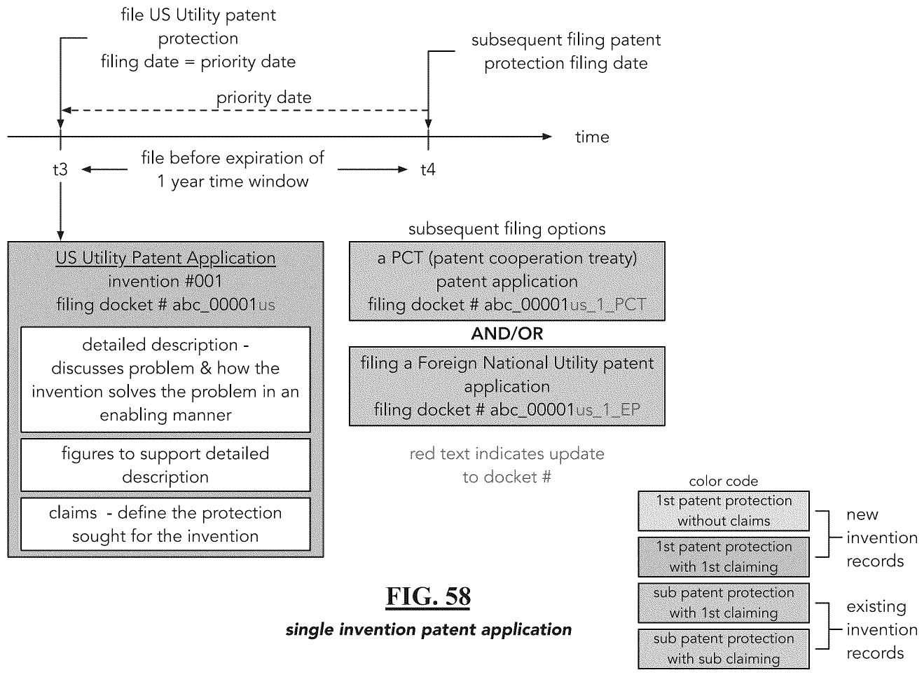

FIG. 58 is a schematic block diagram of an example of first filing a US utility patent application for an invention, updating its record, subsequent patent application filing with first claiming options, and updating their corresponding record within an invention protection database of a private patent tracking database of an improved computer for technology.

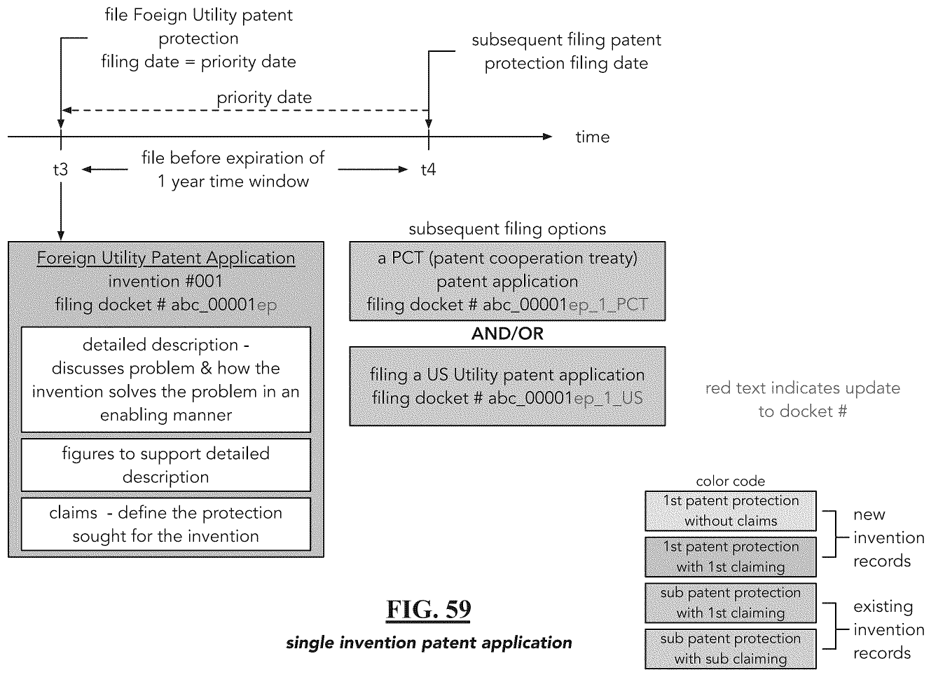

FIG. 59 is a schematic block diagram of an example of first filing a Foreign utility patent application for an invention, updating its record, subsequent patent application filing with first claiming options, and updating their corresponding record within an invention protection database of a private patent tracking database of an improved computer for technology.

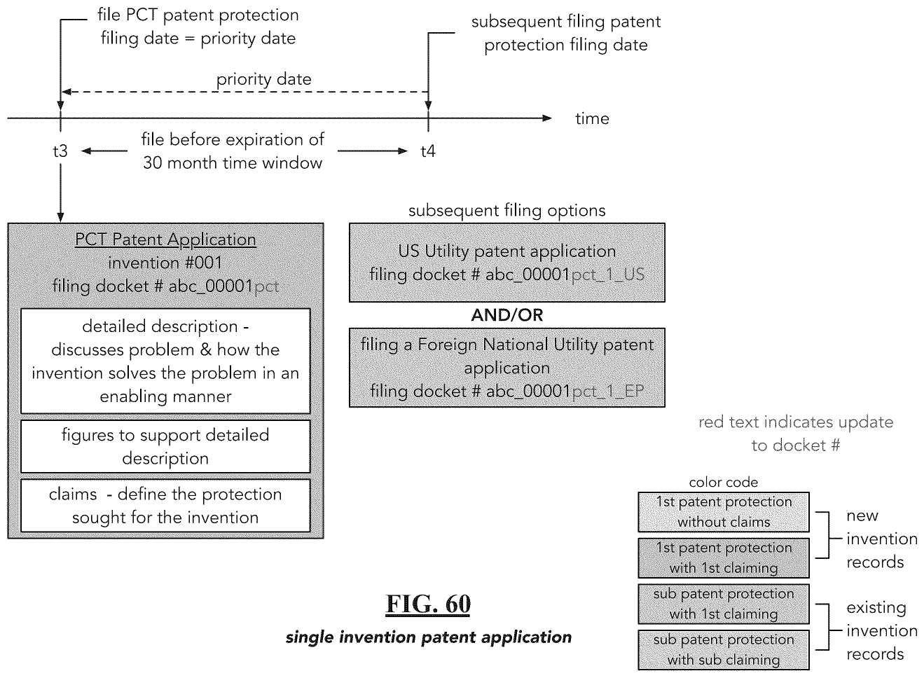

FIG. 60 is a schematic block diagram of an example of first filing a PCT patent application for an invention, updating its record, subsequent patent application filing with first claiming options, and updating their corresponding record within an invention protection database of a private patent tracking database of an improved computer for technology.

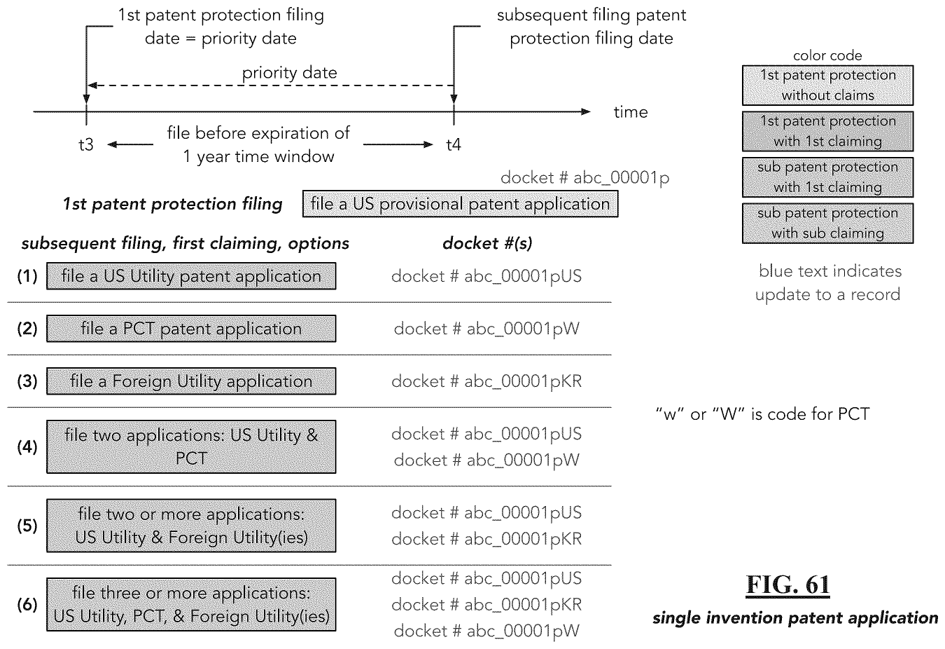

FIG. 61 is a schematic block diagram of another example of first filing a provisional patent application for an invention, updating its record, subsequent patent application filing with first claiming options, and updating their corresponding record within an invention protection database of a private patent tracking database of an improved computer for technology.

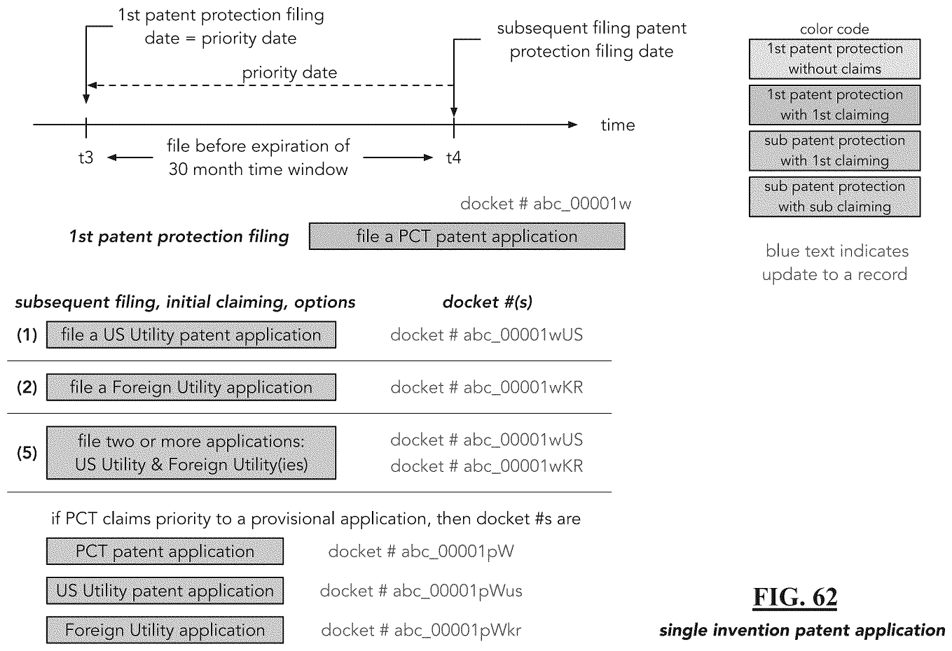

FIG. 62 is a schematic block diagram of another example of first filing a PCT patent application for an invention, updating its record, subsequent patent application filing with first claiming options, and updating their corresponding record within an invention protection database of a private patent tracking database of an improved computer for technology.

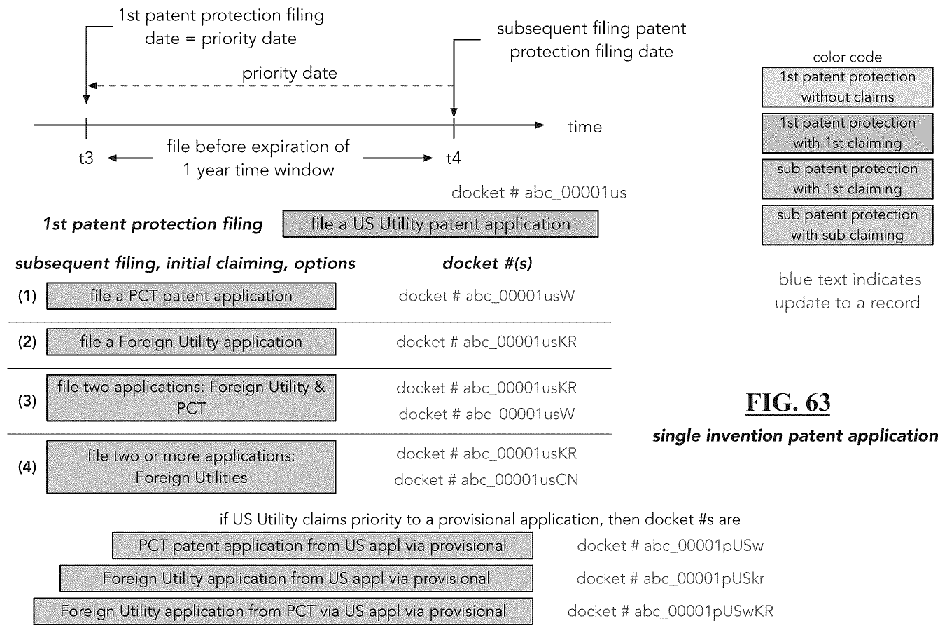

FIG. 63 is a schematic block diagram of another example of first filing a US utility patent application for an invention, updating its record, subsequent patent application filing with first claiming options, and updating their corresponding record within an invention protection database of a private patent tracking database of an improved computer for technology.

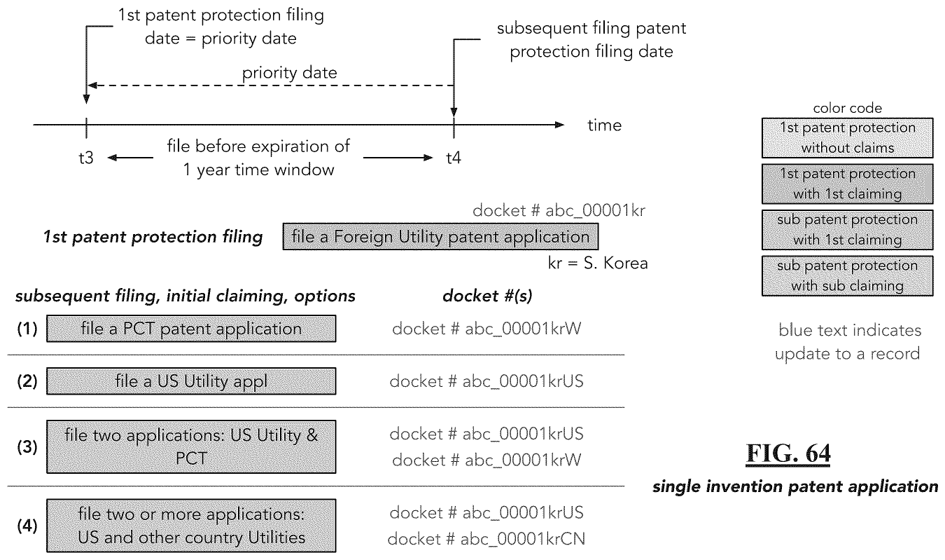

FIG. 64 is a schematic block diagram of another example of first filing a Foreign utility patent application for an invention, updating its record, subsequent patent application filing with first claiming options, and updating their corresponding record within an invention protection database of a private patent tracking database of an improved computer for technology.

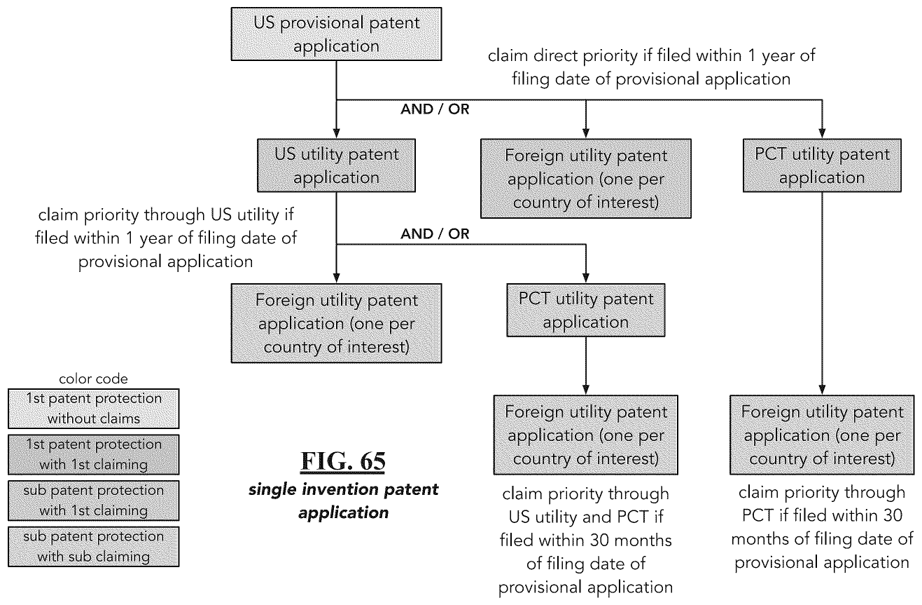

FIG. 65 is a schematic block diagram of another example of first filing a provisional patent application for an invention, subsequent patent application filing with first claiming options, and subsequent patent application filing with subsequent claiming options as recorded within an invention protection database of a private patent tracking database of an improved computer for technology.

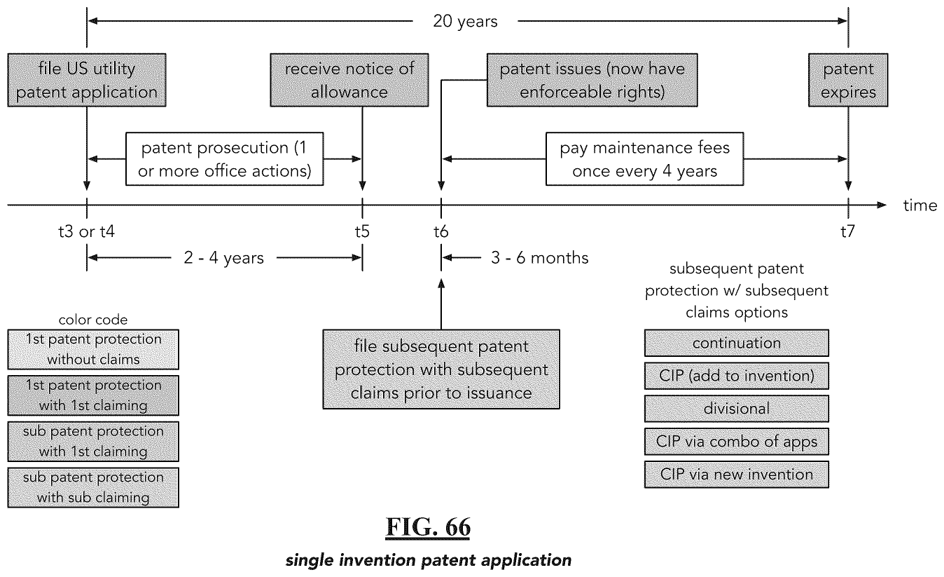

FIG. 66 is a schematic block diagram of an example of first filing a US utility patent application for an invention with first claiming, its prosecution to expiration timeline, and US subsequent patent application filing with subsequent claiming options as recorded within an invention protection database of a private patent tracking database of an improved computer for technology.

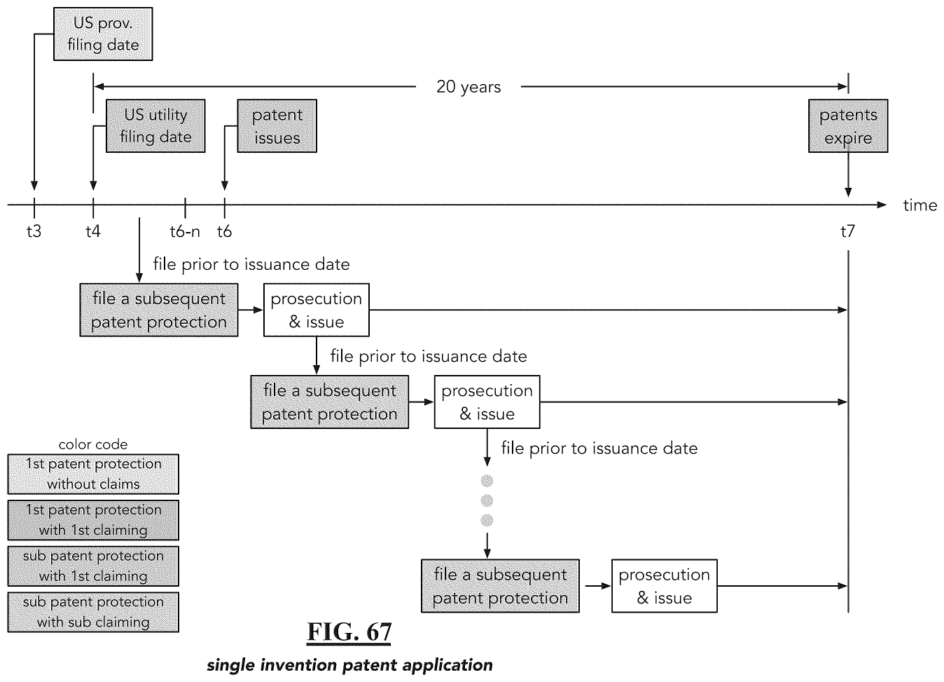

FIG. 67 is a schematic block diagram of an example of first filing a provisional patent application for an invention, filing a US utility application for the invention as a subsequent filing with first claiming, its prosecution to expiration timeline, and a series of US subsequent patent application filings with subsequent claiming as recorded within an invention protection database of a private patent tracking database of an improved computer for technology.

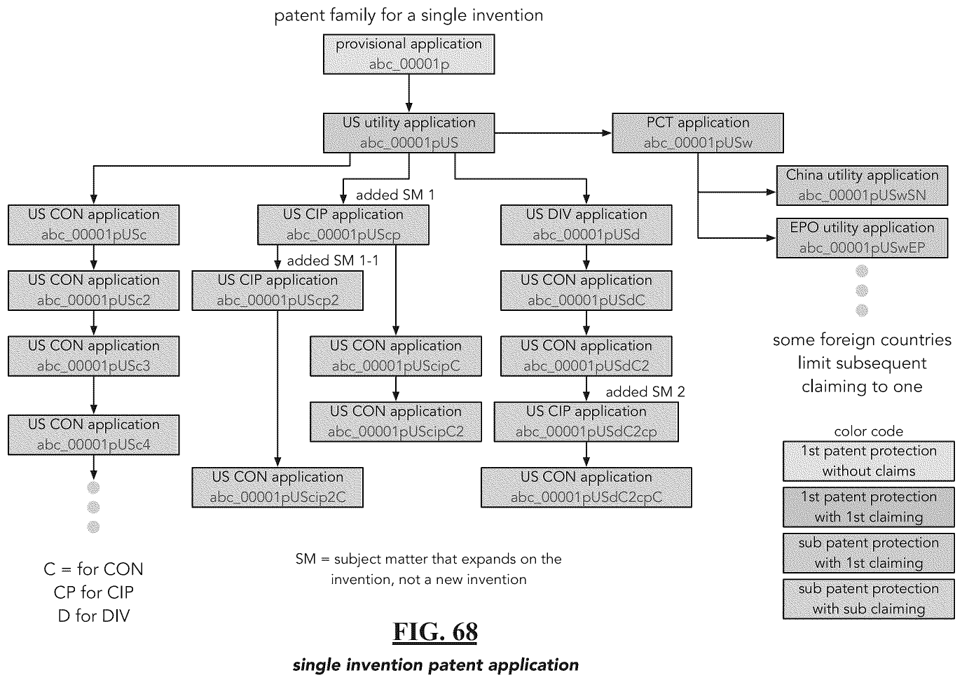

FIG. 68 is a schematic block diagram of an example of first filing a provisional patent application for an invention, filing a US utility application for the invention as a subsequent filing with first claiming, filing a PCT application for the invention as a subsequent filing with first claiming, filing one or more Foreign utility applications for the invention as a subsequent filing with first claiming, a series of US subsequent patent application filings with subsequent claiming, and corresponding docket numbers as recorded within an invention protection database of a private patent tracking database of an improved computer for technology.

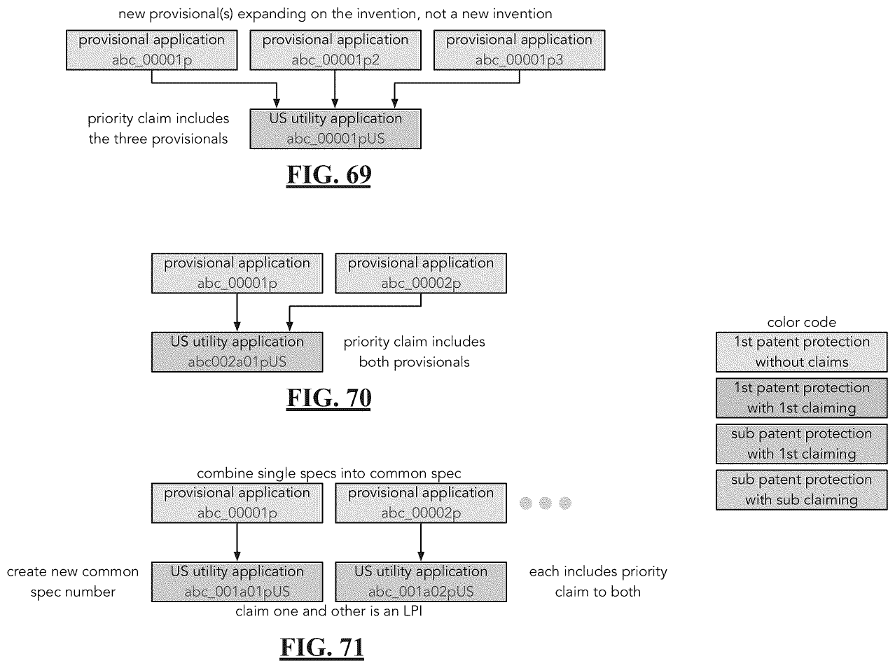

FIG. 69 is a schematic block diagram of an example of first filing multiple provisional patent applications for different aspects of an invention, filing a US utility application for the invention as a subsequent filing with first claiming and with priority to the multiple provisional applications, and corresponding docket numbers as recorded within an invention protection database of a private patent tracking database of an improved computer for technology.

FIG. 70 is a schematic block diagram of an example of first filing multiple provisional patent applications for multiple inventions, filing a common spec US utility application for the inventions as a subsequent filing with first claiming of one of the inventions and with priority to the multiple provisional applications, and corresponding docket numbers as recorded within an invention protection database of a private patent tracking database of an improved computer for technology.

FIG. 71 is a schematic block diagram of an example of first filing multiple provisional patent applications for multiple inventions, filing multiple US utility applications using a common spec for the inventions as a subsequent filing with first claiming of the inventions and with priority to the multiple provisional applications, and corresponding docket numbers as recorded within an invention protection database of a private patent tracking database of an improved computer for technology.

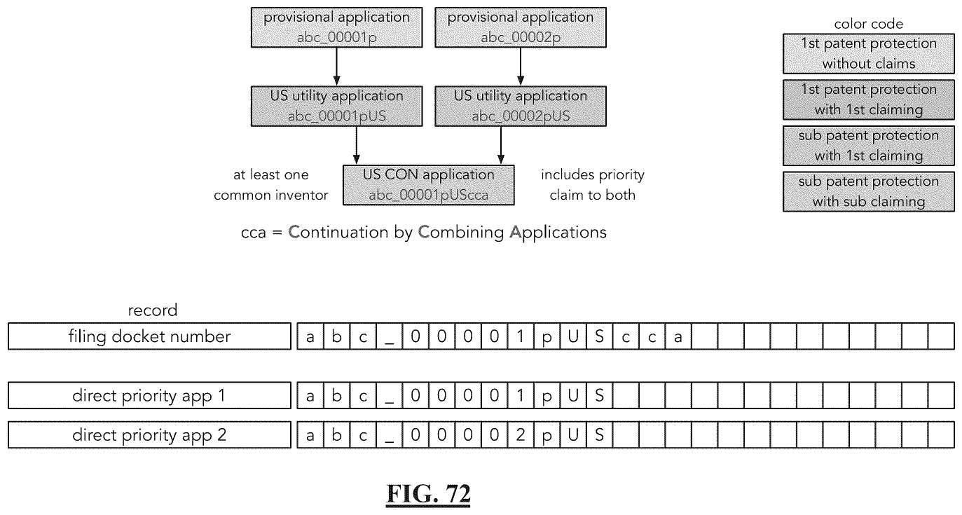

FIG. 72 is a schematic block diagram of an example of first filing multiple provisional patent applications for multiple inventions, filing multiple US utility applications for the inventions as a subsequent filing with first claiming of the inventions and each with priority to one of the provisional applications, subsequent filing with subsequent claiming via combining the multiple US utility applications, and corresponding docket numbers as recorded within an invention protection database of a private patent tracking database of an improved computer for technology.

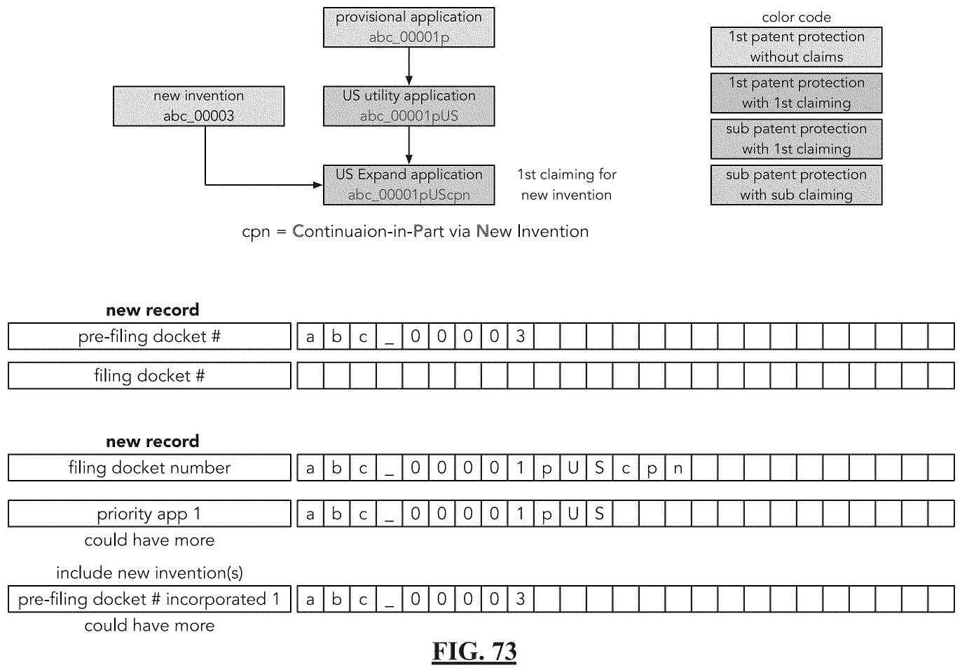

FIG. 73 is a schematic block diagram of an example of first filing a provisional patent application for an invention, filing a US utility application for the invention as a subsequent filing with first claiming of the invention and with priority to the provisional application, subsequent filing with subsequent claiming via combining the US utility application with a new invention, and corresponding docket numbers as recorded within an invention protection database of a private patent tracking database of an improved computer for technology.

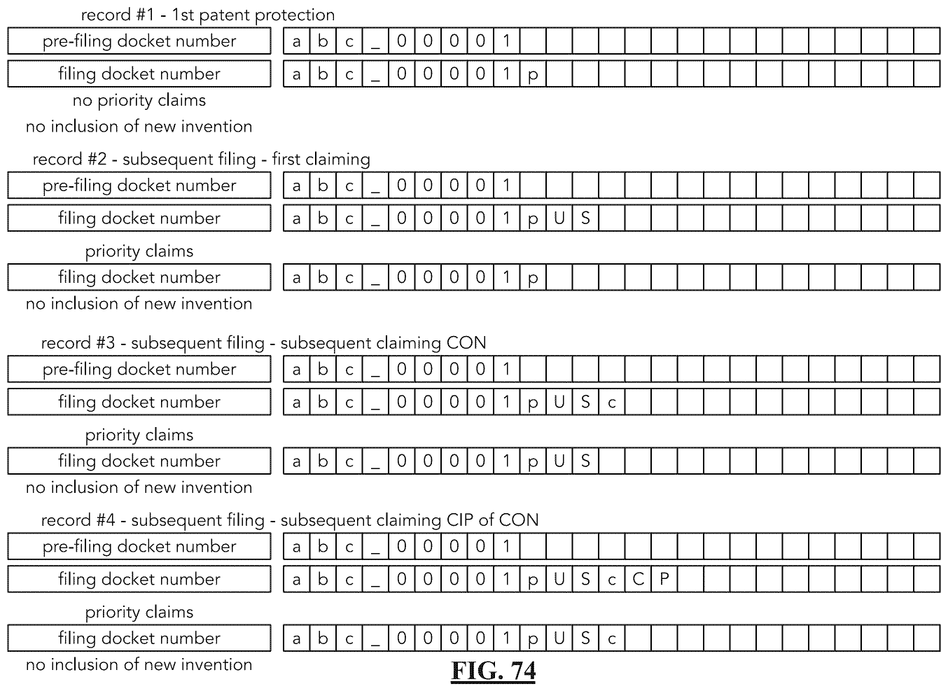

FIG. 74 is a schematic block diagram of an example of four records within an invention protection database (of a private patent tracking database of an improved computer for technology), a first record for first patent protection of an invention via a provisional application, a second record for a subsequent filing with first claiming via a US utility application, a third record for a subsequent filing with subsequent claiming via a US CON application for the invention, and a fourth record for another subsequent filing with subsequent claiming via a US CIP application for the invention.

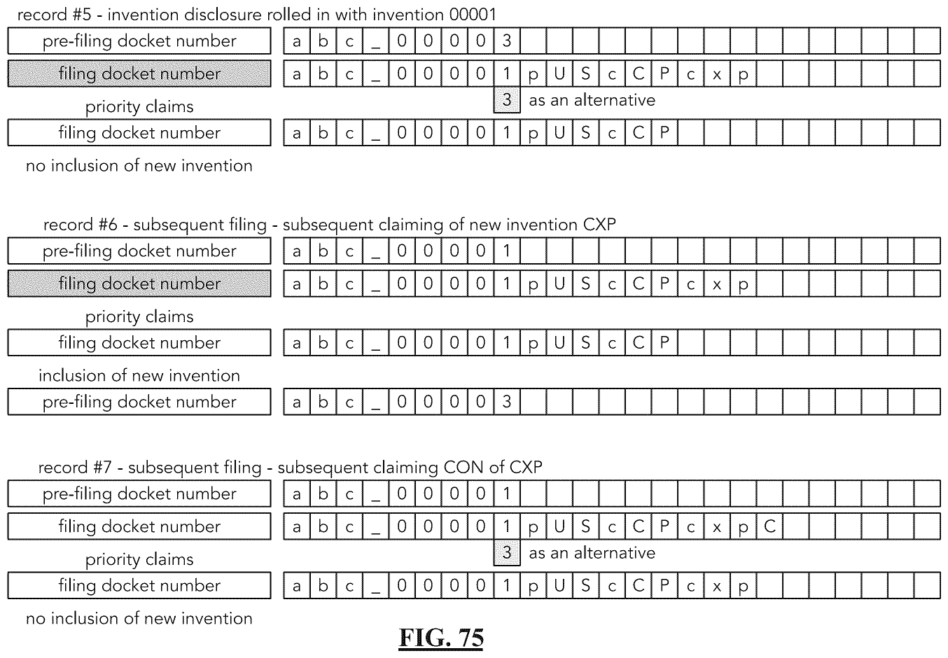

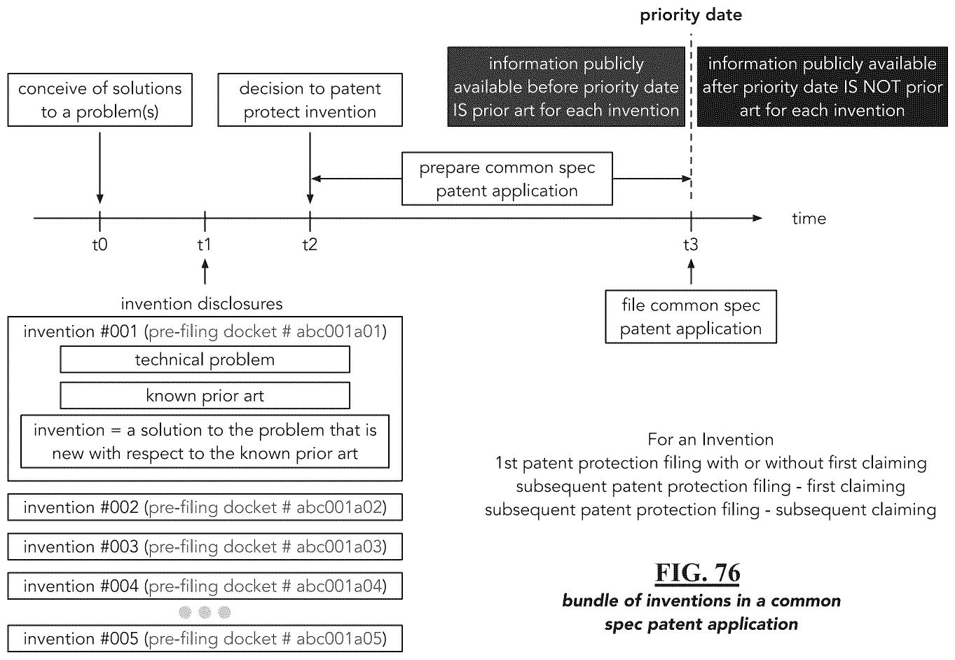

FIG. 75 is a schematic block diagram of another example of three records within an invention protection database (of a private patent tracking database of an improved computer for technology), a fifth record for a new invention that is combined with a pending application and filed as a second invention via a US CIP with new invention application, a sixth record for the pending patent application that was combined with the new invention, a seventh record for a subsequent filing with subsequent claiming via a US CON application for the new invention of the combined CIP application.

FIG. 76 is a schematic block diagram of an example of multiple record regarding multiple inventions and a common spec patent application thereof as recorded within an invention protection database of a private patent tracking database of an improved computer for technology.

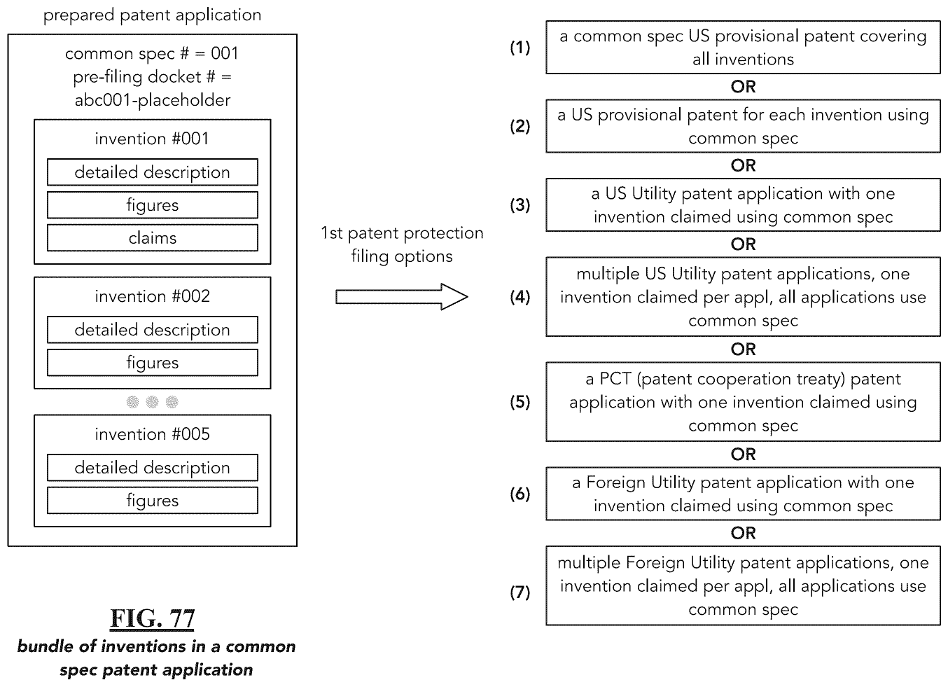

FIG. 77 is a schematic block diagram of an example of various patent application filing options for multiple inventions of a common spec application as associated with an invention protection database of a private patent tracking database of an improved computer for technology.

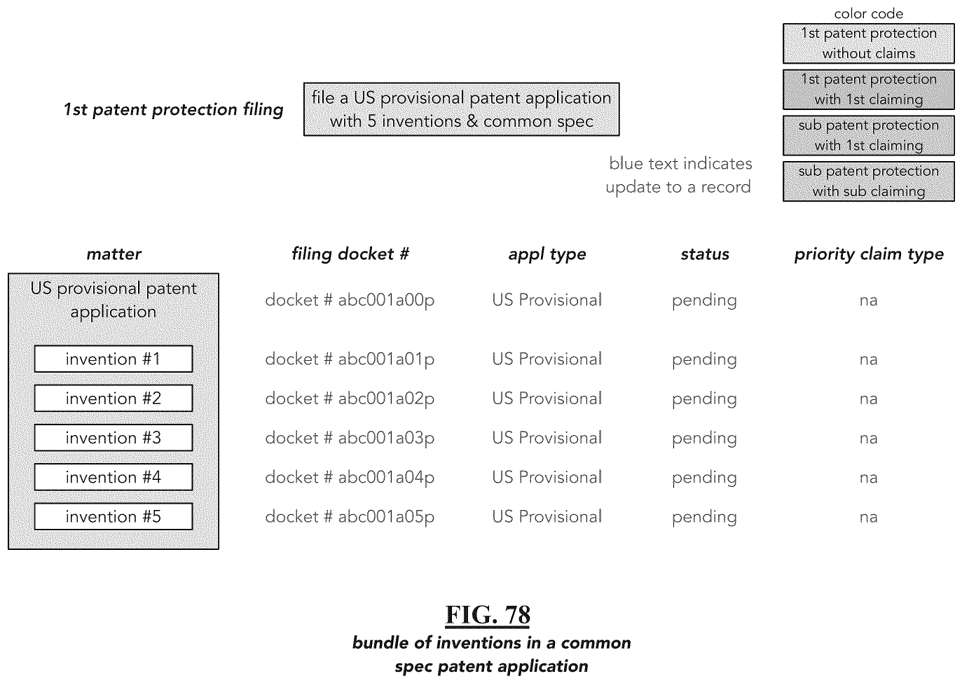

FIG. 78 is a schematic block diagram of an example of first filing a provisional patent application for multiple inventions, updating their records by updating the corresponding docket numbers, invention patent protection type, invention patent protection status, and priority claim type as recorded within an invention protection database of a private patent tracking database of an improved computer for technology.

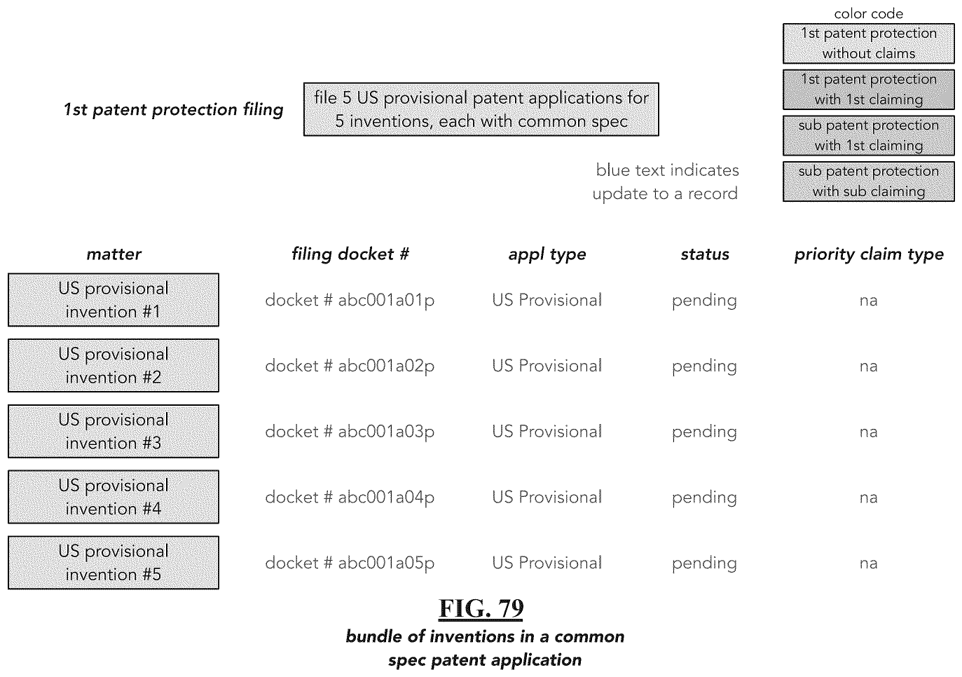

FIG. 79 is a schematic block diagram of an example of first filing multiple provisional patent applications for multiple inventions, updating their records by updating the corresponding docket numbers, invention patent protection type, invention patent protection status, and priority claim type as recorded within an invention protection database of a private patent tracking database of an improved computer for technology.

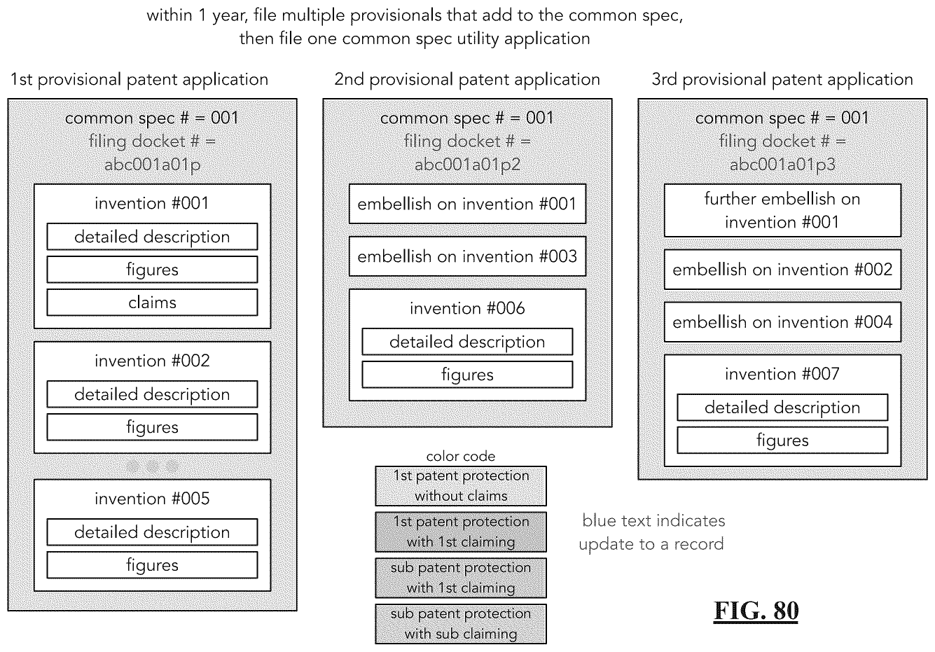

FIG. 80 is a schematic block diagram of an example of first filing multiple provisional patent applications for multiple inventions, the first provisional application includes one new invention and embellishes on two inventions of the first provisional application, the third provisional application includes one new invention and further embellishes on three inventions of the first two provisional applications as recorded within an invention protection database of a private patent tracking database of an improved computer for technology.

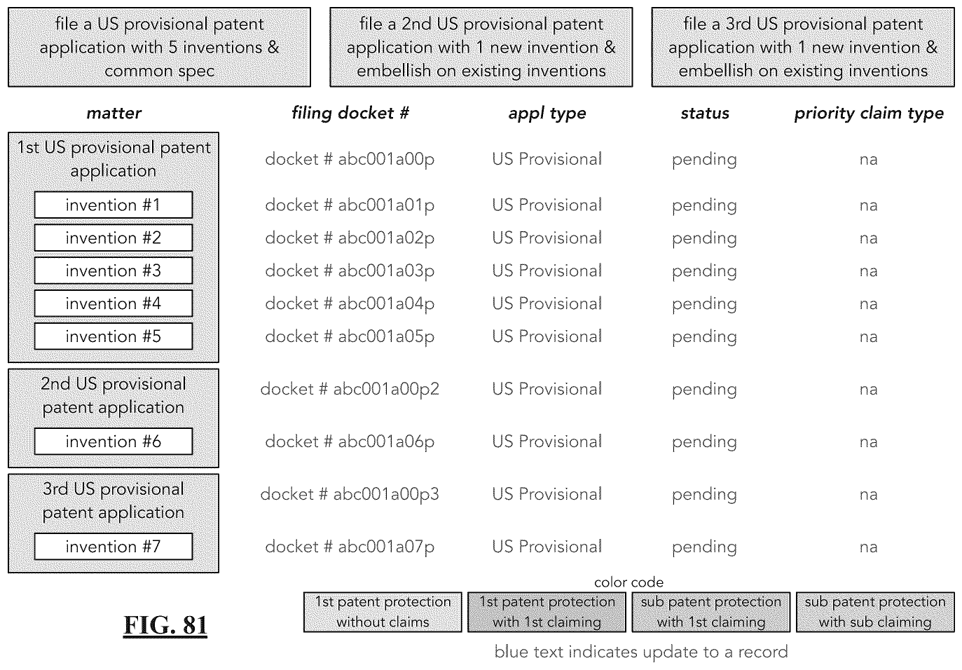

FIG. 81 is a schematic block diagram of updating records of the provisional applications and inventions thereof of FIG. 80 by updating the corresponding docket numbers, invention patent protection type, invention patent protection status, and priority claim type as recorded within an invention protection database of a private patent tracking database of an improved computer for technology.

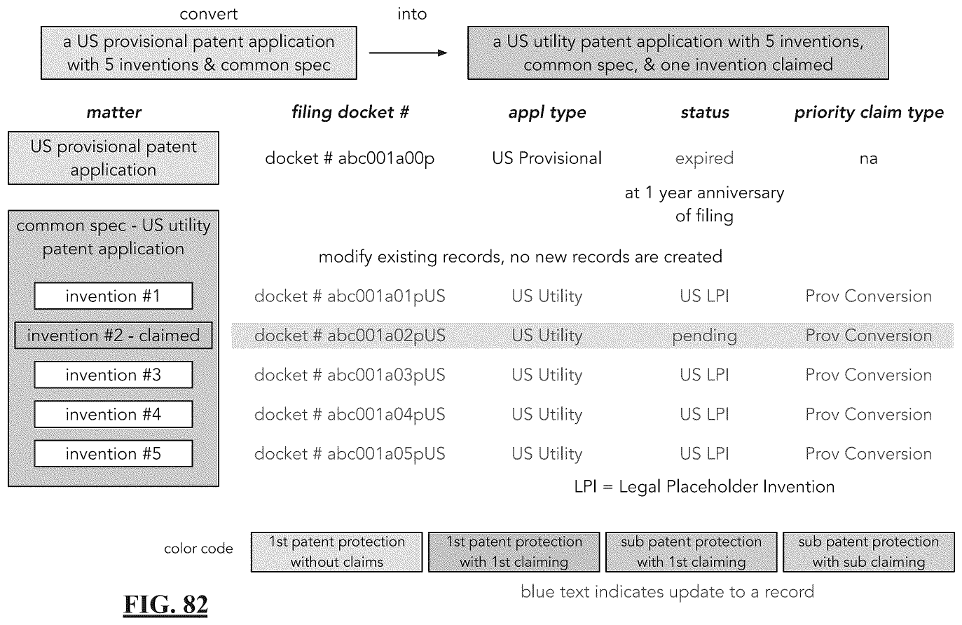

FIG. 82 is a schematic block diagram of an example of first filing a provisional patent application for multiple inventions, converting the provisional application into a US utility patent application with claims for invention number 2, updating their records by updating the corresponding docket numbers, invention patent protection type, invention patent protection status, and priority claim type as recorded within an invention protection database of a private patent tracking database of an improved computer for technology.

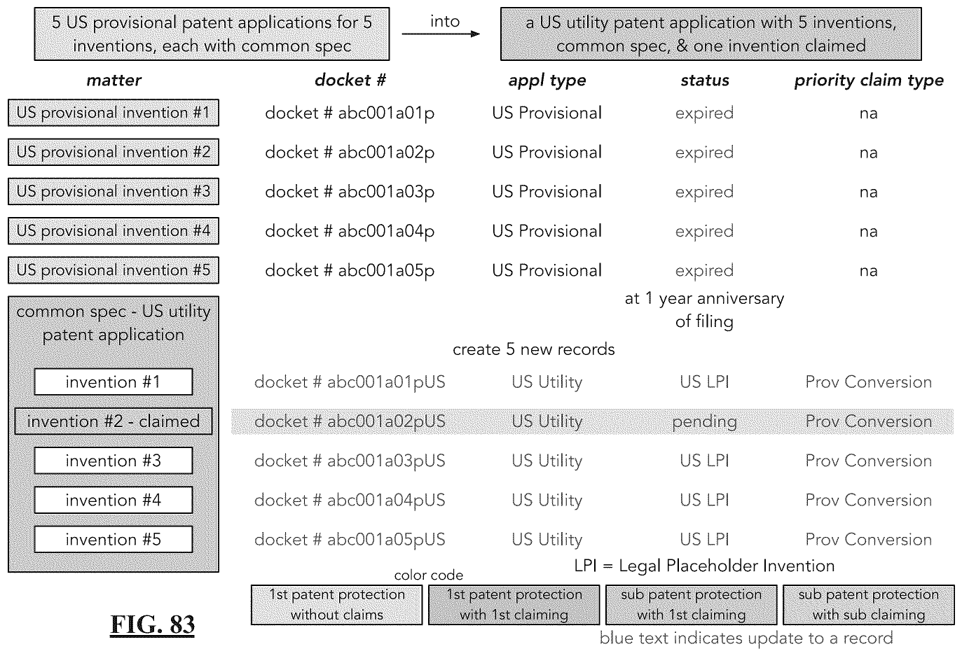

FIG. 83 is a schematic block diagram of an example of first filing multiple provisional patent applications for multiple inventions, converting the multiple provisional applications into a US utility patent application with claims for invention number 2, updating their records by updating the corresponding docket numbers, invention patent protection type, invention patent protection status, and priority claim type as recorded within an invention protection database of a private patent tracking database of an improved computer for technology.

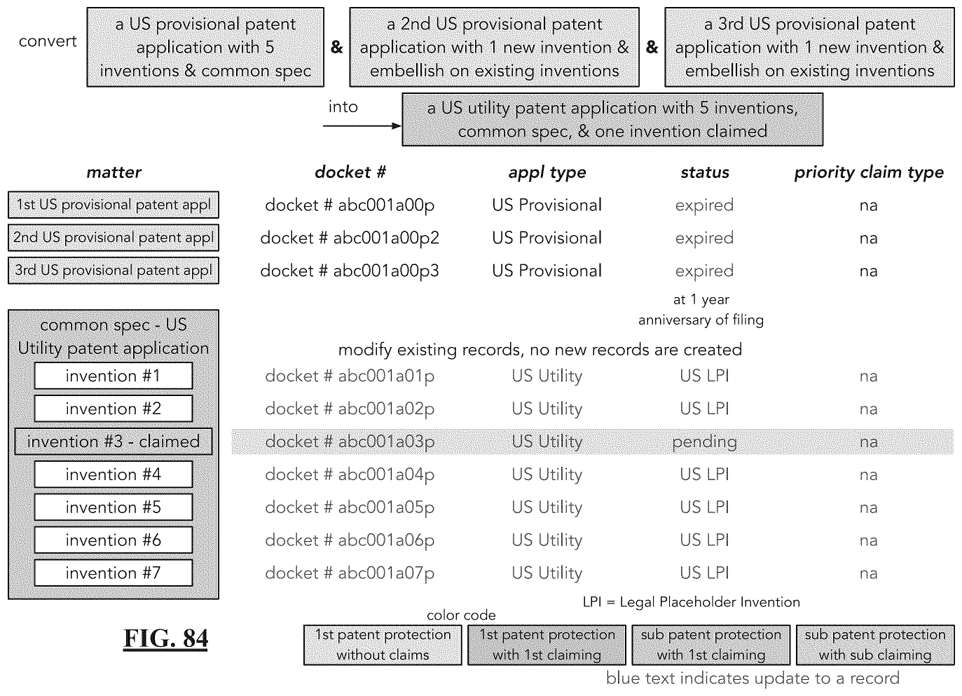

FIG. 84 is a schematic block diagram of an example of first filing three provisional patent applications for multiple inventions, converting the three multiple provisional applications into a US utility patent application with claims for invention number 3, updating their records by updating the corresponding docket numbers, invention patent protection type, invention patent protection status, and priority claim type as recorded within an invention protection database of a private patent tracking database of an improved computer for technology.

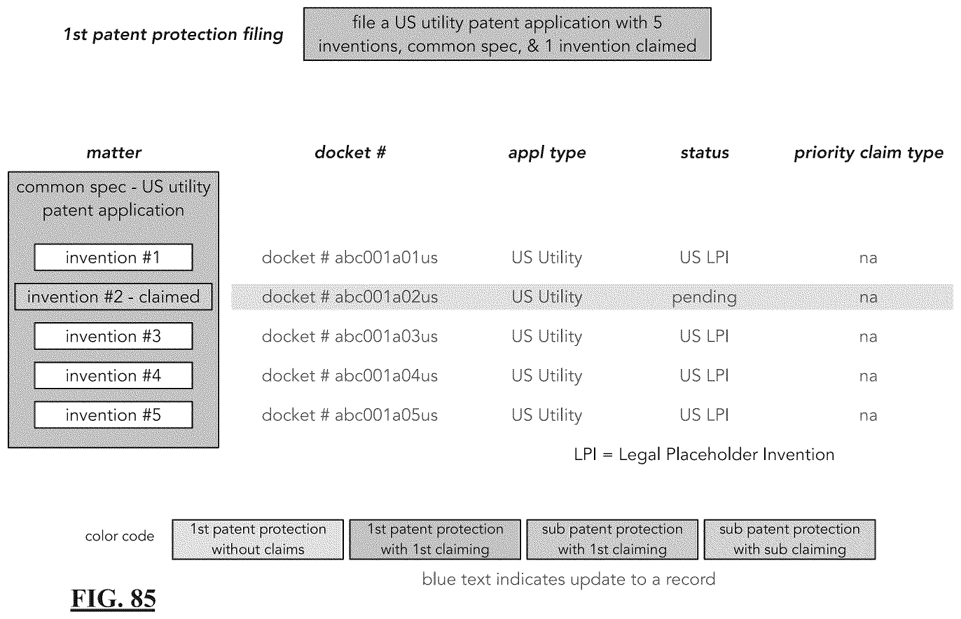

FIG. 85 is a schematic block diagram of an example of first filing a common spec US utility patent application for multiple inventions with claims for invention number 2, updating their records by updating the corresponding docket numbers, invention patent protection type, invention patent protection status, and priority claim type as recorded within an invention protection database of a private patent tracking database of an improved computer for technology.

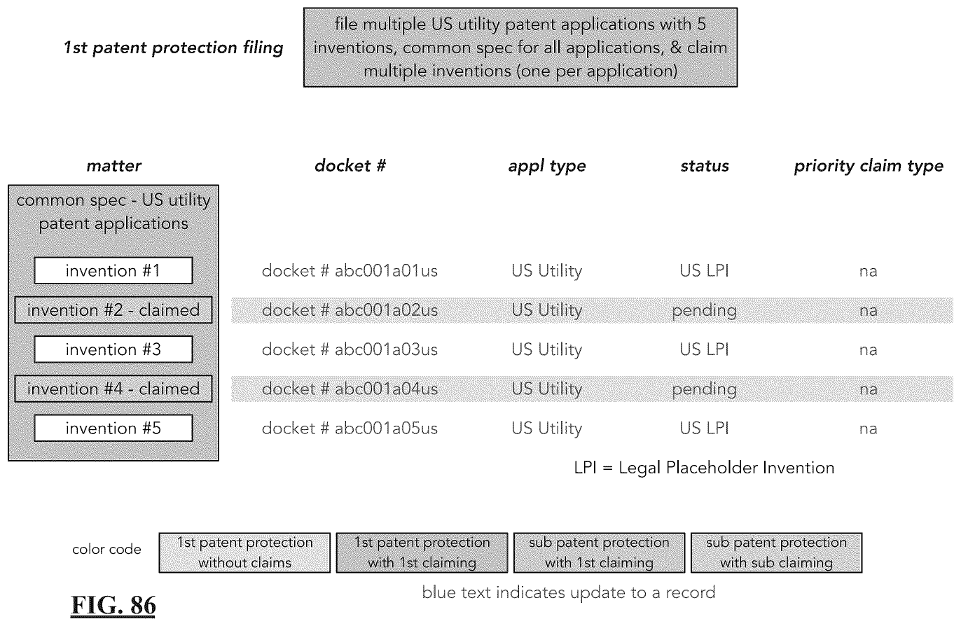

FIG. 86 is a schematic block diagram of an example of first filing two US utility patent applications for multiple inventions and sharing a common spec, the first patent application includes claims for invention number 2, the second patent application includes claims for invention number 4, updating their records by updating the corresponding docket numbers, invention patent protection type, invention patent protection status, and priority claim type as recorded within an invention protection database of a private patent tracking database of an improved computer for technology.

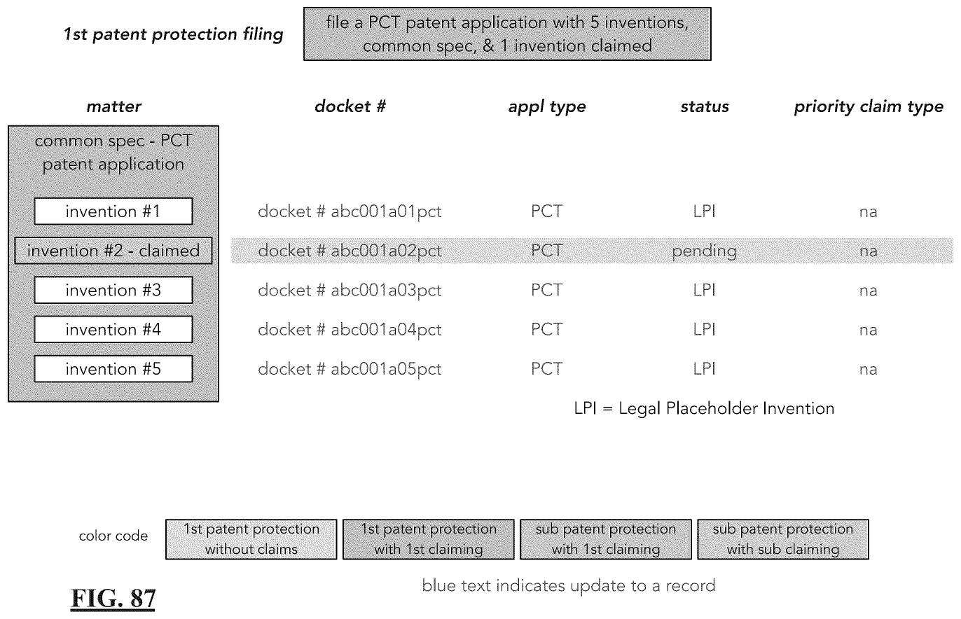

FIG. 87 is a schematic block diagram of an example of first filing a common spec PCT patent application for multiple inventions with claims for invention number 2, updating their records by updating the corresponding docket numbers, invention patent protection type, invention patent protection status, and priority claim type as recorded within an invention protection database of a private patent tracking database of an improved computer for technology.

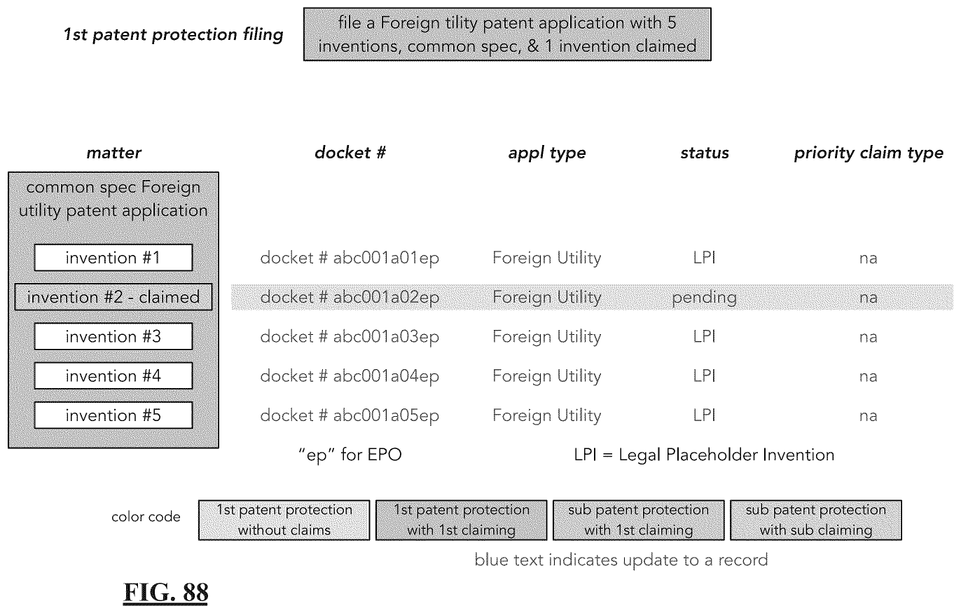

FIG. 88 is a schematic block diagram of an example of first filing a common spec Foreign utility patent application for multiple inventions with claims for invention number 2, updating their records by updating the corresponding docket numbers, invention patent protection type, invention patent protection status, and priority claim type as recorded within an invention protection database of a private patent tracking database of an improved computer for technology.

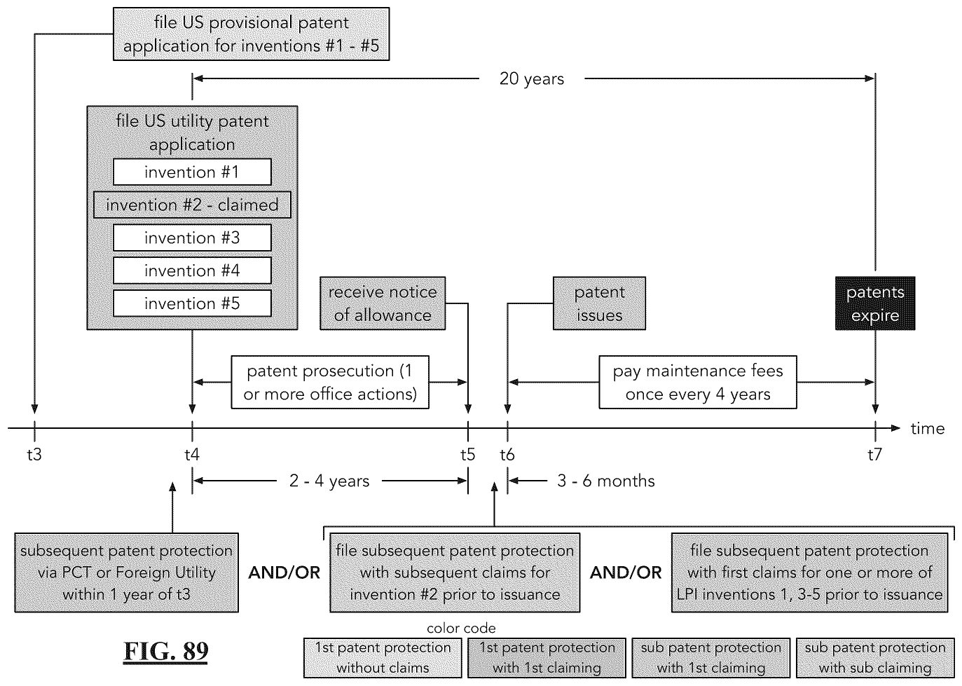

FIG. 89 is a schematic block diagram of an example of first filing a provisional patent application for five inventions, converting the provisional patent application into a US utility patent application having a common spec for the five inventions and having claims for invention number 2, the US utility application's prosecution to expiration timeline, subsequent filing with first claiming filing options prior to time t4, subsequent patent application filing with first claiming options for one of the other inventions before t6, and subsequent patent application filing with subsequent claiming options for invention number 2 before t6 as recorded within an invention protection database of a private patent tracking database of an improved computer for technology.

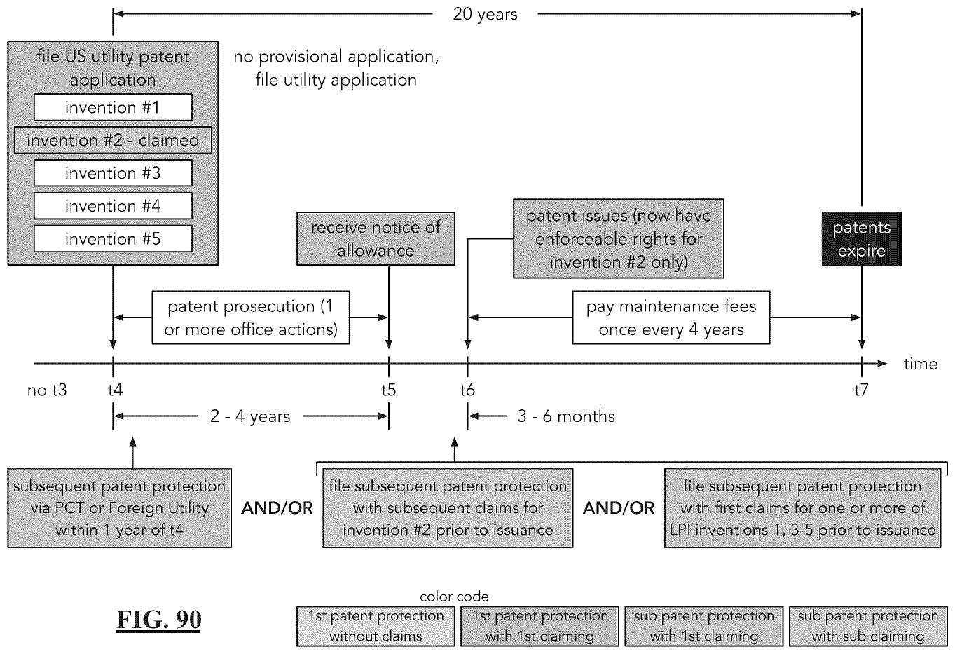

FIG. 90 is a schematic block diagram of an example of first filing a US utility patent application having a common spec for five inventions and having claims for invention number 2, the US utility application's prosecution to expiration timeline, subsequent filing with first claiming filing options within one year of time t4 for invention number 2, subsequent patent application filing with first claiming options for one of the other inventions before t6, and subsequent patent application filing with subsequent claiming options for invention number 2 before t6 as recorded within an invention protection database of a private patent tracking database of an improved computer for technology.

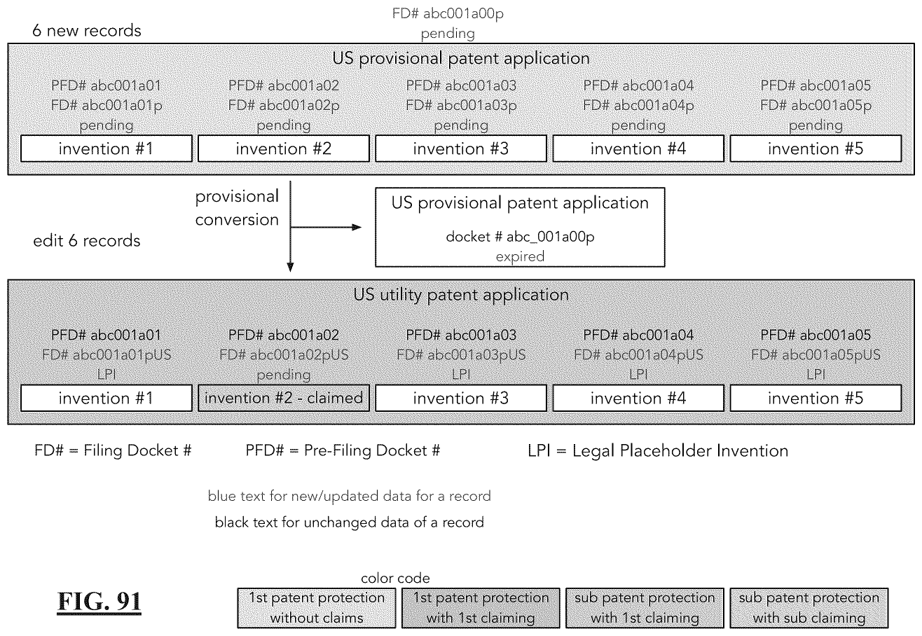

FIG. 91 is a schematic block diagram of an example of first filing a provisional patent application for five inventions, converting the provisional patent application into a US utility patent application having a common spec for the five inventions and having claims for invention number 2, and updates to their corresponding records as recorded within an invention protection database of a private patent tracking database of an improved computer for technology.

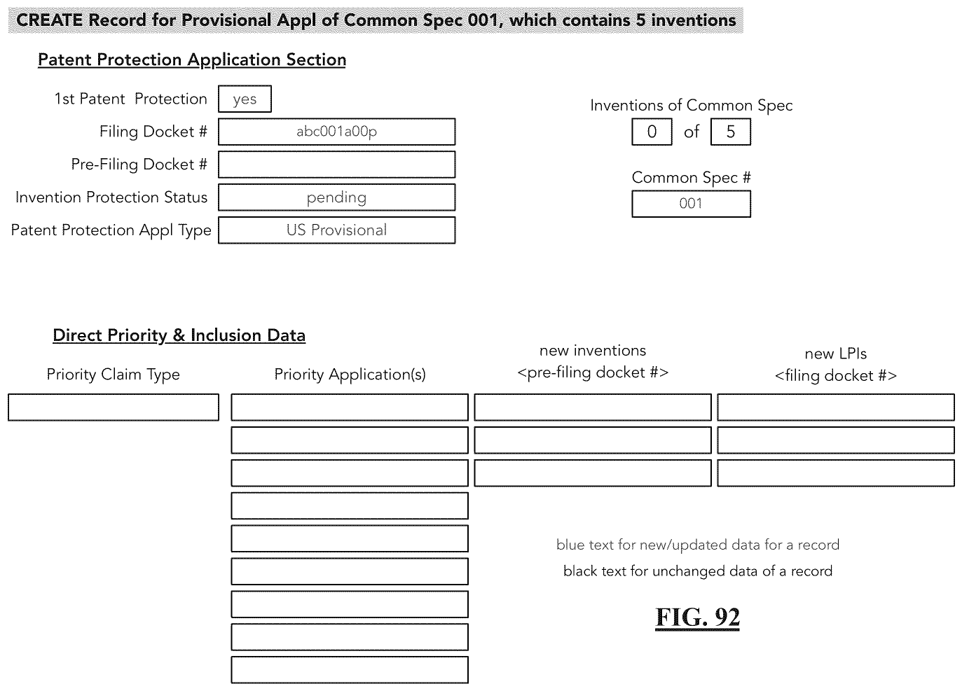

FIG. 92 is a schematic block diagram of an example of a record within an invention protection database (of a private patent tracking database of an improved computer for technology) first filing of a provisional patent application that includes a common spec for five inventions.

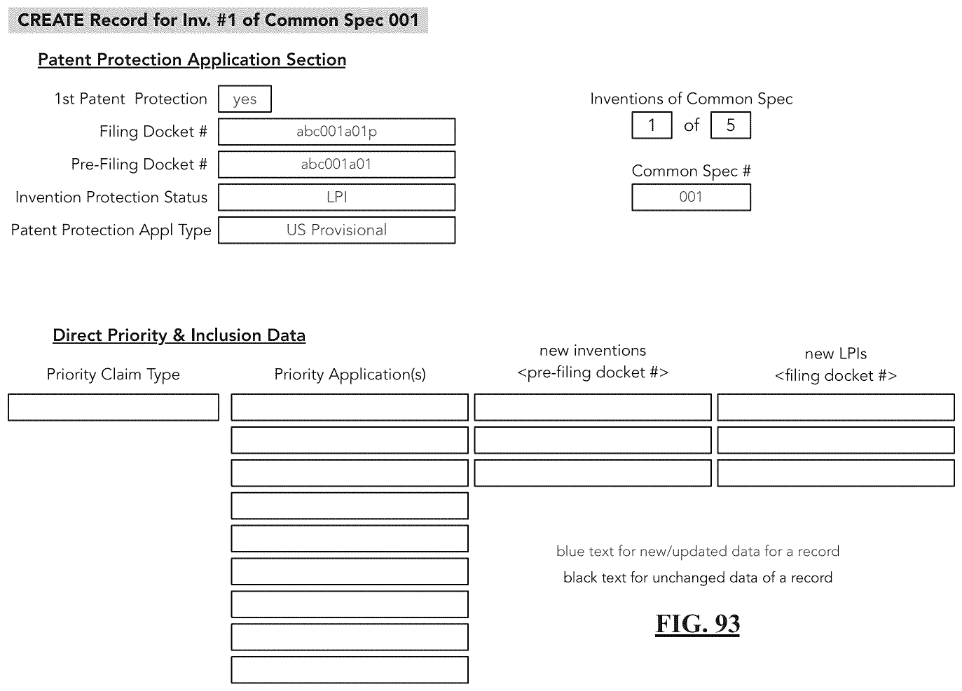

FIG. 93 is a schematic block diagram of an example of a record within an invention protection database (of a private patent tracking database of an improved computer for technology) for a first invention of first filing of a provisional patent application that includes a common spec for five inventions.

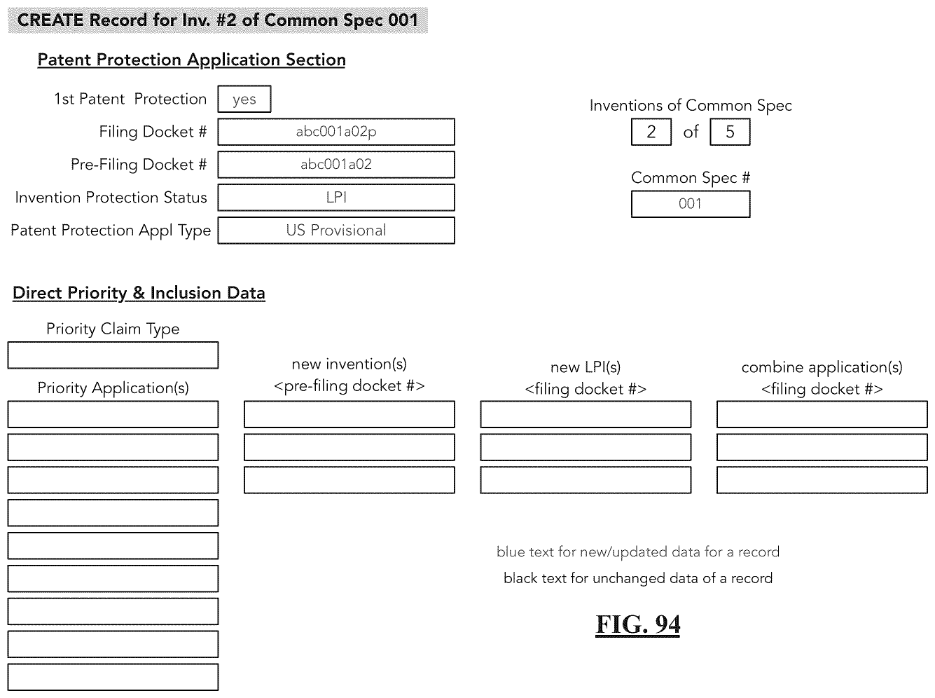

FIG. 94 is a schematic block diagram of an example of a record within an invention protection database (of a private patent tracking database of an improved computer for technology) for a second invention of first filing of a provisional patent application that includes a common spec for five inventions.

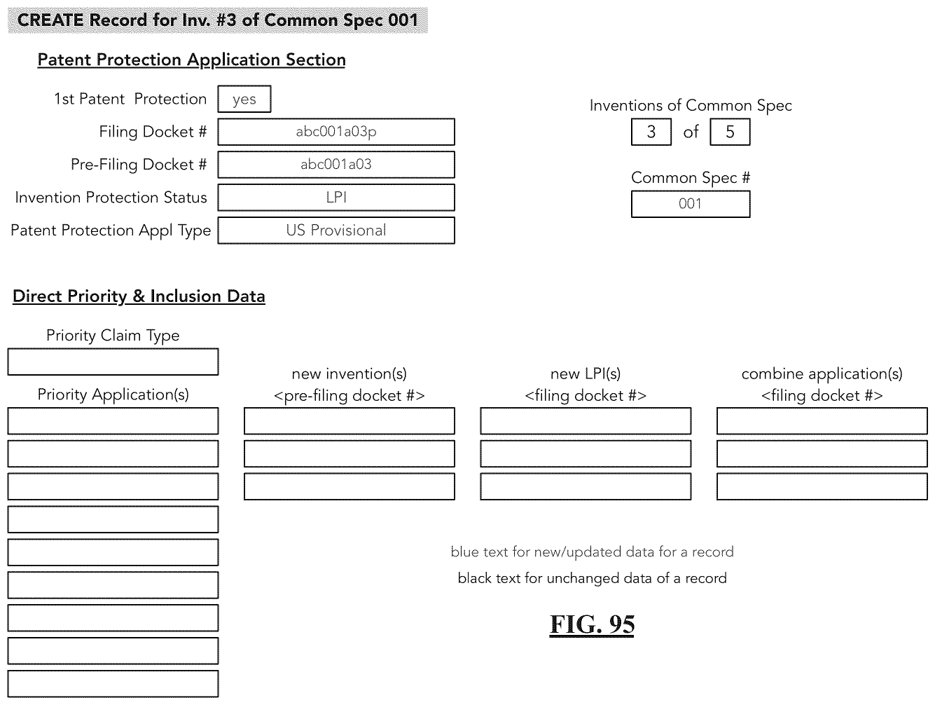

FIG. 95 is a schematic block diagram of an example of a record within an invention protection database (of a private patent tracking database of an improved computer for technology) for a third invention of first filing of a provisional patent application that includes a common spec for five inventions.

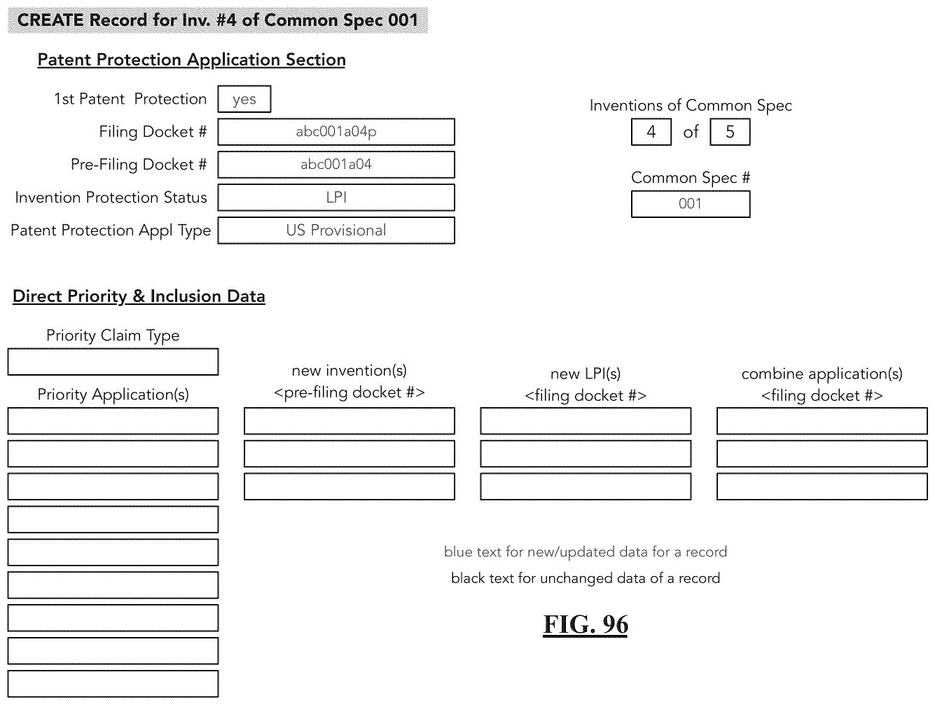

FIG. 96 is a schematic block diagram of an example of a record within an invention protection database (of a private patent tracking database of an improved computer for technology) for a fourth invention of first filing of a provisional patent application that includes a common spec for five inventions.

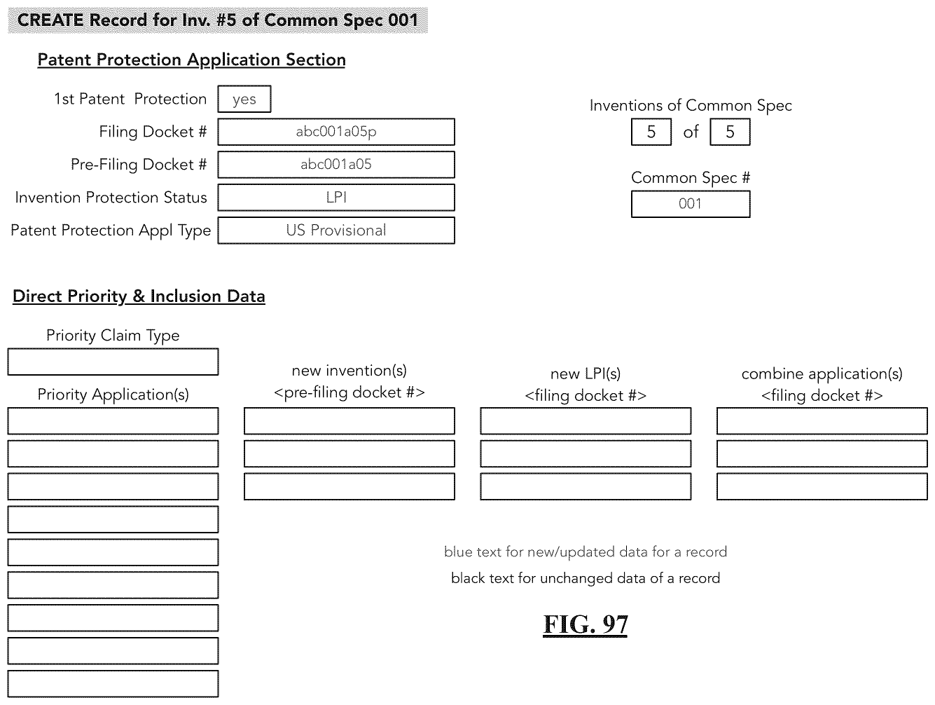

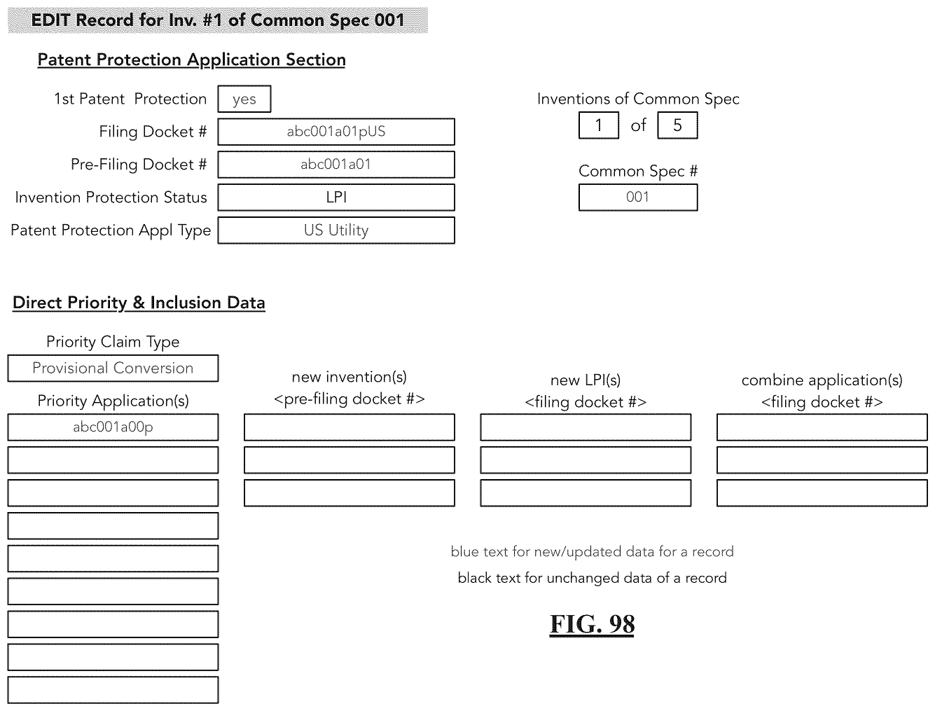

FIG. 97 is a schematic block diagram of an example of a record within an invention protection database (of a private patent tracking database of an improved computer for technology) for a fifth invention of first filing of a provisional patent application that includes a common spec for five inventions.

FIG. 98 is a schematic block diagram of an example of editing a record within an invention protection database (of a private patent tracking database of an improved computer for technology) for a first invention of provisional conversion US utility patent application that claims priority to a provisional patent application, that includes a common spec for five inventions, and that includes claims for invention number 2.

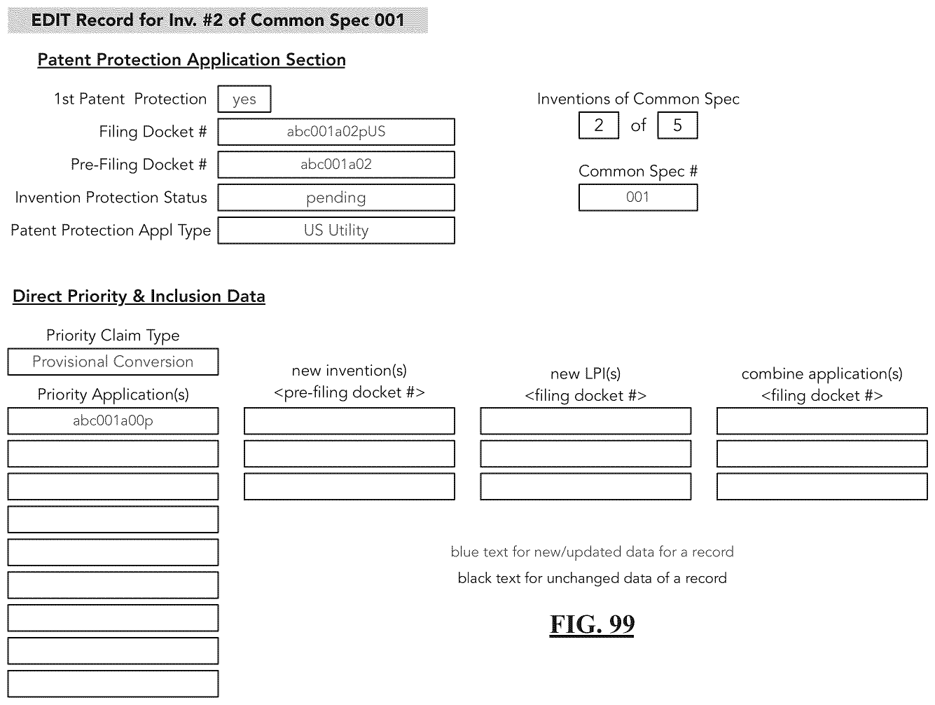

FIG. 99 is a schematic block diagram of an example of editing a record within an invention protection database (of a private patent tracking database of an improved computer for technology) for a second invention of provisional conversion US utility patent application that claims priority to a provisional patent application, that includes a common spec for five inventions, and that includes claims for invention number 2.

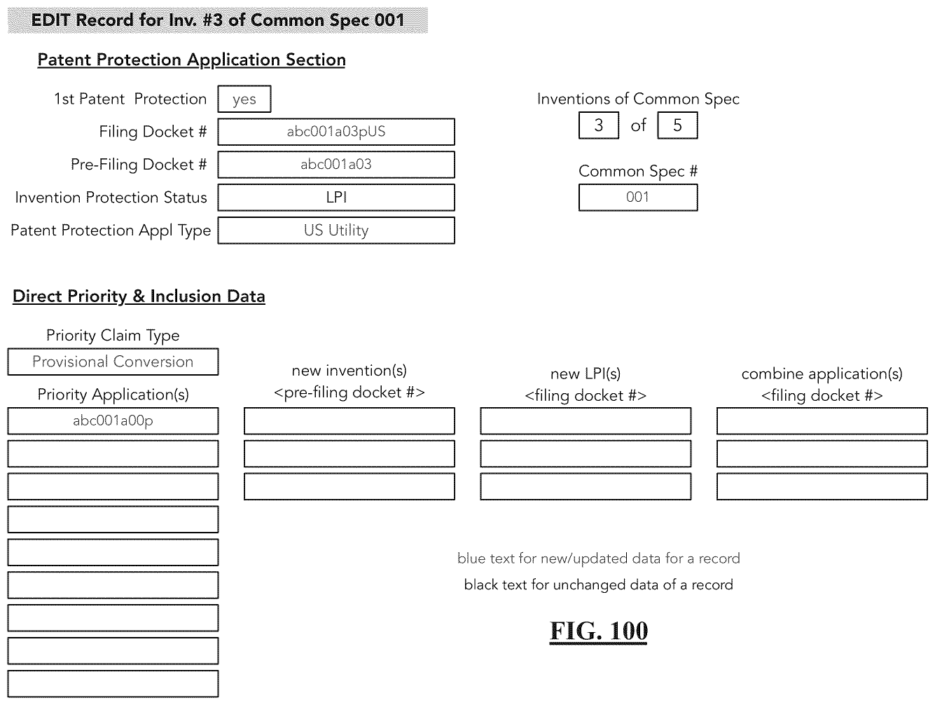

FIG. 100 is a schematic block diagram of an example of editing a record within an invention protection database (of a private patent tracking database of an improved computer for technology) for a third invention of provisional conversion US utility patent application that claims priority to a provisional patent application, that includes a common spec for five inventions, and that includes claims for invention number 2.

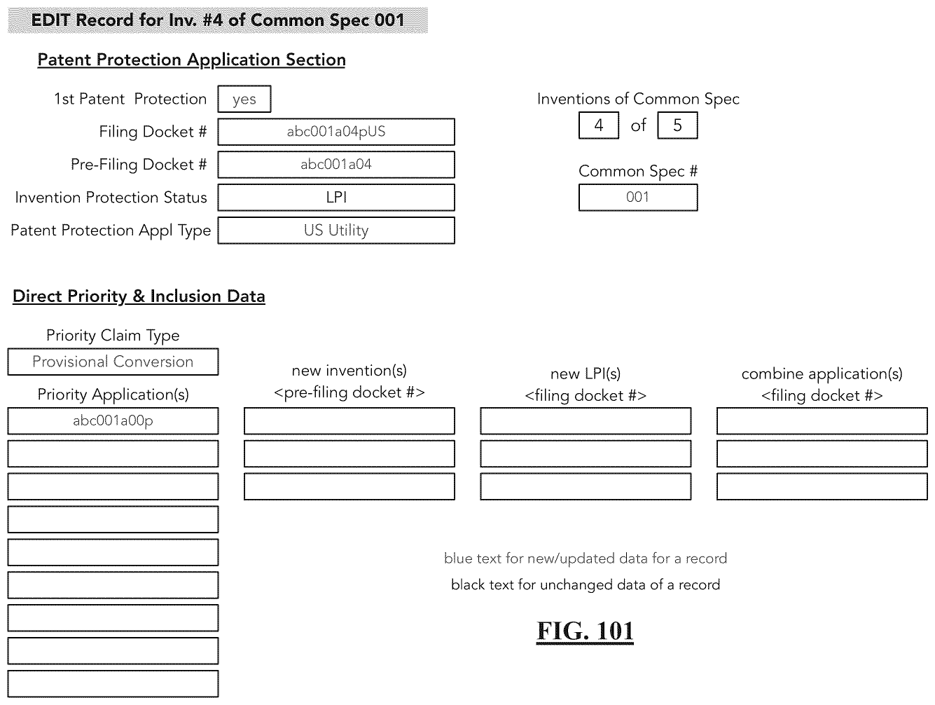

FIG. 101 is a schematic block diagram of an example of editing a record within an invention protection database (of a private patent tracking database of an improved computer for technology) for a fourth invention of provisional conversion US utility patent application that claims priority to a provisional patent application, that includes a common spec for five inventions, and that includes claims for invention number 2.

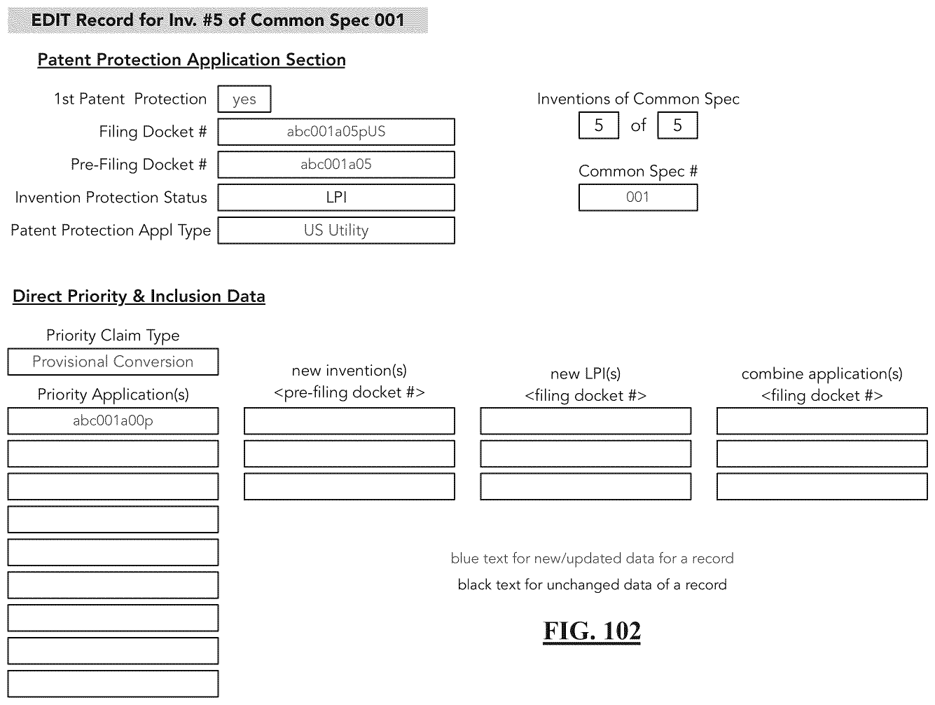

FIG. 102 is a schematic block diagram of an example of editing a record within an invention protection database (of a private patent tracking database of an improved computer for technology) for a fifth invention of provisional conversion US utility patent application that claims priority to a provisional patent application, that includes a common spec for five inventions, and that includes claims for invention number 2.

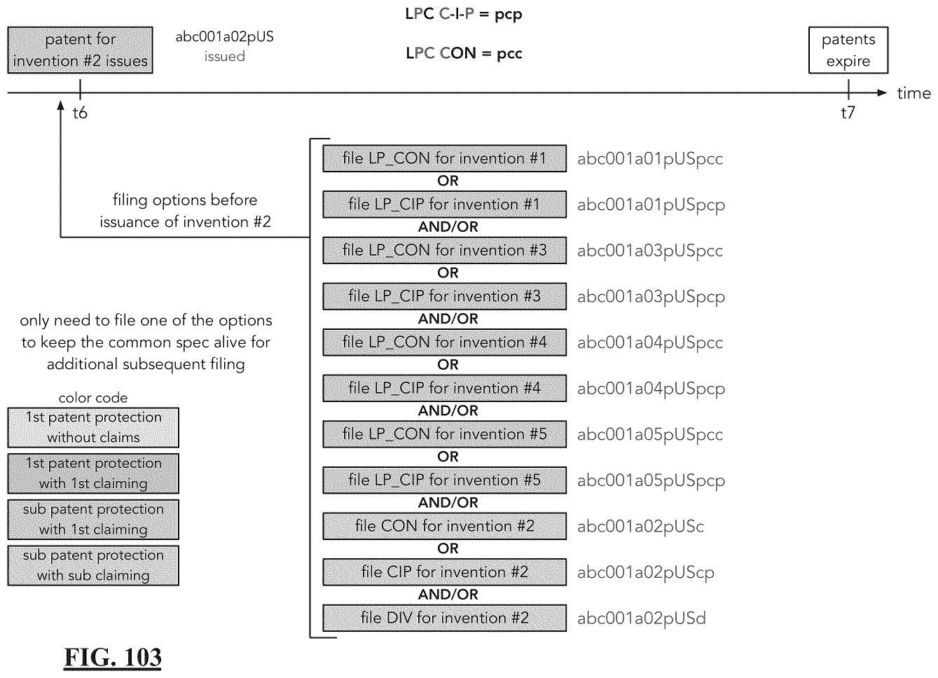

FIG. 103 is a schematic block diagram of an example of subsequent patent application filing options recorded by an invention protection database of a private tracking database of an improved computer for technology. In this example, a US utility patent application (patent for invention #2) filed off of a provisional application (i.e., a provisional conversion application) that includes a common specification for five inventions and claims for invention number 2. The patent for invention #2 issues at a time t6 and expires at a time t7. In an example docket number approach, the docket number for the patent for invention #2 is abc001a02pUS where “abc” is a client designator, “001” is the common specification designator, “a” is the bundle designator, “02” is the invention designator, “p” is the first patent protection type designator (where “p” indicates that it is a provisional conversion application), and “US” is the first subsequent filing type designator (where “US” is the country code indicating that the provisional conversion application was filed in the United States). Embodiments of docket number approaches are further discussed with reference to FIGS. 17C-17F and with reference to one or more of the subsequent Figures.

Because the patent for invention #2 is a provisional conversion application, it is highlighted in green as subsequent patent protection with 1st claiming. When the patent application for invention #2 is filed, the invention protection database is operable to provide a variety of subsequent filing options to be filed prior to the issuance of the patent for invention #2. Subsequent filing options for the patent for invention #2 include subsequent filing with first claiming options of the other inventions described in the common specification (shown in green) and subsequent filing with subsequent claiming options for invention number 2 (shown in brown). A subsequent filing must be filed prior to the issuance of the patent application for invention #2. Information in the subsequent filings that is common to the patent application for invention #2 will expire at time t7.

Other inventions (e.g., inventions 1, 3, 4, and 5) described in the common specification are considered legal placeholder (LP) inventions (or also referred to herein as LPIs) because while the common specification describes these inventions, they are not claimed in the provisional conversion application (the patent for invention #2). The mechanism for filing an application for a legal placeholder invention is a continuation application or a continuation-in-part application (if the application includes any new information from its parent) but these applications are referred to as legal placeholder conversion (LPC) applications. In this example, LPC applications filed as continuation or continuation-in-part are referred to as LP_CONs or LP_CIPs respectively. The subsequent filings with subsequent claiming options for invention number 2 are applications that include new claims that expand on invention 2 material (sub claiming) that can be filed as continuation (CON) applications, continuation-in-part (CIP) applications, or divisional (DIV) applications.

In this docket number approach, docket numbers for the subsequent filings expand on the original (or parent) docket number and indicate the invention number that the claims are related to (e.g., 01, 02, 03, 04, or 05) and the type of subsequent filing (i.e., a subsequent filing designator). For example, a subsequent filing designator of “pcc” is included to indicate a continuation LPC application, a subsequent filing designator of “pcp” is included to indicate a continuation-in-part LPC application, a subsequent filing designator of “c” is included to indicate a continuation application, a subsequent filing designator of “cp” is included to indicate a continuation-in-part application, and a subsequent filing designator of “d” is included to indicate a divisional application.

As specific examples, the subsequent filings with first claiming options of the other inventions include filing a continuation off of the patent for invention #2 (docket #abc001a02pUS) that includes claims for invention 1 (LP_CON for invention 1 having docket number abc001a01pUSpcc), filing a continuation-in-part off of the patent for invention #2 (docket #abc001a02pUS) that includes claims for invention 1 (LP_CIP for invention 1 having docket number abc001a01pUSpcp), filing a continuation off of the patent for invention #2 (docket #abc001a02pUS) that includes claims for invention 3 (LP_CON for invention 3 having docket number abc001a03pUSpcc), filing a continuation-in-part off of the patent for invention #2 (docket #abc001a02pUS) that includes claims for invention 3 (LP_CIP for invention 3 having docket number abc001a03pUSpcp), filing a continuation off of the patent for invention #2 (docket #abc001a02pUS) that includes claims for invention 4 (LP_CON for invention 4 having docket number abc001a04pUSpcc), filing a continuation-in-part off of the patent for invention #2 (docket #abc001a02pUS) that includes claims for invention 4 (LP_CIP for invention 4 having docket number abc001a04pUSpcp), filing a continuation off of the patent for invention #2 (docket #abc001a02pUS) that includes claims for invention 5 (LP_CON for invention 5 having docket number abc001a05pUSpcc), and filing a continuation-in-part (CIP) off of the patent for invention #2 (docket #abc001a02pUS) that includes claims for invention 5 (LP_CIP for invention 5 having docket number abc001a05pUSpcp).

The subsequent filings with subsequent claiming options for invention number 2 include filing a continuation off of the patent for invention #2 (docket #abc001a02pUS) (CON for invention 2 having docket number abc001a02pUSc), filing a continuation-in-part off of the patent for invention #2 (docket #abc001a02pUS) (CIP for invention 2 having docket number abc001a02pUScp), and filing a divisional off of the patent for invention #2 (docket #abc001a02pUS) (DIV for invention 2 having docket number abc001a02pUSd).

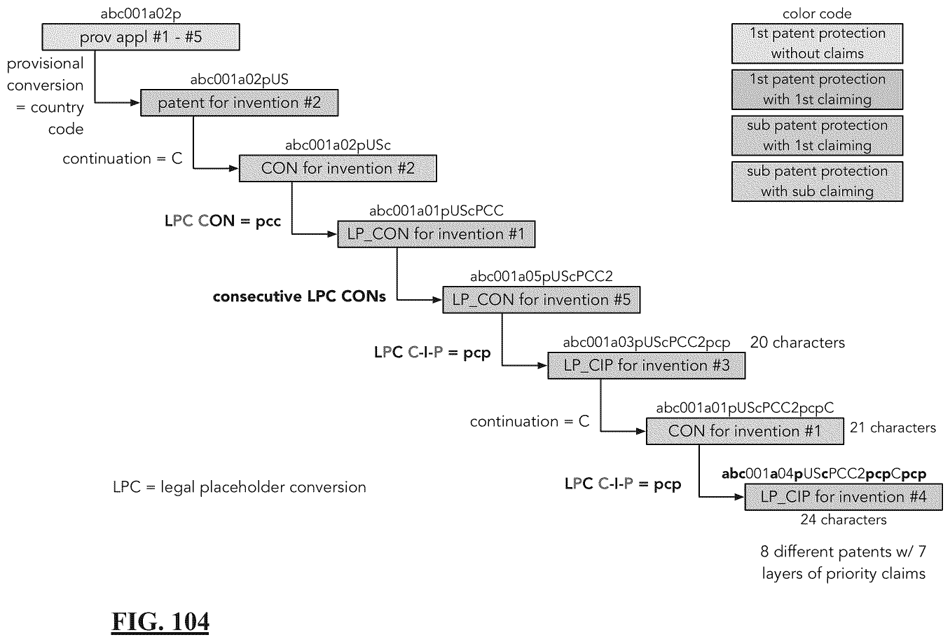

FIG. 104 is a schematic block diagram of an example of a single branch common specification application tree that shows subsequent patent application filing options as recorded by an invention protection database of a private tracking database of an improved computer for technology. The single branch common specification application tree depicts an example where a single patent application related to the common specification is kept pending over time.

The initially filed patent application in this example is a provisional patent application that includes a common specification for five inventions (prov appl #1-#5) having a docket number of abc001a02p (using the docket number approach described with reference to FIG. 103). The provisional patent application is the first patent protection without claims and thus is highlighted in gray. The subsequent filings that follow are subsequent filing with first claiming options (highlighted in green) and subsequent filing with subsequent claiming options (highlighted in brown).

For example, after the provisional patent application is filed but prior to its expiration, a provisional conversion patent application with claims for invention 2 (patent for invention #2) is filed having a docket number of abc001a02pUS. The patent for invention #2 is a subsequent patent protection with 1st claiming (i.e., a provisional conversion application) and thus is highlighted in green. Prior to the issuance of the patent for invention #2, a continuation application (CON) for invention #2 is filed off of the patent for invention #2 having a docket number of abc001a02pUSc. The continuation application is a subsequent patent protection with sub claiming for invention 2 and is thus highlighted in brown.

Before the issuance of the continuation (CON) for invention #2, a legal placeholder conversion (LPC) application is filed as a continuation application off of the CON for invention #2 having a set of claims for invention #1 (LP_CON for invention #1). The LP_CON for invention #1 has a docket number of abc001a01pUScPCC. The designator for the subsequent filings are toggled between upper and lower cases and could also be toggled between bold and normal fonts for ease of viewing. The LP_CON for invention #1 is a subsequent patent protection with 1st claiming (i.e., a legal placeholder conversion application) and thus is highlighted in green.

Before the issuance of the LP_CON for invention #1, a legal placeholder conversion (LPC) application is filed as a continuation application off of the LP_CON for invention #1 having a set of claims for invention #5 (LP_CON for invention #5). The LP_CON for invention #5 has a docket number of abc001a05pUScPCC2 where the “2” indicates it is the second consecutive LPC_CON filed. The LP_CON for invention #5 is a subsequent patent protection with 1st claiming (i.e., a legal placeholder conversion application) and thus is highlighted in green.

Before the issuance of the LP_CON for invention #5, a legal placeholder conversion (LPC) application is filed as a continuation-in-part application off of the LP_CON for invention #5 having a set of claims for invention #3 (LP_CIP for invention #3). The LP_CIP for invention #3 has a docket number of abc001a03pUScPCC2pcp. The LP_CIP for invention #3 is a subsequent patent protection with 1st claiming (i.e., a legal placeholder conversion application) and thus is highlighted in green.

Before the issuance of the LP_CIP for invention #3, a continuation application (CON) for invention #1 is filed off of LP_CIP for invention #3 having a docket number of abc001a01pUScPCC2pcpC. The continuation application for invention #1 is a subsequent patent protection with sub claiming for invention 1 and is thus highlighted in brown.

Before the issuance of the CON for invention #1, a legal placeholder conversion (LPC) application is filed as a continuation-in-part application off of the CON for invention #1 having a set of claims for invention #4 (LP_CIP for invention #4). The LP_CIP for invention #4 has a docket number of abc001a04pUScPCC2pcpCpcp showing an example where designators are toggled between bold and normal font for ease of viewing. The LP_CIP for invention #4 is a subsequent patent protection with 1st claiming (i.e., a legal placeholder conversion application) and thus is highlighted in green. At the end of this single branch common specification application tree example, 8 different patents are issued with 7 layers of priority claims (as indicated by the 7 subsequent filing designators in the most recent docket number). With this docket number approach, the docket numbers become lengthy by the end of the tree (e.g., 24 characters long) but the types of subsequent filings throughout the lineage of the single branch common specification application tree is clear.

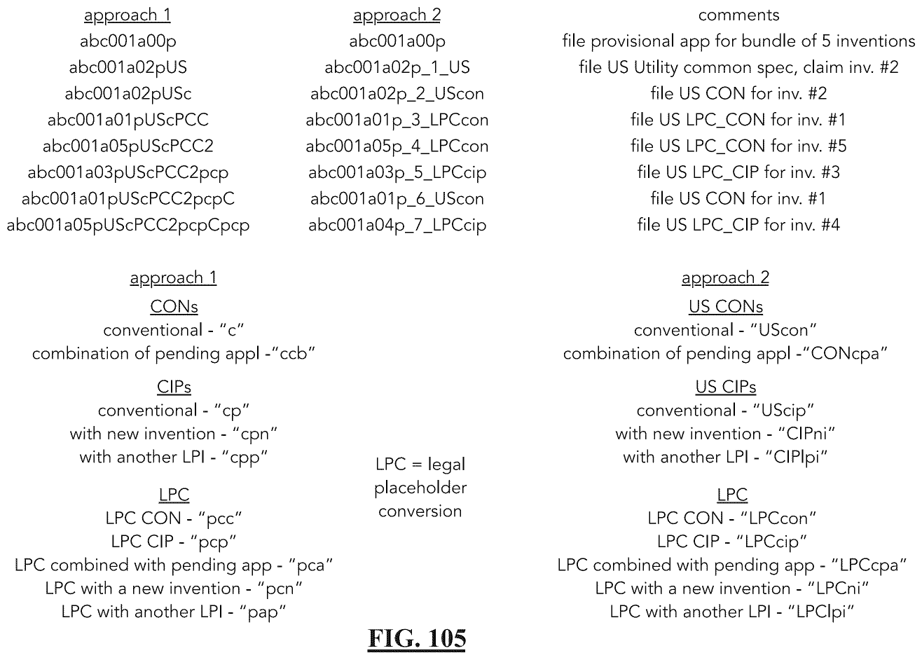

FIG. 105 is a schematic block diagram of an example of two docket number approaches and the corresponding suffixes for the common specification (spec) application tree of FIG. 104 as recorded within an invention protection database of a private patent tracking database of an improved computer for technology. The common spec application tree of FIG. 104 includes filing a provisional application for a bundle of 5 inventions, filing a US Utility application with a common spec and claims for invention #2, filing a US continuation application for invention #2, filing a US legal placeholder conversion (LPC) application as a continuation (LPC_CON) with claims for invention #1, filing a US legal placeholder conversion (LPC) application as a continuation (LPC_CON) with claims for invention #5, filing a US legal placeholder conversion (LPC) application as a continuation-in-part (LPC_CIP) with claims for invention #3, filing a US continuation application (CON) for invention #1, and filing a US legal placeholder conversion (LPC) application as a continuation-in-part (LPC_CIP) with claims for invention #4.

The first docket number approach (approach 1) depicts the docket number approach described with reference to FIGS. 103 and 104 where suffixes are added to the end of the parent docket number and toggled between lower and upper cases for ease of viewing. The suffixes for continuations for approach 1 include “c” for a conventional continuation and “ccb” for a continuation that claims priority to a combination of pending applications. The suffixes for continuations-in-part for approach 1 include “cp” for a conventional continuation-in-part, “cpn” for a continuation-in-part that includes a new invention, and “cpp” for a continuation-in-part that includes another legal placeholder invention (LPI).

The suffixes for legal placeholder conversion (LPC) applications for approach 1 include “pcc” for a legal placeholder conversion (LPC) application filed as a continuation (LPC_CON), “pcp” for a legal placeholder conversion (LPC) application filed as a continuation-in-part (LPC_CIP), “pcp” for an LPC combined with a pending application, “pcn” for an LPC with a new invention, and “pap” for an LPC with another legal placeholder invention (LPI).

The second docket number approach (approach 2) presents an alternative docket number scheme that reduces the length of the docket numbers that occur further down a common specification application tree. Instead of adding suffixes to the end of the parent docket number and toggling between upper and lower cases as in approach 1, in approach 2, a number is included after the invention designator to indicate the depth of the priority claim.

The suffixes for US continuations for approach 2 include “UScon” for a conventional continuation, and “CONcpa” for a continuation that claims priority to a combination of pending applications. The suffixes for US continuations-in-part for approach 2 include “UScip” for a conventional continuation-in-part, “CIPni” for a continuation-in-part combined with a new invention, and “CIPIpi” for a continuation-in-part with another legal placeholder invention (LPI).

The suffixes for legal placeholder conversion (LPC) applications for approach 2 include “LPCcon” for a legal placeholder conversion (LPC) application filed as a continuation, “LPCcip” for a legal placeholder conversion (LPC) application filed as a continuation-in-part, “LPCcpa” for an LPC combined with a pending application, “LPCni” for an LPC with a new invention, and “LPCIpiS” for an LPC that includes another legal placeholder invention (LPI).

The docket numbers for the common specification (spec) application tree of FIG. 104 using approach 2 include abc001a00p for the provisional application bundle with 5 inventions, abc001a02p_1_US for the US Utility application with a common spec and claims for invention #2, abc001a02p_2_UScon for the US continuation application for invention #2, abc001a01p_3_LPCcon for the US legal placeholder conversion (LPC) application as a continuation with claims for invention #1, abc001a05p_4_LPCcon for the US legal placeholder conversion (LPC) application as a continuation with claims for invention #5, abc001a03p_5_LPCcip for the US legal placeholder conversion (LPC) application as a continuation-in-part with claims for invention #3, abc001a01p_6_UScon for the US continuation application for invention #1, and abc001a04p_7_LPCcip for the US legal placeholder conversion (LPC) application as a continuation-in-part with claims for invention #4. In this example, as the common spec application tree continues, the maximum number of characters reached will be 18 using approach 2.

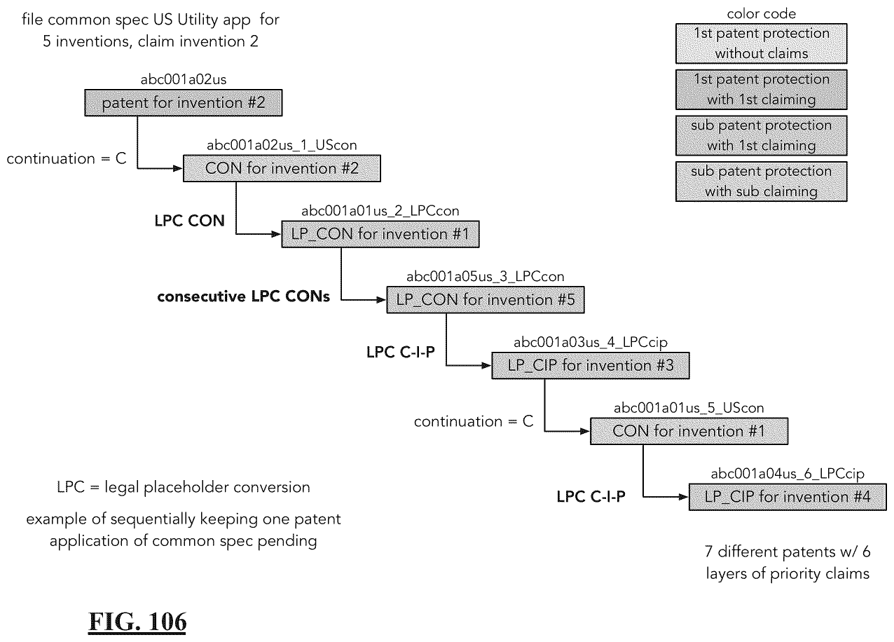

FIG. 106 is a schematic block diagram of another example of a single branch common specification (spec) application tree of a US utility patent application that includes subsequent patent application filing options as recorded within an invention protection database of a private patent tracking database of an improved computer for technology. The single branch common specification application tree of FIG. 106 depicts an example similar to the example of FIG. 104 where a single patent application related to the common specification is kept pending over time, except in the example of FIG. 106, the docket number approach 2 of FIG. 105 is used and the initial filing is a nonprovisional US utility patent application.

The initially filed patent application includes a common specification for five inventions and claims for invention 2 (patent for invention #2) having a docket number of abc001a02 us. The patent for invention #2 is a 1st patent protection with 1st claiming for invention 2 and is thus highlighted in red. The subsequent filings that follow are subsequent filing with first claiming options of the other inventions (highlighted in green) and subsequent filing with subsequent claiming options for inventions 1 and 2 (highlighted in brown).

For example, prior to the issuance of the patent for invention #2, a continuation application (CON) for invention #2 is filed having a docket number of abc001a02us_1_UScon. The continuation application is a subsequent patent protection with sub claiming for invention 2 and is thus highlighted in brown.

Before the issuance of the continuation of invention #2, a legal placeholder conversion (LPC) application is filed as a continuation application off of the CON for invention #2 having a set of claims for invention #1 (LP_CON for invention #1). The LP_CON for invention #1 has a docket number of abc001a01us_2_LPCcon. The LP_CON for invention #1 is a subsequent patent protection with 1st claiming (i.e., a legal placeholder conversion application) and thus is highlighted in green.

Before the issuance of the LP_CON for invention #1, a legal placeholder conversion (LPC) application is filed as a continuation application off of the LP_CON for invention #1 having a set of claims for invention #5 (LP_CON for invention #5). The LP_CON for invention #5 has a docket number of abc001a05us_3_LPCcon. In contrast with the example of FIG. 4, here consecutive LPC applications are indicated by priority claim depth. The LP_CON for invention #5 is a subsequent patent protection with 1st claiming (i.e., a legal placeholder conversion application) and thus is highlighted in green.

Before the issuance of the LP_CON for invention #5, a legal placeholder conversion (LPC) application is filed as a continuation-in-part application off of the LP_CON for invention #5 having a set of claims for invention #3 (LP_CIP for invention #3). The LP_CIP for invention #3 has a docket number of abc001a03us_4_LPCcip. The LP_CIP for invention #3 is a subsequent patent protection with 1st claiming (i.e., a legal placeholder conversion application) and thus is highlighted in green.

Before the issuance of the LP_CIP for invention #3, a continuation application (CON) for invention #1 is filed off of LP_CIP for invention #3 having a docket number of abc001a0lus_5_LPCcon. The continuation application for invention #1 is a subsequent patent protection with sub claiming for invention 1 and is thus highlighted in brown.

Before the issuance of the CON for invention #1, a legal placeholder conversion (LPC) application is filed as a continuation-in-part application off of the CON for invention #1 having a set of claims for invention #4 (LP_CIP for invention #4). The LP_CIP for invention #4 has a docket number of abc001a04us_6_LPCcip. The LP_CIP for invention #4 is a subsequent patent protection with 1st claiming (i.e., a legal placeholder conversion application) and thus is highlighted in green. By the end of the single branch common spec application tree, 7 different patents exist with 6 layers of priority claims (as indicated by the “6” priority depth designator in the final docket number).

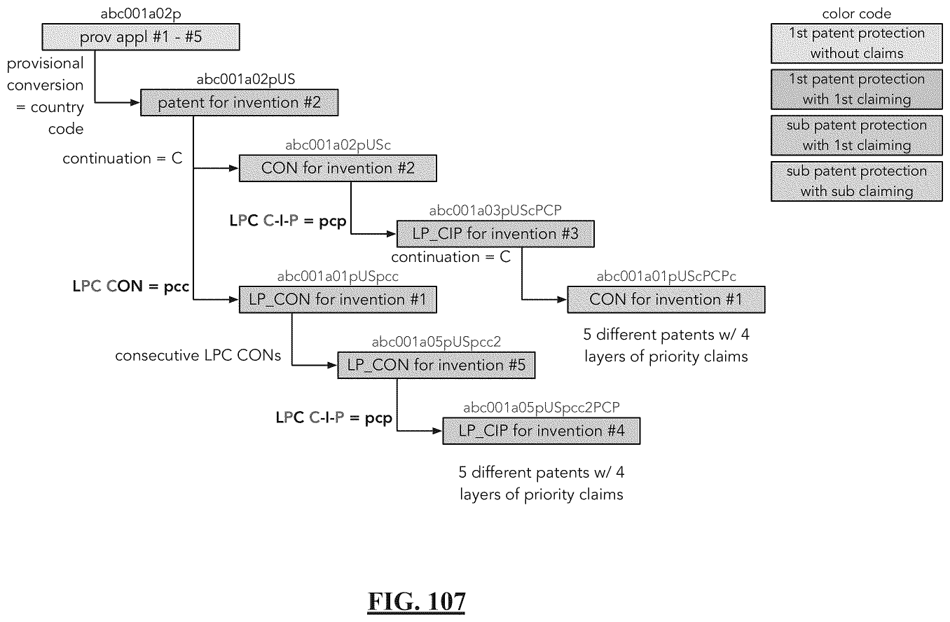

FIG. 107 is a schematic block diagram of an example of a multiple branch common specification application tree of a provisional patent application that includes subsequent claiming options as recorded within an invention protection database of a private patent tracking database of an improved computer for technology. The example of FIG. 107 is similar to the example of FIG. 104 example that instead of a single common specification (spec) application branch where one application is kept pending at a time, the example of FIG. 107 shows that more than one application can be kept pending at a time via multiple branches off of the provisional conversion filing.

The initially filed patent application in this example is a provisional patent application that includes a common specification for five inventions (prov appl #1-#5) having a docket number of abc001a02p (using docket number approach 1 described with reference to FIGS. 103 and 104). The provisional patent application is the first patent protection without claims and thus is highlighted in gray. The subsequent filings that follow are subsequent filing with first claiming options of the other inventions (highlighted in green) and subsequent filing with subsequent claiming options for inventions 1 and 2 (highlighted in brown).

After the provisional patent application is filed and prior to its expiration, a provisional conversion patent application with claims for invention 2 (patent for invention #2) is filed having a docket number of abc001a02pUS. The patent for invention #2 is a subsequent patent protection with 1st claiming (i.e., a provisional conversion application) and thus is highlighted in green.

A first branch of the common spec application tree continues off of the patent for invention #2 where prior to the issuance of the patent for invention #2, a continuation application (CON) for invention #2 is filed having a docket number of abc001a02pUSc. The continuation application is a subsequent patent protection with sub claiming for invention 2 and is thus highlighted in brown. Before the issuance of the continuation of invention #2, a legal placeholder conversion (LPC) application is filed as a continuation application off of the CON for invention #2 having a set of claims for invention #3 (LP_CIP for invention #3). The LP_CIP for invention #3 has a docket number of abc001a03pUScPCP. The LP_CIP for invention #3 is a subsequent patent protection with 1st claiming (i.e., a legal placeholder conversion application) and thus is highlighted in green.

Before the issuance of the LP_CIP for invention #3, a continuation application (CON) for invention #1 is filed off of LP_CIP for invention #3 having a docket number of abc001a01pUScPCPc. The continuation application for invention #1 is a subsequent patent protection with sub claiming for invention 1 and is thus highlighted in brown.

Also during the pendency of the patent for invention #2, a second branch of the common spec application tree is formed by filing a legal placeholder conversion (LPC) application as a continuation off of the patent for invention #2 that includes claims for invention #1 (LP_CON for invention #1) having a docket number of abc001a01pUSpcc. The LP_CON for invention #1 is subsequent patent protection with 1st claiming (i.e., a legal placeholder conversion application) and thus is highlighted in green.

Before the issuance of the LP_CON for invention #1, a legal placeholder conversion (LPC) application is filed as a continuation having a set of claims for invention #5 (LP_CON for invention #5). The LP_CON for invention #5 has a docket number of abc001a05pUSpcc2 where the 2 indicates that it is a consecutively filed LPC continuation application. The LP_CON for invention #5 is a subsequent patent protection with 1st claiming (i.e., a legal placeholder conversion application) and thus is highlighted in green.

Before the issuance of the LP_CON for invention #5, a legal placeholder conversion (LPC) application is filed as a continuation-in-part having a set of claims for invention #4 (LP_CIP for invention #4). The LP_CIP for invention #4 has a docket number of abc001a04pUSpcc2PCP. The LP_CIP for invention #4 is a subsequent patent protection with 1st claiming (i.e., a legal placeholder conversion application) and thus is highlighted in green.

The first branch of the multiple branch common spec application tree includes 5 different patents with 4 layers of priority claims and the second branch of the multiple branch common spec application tree also includes 5 different patents with 4 layers of priority claims. Including multiple branches allows for more patents to be concurrently pending such that more patent protection can potentially be gained in a shorter amount of time.

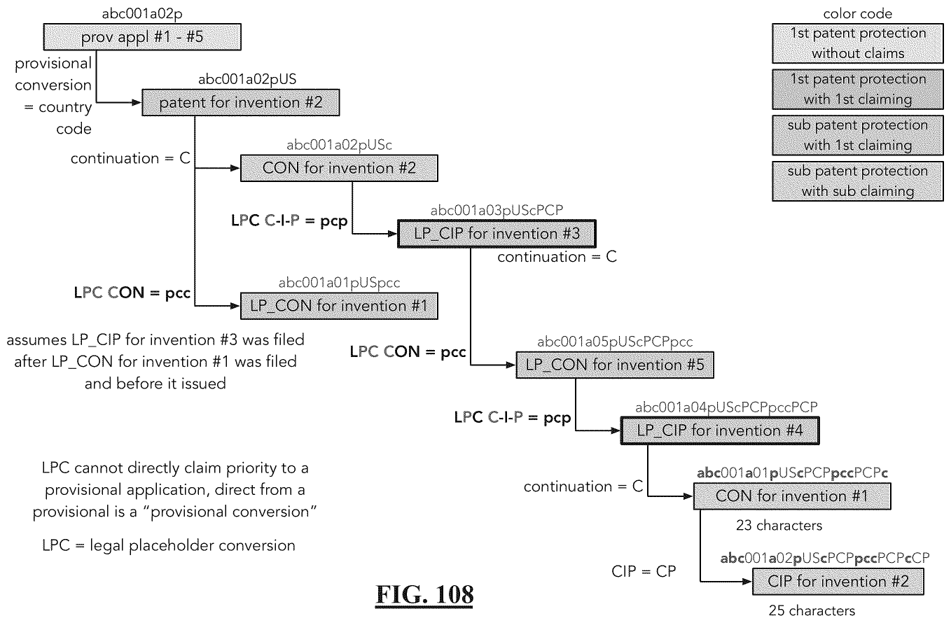

FIG. 108 is a schematic block diagram of another example of a multiple branch common specification application tree that includes subsequent claiming options as recorded within an invention protection database of a private patent tracking database of an improved computer for technology. The example of FIG. 108 is similar to the example of FIG. 107, except that instead of continuing the second branch after the filing of the LP_CON for invention #1, a single chain for inventions with new subject matter is continued through the first branch (e.g., subsequent applications are filed off of LP_CIP for invention #3).

The initially filed patent application in this example is a provisional patent application that includes a common specification for five inventions (prov appl #1-#5) having a docket number of abc001a02p. After the provisional patent application is filed and prior to its expiration, a provisional conversion patent application with claims for invention 2 (patent for invention #2) is filed having a docket number of abc001a02pUS.

A first branch of the common spec application tree continues off the patent for invention #2 where prior to the issuance of the patent for invention #2, a continuation application (CON) for invention #2 is filed having a docket number of abc001a02pUSc. Also during the pendency of the patent for invention #2, a second branch of the common spec application tree is formed by filing a legal placeholder conversion (LPC) application as a continuation off of the patent for invention #2 that includes claims for invention #1 (LP_CON for invention #1) having a docket number of abc001a01pUSpcc.

Before the issuance of the continuation of invention #2, a legal placeholder conversion (LPC) application is filed as a continuation application off of the CON for invention #2 having a set of claims for invention #3 (LP_CIP for invention #3). The LP_CIP for invention #3 has a docket number of abc001a03pUScPCP. It is assumed that LP_CIP for invention #3 was filed after the LP_CON for invention #1 was filed but before it issued.

Before the issuance of the LP_CIP for invention #3, a legal placeholder conversion (LPC) application is filed as a continuation off of LP_CIP for invention #3 having a set of claims for invention #5 (LP_CON for invention #5). The LP_CON for invention #5 has a docket number of abc001a05pUScPCPpcc. Before the issuance of the LP_CON for invention #5, a legal placeholder conversion (LPC) application is filed as a continuation-in-part off of LP_CON for invention #5 having a set of claims for invention #4 (LP_CIP for invention #4). The LP_CIP for invention #4 has a docket number of abc001a04pUScPCPpccPCP. Before the issuance of the LP_CIP for invention #4, a continuation application (CON) for invention #1 is filed off of LP_CIP for invention #4 having a set of claims for invention #1. The CON for invention #1 has a docket number of abc001a01pUScPCPpccPCPc. As shown in this example, in addition to toggling between upper and lower cases, bold and normal font is used for ease of viewing the docket information.

Before the issuance of the CON for invention #1, a continuation-in-part (CIP) application for invention #2 is filed off of the CON for invention #1 having a set of claims for invention #2. The CIP for invention #2 has a docket number of abc001a01pUScPCPpccPCPcCP.

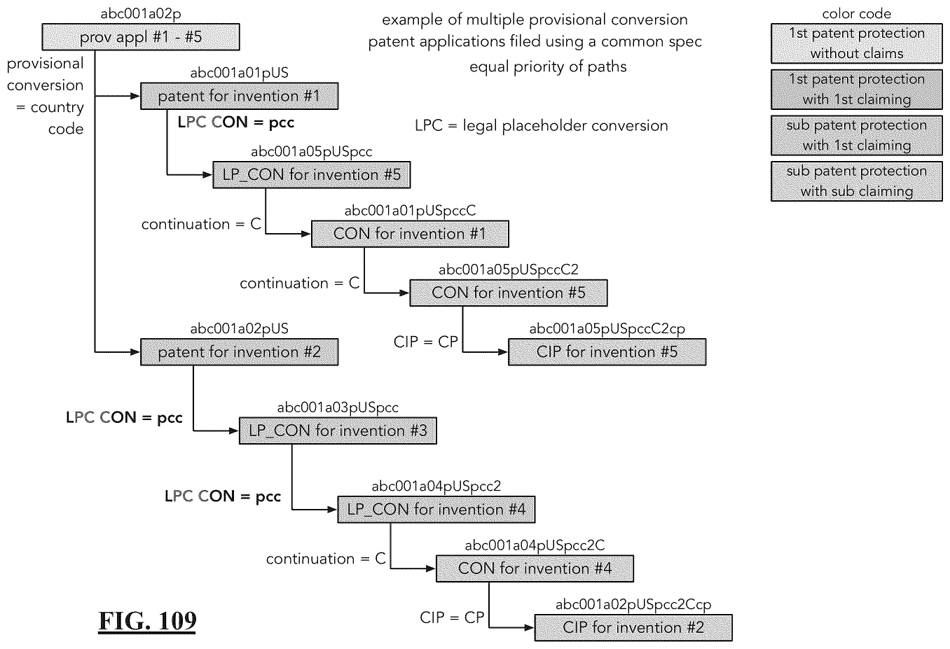

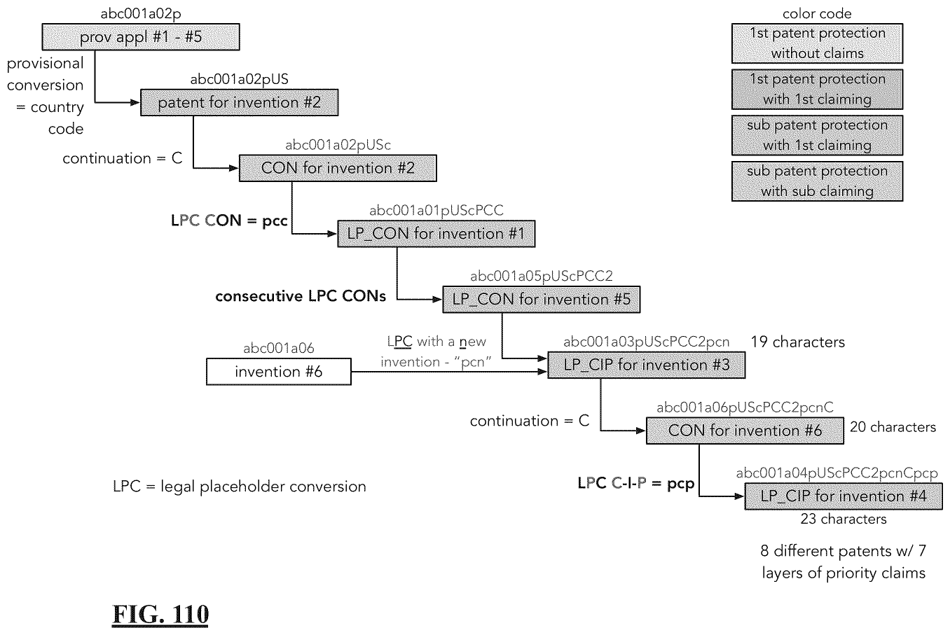

FIG. 109 is a schematic block diagram of another example of a multiple branch common specification application tree that includes subsequent claiming options as recorded within an invention protection database of a private patent tracking database of an improved computer for technology. The example of FIG. 109 is similar to the example of FIG. 107, except that two branches of applications are filed off of the initial provisional patent application with equal priority of paths.

The initially filed patent application in this example is a provisional patent application that includes a common specification for five inventions (prov appl #1-#5) having a docket number of abc001a02p. After the provisional patent application is filed and prior to its expiration, a first branch of the common spec application tree is started by filing a provisional conversion patent application with claims for invention 1 (patent for invention #1) having a docket number of abc001a01pUS.

Also after the provisional patent application is filed and before its expiration, a second branch of the common spec application tree is started by filing a provisional conversion patent application with claims for invention 2 (patent for invention #2) having a docket number of abc001a02pUS.

The first branch of the common spec application tree continues off of the patent for invention #1 where prior to the issuance of the patent for invention #1, a legal placeholder conversion (LPC) application is filed as a continuation off of the patent for invention #1 having a set of claims for invention #5 (LP_CON for invention #5). The LP_CON for invention #5 has a docket number of abc001a05pUSpcc. Before the issuance of the LP_CON for invention #5, a continuation application (CON) for invention #1 is filed off of LP_CON for invention #5 having a set of claims for invention #1. The CON for invention #1 has a docket number of abc001a01pUSpccC.

Before the issuance of the continuation of invention #1, a continuation application (CON) for invention #5 is filed off of the CON for invention #1 having a set of claims for invention #5. The CON for invention #5 has a docket number of abc001a01pUSpccC2 where the 2 indicates a consecutively filed continuation application. Before the issuance of the continuation of invention #5, a continuation-in-part application (CIP) for invention #5 is filed off of the continuation invention #5 having a set of claims for invention #5. The CIP for invention #5 has a docket number of abc001a01pUSpccC2cp.

Meanwhile, the second branch of the common spec application tree continues off of the patent for invention #2 where prior to the issuance of the patent for invention #2, a legal placeholder conversion (LPC) application is filed as a continuation off of the patent for invention #2 having a set of claims for invention #3 (LP_CON for invention #3). The LP_CON for invention #3 has a docket number of abc001a03pUSpcc. Before the issuance of the LP_CON for invention #3, a legal placeholder conversion (LPC) application is filed as a continuation off of the LP_CON for invention #3 having a set of claims for invention #4 (LP_CON for invention #4). The LP_CON for invention #4 has a docket number of abc001a04pUSpcc2 where the 2 indicates a consecutively filed LP_CON application.

Before the issuance of the LP_CON for invention #4, a continuation application (CON) for invention #4 is filed off of LP_CON for invention #4 having a set of claims for invention #4. The CON for invention #4 has a docket number of abc001a04pUSpcc2C. Before the issuance of the continuation of invention #4, a continuation-in-part application (CIP) for invention #2 is filed off of the CON for invention #4 having a set of claims for invention #2. The CIP for invention #2 has a docket number of abc001a02pUSpcc2Ccp.

FIG. 110 is a schematic block diagram of another example of a single branch common spec application tree that includes subsequent claiming options as recorded within an invention protection database of a private patent tracking database of an improved computer for technology. The example of FIG. 110 is similar to the example of FIG. 104 except that the example of FIG. 110 introduces filing a new application with claims for new invention #6 and incorporates invention #6 material in subsequent filings.

The initially filed patent application in this example is a provisional patent application that includes a common specification for five inventions (prov appl #1-#5) having a docket number of abc001a02p. After the provisional patent application is filed and prior to its expiration, a provisional conversion patent application with claims for invention 2 (patent for invention #2) is filed having a docket number of abc0001a02pUS. Prior to the issuance of the patent for invention #2, a continuation application (CON) for invention #2 is filed having a docket number of abc001a02pUSc.

Before the issuance of the continuation of invention #2, a legal placeholder conversion (LPC) application is filed as a continuation application off of the CON for invention #2 having a set of claims for invention #1 (LP_CON for invention #1). The LP_CON for invention #1 has a docket number of abc001a01pUScPCC. Before the issuance of the LP_CON for invention #1, a legal placeholder conversion (LPC) application is filed as a continuation application off of the LP_CON for invention #1 having a set of claims for invention #5 (LP_CON for invention #5). The LP_CON for invention #5 has a docket number of abc001a05pUScPCC2 where the “2” indicates it is the second consecutive LPC CON filed. A new utility US patent application with claims for an invention #6 is filed having a docket number of abc001a06 (patent for invention #6).

Before the issuance of the LP_CON for invention #5 and the patent for invention #6, a legal placeholder conversion (LPC) application is filed as a continuation-in-part application off of both the LP_CON for invention #5 and the new patent for invention #6 having a set of claims for invention #3 (LP_CIP for invention #3). The LP_CIP for invention #3 has a docket number of abc001a03pUScPCC2pen where “pcn” designates priority from an LPC and an application with a new invention.

Before the issuance of the LP_CIP for invention #3, a continuation application (CON) for invention #6 is filed off of LP_CIP for invention #3 having a docket number of abc001a06pUScPC2pcnC. Before the issuance of the CON for invention #6, a legal placeholder conversion (LPC) application is filed as a continuation-in-part application off of the CON for invention #6 having a set of claims for invention #4 (LP_CIP for invention #4). The LP_CIP for invention #4 has a docket number of abc001a04pUScPC2pcnCpcp.

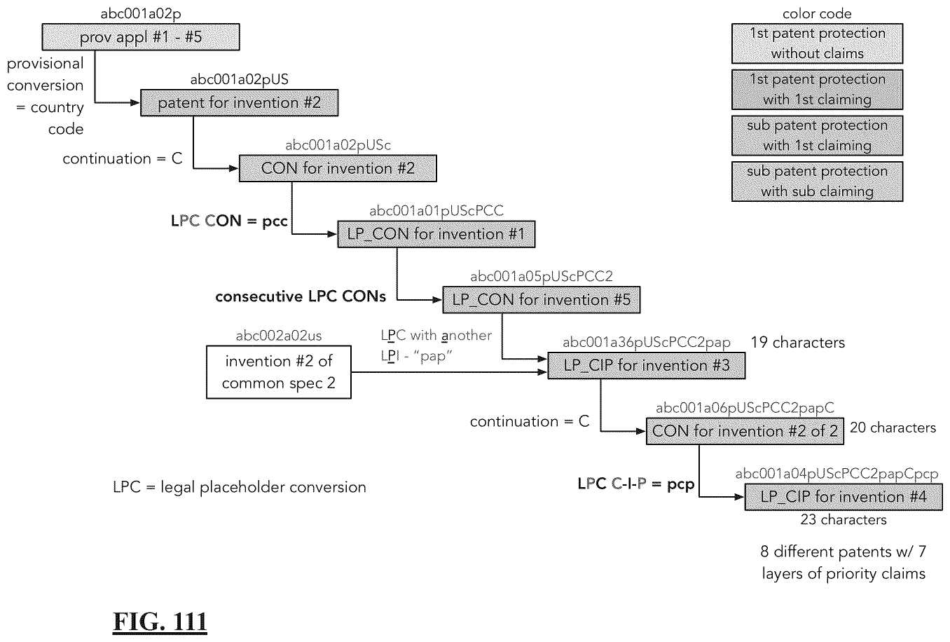

FIG. 111 is a schematic block diagram of another example of a single branch common spec application tree that includes subsequent filing options as recorded within an invention protection database of a private patent tracking database of an improved computer for technology. The example of FIG. 111 is similar to the example of FIG. 110 except that the example of FIG. 111 introduces filing another bundle application with a common specification for at least a new invention #2 (new LPI) and incorporates new LPI #2 material in a subsequent filing.

The initially filed patent application in this example is a provisional patent application that includes a common specification for five inventions (prov appl #1-#5) having a docket number of abc001a02p. After the provisional patent application is filed and prior to its expiration, a provisional conversion patent application with claims for invention 2 (patent for invention #2) is filed having a docket number of abc0001a02pUS. Prior to the issuance of the patent for invention #2, a continuation application (CON) for invention #2 is filed having a docket number of abc001a02pUSc.

Before the issuance of the continuation of invention #2, a legal placeholder conversion (LPC) application is filed as a continuation application off of the CON for invention #2 having a set of claims for invention #1 (LP_CON for invention #1). The LP_CON for invention #1 has a docket number of abc001a01pUScPCC. Before the issuance of the LP_CON for invention #1, a legal placeholder conversion (LPC) application is filed as a continuation application off of the LP_CON for invention #1 having a set of claims for invention #5 (LP_CON for invention #5). The LP_CON for invention #5 has a docket number of abc001a05pUScPCC2 where the “2” indicates it is the second consecutive LPC CON filed. A new bundle application with a common specification and claims for an invention #2 is filed having a docket number of abc002a02 us (patent for invention #2 from the second bundle).

Before the issuance of the LP_CON for invention #5 and the issuance of the patent for invention #2 from second bundle, a legal placeholder conversion (LPC) application is filed as a continuation-in-part application off of both the LP_CON for invention #5 and the patent for invention #2 from second bundle having a set of claims for invention #3 (LP_CIP for invention #3). The LP_CIP for invention #3 has a docket number of abc001a03pUScPCC2pap where “pap” designates priority from an LPC and a legal placeholder invention (LPI) from another bundle.

Before the issuance of the LP_CIP for invention #3, a continuation application (CON) for invention #2 of the second bundle is filed off of LP_CIP for invention #3 having a docket number of abc001a06pUScPCC2papC (where the “06” invention designator refers to the invention #2 of the second bundle). Before the issuance of the CON for invention #2 of the second bundle, a legal placeholder conversion (LPC) application is filed as a continuation-in-part application off of the CON for invention #2 of the second bundle having a set of claims for invention #4 (LP_CIP for invention #4). The LP_CIP for invention #4 has a docket number of abc001a04pUScPCC2papCpcp.

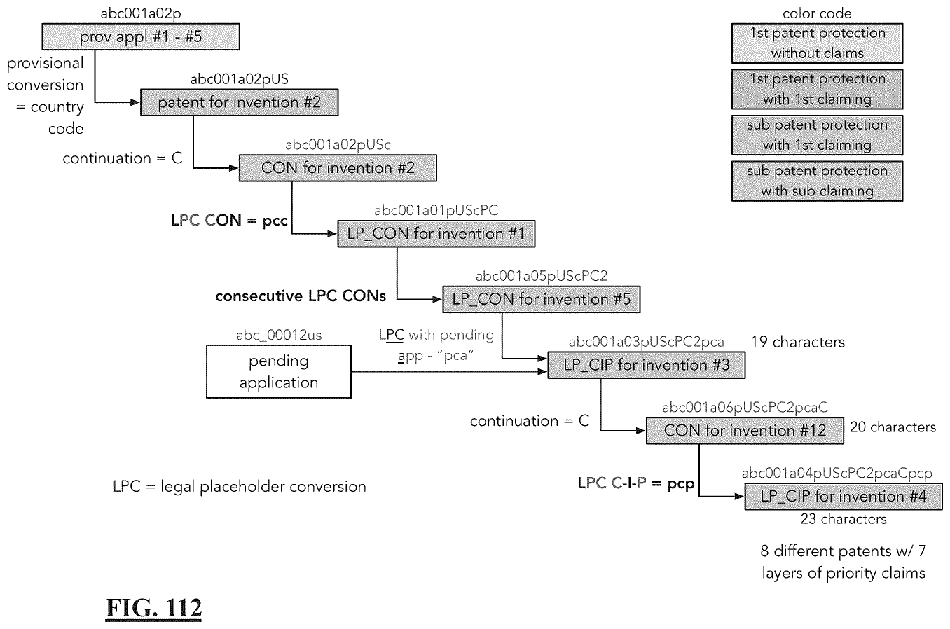

FIG. 112 is a schematic block diagram of another example of a single branch common spec application tree of a provisional patent application that includes subsequent filing options as recorded within an invention protection database of a private patent tracking database of an improved computer for technology. The example of FIG. 112 is similar to the examples of FIGS. 110 and 111 except that the example of FIG. 112 shows claiming priority from a LPC CON in the single branch common spec application tree with a pending application that is not in the single branch common spec application.

The initially filed patent application in this example is a provisional patent application that includes a common specification for five inventions (prov appl #1-#5) having a docket number of abc001a02p. After the provisional patent application is filed and prior to its expiration, a provisional conversion patent application with claims for invention 2 (patent for invention #2) is filed having a docket number of abc0001a02pUS. Prior to the issuance of the patent for invention #2, a continuation application (CON) for invention #2 is filed having a docket number of abc001a02pUSc.

Before the issuance of the continuation of invention #2, a legal placeholder conversion (LPC) application is filed as a continuation application off of the CON for invention #2 having a set of claims for invention #1 (LP_CON for invention #1). The LP_CON for invention #1 has a docket number of abc001a01pUScPCC. Before the issuance of the LP_CON for invention #1, a legal placeholder conversion (LPC) application is filed as a continuation application off of the LP_CON for invention #1 having a set of claims for invention #5 (LP_CON for invention #5). The LP_CON for invention #5 has a docket number of abc001a05pUScPCC2 where the “2” indicates it is the second consecutive LPC CON filed.

Before the issuance of the LP_CON for invention #5 and before the issuance of a pending application outside of the single branch common spec application tree (pending application with docket number abc_00012 us with claims for an invention #12), a legal placeholder conversion (LPC) application is filed as a continuation-in-part application off of both the LP_CON for invention #5 and the pending application. The LP_CIP for invention #3 has a docket number of abc001a03pUScPCC2pca where “pca” designates priority from an LPC and a pending application.

Before the issuance of the LP_CIP for invention #3, a continuation application (CON) for invention #12 is filed off of LP_CIP for invention #3 having a docket number of abc001a06pUScPCC2pcaC where the “06” invention designator refers to invention #12 of the pending application. Before the issuance of the CON for invention #12 of the other pending application, a legal placeholder conversion (LPC) application is filed as a continuation-in-part application off of the CON for invention #12 of pending applications having a set of claims for invention #4 (LP_CIP for invention #4). The LP_CIP for invention #4 has a docket number of abc001a04pUScPCC2papCpcp.

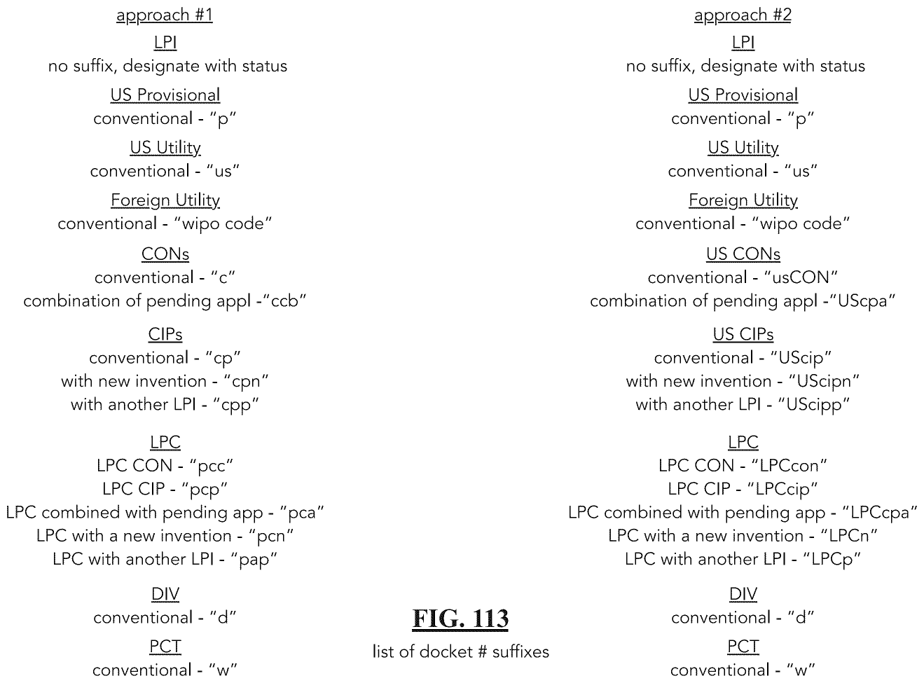

FIG. 113 is a schematic block diagram of another example of two docket number approaches and the corresponding suffixes for records as recorded within an invention protection database of a private patent tracking database of an improved computer for technology. For both approaches #1 and #2, a legal placeholder invention (LPI) is not designated with a suffix but with a status. Further for both approaches #1 and #2, a suffix of “p” designates a conventional US provisional application and a suffix of “us” designates a conventional US utility application. For foreign applications, a suffix of the wipo code for a foreign country designates a foreign utility application.

The suffixes for continuations for approach #1 include “c” for a conventional continuation, and “ccb” for a continuation of a combination of pending applications. The suffixes for continuations-in-part for approach #1 include “cp” for a conventional continuation-in-part, “cpn” for a continuation-in-part with a new invention, and “cpp” for a continuation-in-part with another legal placeholder invention (LPI).

The suffixes for legal placeholder conversion (LPC) applications for approach #1 include “pcc” for a legal placeholder conversion (LPC) application filed as a continuation (LPC_CON), “pcp” for a legal placeholder conversion (LPC) application filed as a continuation-in-part (LPC_CIP), “pcn” for an LPC combined with a pending application with a new invention, and “pap” for an LPC combined with another legal placeholder invention (LPI).

The suffixes for US continuations for approach #2 include “usCON” for a conventional continuation and “UScpa” for a continuation claiming back to a combination of pending applications. The suffixes for US continuations-in-part for approach #2 include “UScip” for a conventional continuation-in-part, “UScipn” for a continuation-in-part with a new invention, and “UScipp” for a continuation-in-part with another legal placeholder invention (LPI).

The suffixes for legal placeholder conversion (LPC) applications for approach #2 include “LPCcon” for a legal placeholder conversion (LPC) application filed as a continuation, “LPCcip” for a legal placeholder conversion (LPC) application filed as a continuation-in-part, “LPCcpa” for an LPC combined with a pending application, “LPCn” for an LPC with a new invention, and “LPCp” for an LPC that includes another legal placeholder invention (LPI).

For both approach #1 and #2, a suffix of “d” designates a divisional (DIV) application and a suffix of “w” designates a PCT application.

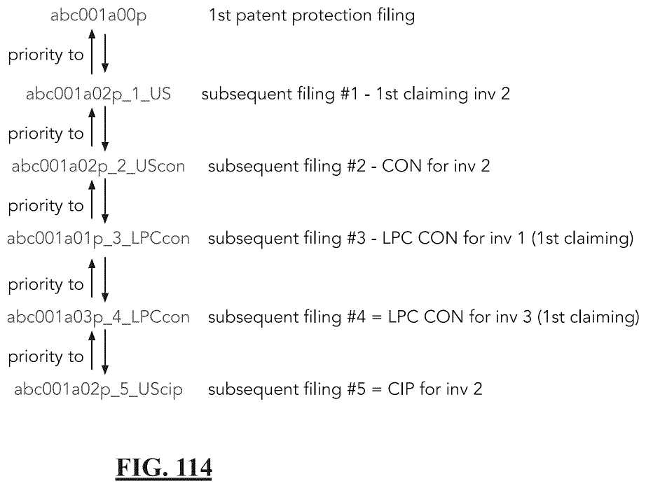

FIG. 114 is a schematic block diagram of another example of a single branch common spec application tree that illustrates the priority of subsequent filing options as recorded within an invention protection database of a private patent tracking database of an improved computer for technology. The example of FIG. 114 is similar to the example of FIG. 106 where the second docket number approach is used for naming the applications in the single branch common spec application tree. The initially filed patent application (1st patent protection filing) is a provisional application that includes a common specification for five inventions and has a docket number of abc001a00p.

The next application filed is a provisional conversion application with claims for invention 2 (subsequent filing #1-1st patent claiming invention 2) having a docket number of abc001a02p_1_US. The 1st patent claiming invention 2 claims priority to the provisional patent. The next application filed is a continuation application with a set of claims for invention 2 (subsequent filing #2-CON for invention #2) having a docket number of abc001a02us_2_UScon. The CON for invention 2 claims priority to the patent claiming invention 2 which claims priority to the provisional patent.

The next application filed is a legal placeholder conversion (LPC) application with a set of claims for invention #1 (subsequent filing #3-LPC CON for invention #1) having a docket number of abc001a01us_3_LPCcon. The LPC CON for invention #1 is filed as a continuation off of the CON for invention #2 and thus claims priority to the CON for invention 2 which claims priority to the patent claiming invention 2 which claims priority to the provisional patent.

The next application filed is a legal placeholder conversion (LPC) application with a set of claims for invention #3 (subsequent filing #4-LPC CON for invention #3) having a docket number of abc001a03us_4_LPCcon. The LPC CON for invention #3 is filed as a continuation off of the LPC CON for invention #1 and thus claims priority to LPC CON for invention #1 which claims priority to the CON for invention 2 which claims priority to the patent claiming invention 2 which claims priority to the provisional patent.

The next application filed is a continuation-in-part application with a set of claims for invention #2 (subsequent filing #5-CIP for invention #2) having a docket number of abc001a02us_5_UScip. The CIP for invention #2 claims priority off of the LPC CON for invention 3 which claims priority to the LPC CON for invention #1 which claims priority to the CON for invention 2 which claims priority to the patent claiming invention 2 which claims priority to the provisional patent.

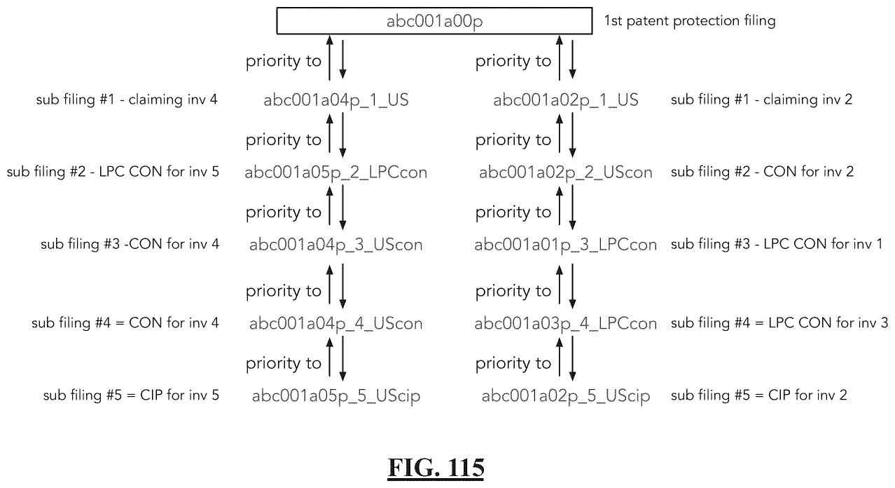

FIG. 115 is a schematic block diagram of another example of a multiple branch common spec application tree that illustrates the priority of subsequent filing options as recorded within an invention protection database of a private patent tracking database of an improved computer for technology. The example of FIG. 115 uses the second docket number approach as described in one or more of the previous Figures. The initially filed patent application (1st patent protection filing) in this example is a provisional application that includes a common specification for five inventions and has a docket number of abc001a00p.

To begin a first branch of the multiple branch common spec application tree, prior to the expiration of the provisional application, a provisional conversion application with claims for invention #4 (subsequent filing #1-claiming invention 4) having a docket number of abc001a04p_1_US is filed. The subsequent filing #1 claiming invention #4 claims priority to the provisional patent.

To begin a second branch of the multiple branch common spec application tree, prior to the expiration of the provisional application, a provisional conversion application with claims for invention 2 (subsequent filing #1-claiming invention 2) having a docket number of abc001a02p_1_US is filed. The subsequent filing #1 claiming invention #2 claims priority to the provisional patent.

The next application filed in the first branch is a legal placeholder conversion (LPC) application with a set of claims for invention #5 (subsequent filing #2-LPC CON for invention #5) having a docket number of abc001a05us_2_LPCcon. The LPC CON for invention #5 is filed as a continuation off of the patent claiming invention #4 which claims priority to the provisional patent.

The next application filed in the first branch is a continuation (CON) application for invention #4 (subsequent filing #3-CON for invention #4) having a docket number of abc001a04us_3_UScon. The CON for invention #4 claims priority to the LPC CON for invention #5 which claims priority to the patent claiming invention #4 which claims priority to the provisional patent.

The next application filed in the first branch is another continuation (CON) application for invention #4 (subsequent filing #4-CON for invention #4) having a docket number of abc001a04us_4_UScon. The CON for invention #4 claims priority to the previous CON for invention #4 which claims priority to the LPC CON for invention #5 which claims priority to the patent claiming invention 4 which claims priority to the provisional patent.

The next application filed in the first branch is a continuation-in-part (CIP) application for invention #5 (subsequent filing #5-CIP for invention #5) having a docket number of abc001a05us_5_UScip. The CIP for invention #5 claims priority to the CON for invention #4 which claims priority to the previous CON for invention #4 which claims priority to the LPC CON for invention #5 which claims priority to the patent claiming invention #4 which claims priority to the provisional patent.

After the subsequent filing #1 of the second branch, the next application filed in the second branch is a continuation (CON) application for invention #2 (subsequent filing #2-CON for invention #2) having a docket number of abc001a02p_2_UScon. The CON for invention #2 claims priority to the patent claiming invention #2 which claims priority to the provisional patent.

The next application filed in the second branch is a legal placeholder conversion (LPC) application with a set of claims for invention #1 (subsequent filing #3-LPC CON for invention #1) having a docket number of abc001a01us_3_LPCcon. The LPC CON for invention #1 is filed as a continuation off of the CON for invention #2 and thus claims priority to the CON for invention 2 which claims priority to the patent claiming invention #2 which claims priority to the provisional patent.

The next application filed in the second branch is a legal placeholder conversion (LPC) application with a set of claims for invention #3 (subsequent filing #4-LPC CON for invention #3) having a docket number of abc001a03us_4_LPCcon. The LPC CON for invention #3 is filed as a continuation off of the LPC CON for invention #1 and thus claims priority to LPC CON for invention #1 which claims priority to the CON for invention #2 which claims priority to the patent claiming invention #2 which claims priority to the provisional patent.

The next application filed in the second branch is a continuation-in-part application with a set of claims for invention #2 (subsequent filing #5-CIP for invention #2) having a docket number of abc001a02us_5_UScip. The CIP for invention #2 claims priority off of the LPC CON for invention #3 which claims priority to the LPC CON for invention #1 which claims priority to the CON for invention #2 which claims priority to the patent claiming invention #2 which claims priority to the provisional patent.

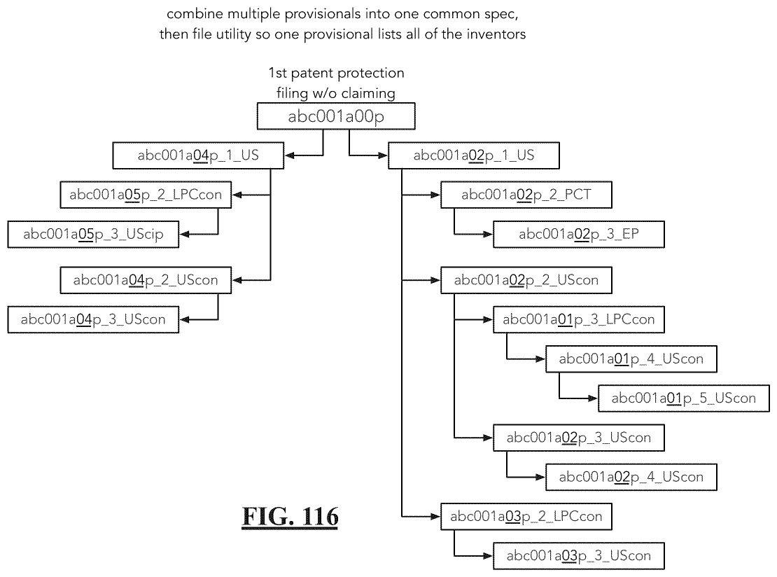

FIG. 116 is a schematic block diagram of another example of a multiple branch common spec application tree that includes subsequent filing options as recorded within an invention protection database of a private patent tracking database of an improved computer for technology. The example of FIG. 116 uses the second docket number approach as described in one or more of the previous Figures. The initially filed patent application (1st patent protection filing without claiming) in this example is a provisional application that includes a common specification for five inventions and has a docket number of abc001a00p. When filing the provisional, all the inventors for the five inventions are listed such that common inventorship exists throughout the multiple branch common spec application tree. Searching the invention protection database for “abc001” will retrieve all records for this common spec.

A first branch of the multiple branch common spec application tree includes a provisional conversion application with claims for invention #4 having a docket number of abc001a04p_1_US. The invention designators are underlined in this example for highlighting. Underlining is not necessary for docket numbering. The first branch further breaks into two subbranches. A legal placeholder conversion (LPC) application with a set of claims for invention #5 having a docket number of abc001a05us_2_LPCcon is filed as a continuation off of the patent claiming invention #4 to start a first subbranch and a continuation (CON) application is filed off of the patent claiming invention #4 having a docket number of abc001a04p_2_UScon to start a second subbranch.

The next application filed in the first subbranch is a continuation-in-part (CIP) application for invention #5 having a docket number of abc001a05us_3_UScip. The next application filed in the second subbranch is another continuation (CON) application for invention #4 having a docket number of abc001a04us_3_UScon.

A second branch of the multiple branch common spec application tree includes a provisional conversion application with claims for invention #2 having a docket number of abc001a02p_1_US. The second branch then further breaks into three subbranches. A PCT application with claims for invention #2 having a docket number of abc001a02p_2_PCT is filed off of the patent for invention #2 to begin the first subbranch. The next application filed in the first subbranch is a European patent off of the PCT application with claims for invention #2 having a docket number of abc001a02p_3_EP where “EP” is the wipo code for Europe.

The next application filed in the second subbranch is a continuation (CON) application for invention #2 having a docket number of abc001a02p_2_UScon. The CON for invention #2 claims priority to the patent claiming invention #2 which claims priority to the provisional patent. The next application filed in the second subbranch is a legal placeholder conversion (LPC) application with a set of claims for invention #1 having a docket number of abc001a01us_3_LPCcon. The LPC CON for invention #1 is filed as a continuation off of the CON for invention #2 and thus claims priority to the CON for invention #2 which claims priority to the patent claiming invention #2 which claims priority to the provisional patent.

The next application filed in the second subbranch is a continuation (CON) application with a set of claims for invention #1 having a docket number of abc001a01us_4_UScon. The CON for invention #1 is filed as a continuation off of the LPC CON for invention #1. The next application filed in the second subbranch is another continuation (CON) application with a set of claims for invention #1 having a docket number of abc001a01us_5_UScon.

A legal placeholder conversion (LPC) application with claims for invention #3 having a docket number of abc001a03p_2_LPCcon is filed off of the patent for invention #2 as a continuation to begin the third subbranch. The next application filed in the third subbranch is a continuation application with a set of claims for invention #3 having a docket number of abc001a03us_3_UScip.

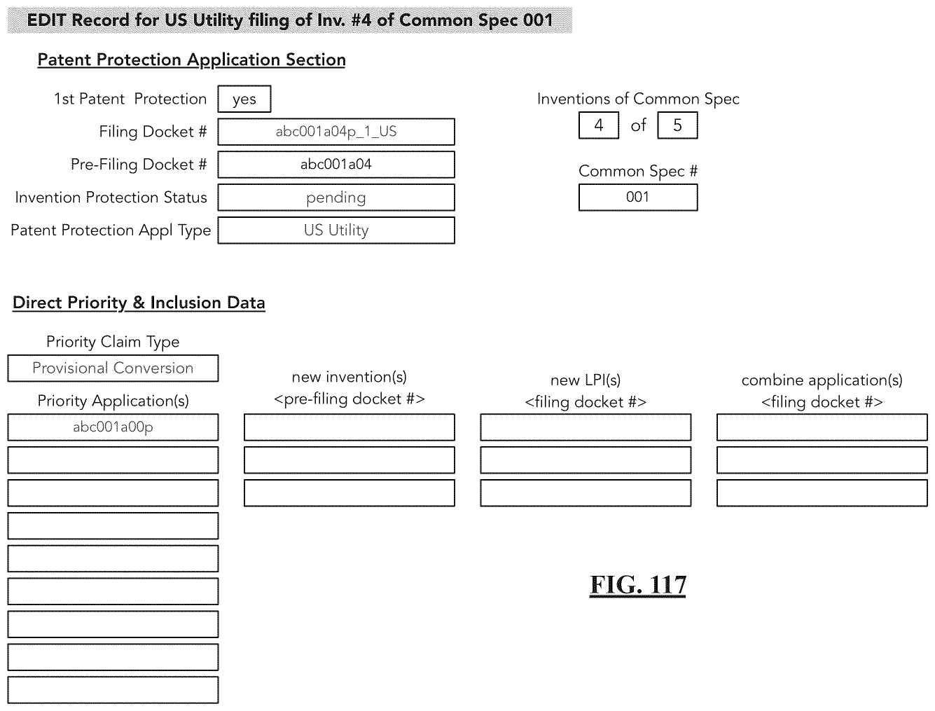

FIG. 117 is a schematic block diagram of an example of editing a record within an invention protection database (of a private patent tracking database of an improved computer for technology) for a provisional conversion application claiming a fourth invention of a common specification (patent application with docket number abc0001a04p_1_Us of FIG. 116). The provisional application that the provisional conversion application with claims for invention 4 claims priority to includes a common specification for five inventions.

The record in this example includes a Patent Protection Application Section and a Direct Priority & Inclusion Data section. The Patent Protection Application Section includes fields for whether the application is a 1st patent protection application (e.g., “yes” or “no”), the Filing Docket #, the Pre-Filing Docket #, the Invention Protection Status, the Patent Protection Application (Appl) Type, the invention of the Common Spec, and the Common Spec #.

In this example, the 1st Patent Protection field is filled as “yes” because it is the first patent application that includes claims for invention #4. The Filing Docket # is abc001a04p_1_US and the Pre-Filing Docket # is abc001a04. The Invention Protection Status is set as pending and the Patent Protection Appl Type is a US Utility application. The Inventions of Common Spec indicates that this application relates to invention #4 out of 5 inventions included in the common spec. The Common Spec # is identified as 001.

The Direct Priority & Inclusion Data section includes fields for the Priority Claim Type, Priority Application(s), new invention(s) (pre-filing docket #), new legal placeholder invention(s) (LPIs) (filing docket #), and combine application(s) (filing docket #). In this example, the Priority Claim Type is a Provisional Conversion application and the Priority Application is the provisional application having a docket number of abc001a00p.

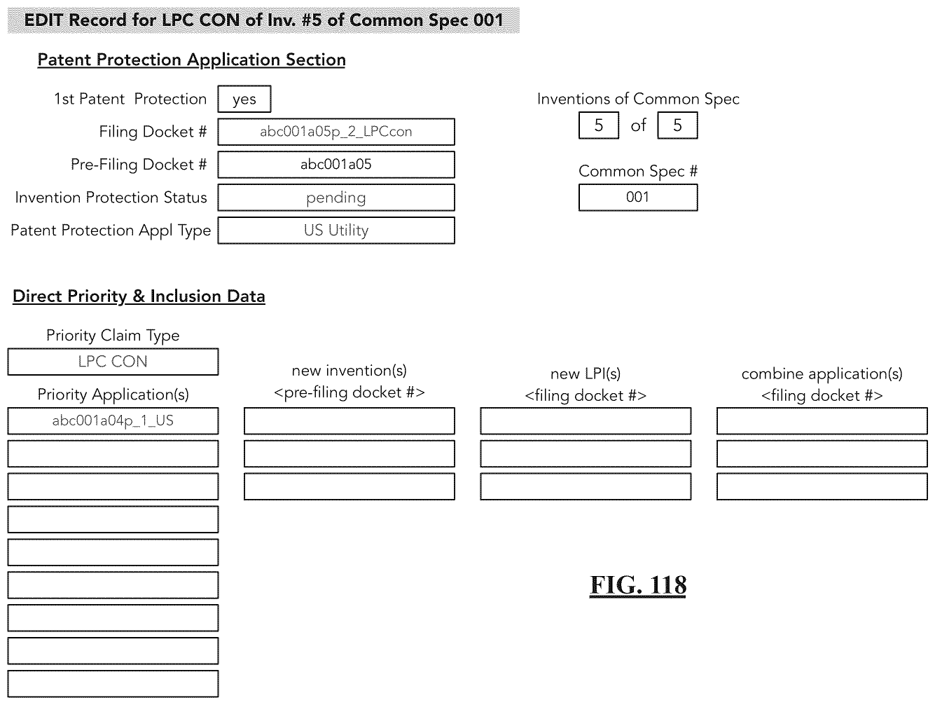

FIG. 118 is a schematic block diagram of an example of editing a record within an invention protection database (of a private patent tracking database of an improved computer for technology) for a legal placeholder conversion (LPC) application with claims for a fifth invention (patent application with docket number abc001a05p_2_LPCcon of FIG. 116) that claims priority to provisional conversion application with claims for invention #4 of FIGS. 116 and 117.

In this example, the 1st Patent Protection field is filled as “yes” because it is the first patent application that includes claims for invention #5. The Filing Docket # is abc001a05p_2_LPCcon and the Pre-Filing Docket # is abc001a05. The Invention Protection Status is set as pending and the Patent Protection Appl Type is a US Utility application. The Inventions of Common Spec indicates that this application relates to invention #5 out of 5 inventions included in the common spec. The Common Spec # is identified as 001. The Priority Claim Type is an LPC CON application and the Priority Application is the provisional conversion application having a docket number of abc001a04p_1_US.

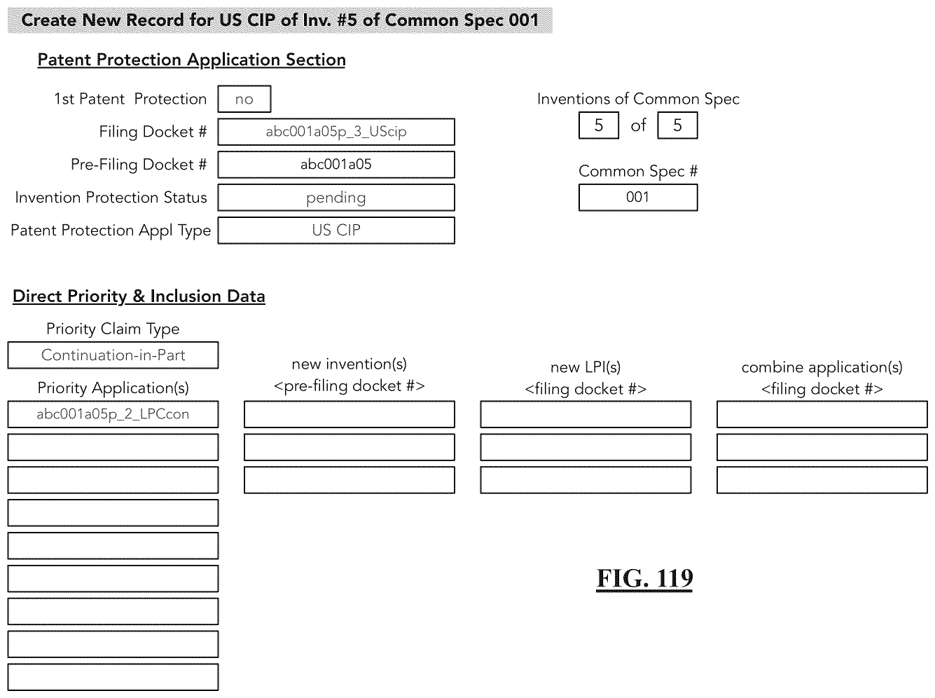

FIG. 119 is a schematic block diagram of an example of creating a record within an invention protection database (of a private patent tracking database of an improved computer for technology) for a continuation-in-part (CIP) application with claims for the fifth invention (patent application with docket number abc001a05p_3_UScip of FIG. 116) that claims priority to the LPC CON application with claims for invention #5 of FIGS. 116 and 118.

In this example, the 1st Patent Protection field is filled as “no” because it is not the first patent application that includes claims for invention #5 in the priority chain. The Filing Docket # is abc001a05p_3_UScip and the Pre-Filing Docket # is abc001a05. The Invention Protection Status is set as pending and the Patent Protection Appl Type is a US CIP. The Inventions of Common Spec indicates that this application relates to invention #5 out of 5 inventions included in the common spec. The Common Spec # is identified as 001. The Priority Claim Type is a Continuation-in-Part application and the Priority Application is the LPC CON application having a docket number of abc001a05p_2_LPCcon.

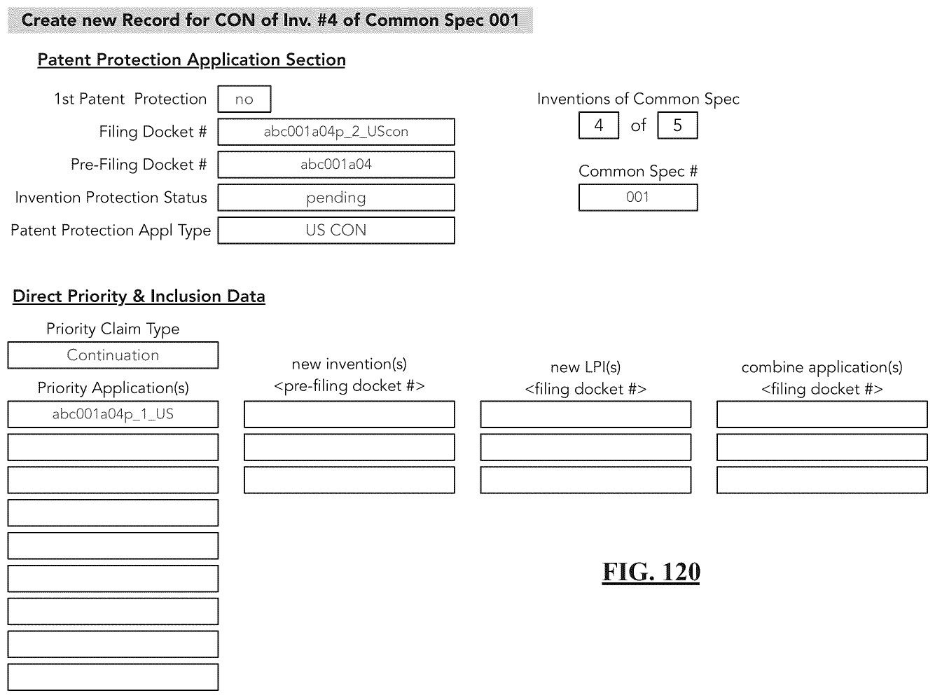

FIG. 120 is a schematic block diagram of an example of creating a record within an invention protection database (of a private patent tracking database of an improved computer for technology) for a continuation (CON) application with claims for the fourth invention (patent application with docket number abc001a04p_2_UScon of FIG. 116) that claims priority to the provisional conversion application claiming a fourth invention of a common specification (patent application with docket number abc001a04p_1_Us of FIG. 116).

In this example, the 1st Patent Protection field is filled as “no” because it is not the first patent application that includes claims for invention #4 in the priority chain. The Filing Docket # is abc001a04p_2_UScon and the Pre-Filing Docket # is abc001a04. The Invention Protection Status is set as pending and the Patent Protection Appl Type is a US CON. The Inventions of Common Spec indicates that this application relates to invention #4 out of 5 inventions included in the common spec. The Common Spec # is identified as 001. The Priority Claim Type is a Continuation application and the Priority Application is the legal placeholder conversion application having a docket number of abc001a04p_1_US.

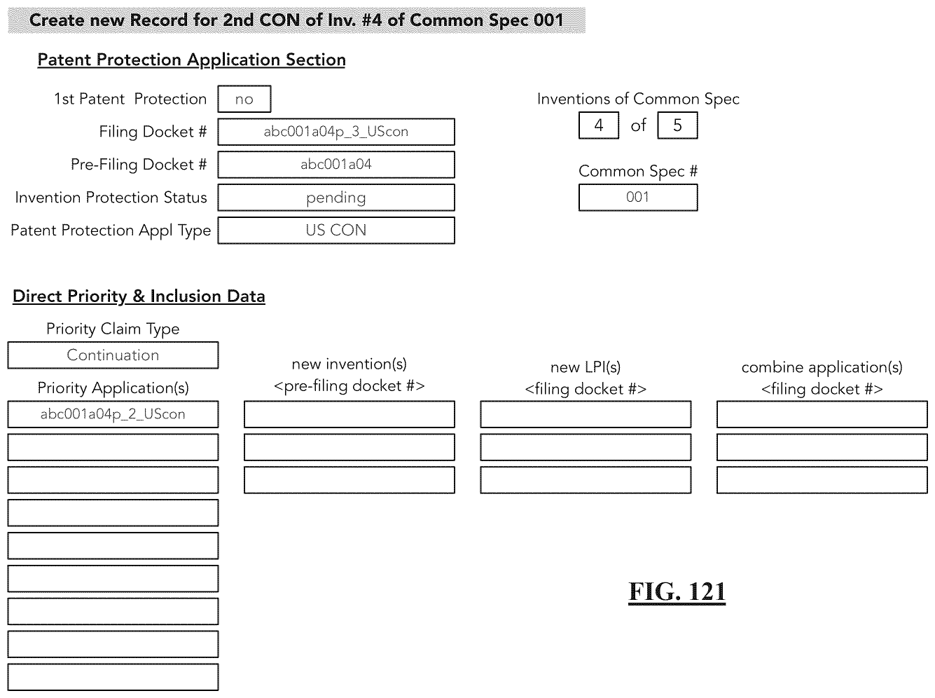

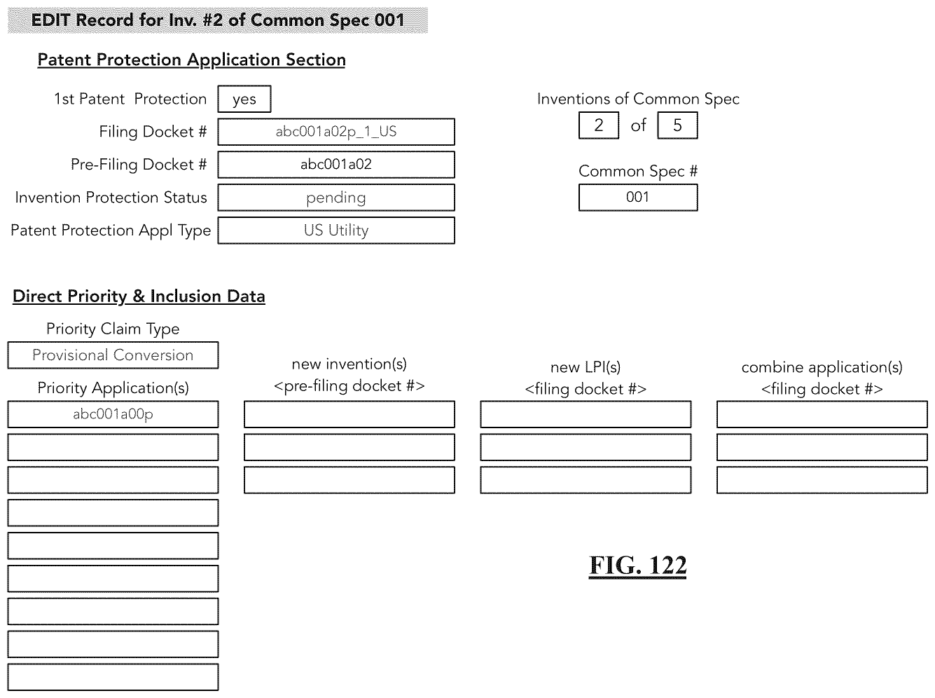

FIG. 121 is a schematic block diagram of an example of creating a record within an invention protection database (of a private patent tracking database of an improved computer for technology) for another continuation (CON) application with claims for the fourth invention (patent application with docket number abc001a04p_3_UScon of FIG. 116) that claims priority to the provisional conversion application claiming a fourth invention of a common specification (patent application with docket number abc001a04p_1_Us of FIG. 116).

In this example, the 1st Patent Protection field is filled as “no” because it is not the first patent application that includes claims for invention #4 in the priority chain. The Filing Docket # is abc001a04p_3_UScon and the Pre-Filing Docket # is abc001a04. The Invention Protection Status is set as pending and the Patent Protection Appl Type is a US CON. The Inventions of Common Spec indicates that this application relates to invention #4 out of 5 inventions included in the common spec. The Common Spec # is identified as 001. The Priority Claim Type is a Continuation application and the Priority Application is the legal placeholder conversion application having a docket number of abc001a04p_2_US.

FIG. 122 is a schematic block diagram of an example of editing a record within an invention protection database (of a private patent tracking database of an improved computer for technology) for a for a provisional conversion application claiming a second invention of a common specification (patent application with docket number abc001a02p_1_Us of FIG. 116). The provisional application that the provisional conversion application with claims for invention #2 claims priority to includes a common specification for five inventions.

In this example, the 1st Patent Protection field is filled as “yes” because it is the first patent application that includes claims for invention #2. The Filing Docket # is abc001a02p_1_US and the Pre-Filing Docket # is abc001a02. The Invention Protection Status is set as pending and the Patent Protection Appl Type is a US Utility application. The Inventions of Common Spec indicates that this application relates to invention #2 out of 5 inventions included in the common spec. The Common Spec # is identified as 001. The Priority Claim Type is a Provisional Conversion application and the Priority Application is the provisional application having a docket number of abc001a00p.

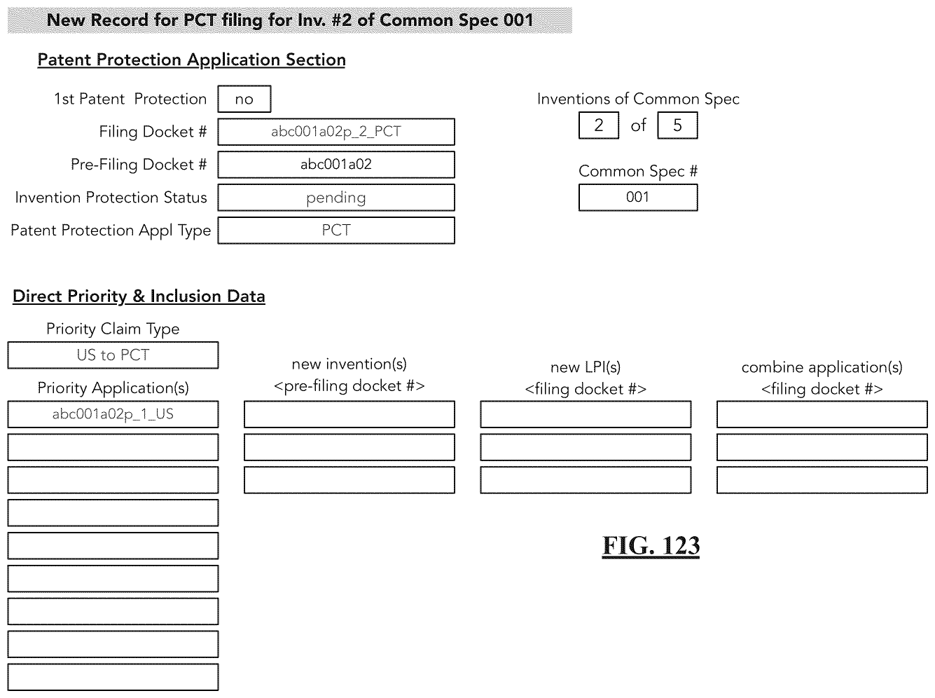

FIG. 123 is a schematic block diagram of an example of creating a record within an invention protection database (of a private patent tracking database of an improved computer for technology) for a PCT application with claims for a second invention (patent application with docket number abc001a02p_2_PCT of FIG. 116) that claims priority to the provisional conversion application claiming a second invention of a common specification (patent application with docket number abc001a02p_1_Us of FIG. 116).

In this example, the 1st Patent Protection field is filled as “no” because it is not the first patent application that includes claims for invention #2 in the priority chain. The Filing Docket # is abc001a02p_2_PCT and the Pre-Filing Docket # is abc001a02. The Invention Protection Status is set as pending and the Patent Protection Appl Type is a PCT. The Inventions of Common Spec indicates that this application relates to invention #2 out of 5 inventions included in the common spec. The Common Spec # is identified as 001. The Priority Claim Type is a US to PCT application and the Priority Application is the legal placeholder conversion application having a docket number of abc001a02p_1_US.

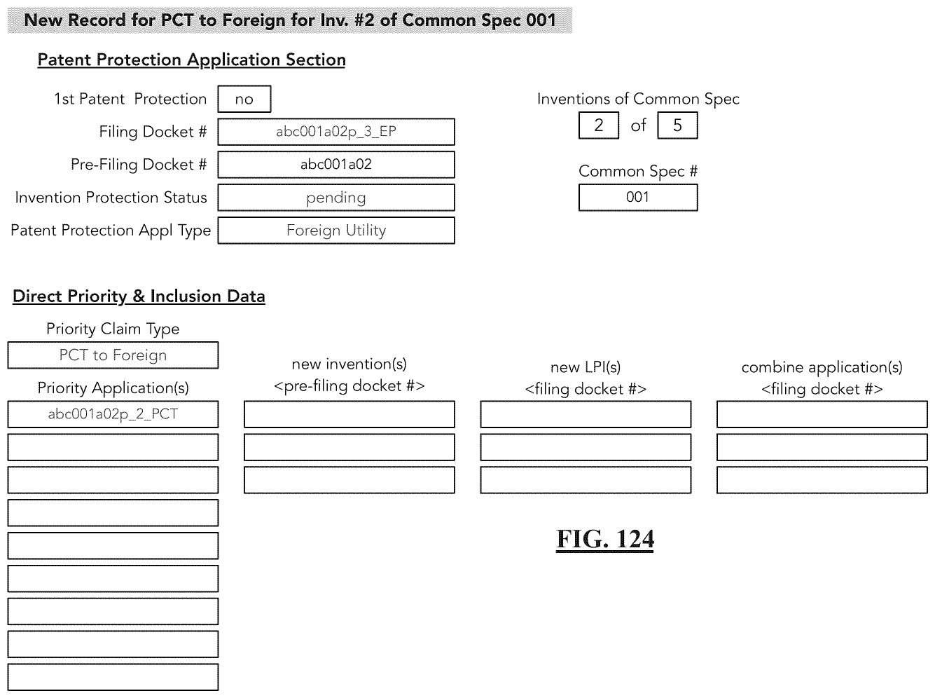

FIG. 124 is a schematic block diagram of an example of creating a record within an invention protection database (of a private patent tracking database of an improved computer for technology) for a for a European patent application with claims for the second invention (patent application with docket number abc001a02p_3_EP of FIG. 116) that claims priority to the PCT patent application claiming a second invention of a common specification (patent application with docket number abc001a02p_2_PCT of FIG. 116).

In this example, the 1st Patent Protection field is filled as “no” because it is not the first patent application that includes claims for invention #2 in the priority chain. The Filing Docket # is abc001a02p_2_EP and the Pre-Filing Docket # is abc001a02. The Invention Protection Status is set as pending and the Patent Protection Appl Type is a Foreign Utility patent application. The Inventions of Common Spec indicates that this application relates to invention #2 out of 5 inventions included in the common spec. The Common Spec # is identified as 001. The Priority Claim Type is a PCT to Foreign application and the Priority Application is the PCT application having a docket number of abc001a02p_2_PCT.

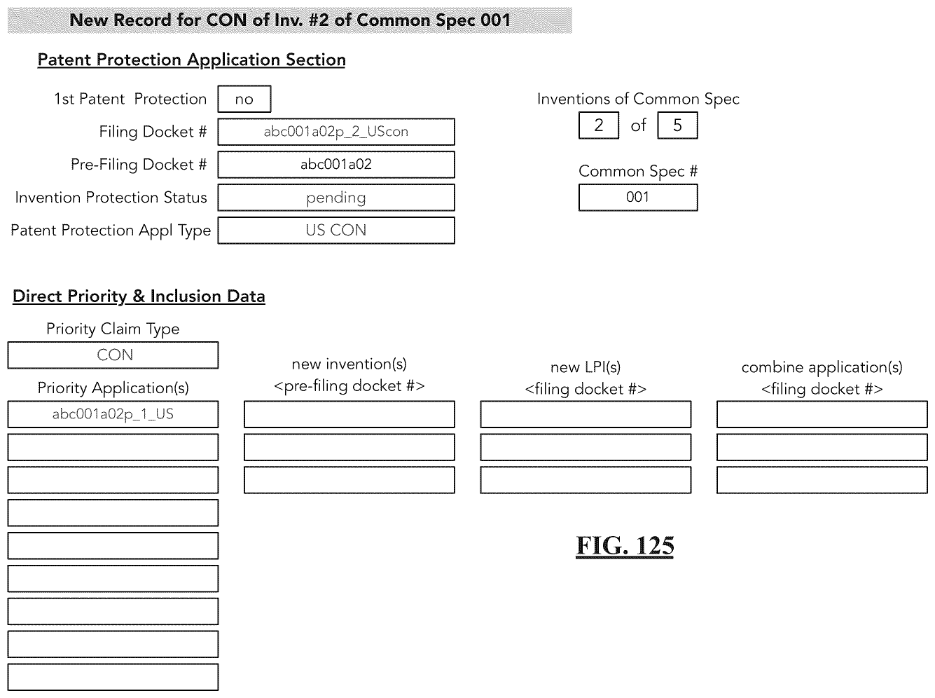

FIG. 125 is a schematic block diagram of an example of creating a record within an invention protection database (of a private patent tracking database of an improved computer for technology) for a for a continuation (CON) application with claims for a second invention (patent application with docket number abc001a02p_2_UScon of FIG. 116) that claims priority to the provisional conversion application claiming a second invention of a common specification (patent application with docket number abc001a02p_1_Us of FIG. 116).

In this example, the 1st Patent Protection field is filled as “no” because it is not the first patent application that includes claims for invention #2 in the priority chain. The Filing Docket # is abc001a02p_2_UScon and the Pre-Filing Docket # is abc001a02. The Invention Protection Status is set as pending and the Patent Protection Appl Type is a US CON. The Inventions of Common Spec indicates that this application relates to invention #2 out of 5 inventions included in the common spec. The Common Spec # is identified as 001. The Priority Claim Type is a CON application and the Priority Application is the legal placeholder conversion application having a docket number of abc001a02p_1_US.

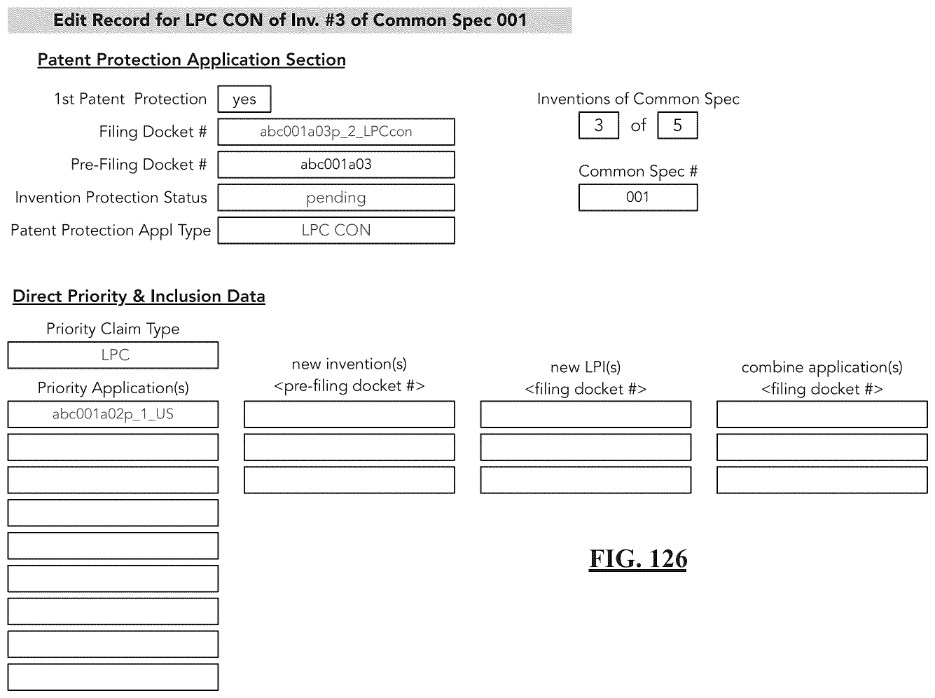

FIG. 126 is a schematic block diagram of an example of editing a record within an invention protection database (of a private patent tracking database of an improved computer for technology) for a for a legal placeholder conversion (LPC) application with claims for a third invention (patent application with docket number abc001a03p_2_LPCcon of FIG. 116) that claims priority to the provisional conversion application claiming a second invention of a common specification (patent application with docket number abc001a02p_1_Us of FIG. 116).

In this example, the 1st Patent Protection field is filled as “yes” because it is the first patent application that includes claims for invention #3 in the priority chain. The Filing Docket # is abc001a03p_2_LPCcon and the Pre-Filing Docket # is abc001a03. The Invention Protection Status is set as pending and the Patent Protection Appl Type is a US CON. The Inventions of Common Spec indicates that this application relates to invention #3 out of 5 inventions included in the common spec. The Common Spec # is identified as 001. The Priority Claim Type is an LPC application and the Priority Application is the legal placeholder conversion application having a docket number of abc001a02p_1_US.

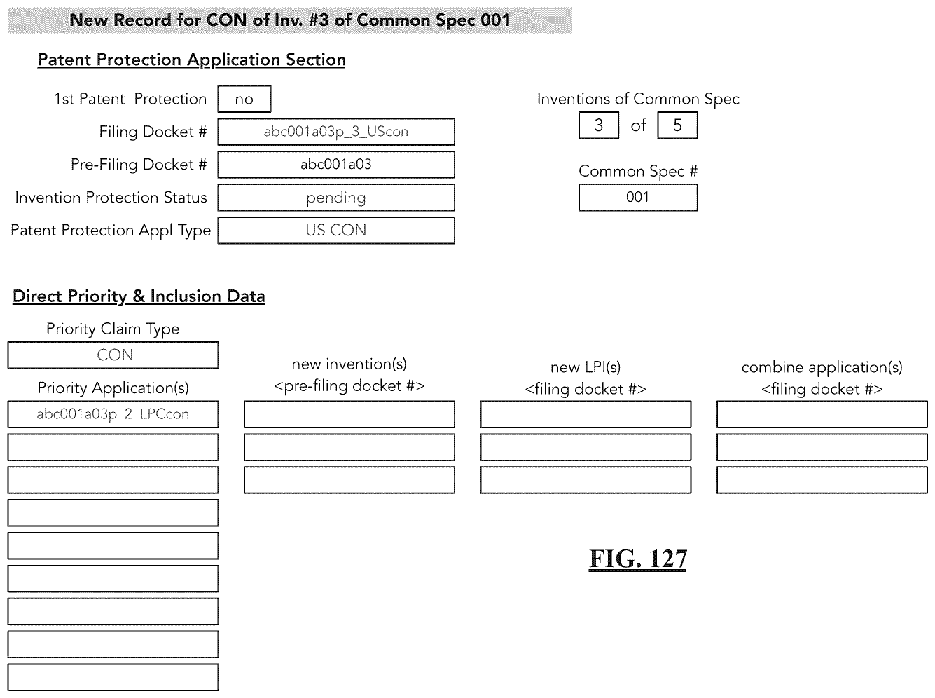

FIG. 127 is a schematic block diagram of an example of creating a record within an invention protection database (of a private patent tracking database of an improved computer for technology) for a for a continuation (CON) application with claims for a third invention (patent application with docket number abc001a03p_3_UScon of FIG. 116) that claims priority to the LPC CON application claiming a third invention of a common specification (patent application with docket number abc001a03p_2_LCPcon of FIG. 116).

In this example, the 1st Patent Protection field is filled as “no” because it is not the first patent application that includes claims for invention #3 in the priority chain. The Filing Docket # is abc001a03p_3_UScon and the Pre-Filing Docket # is abc001a03. The Invention Protection Status is set as pending and the Patent Protection Appl Type is a US CON. The Inventions of Common Spec indicates that this application relates to invention #3 out of 5 inventions included in the common spec. The Common Spec # is identified as 001. The Priority Claim Type is a CON application and the Priority Application is the legal placeholder conversion application having a docket number of abc001a03p_2_LPCcon.

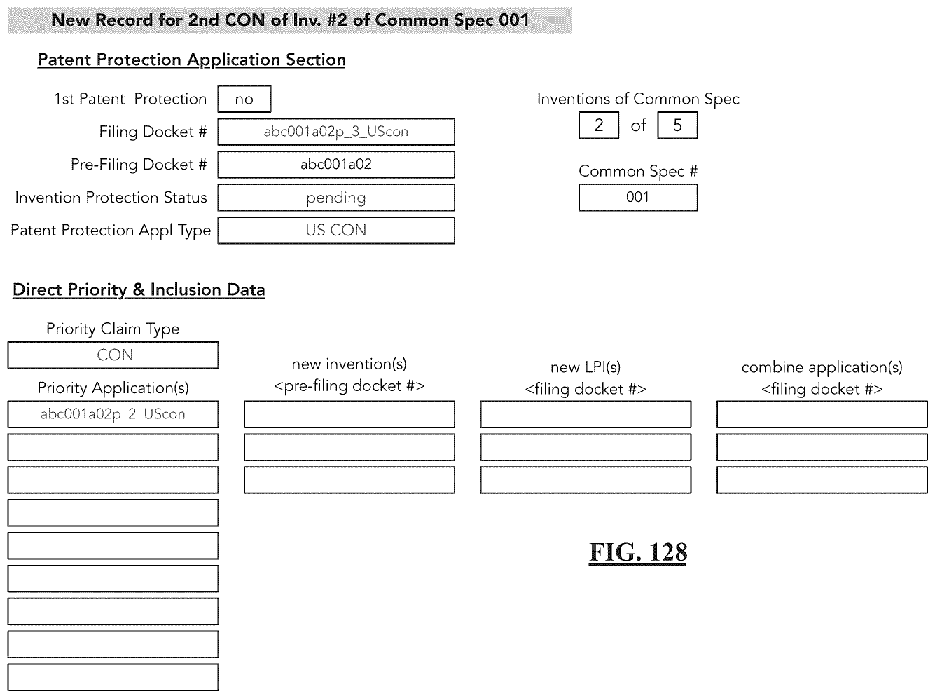

FIG. 128 is a schematic block diagram of an example of creating a record within an invention protection database (of a private patent tracking database of an improved computer for technology)) for a continuation (CON) application with claims for a second invention (patent application with docket number abc001a02p_3_UScon of FIG. 116) that claims priority to the LPC CON application claiming a second invention of a common specification (patent application with docket number abc001a02p_2_UScon of FIG. 116).

In this example, the 1st Patent Protection field is filled as “no” because it is not the first patent application that includes claims for invention #2 in the priority chain. The Filing Docket # is abc001a02p_3_UScon and the Pre-Filing Docket # is abc001a02. The Invention Protection Status is set as pending and the Patent Protection Appl Type is a US CON. The Inventions of Common Spec indicates that this application relates to invention #2 out of 5 inventions included in the common spec. The Common Spec # is identified as 001. The Priority Claim Type is a CON application and the Priority Application is the continuation application having a docket number of abc001a02p_2_UScon.

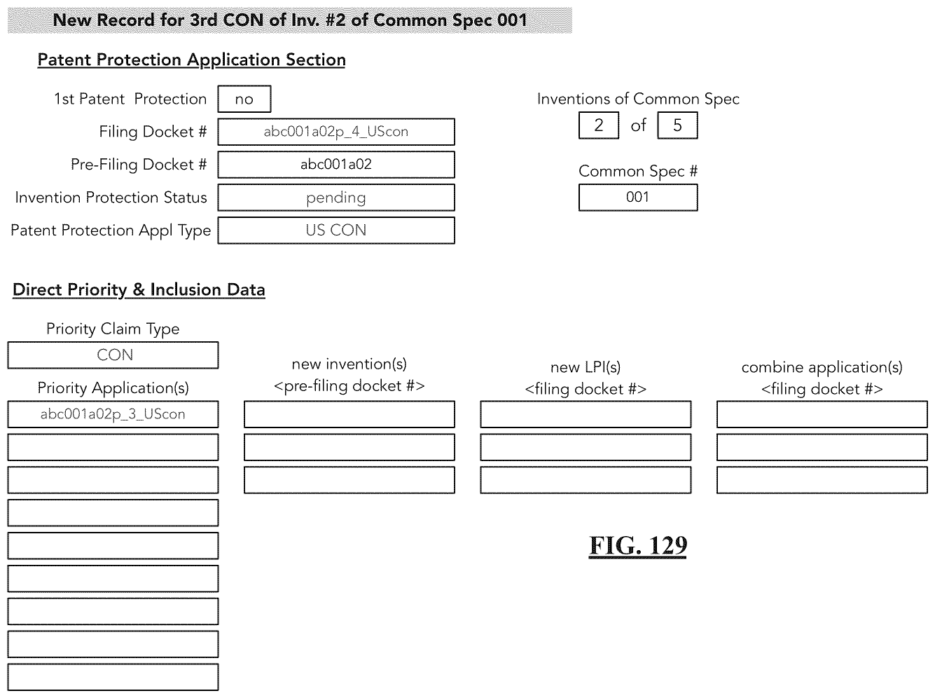

FIG. 129 is a schematic block diagram of an example of creating a record within an invention protection database (of a private patent tracking database of an improved computer for technology) for another continuation (CON) application with claims for a second invention (patent application with docket number abc001a02p_4_UScon of FIG. 116) that claims priority to the continuation application claiming a second invention of a common specification (patent application with docket number abc001a02p_3_UScon of FIG. 116).

In this example, the 1st Patent Protection field is filled as “no” because it is not the first patent application that includes claims for invention #2 in the priority chain. The Filing Docket # is abc001a02p_4_UScon and the Pre-Filing Docket # is abc001a02. The Invention Protection Status is set as pending and the Patent Protection Appl Type is a US CON. The Inventions of Common Spec indicates that this application relates to invention #2 out of 5 inventions included in the common spec. The Common Spec # is identified as 001. The Priority Claim Type is a CON application, and the Priority Application is the continuation application having a docket number of abc001a02p_3_UScon.

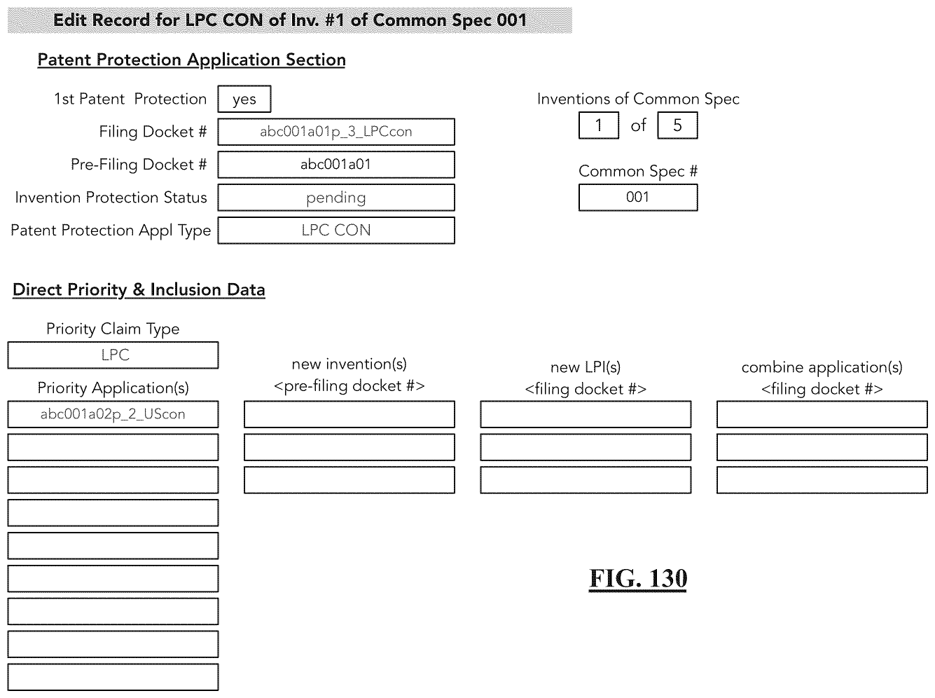

FIG. 130 is a schematic block diagram of an example of editing a record within an invention protection database (of a private patent tracking database of an improved computer for technology) for a for a legal placeholder conversion (LPC) application with claims for a first invention (patent application with docket number abc001a01p_3_LPCcon of FIG. 116) that claims priority to the CON application claiming a second invention of a common specification (patent application with docket number abc001a02p_2_UScon of FIG. 116).

In this example, the 1st Patent Protection field is filled as “yes” because it is the first patent application that includes claims for invention #1 in the priority chain. The Filing Docket # is abc001a01p_3_LPCcon and the Pre-Filing Docket # is abc001a01. The Invention Protection Status is set as pending and the Patent Protection Appl Type is a LPC CON. The Inventions of Common Spec indicates that this application relates to invention #1 out of 5 inventions included in the common spec. The Common Spec # is identified as 001. The Priority Claim Type is an LPC application and the Priority Application is the continuation application having a docket number of abc001a02p_2_UScon.

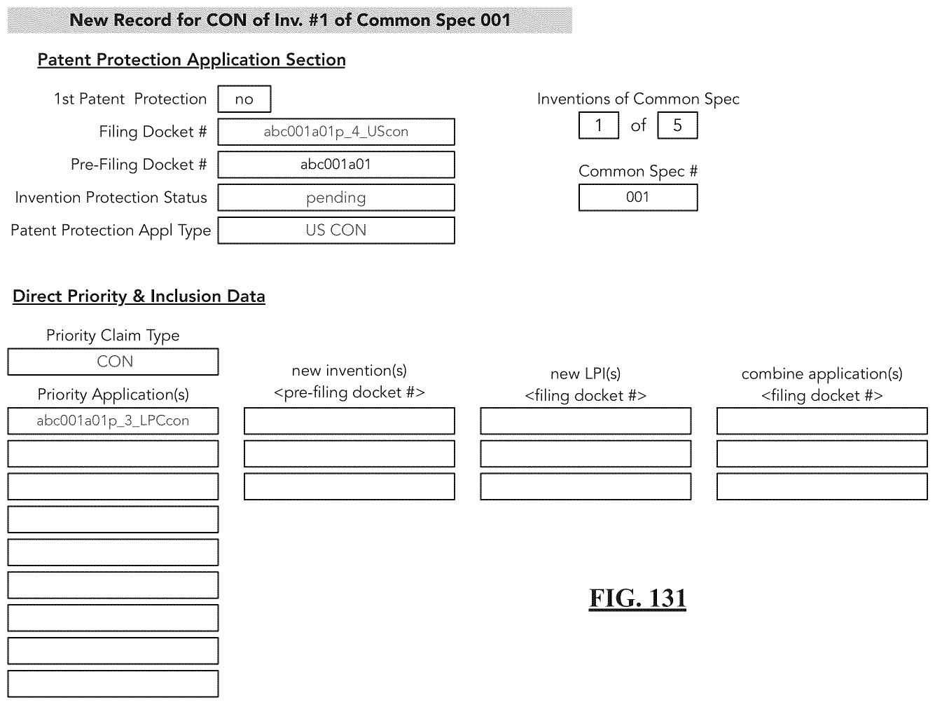

FIG. 131 is a schematic block diagram of an example of creating a record within an invention protection database (of a private patent tracking database of an improved computer for technology) for another continuation (CON) application with claims for a first invention (patent application with docket number abc001a01p_4_UScon of FIG. 116) that claims priority to the LPC CON application claiming a first invention of a common specification (patent application with docket number abc001a01p_3_LPCcon of FIG. 116).

In this example, the 1st Patent Protection field is filled as “no” because it is not the first patent application that includes claims for invention #1 in the priority chain. The Filing Docket # is abc001a01p_4_UScon and the Pre-Filing Docket # is abc001a01. The Invention Protection Status is set as pending and the Patent Protection Appl Type is a US CON. The Inventions of Common Spec indicates that this application relates to invention #1 out of 5 inventions included in the common spec. The Common Spec # is identified as 001. The Priority Claim Type is a CON application, and the Priority Application is the LPC CON application having a docket number of abc001a01p_3_UScon.

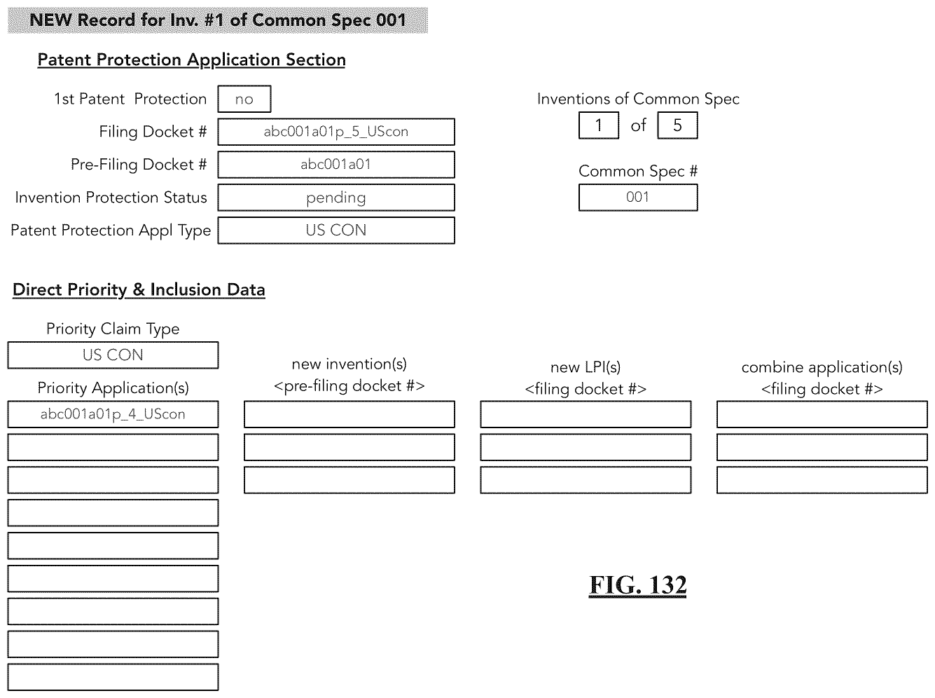

FIG. 132 is a schematic block diagram of an example of creating a record within an invention protection database (of a private patent tracking database of an improved computer for technology) for another continuation (CON) application with claims for a first invention (patent application with docket number abc001a01p_5_UScon of FIG. 116) that claims priority to the continuation application claiming a first invention of a common specification (patent application with docket number abc001a01p_4_UScon of FIG. 116).

In this example, the 1st Patent Protection field is filled as “no” because it is not the first patent application that includes claims for invention #1 in the priority chain. The Filing Docket # is abc001a01p_5_UScon and the Pre-Filing Docket # is abc001a01. The Invention Protection Status is set as pending and the Patent Protection Appl Type is a US CON. The Inventions of Common Spec indicates that this application relates to invention #1 out of 5 inventions included in the common spec. The Common Spec # is identified as 001. The Priority Claim Type is a CON application, and the Priority Application is the continuation application having a docket number of abc001a01p_4_UScon.

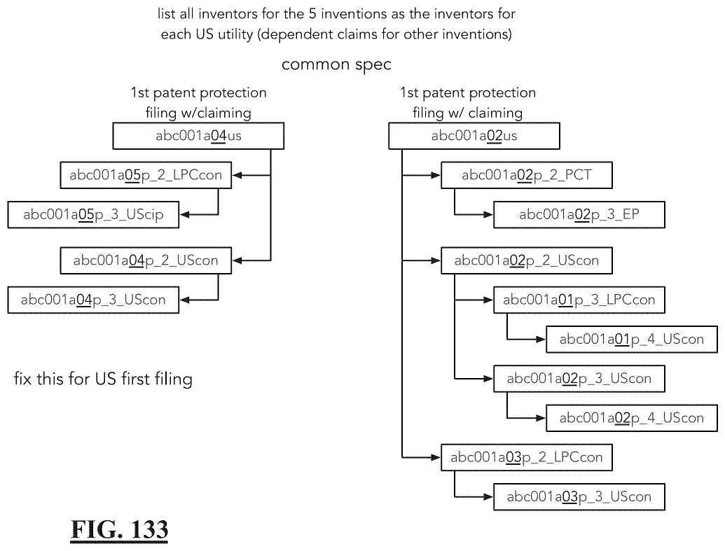

FIG. 133 is a schematic block diagram of another example of a multiple branch common spec application tree that shows subsequent filing options of two US utility patents as recorded within an invention protection database of a private patent tracking database of an improved computer for technology.

In FIG. 133, the initially filed patent applications (1st patent protection filing with claiming) are both US utility patent applications that include a common specification for five inventions. A first patent application is filed with claims for invention #4 and has a docket number of abc001a04 us. A second patent application is filed with claims for invention #2 and has a docket number of abc001a02 us. The inventors for the five inventions are listed in each application such that common inventorship exists throughout the multiple branch common spec application tree. Searching the invention protection database for “abc001” will retrieve all records for this common spec.

A first branch of the multiple branch common spec application tree includes a legal placeholder conversion (LPC) application with a set of claims for invention #5 having a docket number of abc001a05us_2_LPCcon filed as a continuation off of the patent claiming invention #4 to start a first subbranch and a continuation (CON) application filed off of the patent claiming invention #4 having a docket number of abc001a04p_2_UScon to start a second subbranch.

The next application filed in the first subbranch is a continuation-in-part (CIP) application for invention #5 having a docket number of abc001a05us_3_UScip. The next application filed in the second subbranch is another continuation (CON) application for invention #4 having a docket number of abc001a04us_3_UScon.

A second branch of the multiple branch common spec application tree includes a PCT application with claims for invention #2 having a docket number of abc001a02p_2_PCT filed off of the patent for invention #2 to begin a first subbranch. The next application filed in the first subbranch is a European patent off of the PCT application with claims for invention #2 having a docket number of abc001a02p_3_EP where “EP” is the wipo code for Europe.

The second branch of the multiple branch common spec application tree further includes a continuation (CON) application for invention #2 having a docket number of abc001a02p_2_UScon filed off of the patent for invention #2 to begin a second subbranch. The next applications filed in the second subbranch are a legal placeholder conversion (LPC) application for invention #1 having a docket number of abc001a01p_3_LPCcon and a continuation (CON) application for invention #2 having a docket number of abc001a02p_3_UScon. A CON application is filed off of the LPC application for invention #1 with claims for invention #1 and a docket number of abc001a01p_4_UScon. A CON application is also filed off of the CON application for invention #2 with claims for invention #2 and a docket number of abc001a02p_4_UScon.

The second branch of the multiple branch common spec application tree further includes a legal placeholder conversion (LPC) application with a set of claims for invention #3 and a docket number of abc001a03us_2_LPCcon and is filed as a continuation off of the patent for invention #2 to begin a third subbranch. A CON application is filed off of the LPC application for invention #3 with claims for invention #3 and a docket number of abc001a03p_4_UScon.

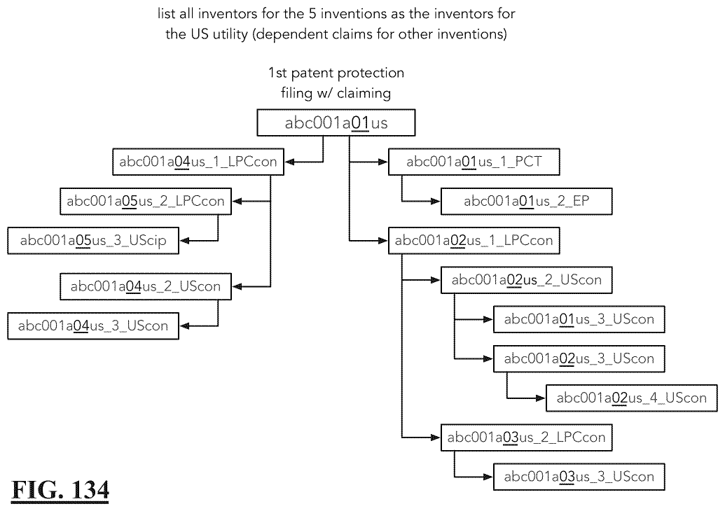

FIG. 134 is a schematic block diagram of another example of a multiple branch common spec application tree that includes subsequent filing options of a US utility patent as recorded within an invention protection database of a private patent tracking database of an improved computer for technology.

In FIG. 134, the initially filed US utility patent application (1st patent protection filing with claiming) includes a common specification for five inventions and claims for invention #1. The patent application includes a docket number of abc001a0lus. The inventors for the five inventions are listed in the application such that common inventorship exists through the multiple branch common spec application tree.

A first branch of the multiple branch common spec application tree includes a legal placeholder conversion (LPC) application with a set of claims for invention #4 having a docket number of abc001a04us_1_LPCcon filed as a continuation off of the patent claiming invention #1 to start a first subbranch and a continuation (CON) application filed off of the patent claiming invention #4 having a docket number of abc001a04us_2_UScon to start a second subbranch.

The next application filed in the first subbranch is a legal placeholder conversion (LPC) application for invention #5 having a docket number of abc001a05us_3_LPCcon. The next application filed in the first subbranch is a continuation-in-part (CIP) application for invention #5 having a docket number of abc001a05us_3_UScip. The next application filed in the second subbranch is a continuation (CON) application for invention #4 having a docket number of abc001a04us_3_UScon.

A second branch of the multiple branch common spec application tree includes a PCT application with claims for invention #1 having a docket number of abc001a0lus_1_PCT filed off of the patent for invention #1 to begin a first subbranch. The next application filed in the first subbranch is a European patent off of the PCT application with claims for invention #1 having a docket number of abc001a0lus_2_EP where “EP” is the wipo code for Europe.

The second branch of the multiple branch common spec application tree further includes a legal placeholder conversion (LPC) application for invention #2 having a docket number of abc001a02us_1_LPCcon filed off of the patent for invention #1 to begin a second subbranch. The next applications filed in the second subbranch are a continuation (CON) application for invention #2 having a docket number of abc001a02us_2_UScon and a legal placeholder conversion (LPC) application for invention #3 having a docket number of abc001a03us_2_LPCcon.

Two CON applications are filed off of the CON application for invention #2. The first CON application has claims for invention #1 and a docket number of abc001a01us_3_UScon. The second CON application has claims for invention #2 and a docket number of abc001a02us_3_UScon. A CON application is filed off of the second CON application with claims for invention #2 and a docket number of abc001a02us_4_UScon. A CON application is also filed off of the LPC application for invention #3 with claims for invention #3 and a docket number of abc001a03us_3_UScon.

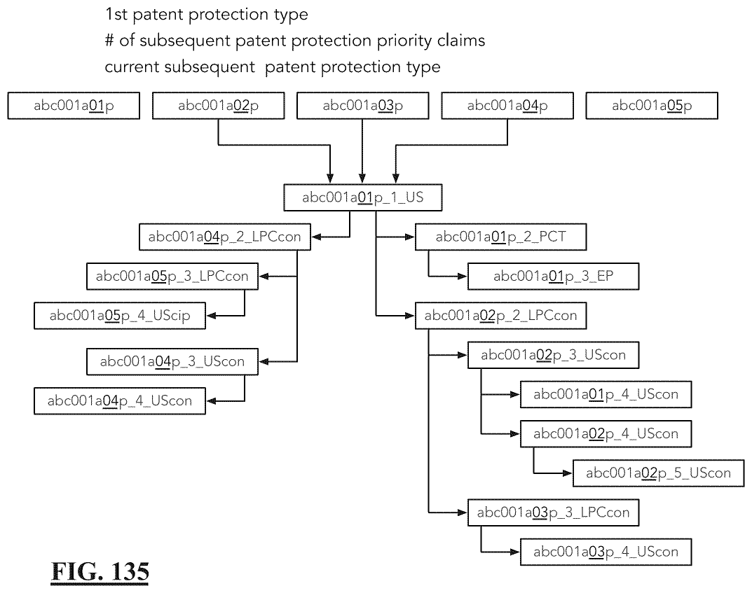

FIG. 135 is a schematic block diagram of another example of a multiple branch common spec application tree that includes subsequent filing options as recorded within an invention protection database of a private patent tracking database of an improved computer for technology. In this example, multiple provisional patent applications are converted into a US utility application that includes a common spec for five inventions.

For example, a first provisional patent application includes a spec for invention #1 and a docket number of abc001a01p, a second provisional patent application includes a spec for invention #2 and a docket number of abc001a02p, a third provisional patent application includes a spec for invention #3 and a docket number of abc001a03p, a fourth provisional patent application includes a spec for invention #4 and a docket number of abc001a04p, and a fifth provisional patent application includes a spec for invention #5 and a docket number of abc001a05p.

The provisional applications are converted into a provisional conversion patent application with a common spec for inventions #1-#5 and claims for invention #1 that has a docket number of abc001a01p_1_US. A first branch of the multiple branch common spec application tree includes a legal placeholder conversion (LPC) application with a set of claims for invention #4 having a docket number of abc001a04p_2_LPCcon filed as a continuation off of the provisional conversion patent application claiming invention 1. A legal placeholder conversion (LPC) application with claims for invention #5 (with a docket number of abc001a05p_3_LPCcon) and a continuation (CON) application with claims for invention #4 (with a docket number of abc001a04p_3_UScon) are filed off of the continuation application with claims for invention #4 (docket #abc001a04us_2_LPCcon).

A continuation-in-part (CIP) application for invention #5 having a docket number of abc001a05p_4_UScip is filed off of the LPC application with claims for invention #5 (docket #abc001a05p_3_LPCcon). A continuation (CON) application for invention #4 having a docket number of abc001a04p_4_UScon is filed off of the continuation (CON) application with claims for invention #4 (docket #abc001a04p_3_UScon).

A second branch of the multiple branch common spec application tree includes a PCT application with claims for invention #1 having a docket number of abc001a01p_2_PCT filed off of the patent for invention #1 to begin a first subbranch. The next application filed in the first subbranch is a European patent off of the PCT application with claims for invention #1 having a docket number of abc001a01p_3_EP where “EP” is the wipo code for Europe.

The second branch of the multiple branch common spec application tree further includes a legal placeholder conversion (LPC) application for invention #2 having a docket number of abc001a02p_1_LPCcon filed off of the patent for invention 1 to begin a second subbranch. The next applications filed in the second subbranch are a continuation (CON) application for invention #2 having a docket number of abc001a02p_3_UScon and a legal placeholder conversion (LPC) application for invention #3 having a docket number of abc001a03p_3_LPCcon.

Two CON applications are filed off of the CON application for invention #2. The first CON application has claims for invention #1 and a docket number of abc001a01p_4_UScon. The second CON application has claims for invention #2 and a docket number of abc001a02p_4_UScon. A CON application is filed off of the second CON application with claims for invention #2 and a docket number of abc001a02p_5_UScon. A CON application is also filed off of the LPC application for invention #3 with claims for invention #3 and a docket number of abc001a03p_4_UScon.

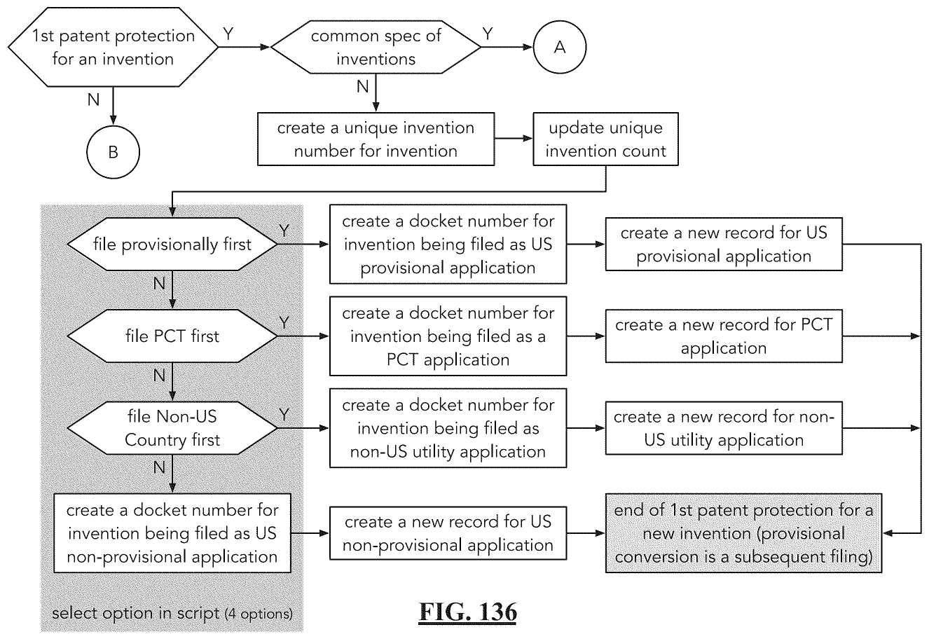

FIG. 136 is a logic diagram of an example of a method for generating a docket number and/or a record within an invention protection database of a private patent tracking database of an improved computer for technology.

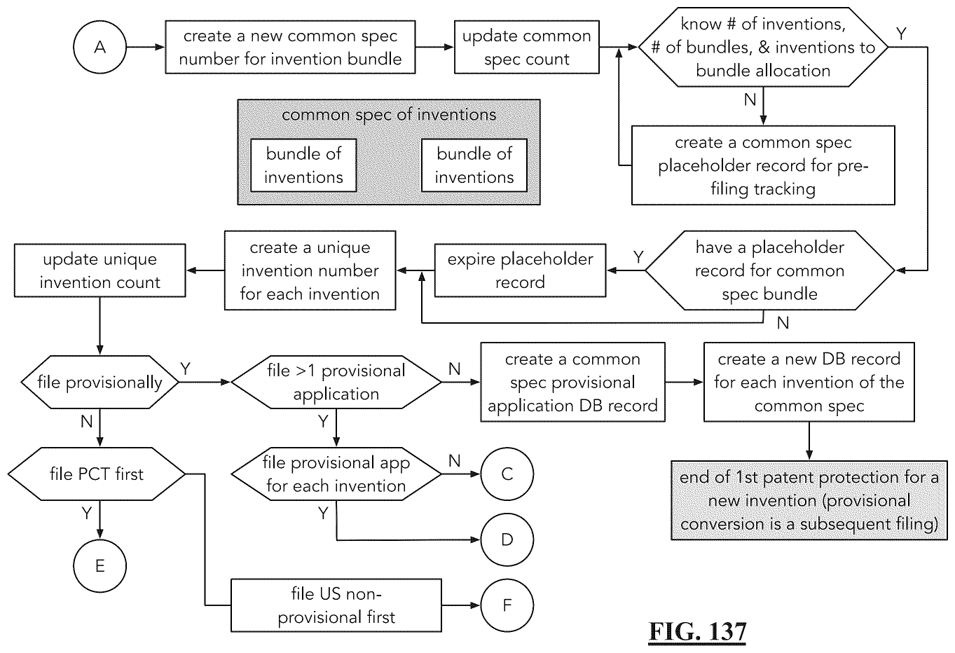

FIG. 137 is a logic diagram of another example of a method for generating a docket number and/or a record within an invention protection database of a private patent tracking database of an improved computer for technology.

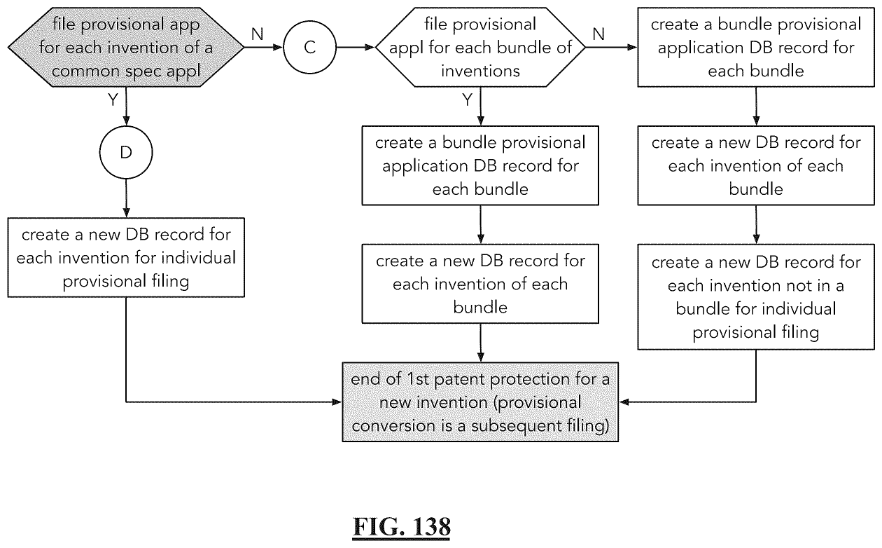

FIG. 138 is a logic diagram of another example of a method for generating a docket number and/or a record within an invention protection database of a private patent tracking database of an improved computer for technology.

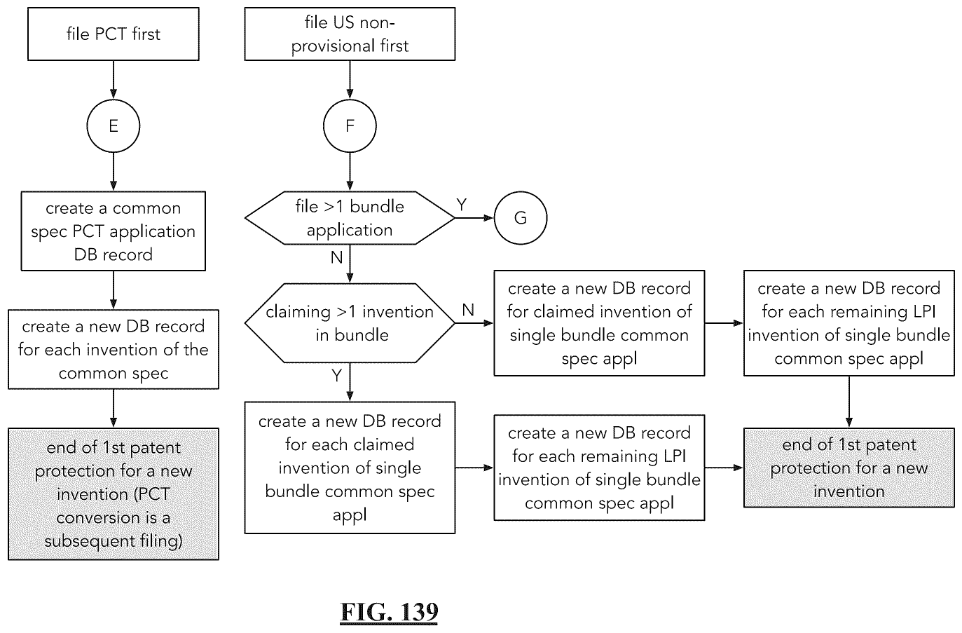

FIG. 139 is a logic diagram of another example of a method for generating a docket number and/or a record within an invention protection database of a private patent tracking database of an improved computer for technology.

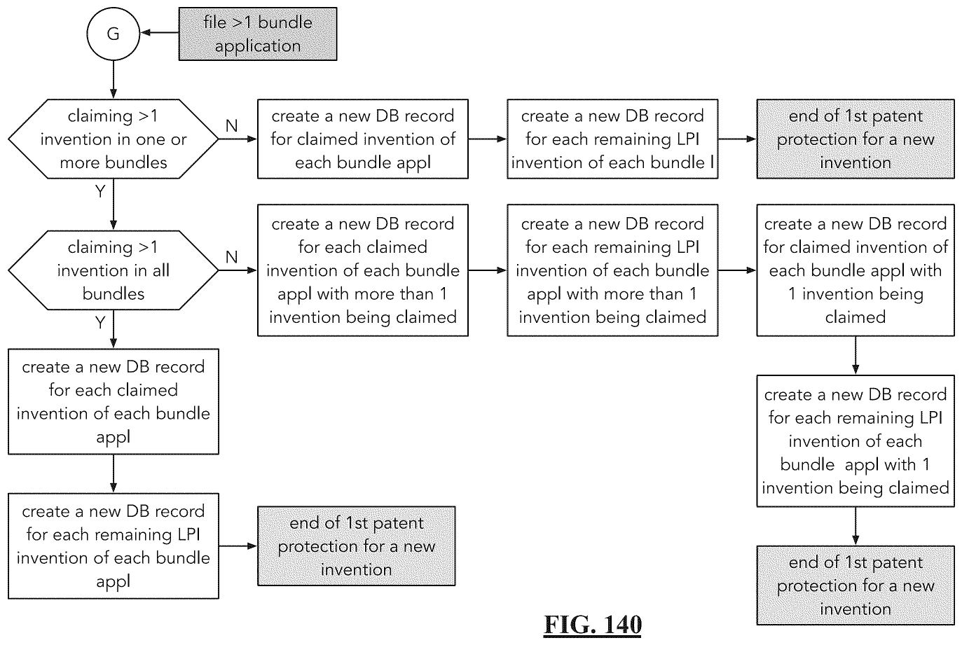

FIG. 140 is a logic diagram of another example of a method for generating a docket number and/or a record within an invention protection database of a private patent tracking database of an improved computer for technology.

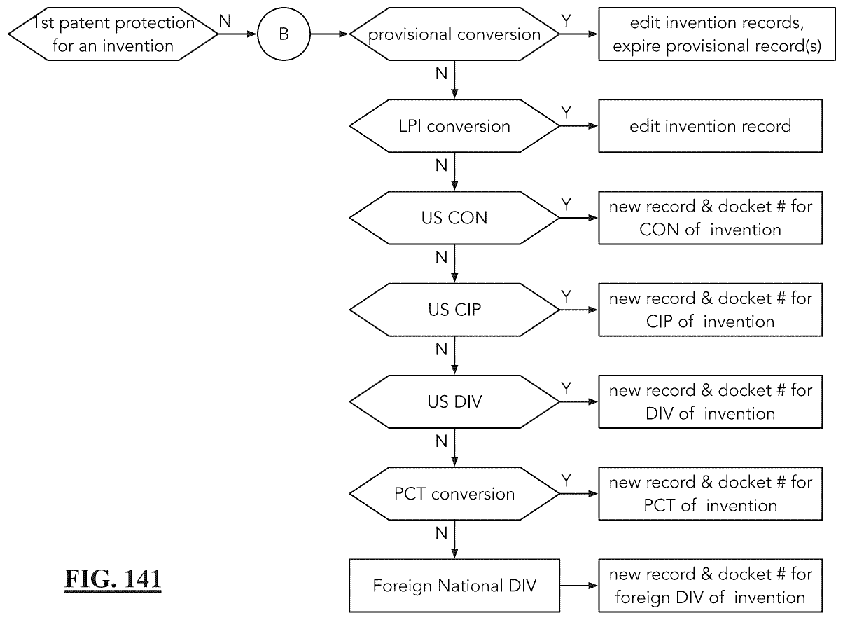

FIG. 141 is a logic diagram of another example of a method for generating a docket number and/or a record within an invention protection database of a private patent tracking database of an improved computer for technology.

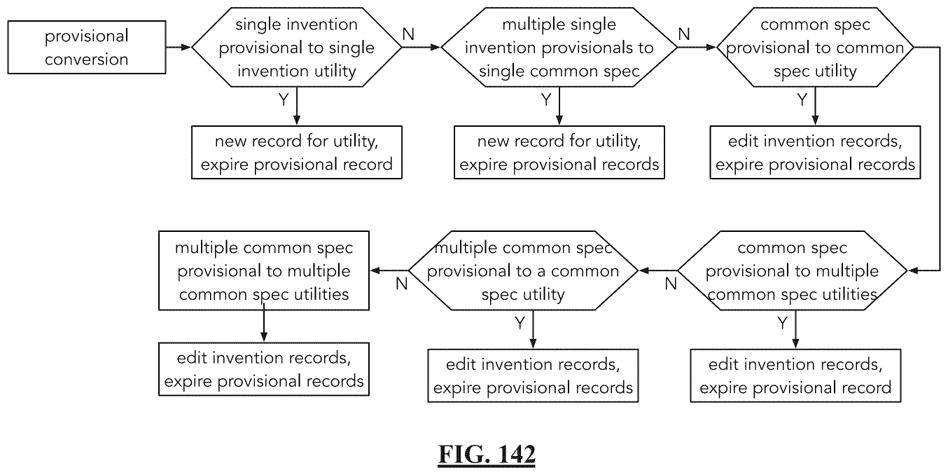

FIG. 142 is a logic diagram of another example of a method for generating a docket number and/or a record within an invention protection database of a private patent tracking database of an improved computer for technology.

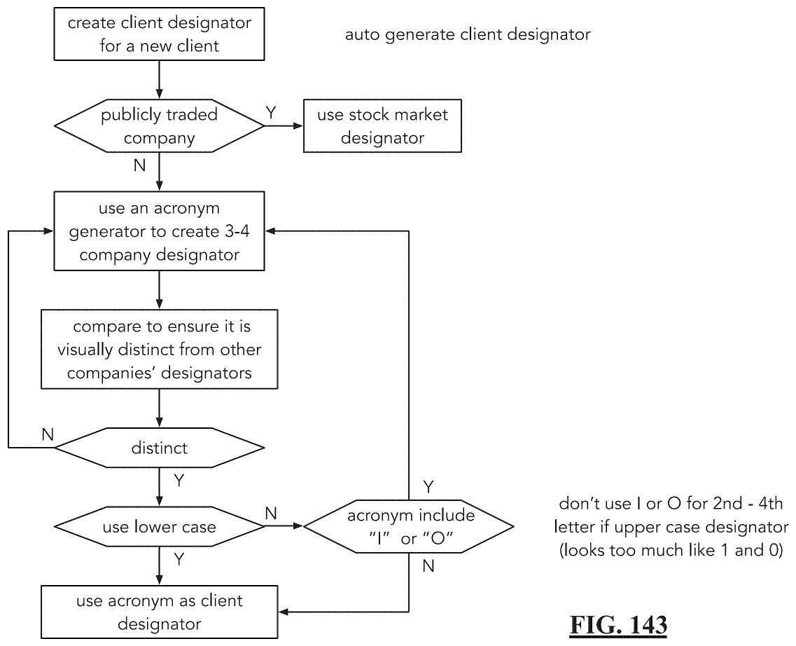

FIG. 143 is a logic diagram of another example of a method for generating a client designator for a docket number of a record within an invention protection database of a private patent tracking database of an improved computer for technology.

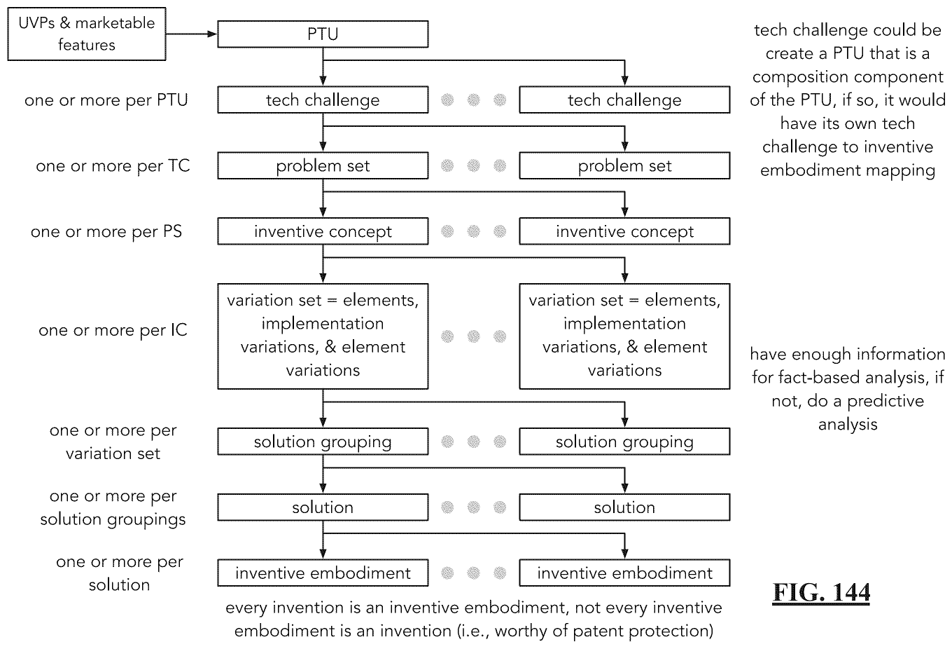

FIG. 144 is a diagram of an example of a PTU to inventive embodiment hierarchy of a PTU database and/or of an invention protection database of a private patent tracking database of an improved computer for technology.

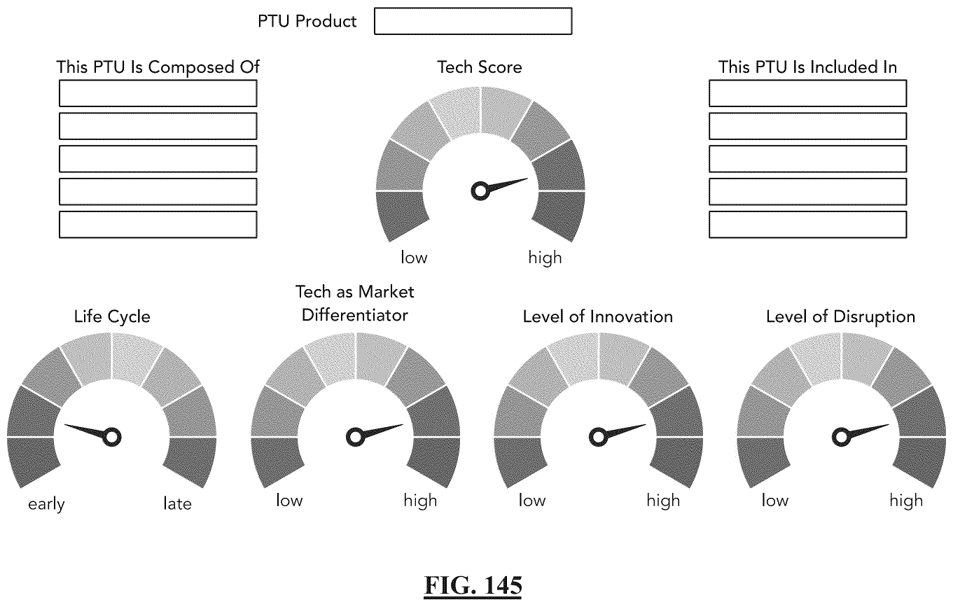

FIG. 145 is a diagram of an example of a graphical representation of tech score for a PTU product based on data of a tech score database, where the graphical representation is created and/or displayed by a data query processing computing entity and/or by a data storage computing entity of a private patent tracking database of an improved computer for technology.

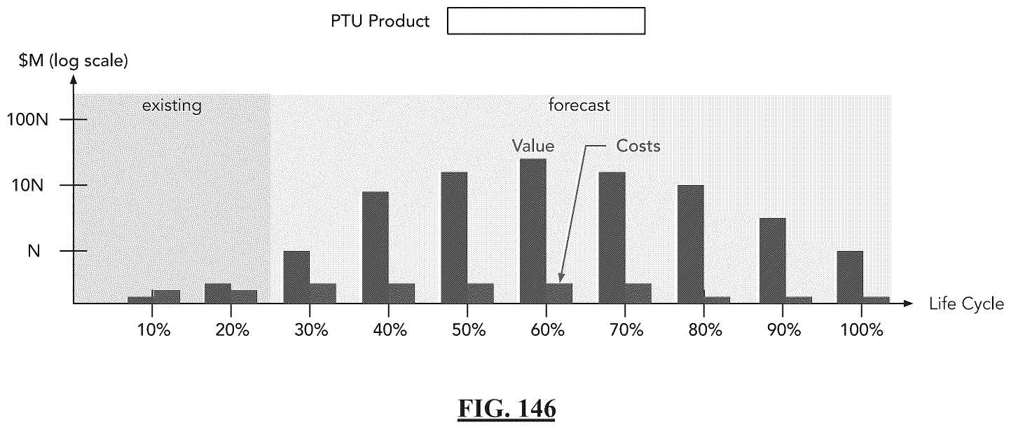

FIG. 146 is a diagram of another example of a graphical representation of tech score for a PTU product based on value and cost data of a tech score database, where the graphical representation is created and/or displayed by a data query processing computing entity and/or by a data storage computing entity of a private patent tracking database of an improved computer for technology.

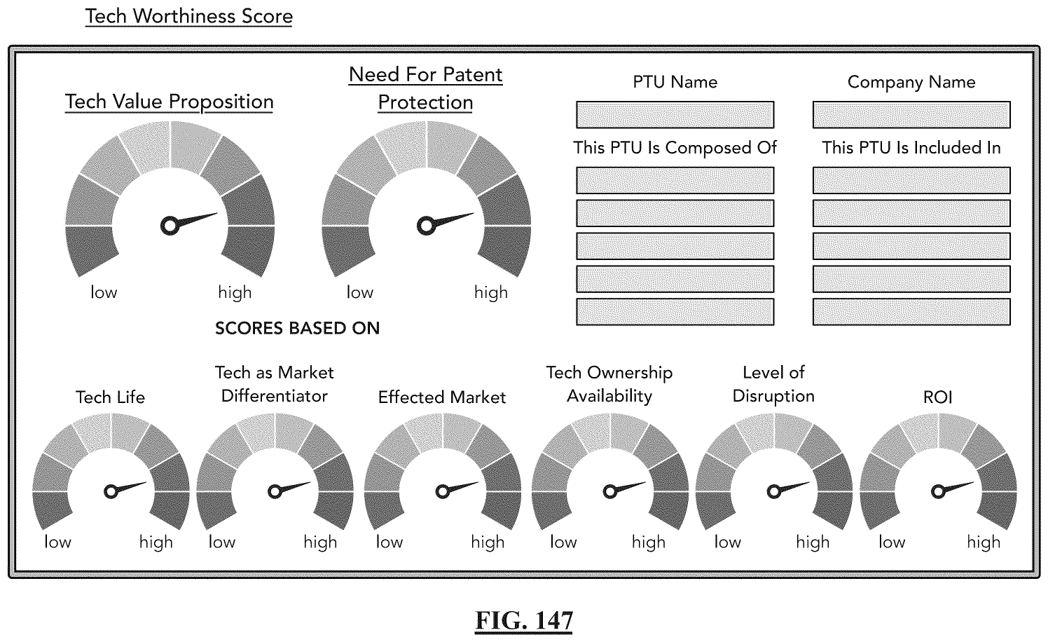

FIG. 147 is a diagram of an example of a graphical representation of tech score for a PTU product based on data of a tech score database, where the graphical representation is created, processed, and/or displayed by a data query processing computing entity and/or by a data storage computing entity of a private patent tracking database of an improved computer for technology.

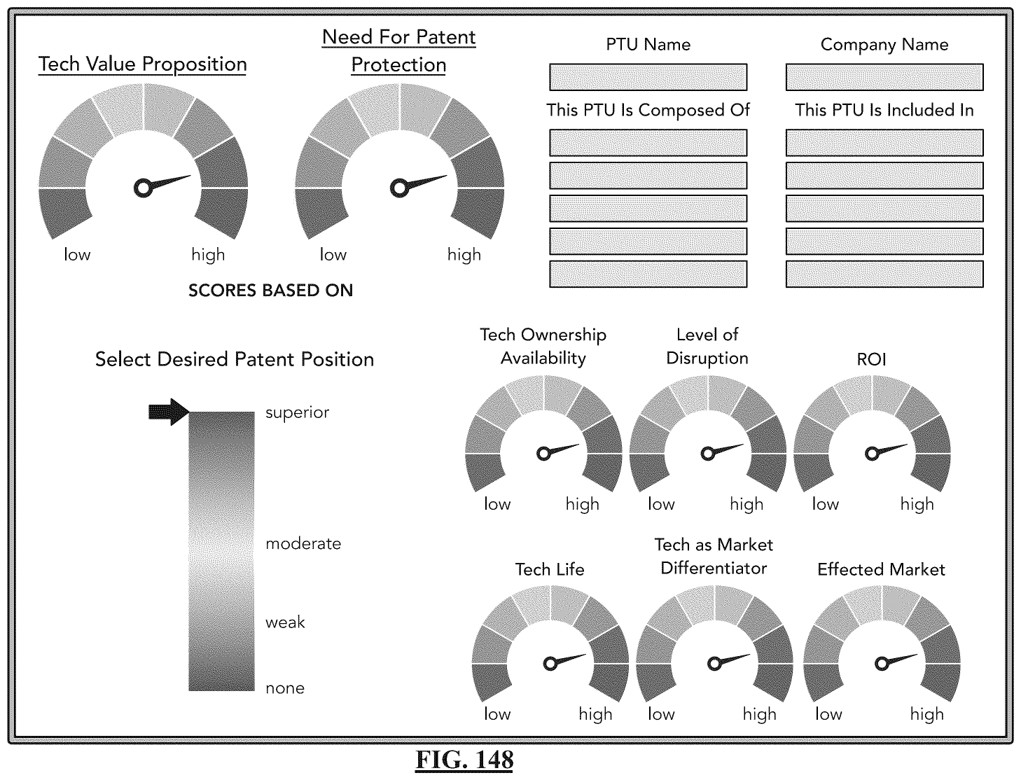

FIG. 148 is a diagram of an example of a graphical representation of tech score for a PTU product based on data of a tech score database, where the graphical representation is created, processed, and/or displayed by a data query processing computing entity and/or by a data storage computing entity of a private patent tracking database of an improved computer for technology.

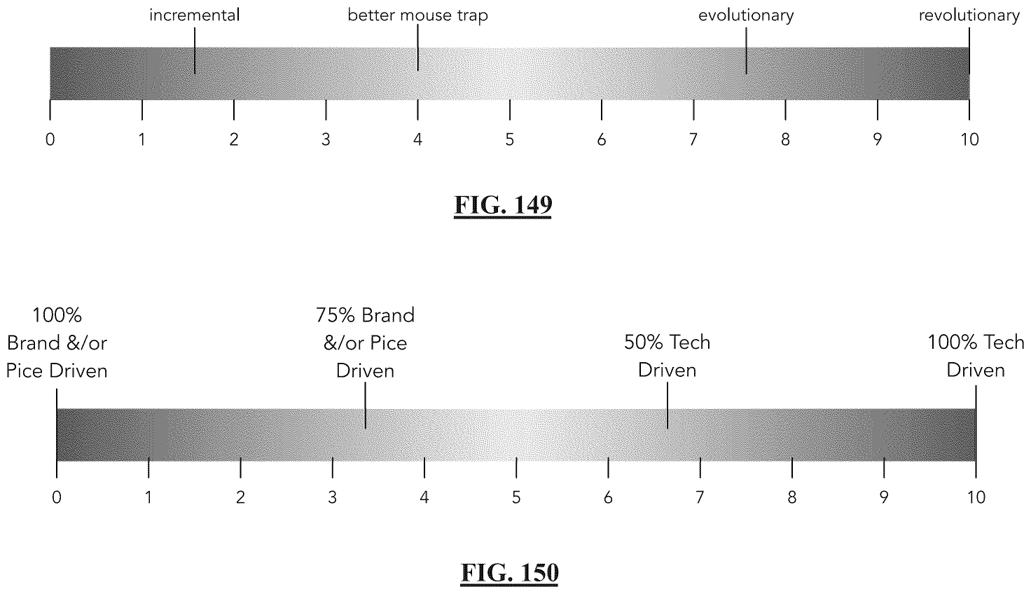

FIG. 149 is a diagram of an example of a graphical representation of a selectable level of disruption input for a tech score for a PTU product, where the graphical representation is created, processed, and/or displayed by a data query processing computing entity and/or by a data storage computing entity of a private patent tracking database of an improved computer for technology.

FIG. 150 is a diagram of an example of a graphical representation of a selectable level of market differentiation based on technology input for a tech score for a PTU product, where the graphical representation is created, processed, and/or displayed by a data query processing computing entity and/or by a data storage computing entity of a private patent tracking database of an improved computer for technology.

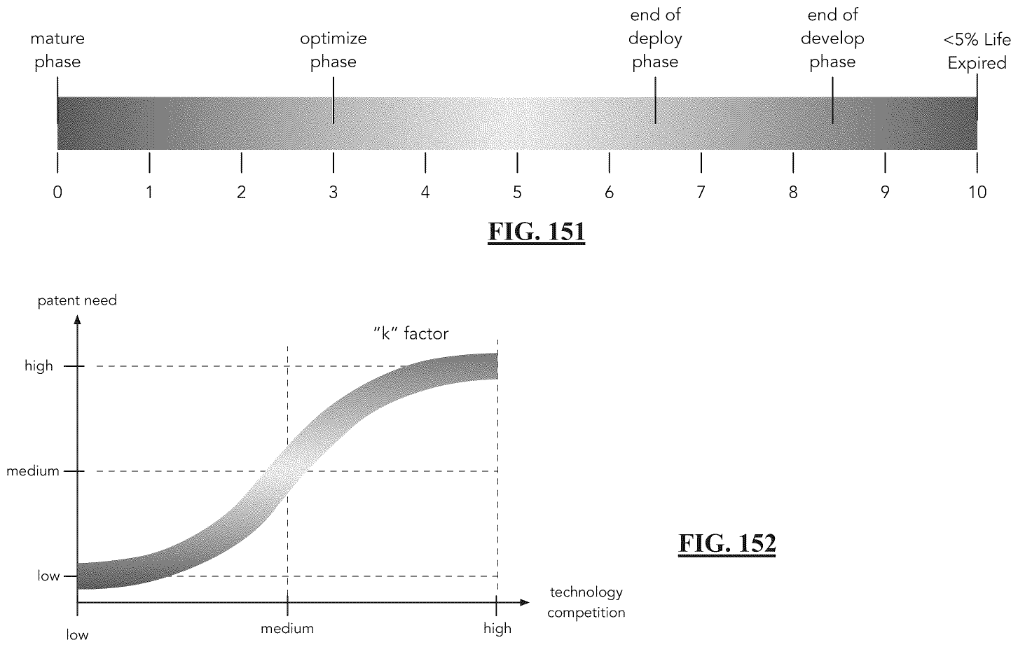

FIG. 151 is a diagram of an example of a graphical representation of a product and/or tech development level or remaining tech life input for a tech score for a PTU product, where the graphical representation is created, processed, and/or displayed by a data query processing computing entity and/or by a data storage computing entity of a private patent tracking database of an improved computer for technology.

FIG. 152 is a diagram of an example of a graphical representation of a product-tech-patent “k” factor input for a tech score for a PTU product, where the graphical representation is created, processed, and/or displayed by a data query processing computing entity and/or by a data storage computing entity of a private patent tracking database of an improved computer for technology.

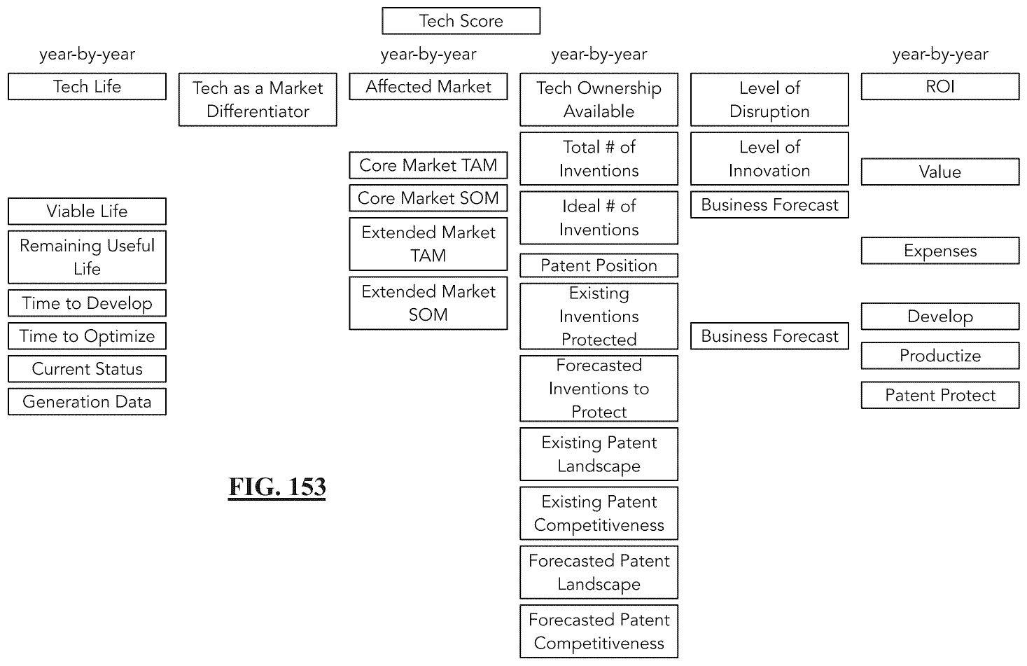

FIG. 153 is a diagram of an example of inputs for generating a tech score for a PTU product by a data query processing computing entity and/or by a data storage computing entity of a private patent tracking database of an improved computer for technology.

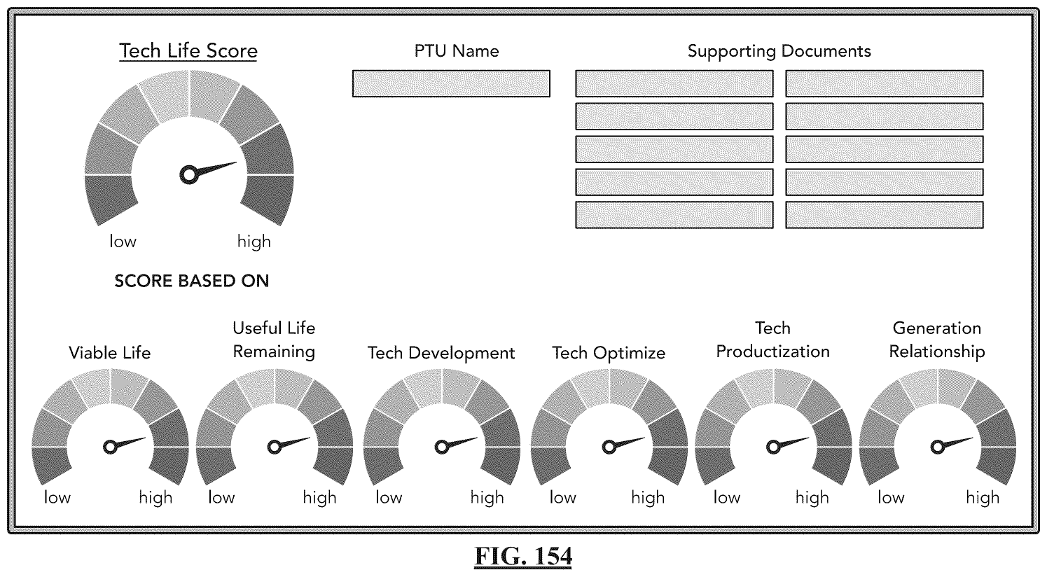

FIG. 154 is a diagram of an example of a graphical representation of a tech life score and its factors that are inputs for a tech score for a PTU product, where the graphical representation is created, processed, and/or displayed by a data query processing computing entity and/or by a data storage computing entity of a private patent tracking database of an improved computer for technology.

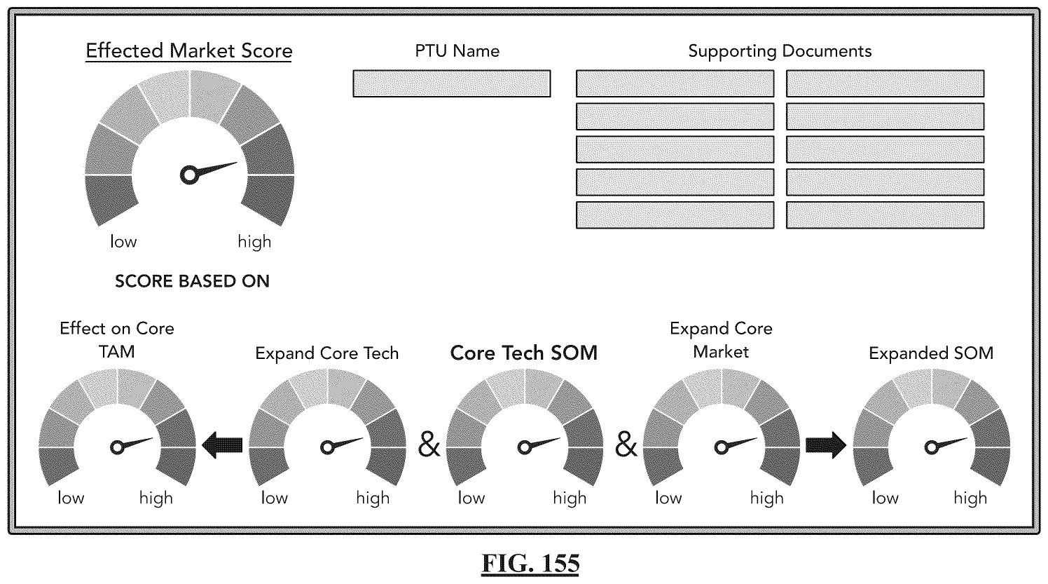

FIG. 155 is a diagram of an example of a graphical representation of an effected market score and its factors that are inputs for a tech score for a PTU product, where the graphical representation is created, processed, and/or displayed by a data query processing computing entity and/or by a data storage computing entity of a private patent tracking database of an improved computer for technology.

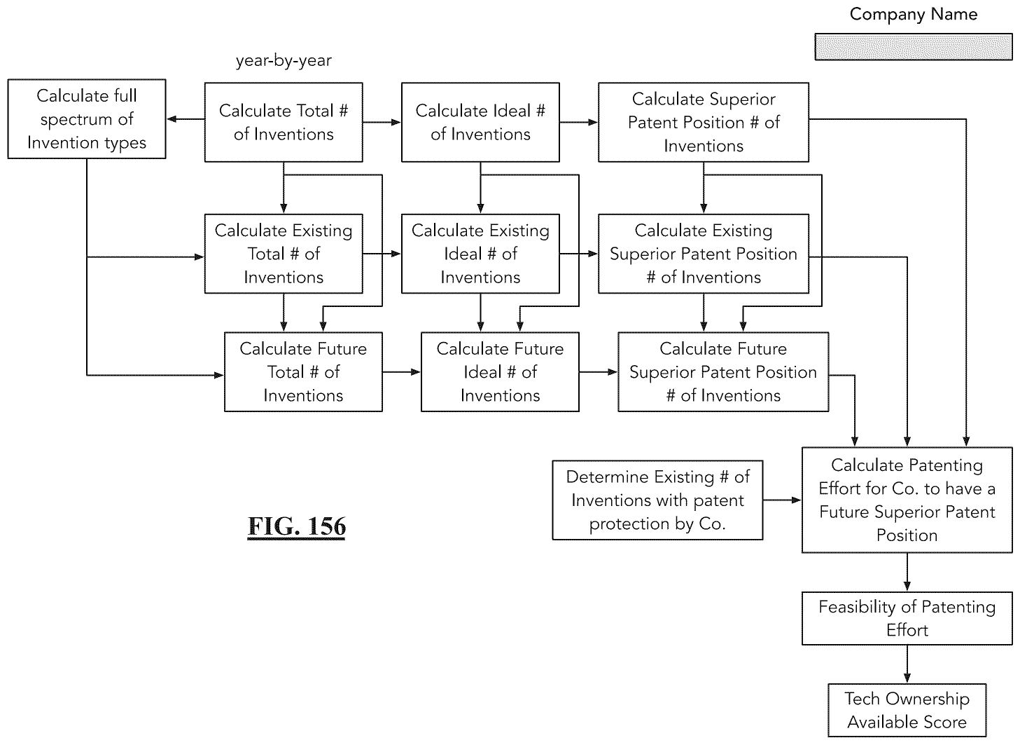

FIG. 156 is a logic diagram of an example of a method for generating a tech ownership availability score by a data query processing computing entity and/or by a data storage computing entity of a private patent tracking database of an improved computer for technology.

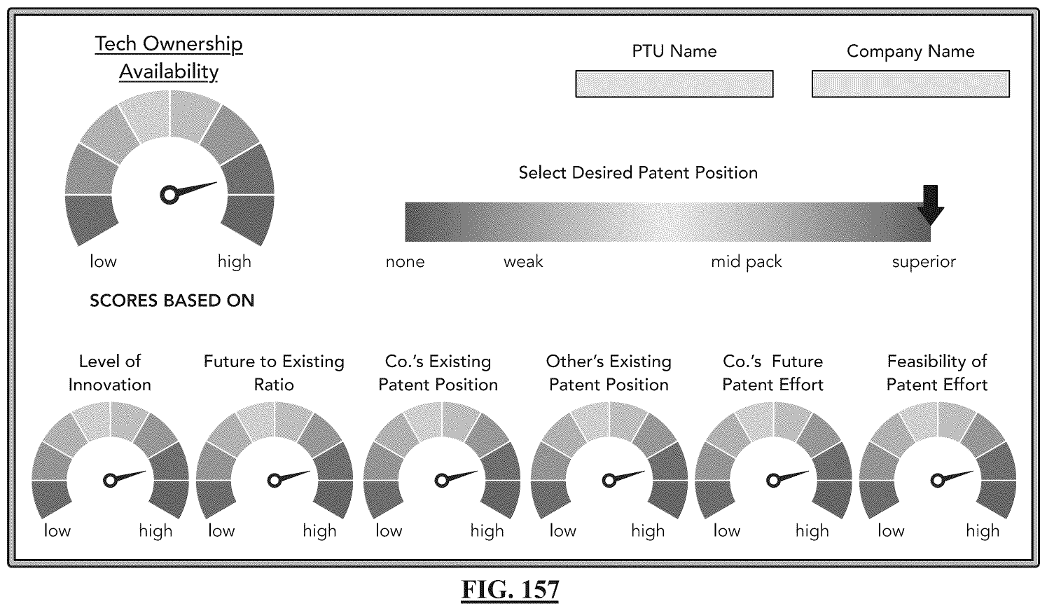

FIG. 157 is a diagram of an example of a graphical representation of a tech ownership availability score and its factors that are inputs for a tech score for a PTU product, where the graphical representation is created, processed, and/or displayed by a data query processing computing entity and/or by a data storage computing entity of a private patent tracking database of an improved computer for technology.

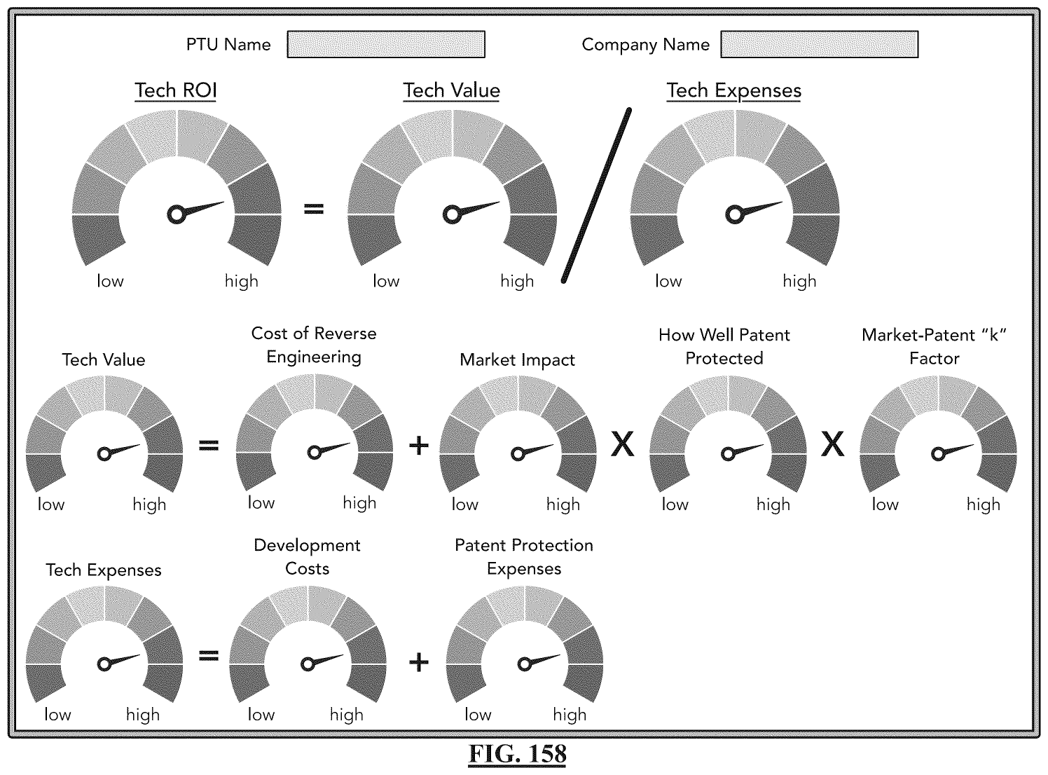

FIG. 158 is a diagram of an example of a graphical representation of a tech ROI score and its factors that are inputs for a tech score for a PTU product, where the graphical representation is created, processed, and/or displayed by a data query processing computing entity and/or by a data storage computing entity of a private patent tracking database of an improved computer for technology.

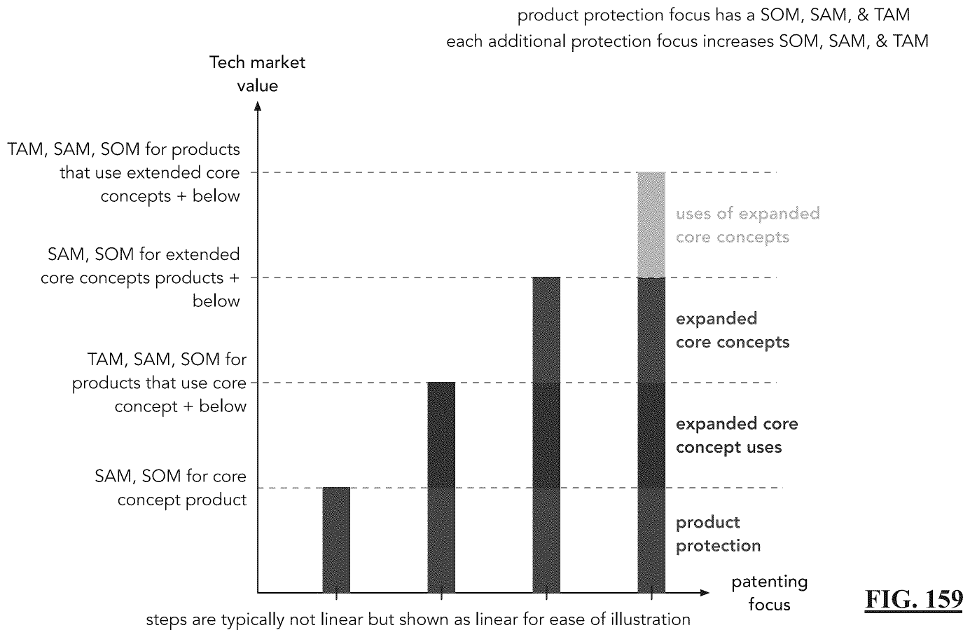

FIG. 159 is a diagram of an example of a graph that plots patenting focus versus tech market value, which are inputs for a tech score for a PTU product as created, processed, and/or displayed by a data query processing computing entity and/or by a data storage computing entity of a private patent tracking database of an improved computer for technology.

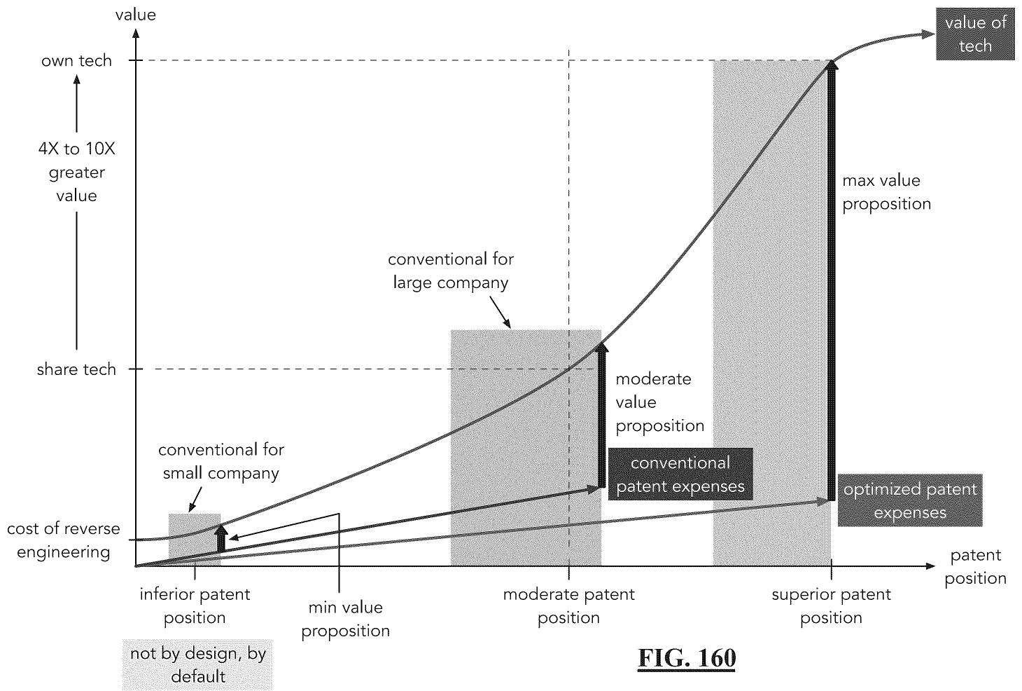

FIG. 160 is a diagram of an example of a graph that plots patenting position versus tech value, which are inputs for a tech score for a PTU product as created, processed, and/or displayed by a data query processing computing entity and/or by a data storage computing entity of a private patent tracking database of an improved computer for technology.

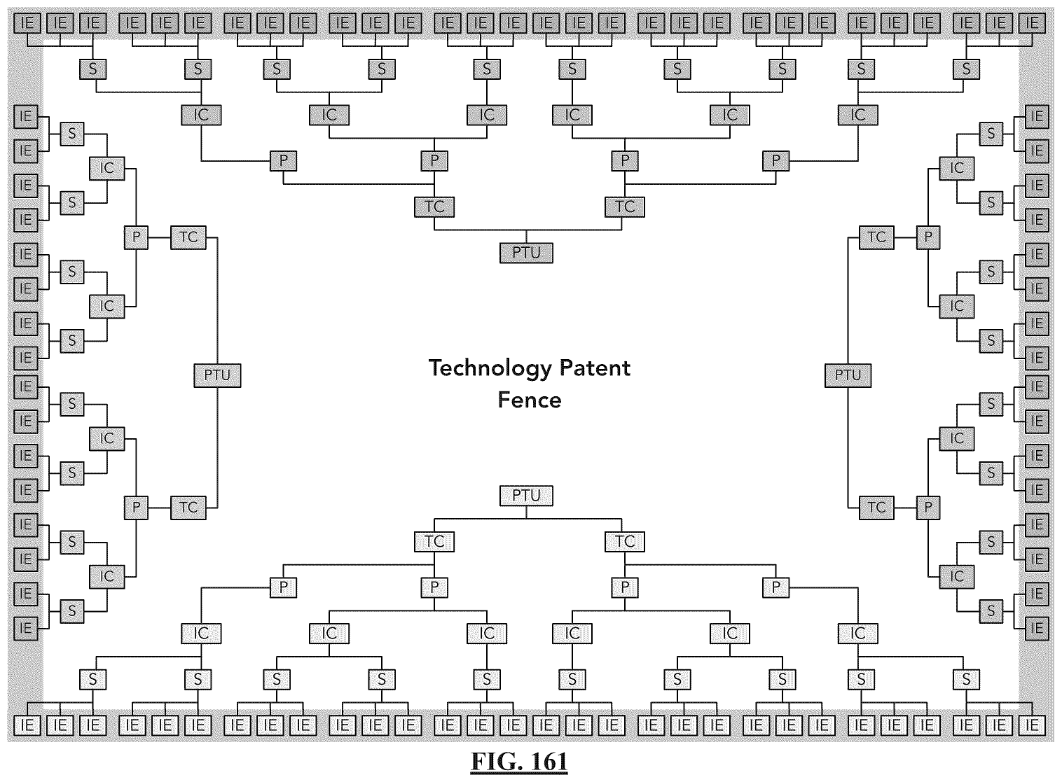

FIG. 161 is a schematic block diagram of an example of tech challenge to inventive embodiment patent fence, which are inputs for a tech score for, and/or a patent plan of, a PTU product as created, processed, and/or displayed by a data query processing computing entity and/or by a data storage computing entity of a private patent tracking database of an improved computer for technology.

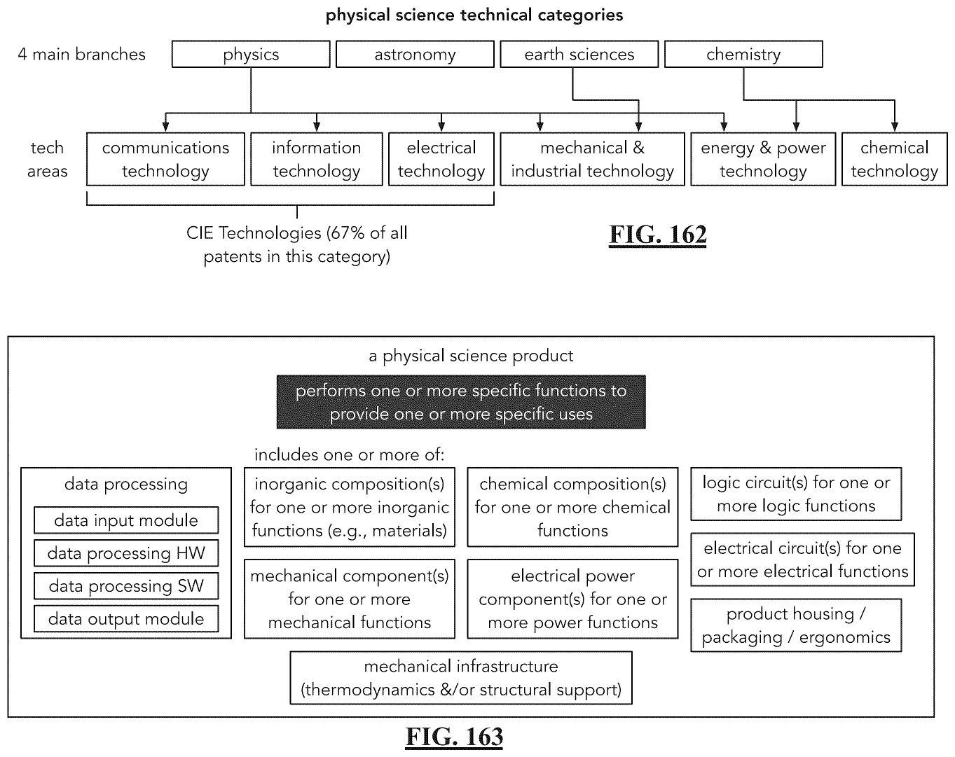

FIG. 162 is a schematic block diagram of an example of physical sciences to tech area mapping, which are inputs for a tech score for, a patent plan of, and/or defining a PTU product as created, processed, and/or displayed by a data query processing computing entity and/or by a data storage computing entity of an improved computer for technology.

FIG. 163 is a schematic block diagram of an example of a physical science product and its generic high-level components, which are inputs for a tech score for, a patent plan of, and/or defining a PTU product as created, processed, and/or displayed by a data query processing computing entity and/or by a data storage computing entity of an improved computer for technology.

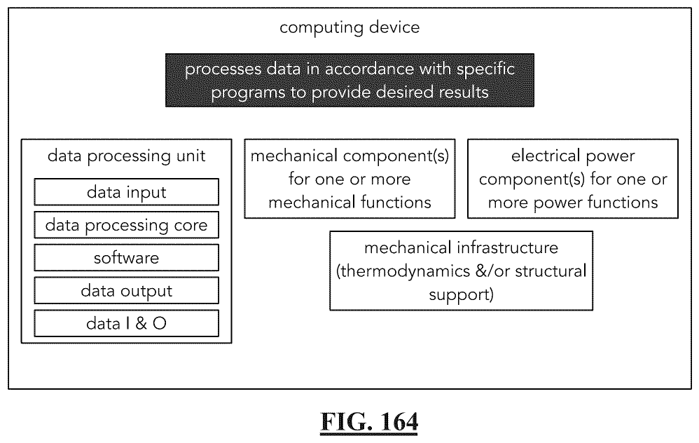

FIG. 164 is a schematic block diagram of an example of a computing device and its generic high-level components, which are inputs for a tech score for, a patent plan of, and/or defining a PTU product as created, processed, and/or displayed by a data query processing computing entity and/or by a data storage computing entity of an improved computer for technology.

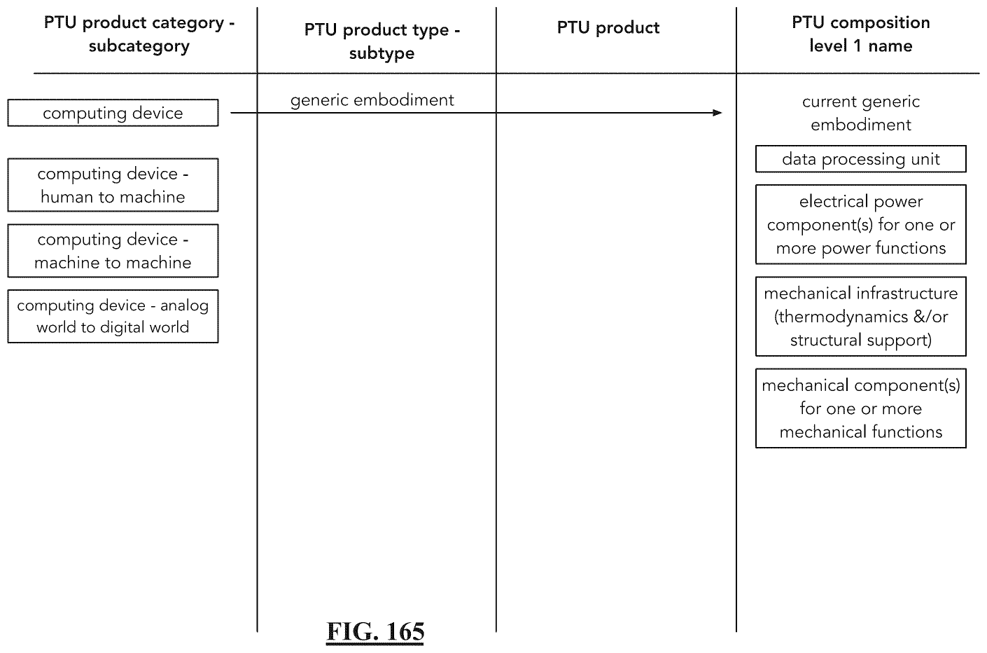

FIG. 165 is a schematic block diagram of an example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology.

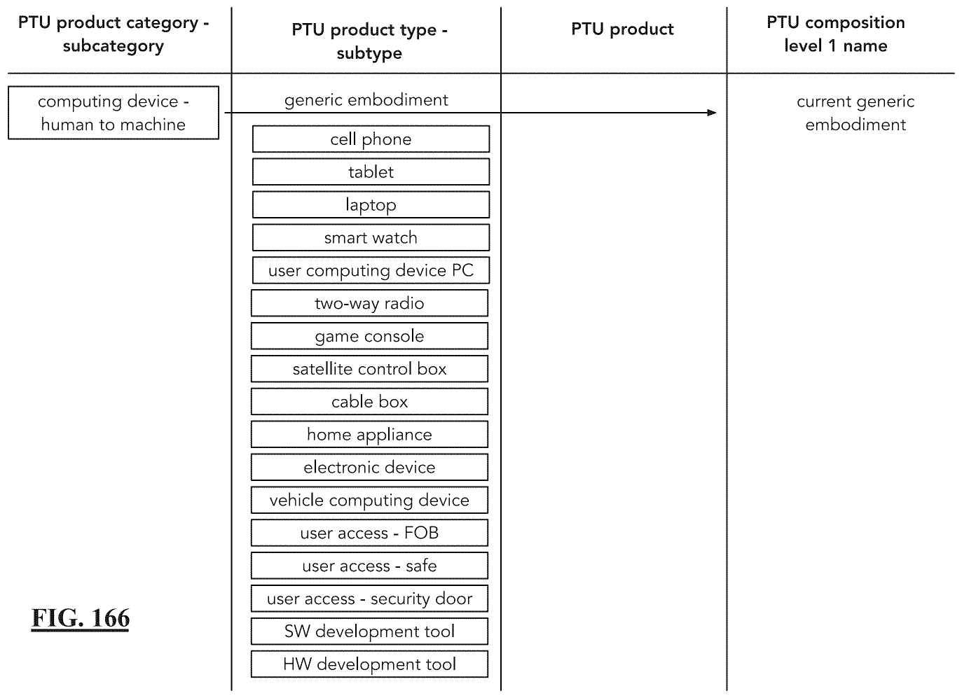

FIG. 166 is a schematic block diagram of another example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology.

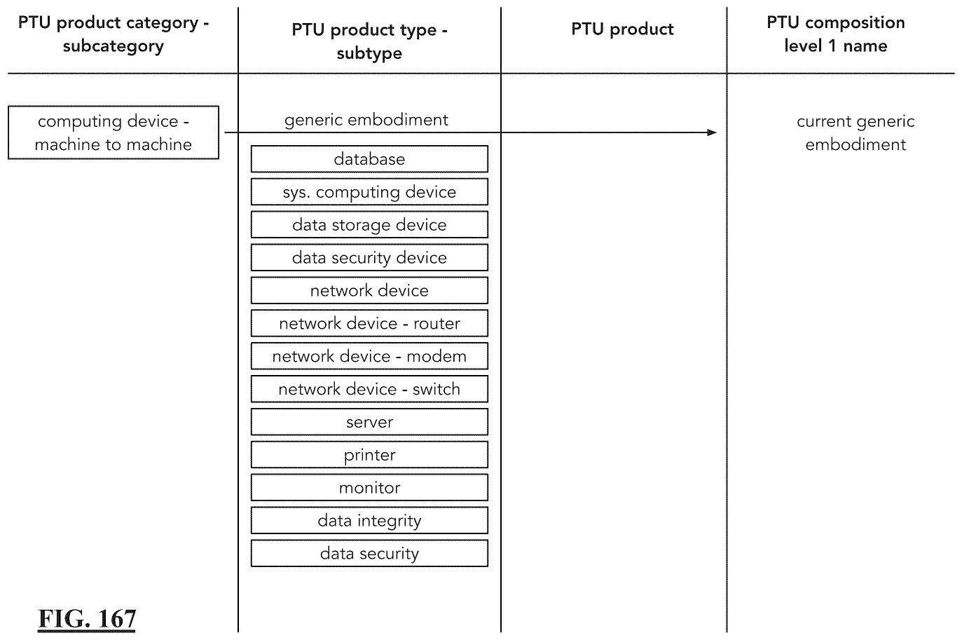

FIG. 167 is a schematic block diagram of another example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology.

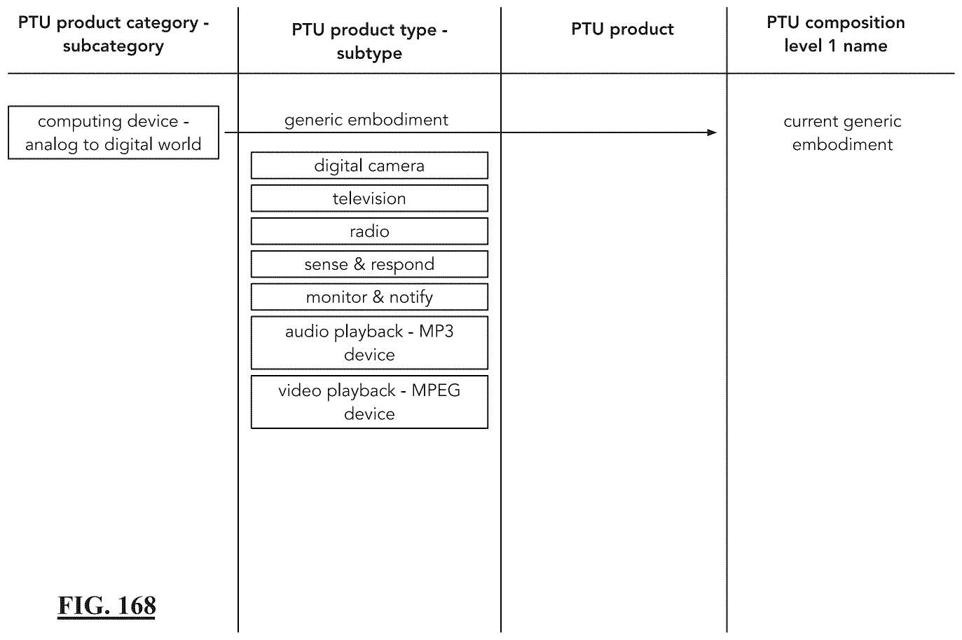

FIG. 168 is a schematic block diagram of another example of PTU naming and/or PTU hierarchy of a computing device and its generic high-level components, which are inputs for a tech score for, a patent plan of, and/or defining a PTU product as created, processed, and/or displayed by a data query processing computing entity and/or by a data storage computing entity of an improved computer for technology.

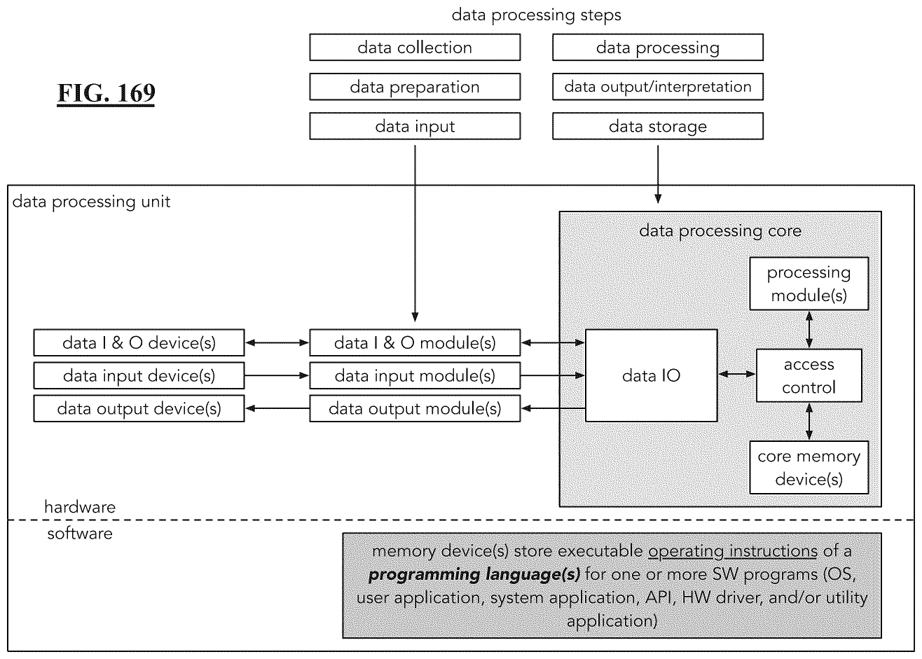

FIG. 169 is a schematic block diagram of an example of a graphical representation of data processing unit and its generic high-level components, which are inputs for a tech score for, a patent plan of, and/or defining a PTU product as created, processed, and/or displayed by a data query processing computing entity and/or by a data storage computing entity of an improved computer for technology.

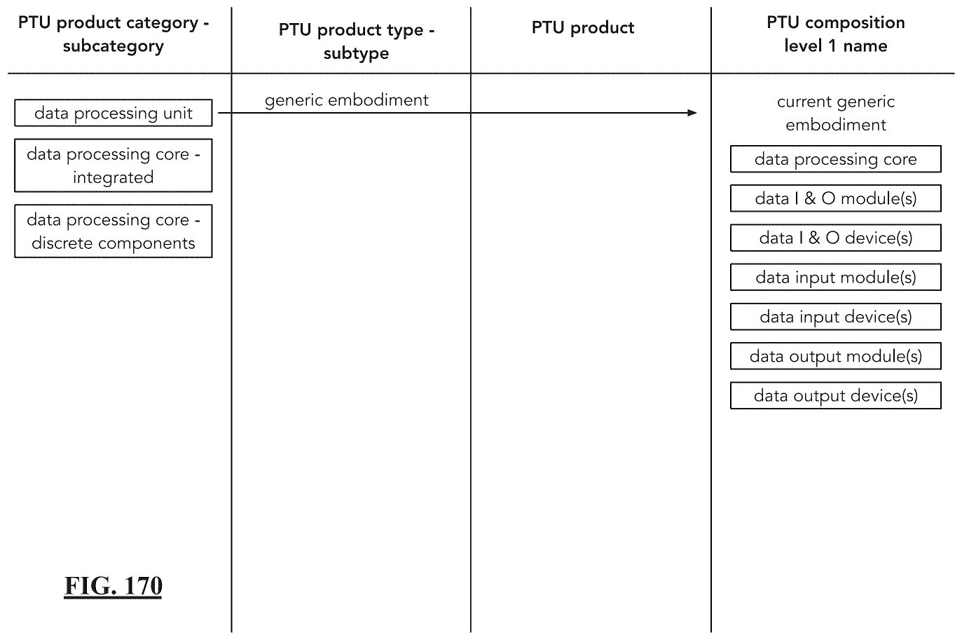

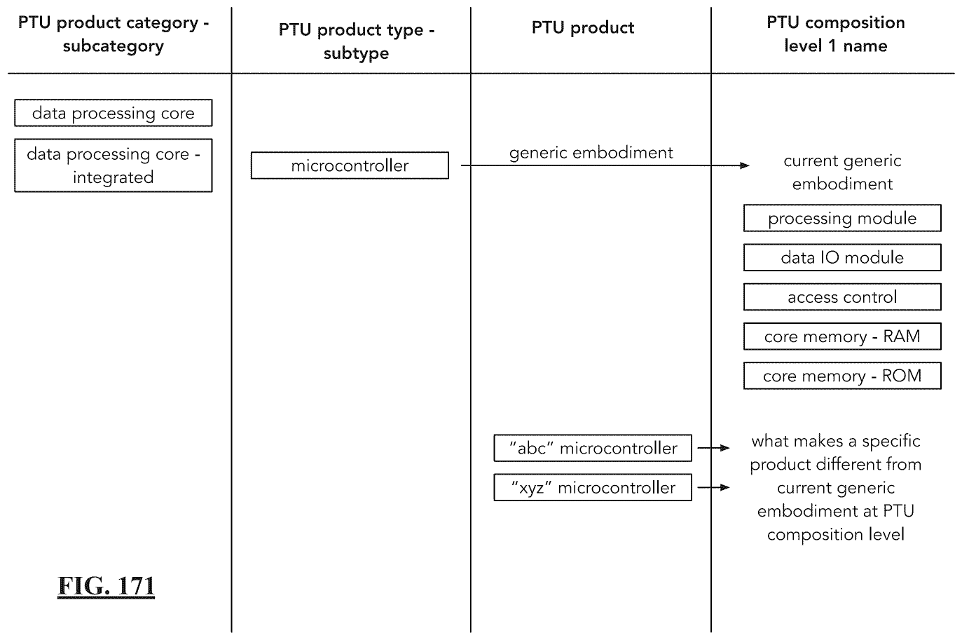

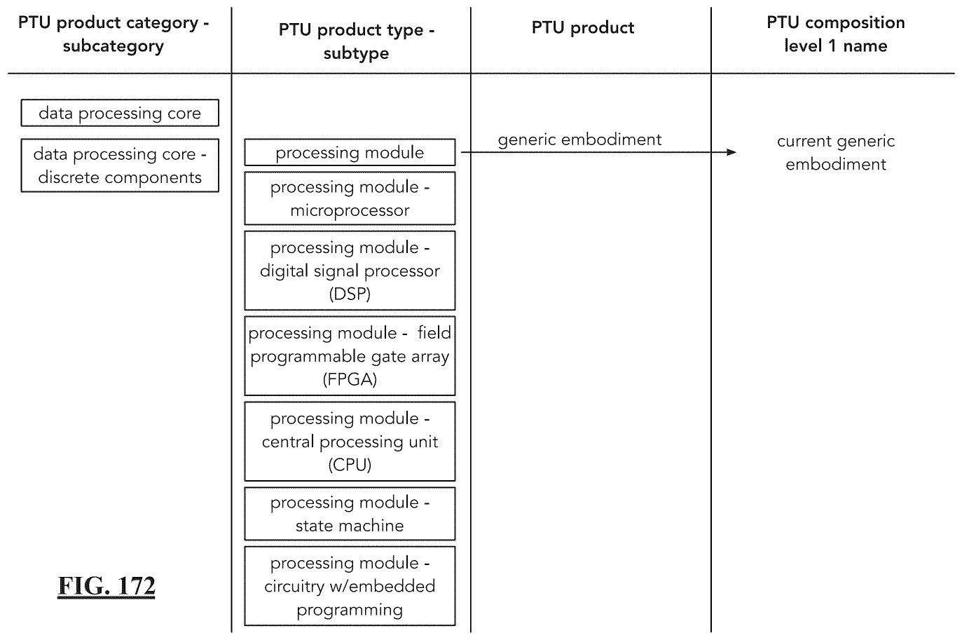

FIG. 170 is a schematic block diagram of another example of PTU naming and/or PTU hierarchy of a data processing unit and its generic high-level components, which are inputs for a tech score for, a patent plan of, and/or defining a PTU product as created, processed, and/or displayed by a data query processing computing entity and/or by a data storage computing entity of an improved computer for technology.

FIG. 171 is a schematic block diagram of an example of PTU naming and/or PTU hierarchy of a data processing unit, a specific PTU product type/sub-type, and its generic high-level components, which are inputs for a tech score for, a patent plan of, and/or defining a PTU product as created, processed, and/or displayed by a data query processing computing entity and/or by a data storage computing entity of an improved computer for technology.

FIG. 172 is a schematic block diagram of another example of PTU naming and/or PTU hierarchy of a data processing unit, a specific PTU product type/sub-type, and its generic high-level components, which are inputs for a tech score for, a patent plan of, and/or defining a PTU product as created, processed, and/or displayed by a data query processing computing entity and/or by a data storage computing entity of an improved computer for technology.

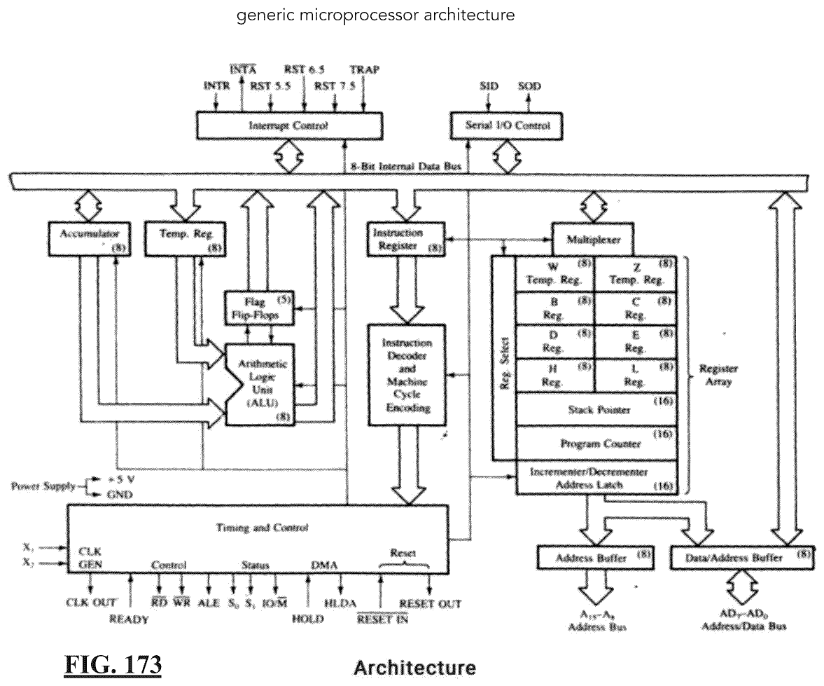

FIG. 173 is a schematic block diagram of an example of a graphical representation of microprocessor and its generic high-level components, which are inputs for a tech score for, a patent plan of, and/or defining a PTU product as created, processed, and/or displayed by a data query processing computing entity and/or by a data storage computing entity of an improved computer for technology.

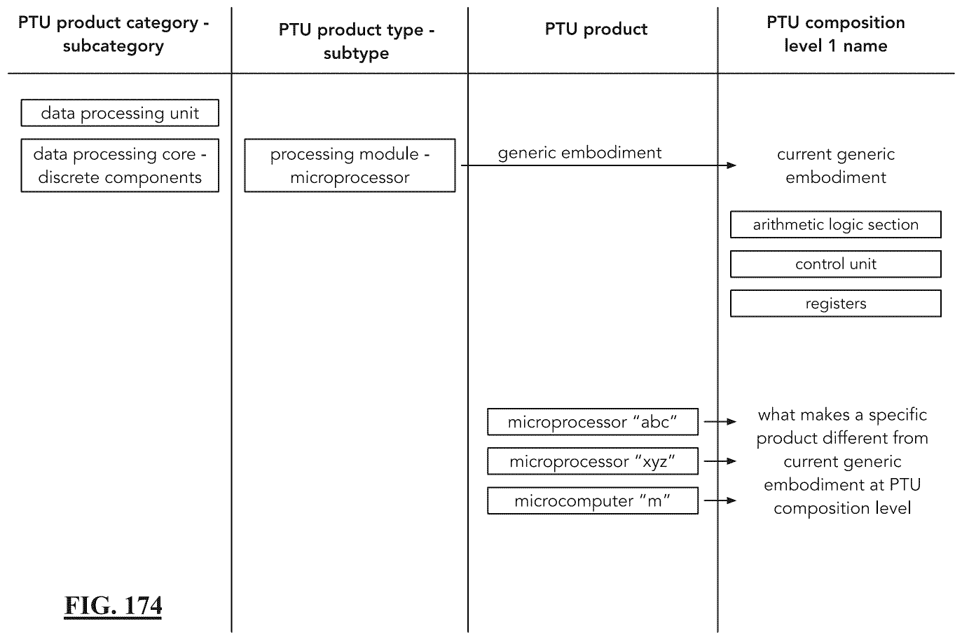

FIG. 174 is a schematic block diagram of an example of PTU naming and/or PTU hierarchy of a data processing unit, a specific PTU product type/sub-type, and its generic high-level components, which are inputs for a tech score for, a patent plan of, and/or defining a PTU product as created, processed, and/or displayed by a data query processing computing entity and/or by a data storage computing entity of an improved computer for technology.

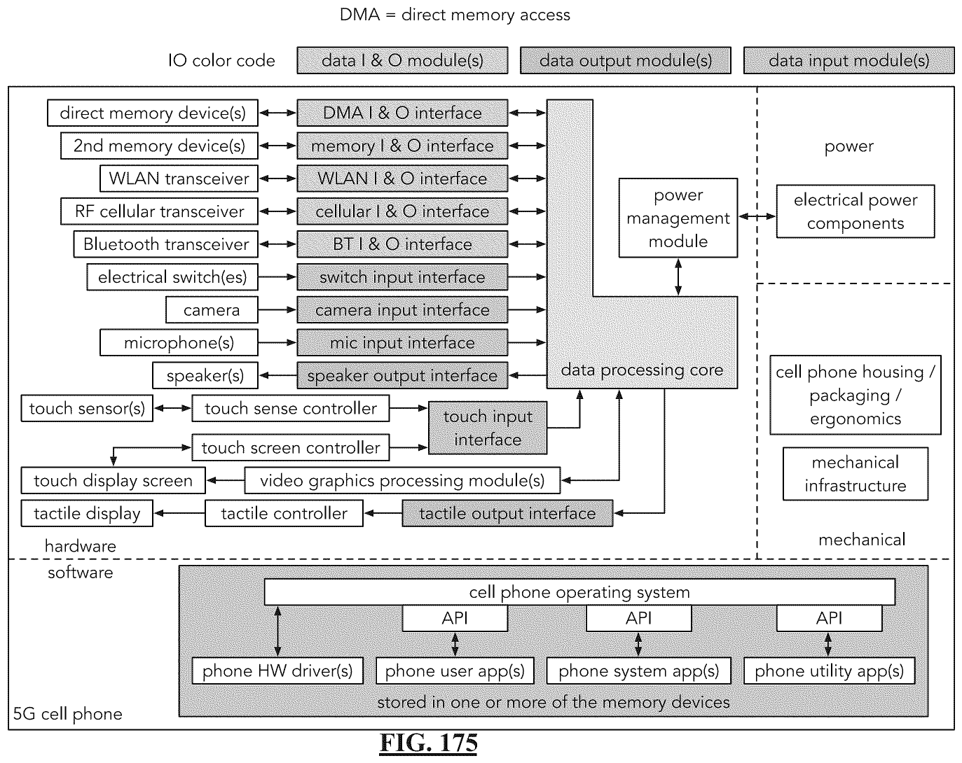

FIG. 175 is a schematic block diagram of an example of a graphical representation of cell phone and its generic high-level components, which are inputs for a tech score for, a patent plan of, and/or defining a PTU product as created, processed, and/or displayed by a data query processing computing entity and/or by a data storage computing entity of an improved computer for technology.

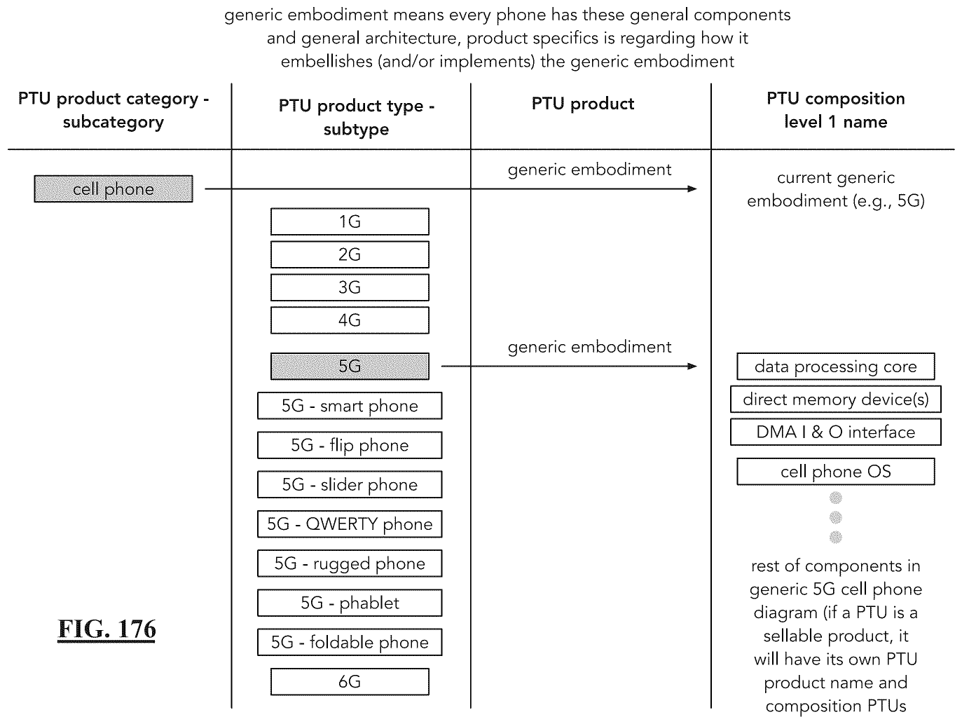

FIG. 176 is a schematic block diagram of an example of PTU naming and/or PTU hierarchy of a cell phone, specific PTU product type/sub-types, and its generic high-level components, which are inputs for a tech score for, a patent plan of, and/or defining a PTU product as created, processed, and/or displayed by a data query processing computing entity and/or by a data storage computing entity of an improved computer for technology.

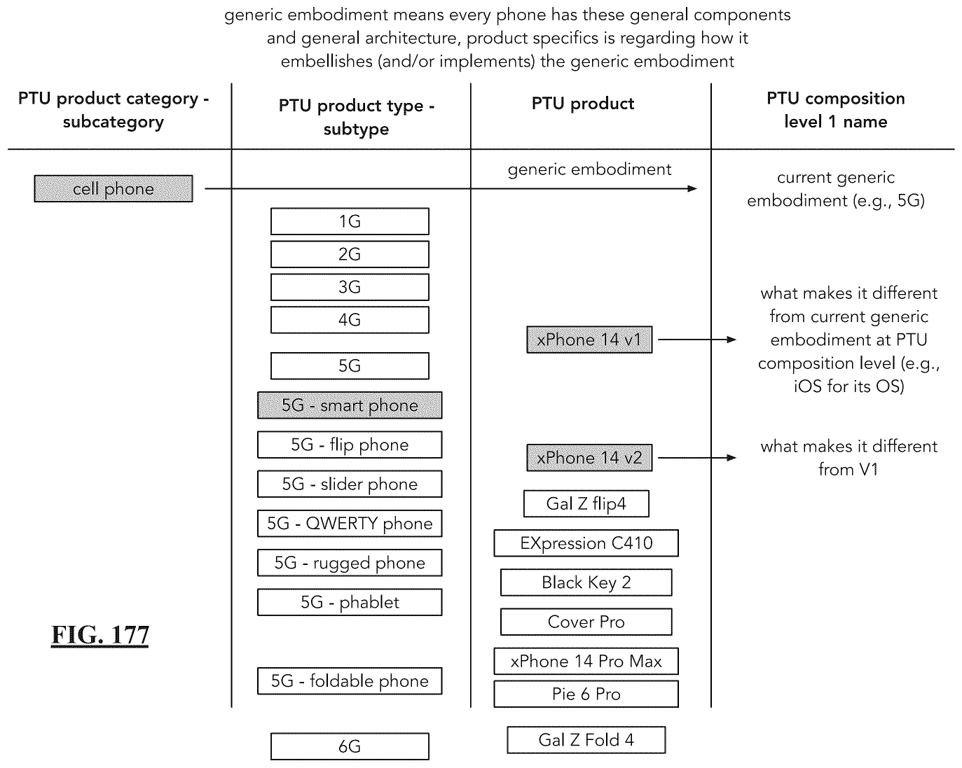

FIG. 177 is a schematic block diagram of an example of PTU naming and/or PTU hierarchy of a cell phone, specific PTU product type/sub-types, specific PTU products, and its high-level components, which are inputs for a tech score for, a patent plan of, and/or defining a PTU product as created, processed, and/or displayed by a data query processing computing entity and/or by a data storage computing entity of an improved computer for technology.

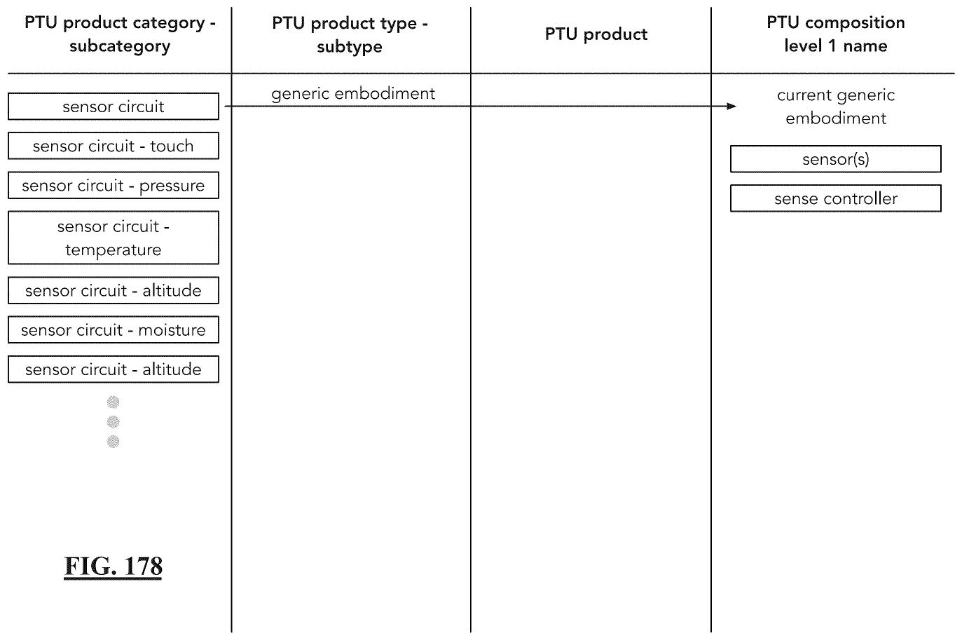

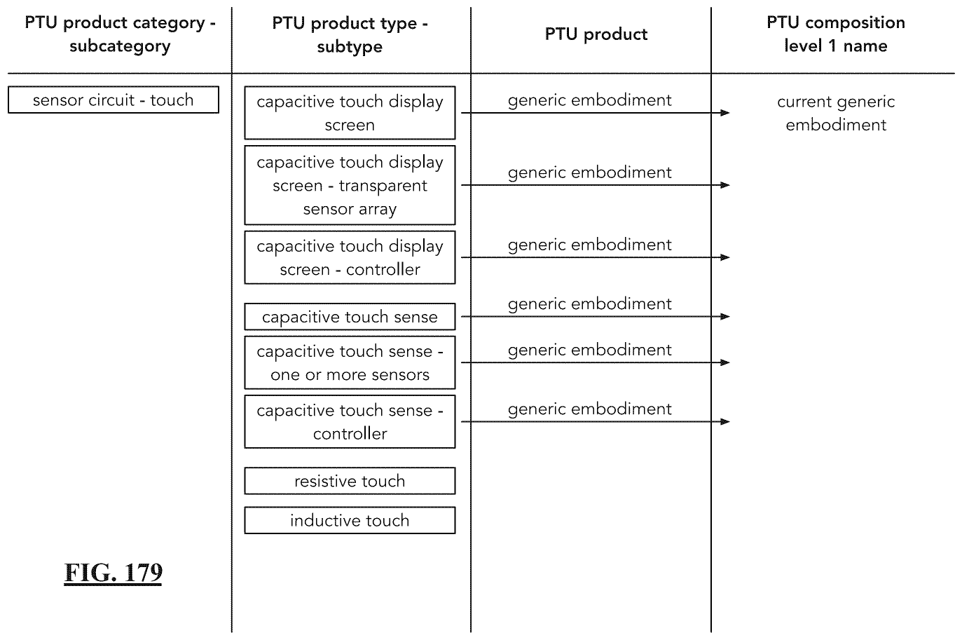

FIG. 178 is a schematic block diagram of an example of PTU naming and/or PTU hierarchy of a sensor circuit and its generic high-level components, which are inputs for a tech score for, a patent plan of, and/or defining a PTU product as created, processed, and/or displayed by a data query processing computing entity and/or by a data storage computing entity of an improved computer for technology.

FIG. 179 is a schematic block diagram of an example of PTU naming and/or PTU hierarchy of a sensor circuit, specific PTU product type/sub-types, and its generic high-level components, which are inputs for a tech score for, a patent plan of, and/or defining a PTU product as created, processed, and/or displayed by a data query processing computing entity and/or by a data storage computing entity of an improved computer for technology.

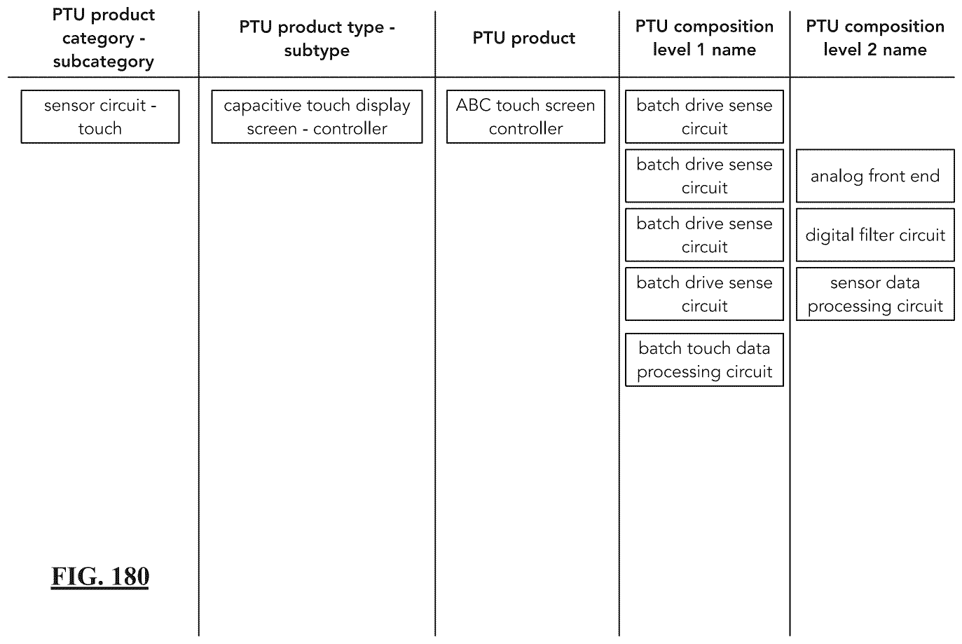

FIG. 180 is a schematic block diagram of an example of PTU naming and/or PTU hierarchy of a touch sensor circuit, a specific PTU product type/sub-type, a specific PTU product, and its high-level components, which are inputs for a tech score for, a patent plan of, and/or defining a PTU product as created, processed, and/or displayed by a data query processing computing entity and/or by a data storage computing entity of an improved computer for technology.

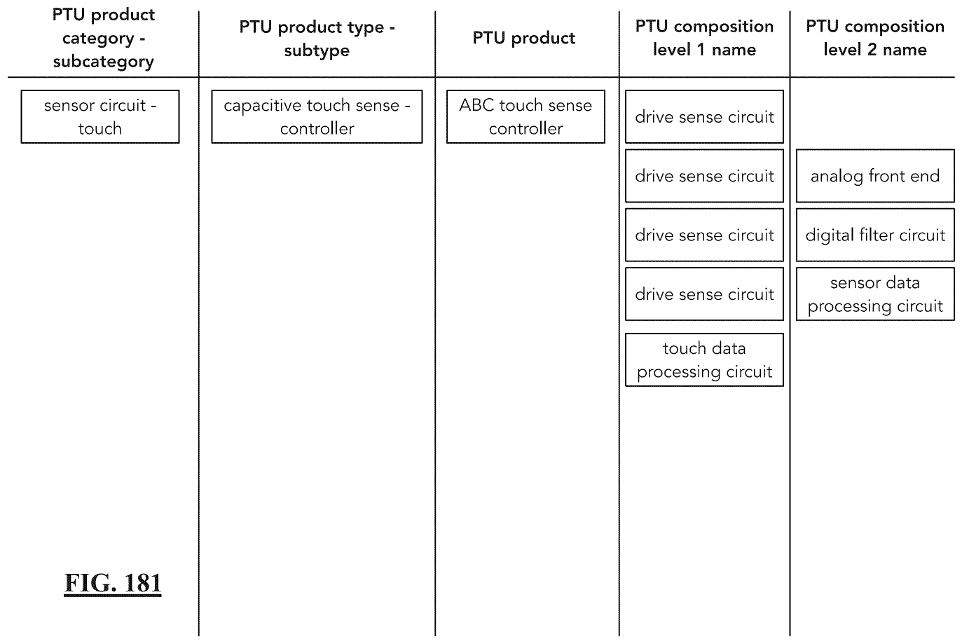

FIG. 181 is a schematic block diagram of another example of PTU naming and/or PTU hierarchy of a touch sensor circuit, a specific PTU product type/sub-type, a specific PTU product, and its high-level components, which are inputs for a tech score for, a patent plan of, and/or defining a PTU product as created, processed, and/or displayed by a data query processing computing entity and/or by a data storage computing entity of an improved computer for technology.

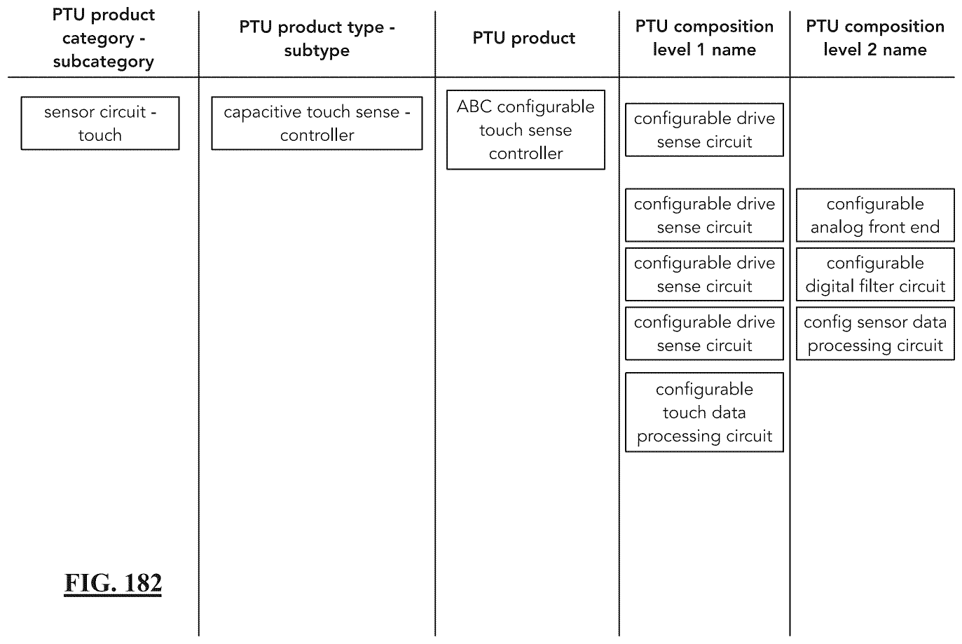

FIG. 182 is a schematic block diagram of another example of PTU naming and/or PTU hierarchy of a touch sensor circuit, a specific PTU product type/sub-type, a specific PTU product, and its high-level components, which are inputs for a tech score for, a patent plan of, and/or defining a PTU product as created, processed, and/or displayed by a data query processing computing entity and/or by a data storage computing entity of an improved computer for technology.

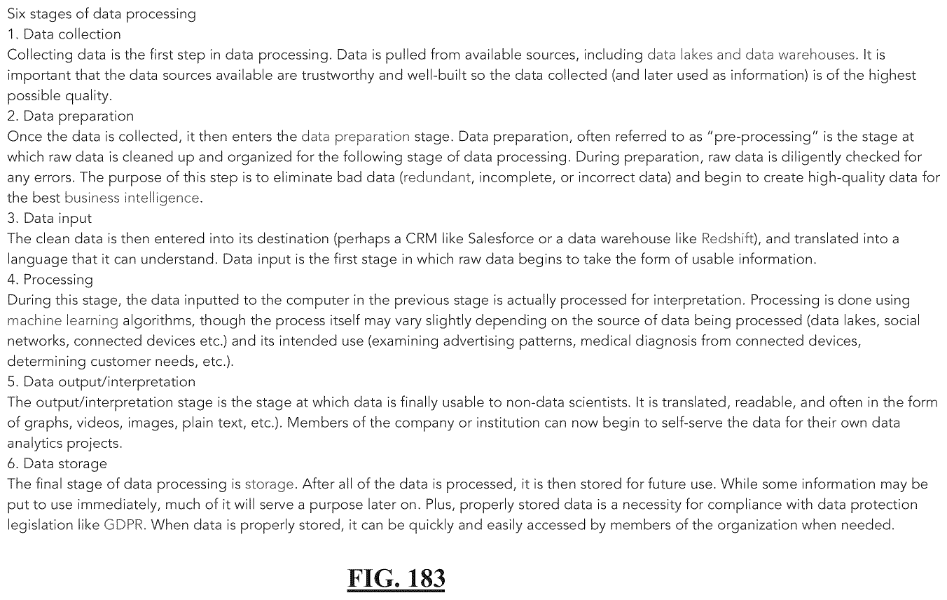

FIG. 183 is a diagram of an example of data processing stages, which are inputs for a tech score for, a patent plan of, and/or defining a PTU product as created, processed, and/or displayed by a data query processing computing entity and/or by a data storage computing entity of an improved computer for technology.

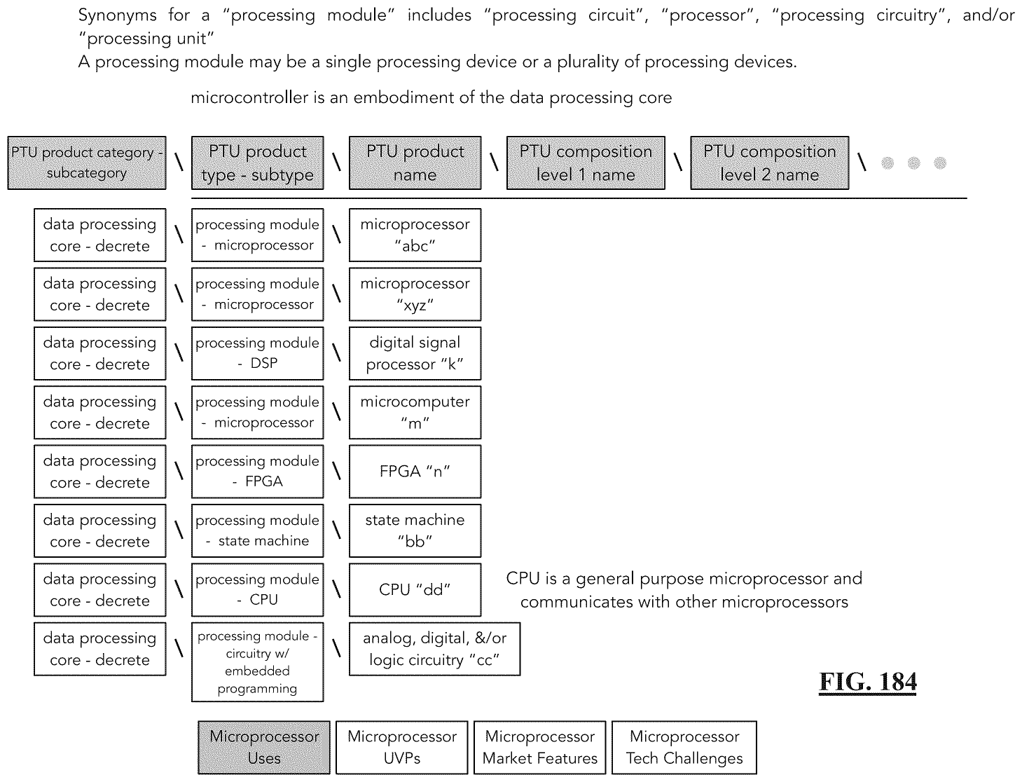

FIG. 184 is a schematic block diagram of an example of PTU naming and/or PTU hierarchy of a data processing unit, specific PTU product type/sub-types, specific PTU products, and their high-level components, which are inputs for a tech score for, a patent plan of, and/or defining a PTU product as created, processed, and/or displayed by a data query processing computing entity and/or by a data storage computing entity of an improved computer for technology.

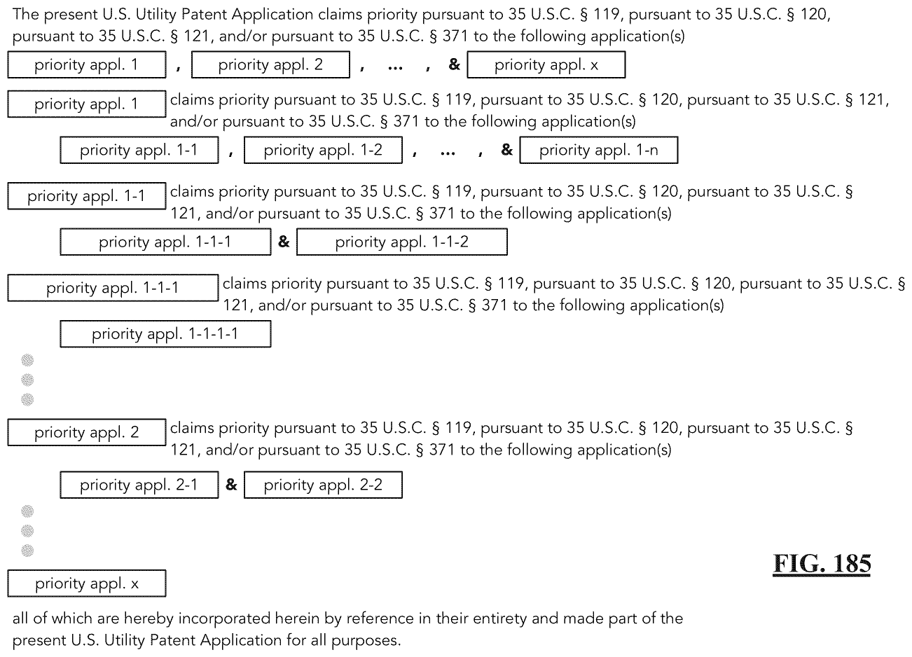

FIG. 185 is a schematic block diagram of an example of priority claim language that is auto-generated by an invention protection database (of a private patent tracking database of an improved computer for technology) in accordance with priority data of one or more records within the invention protection database.

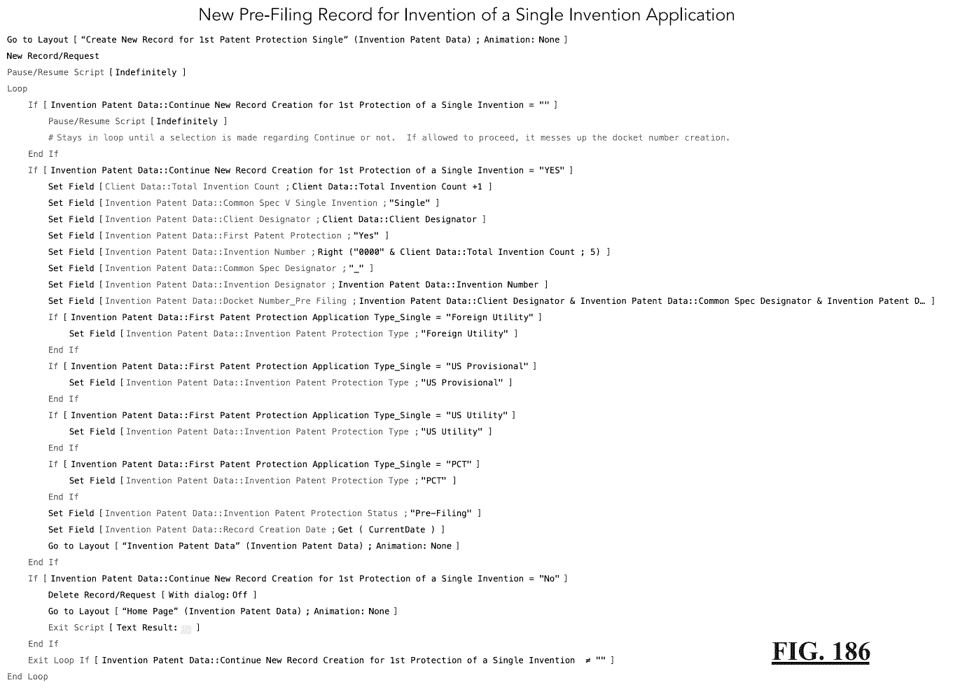

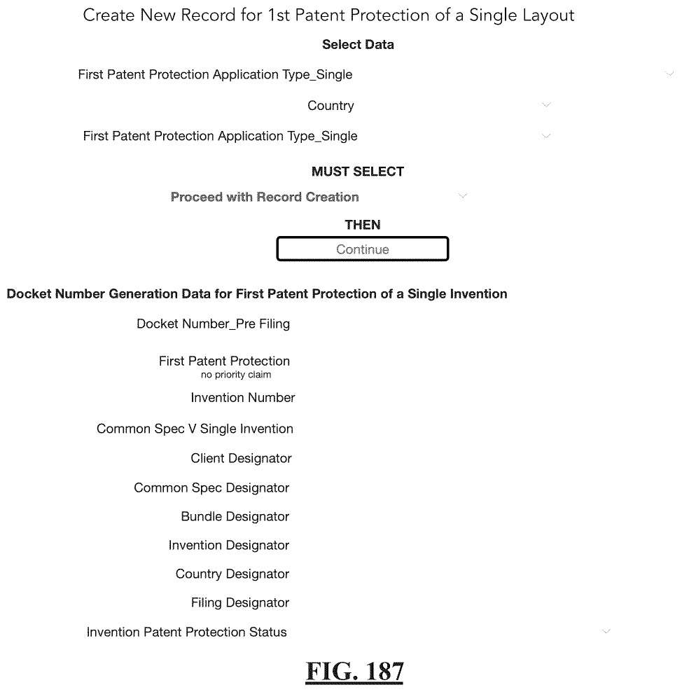

FIG. 186 is a schematic block diagram of an example of programming language that of an invention protection database (of a private patent tracking database of an improved computer for technology) to generate a new record and/or a new docket number of a single invention patent protection.

FIG. 187 is a schematic block diagram of an example of a data input layout of an invention protection database (of a private patent tracking database of an improved computer for technology) regarding the generation of a new record and/or of a new docket number for a single invention patent protection.

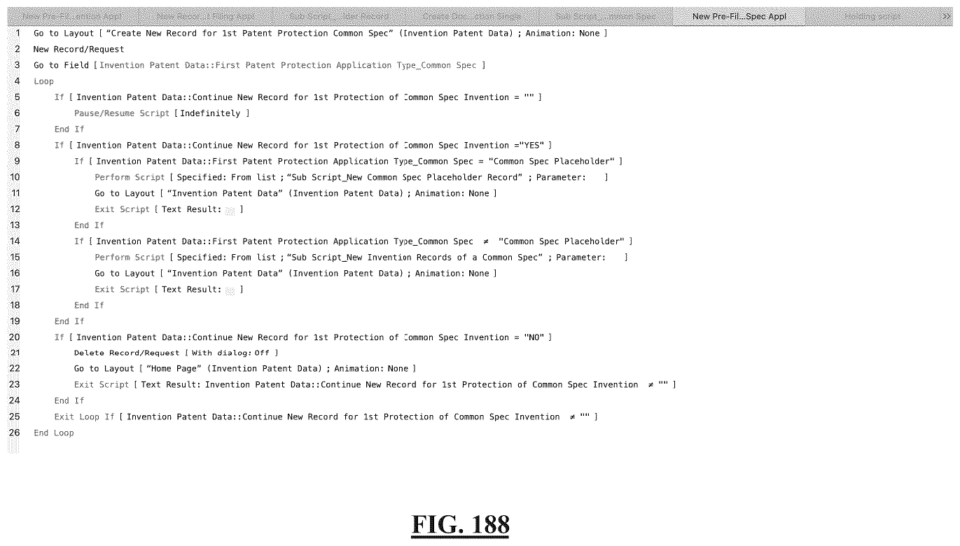

FIG. 188 is a schematic block diagram of an example of programming language of an invention protection database (of a private patent tracking database of an improved computer for technology) to generate a new record and/or a new docket number for an invention of a common spec.

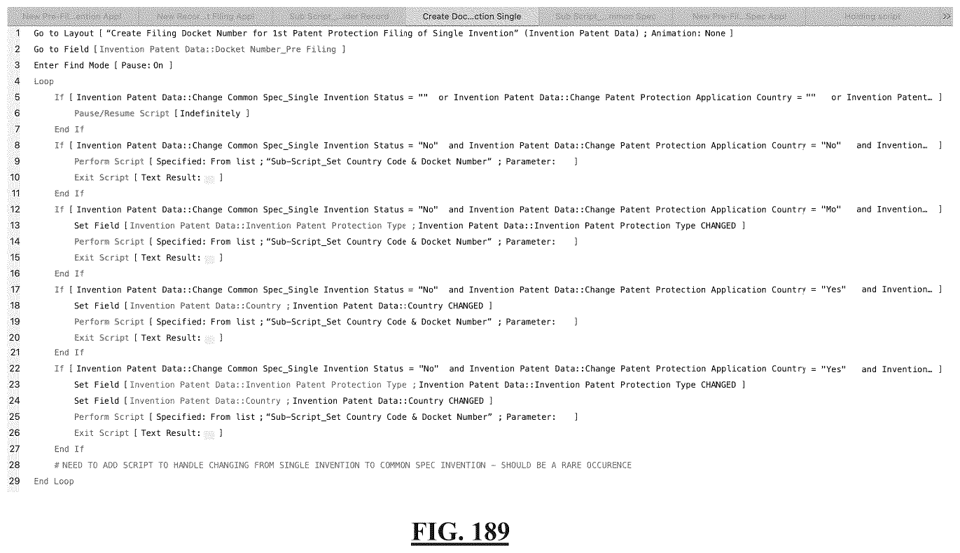

FIG. 189 is a schematic block diagram of a further example of programming language of an invention protection database (of a private patent tracking database of an improved computer for technology) to generate a new record and/or a new docket number for an invention of a common spec.

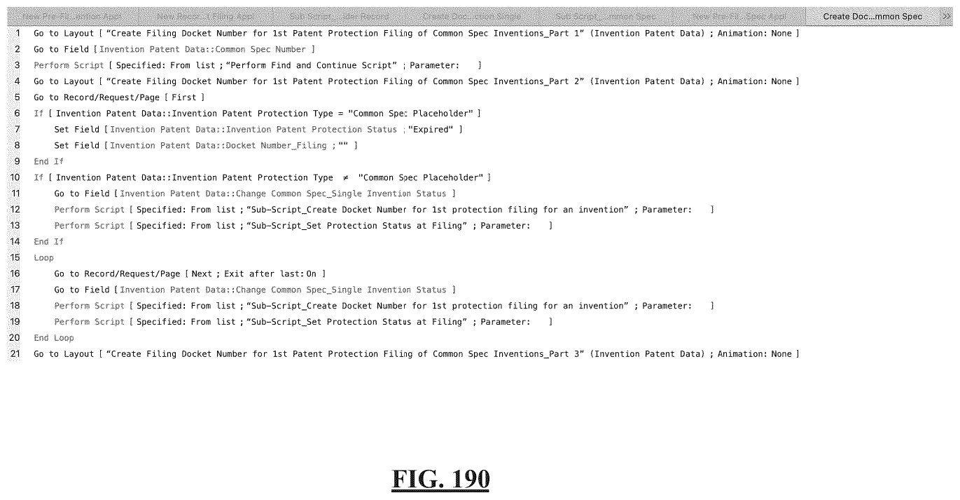

FIG. 190 is a schematic block diagram of a further example of programming language of an invention protection database (of a private patent tracking database of an improved computer for technology) to generate a new record and/or a new docket number for an invention of a common spec.

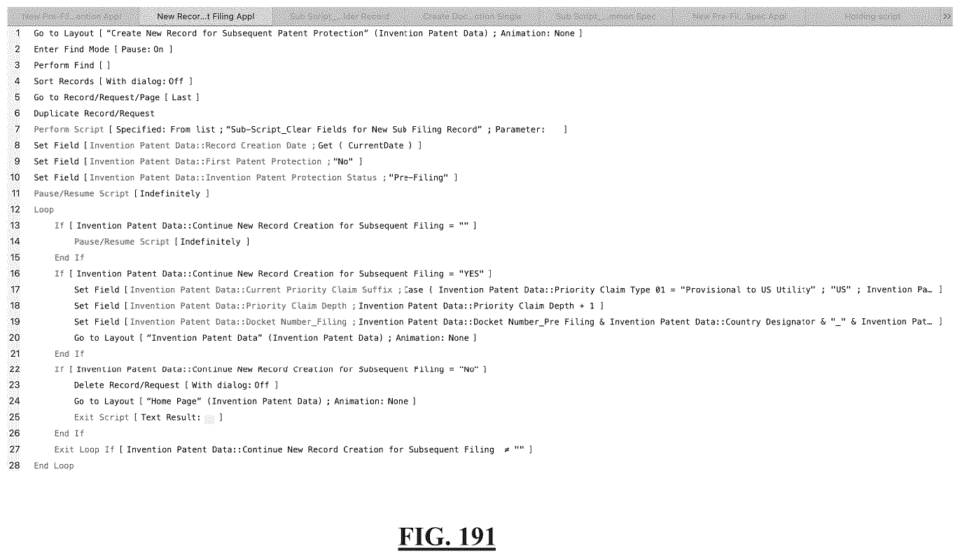

FIG. 191 is a schematic block diagram of an example of a data input layout of an invention protection database (of a private patent tracking database of an improved computer for technology) regarding the generation of a new record and/or of a new docket number for patent protection of an invention.

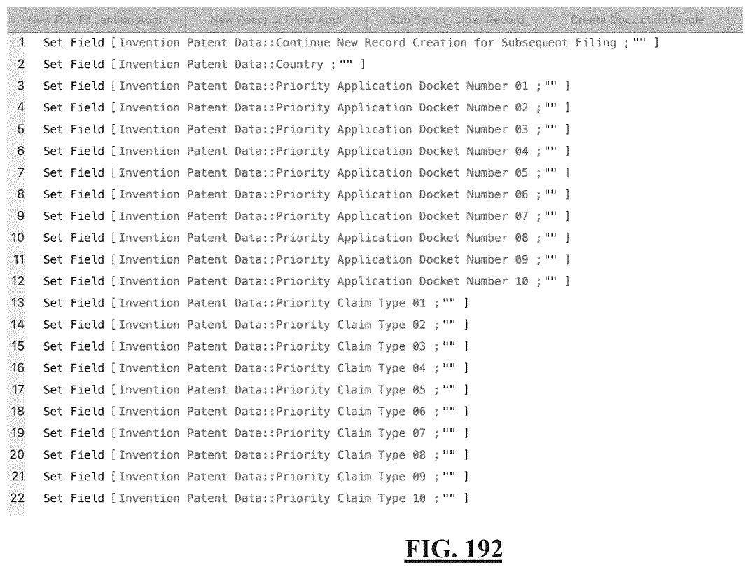

FIG. 192 is a schematic block diagram of a further example of a data input layout of an invention protection database (of a private patent tracking database of an improved computer for technology) regarding the generation of a new record and/or of a new docket number for patent protection of an invention.

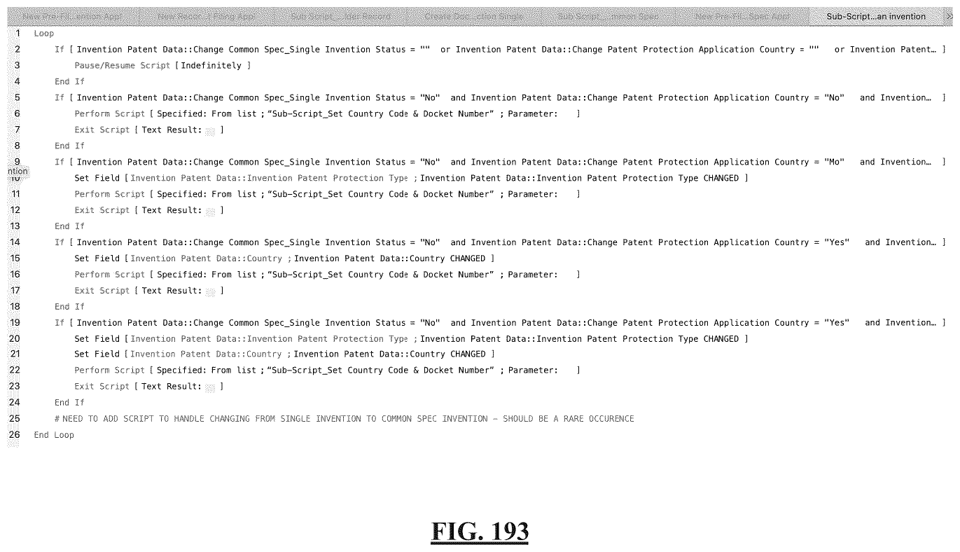

FIG. 193 is a schematic block diagram of a further example of a data input layout of an invention protection database (of a private patent tracking database of an improved computer for technology) regarding the generation of a new record and/or of a new docket number for patent protection of an invention.

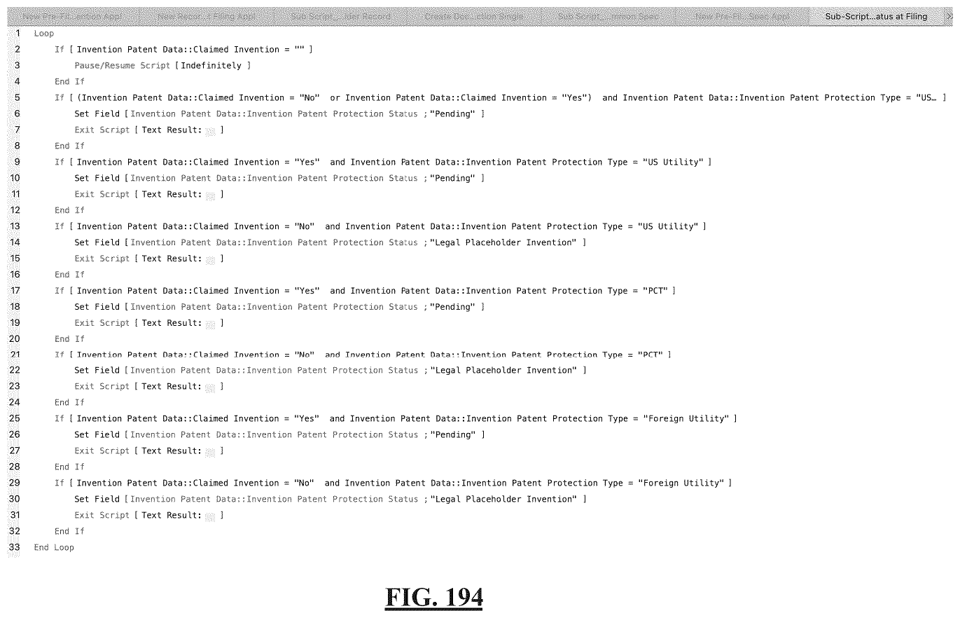

FIG. 194 is a schematic block diagram of a further example of a data input layout of an invention protection database (of a private patent tracking database of an improved computer for technology) regarding the generation of a new record and/or of a new docket number for patent protection of an invention.

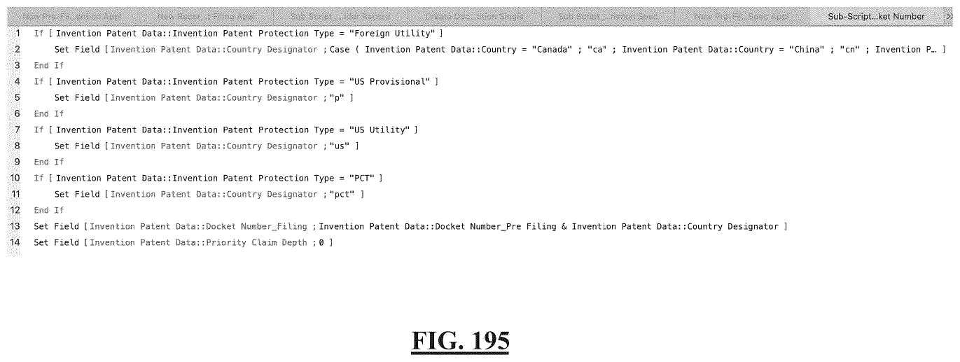

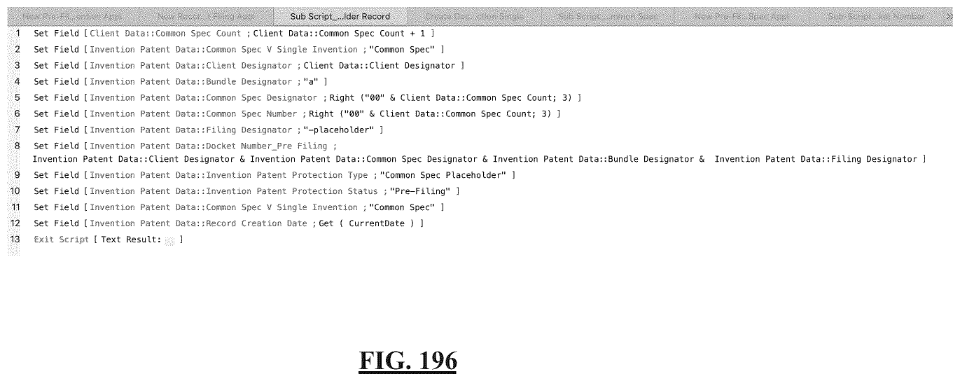

FIG. 195 is a schematic block diagram of a further example of a data input layout of an invention protection database (of a private patent tracking database of an improved computer for technology) regarding the generation of a new record and/or of a new docket number for patent protection of an invention.

FIG. 196 is a schematic block diagram of a further example of a data input layout of an invention protection database (of a private patent tracking database of an improved computer for technology) regarding the generation of a new record and/or of a new docket number for patent protection of an invention.

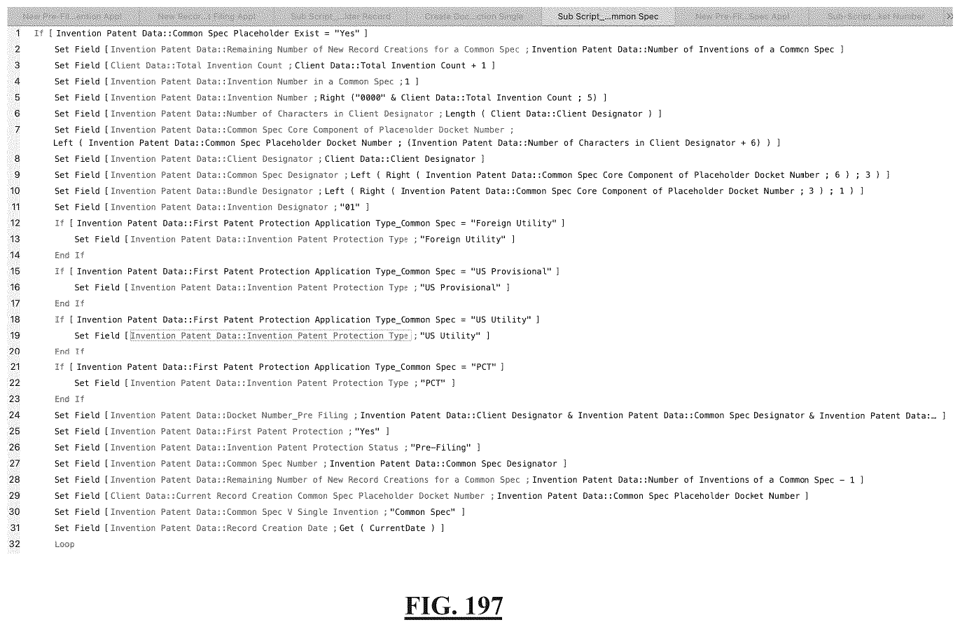

FIG. 197 is a schematic block diagram of a further example of a data input layout of an invention protection database (of a private patent tracking database of an improved computer for technology) regarding the generation of a new record and/or of a new docket number for patent protection of an invention.

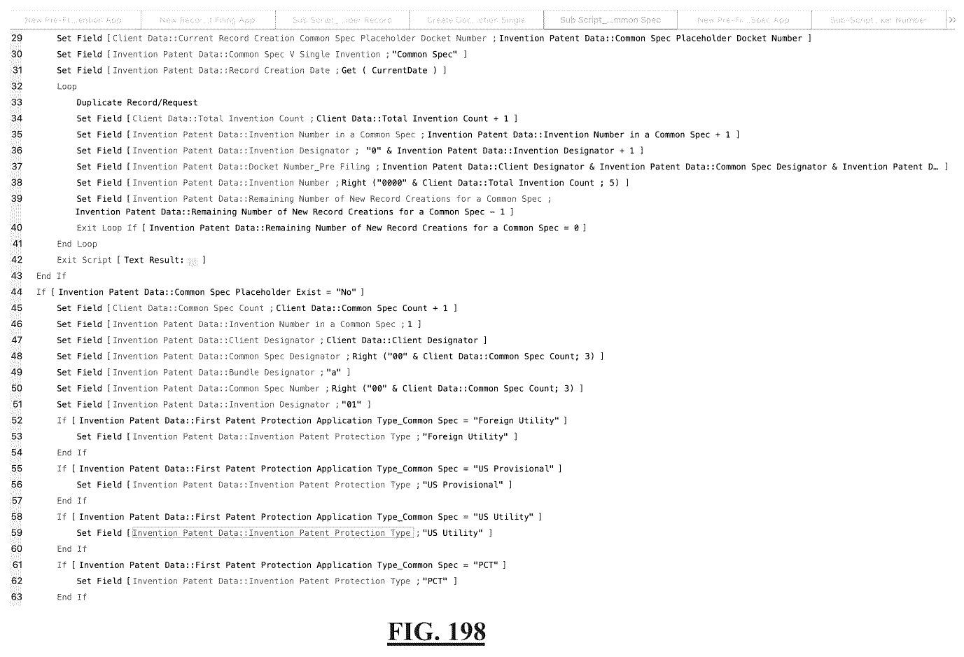

FIG. 198 is a schematic block diagram of a further example of a data input layout of an invention protection database (of a private patent tracking database of an improved computer for technology) regarding the generation of a new record and/or of a new docket number for patent protection of an invention.

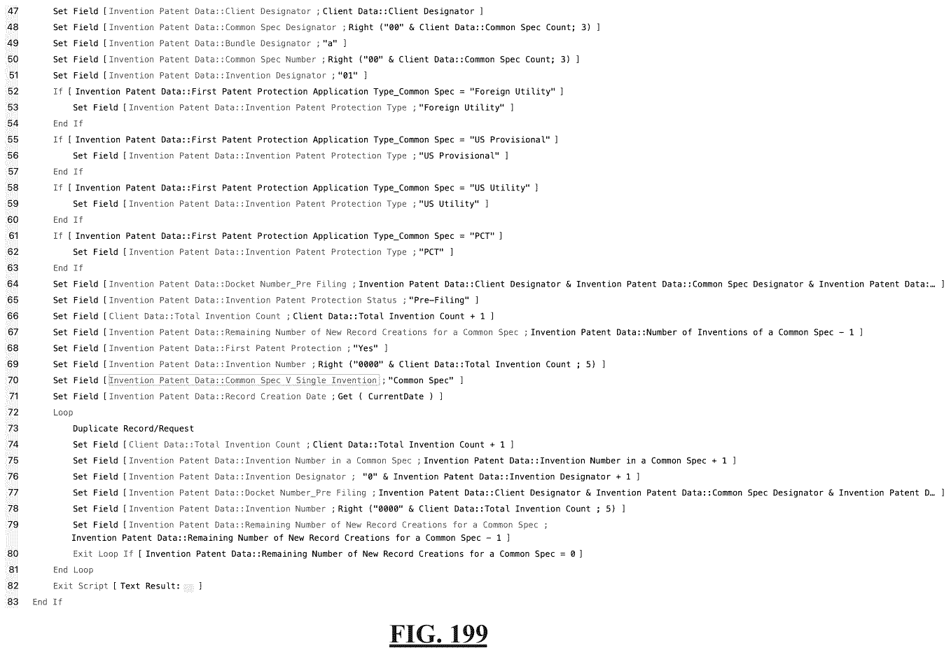

FIG. 199 is a schematic block diagram of a further example of a data input layout of an invention protection database (of a private patent tracking database of an improved computer for technology) regarding the generation of a new record and/or of a new docket number for patent protection of an invention.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form of a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for generating a docket number, the method comprises:
determining, by a computing entity, whether a specification of an application includes a detailed discussion for a single invention or for a plurality of inventions;
when the specification includes the detailed discussion for the plurality of inventions,
generating, by the computing entity, a common specification number;
generating, by the computing entity, a common specification designator,
generating, by the computing entity, a plurality of invention numbers, wherein a first invention number of the plurality of invention numbers corresponds to a first invention of the plurality of inventions;
generating, by the computing entity, a plurality of protection type designators, wherein a first protection type designator of the plurality of protection type designators corresponds to the first invention; and
for the first invention, combining, by the computing entity, the common specification number, the common specification designator, the first invention number, and the first protection type designator to produce a first docket number for the first invention.
